(19) United States
(12) Patent Application Publication
(10) Pub. No.: US 2026/0220072 A1
(43) Pub. Date: Jul. 30, 2026

(54) Translating Between UALink UPLI Requests and CXL.cache Messages for Scalable AI Inference Memory Expansion Beyond the Accelerator Memory Wall

(71) Applicant: UnifabriX Ltd., Haifa (IL)

(72) Inventors: Ronen Aharon Hyatt, Haifa (IL); Gaya Opal Hyatt, Haifa (IL); Ethan Sharon Hyatt, Haifa (IL); Gil Thieberger, Kiryat Tivon (IL)

(73) Assignee: UnifabriX Ltd., Haifa (IL)

(21) Appl. No.: 19/630,287

(22) Filed: Mar. 26, 2026

Related U.S. Application Data
(63) Continuation-in-part of application No. 19/371,779, filed on Oct. 28, 2025.
Application No. 19/371,779 is a continuation of application No. 19/017,420, filed on Jan. 11, 2025, now Pat. No. 12,613,826.
Application No. 19/017,420 is a continuation-in-part of application No. 18/981,443, filed on Dec. 13, 2024.
(60) Provisional application No. 63/609,833, filed on Dec. 13, 2023.
(60) Provisional application No. 63/641,404, filed on May 1, 2024.
(60) Provisional application No. 63/652,165, filed on May 27, 2024.
(60) Provisional application No. 63/678,045, filed on Jul. 31, 2024.
(60) Provisional application No. 63/695,957, filed on Sep. 18, 2024.
(60) Provisional application No. 63/701,554, filed on Sep. 30, 2024.
(60) Provisional application No. 63/719,640, filed on Nov. 12, 2024.
(60) Provisional application No. 63/734,031, filed on Dec. 13, 2024.
(60) Provisional application No. 63/743,658, filed on Jan. 10, 2025.
(60) Provisional application No. 63/752,940, filed on Feb. 3, 2025.
(60) Provisional application No. 63/784,089, filed on Apr. 5, 2025.
(60) Provisional application No. 63/811,859, filed on May 25, 2025.
(60) Provisional application No. 63/826,342, filed on Jun. 18, 2025.
(60) Provisional application No. 63/856,653, filed on Aug. 3, 2025.
(60) Provisional application No. 63/874,393, filed on Sep. 2, 2025.
(60) Provisional application No. 63/895,053, filed on Oct. 7, 2025.
(60) Provisional application No. 63/906,709, filed on Oct. 28, 2025.
(60) Provisional application No. 63/931,124, filed on Dec. 4, 2025.
(60) Provisional application No. 63/991,122, filed on Feb. 25, 2026.

(51) Int. Cl. G06F 13/42

(52) U.S. Cl. CPC G06F 13/4221; G06F 2213/0026

(57) ABSTRACT

Translating between UALink Protocol Level Interface (UPLI) and CXL.cache Device-to-Host (D2H) messages enables memory access across different protocol domains. Some implementations describe receiving, from a first entity, a UPLI request comprising a read command; translating, by a Resource Provisioning Unit (RPU), the UPLI request to a CXL.cache D2H request comprising a read opcode; sending the CXL.cache D2H request to a second entity; receiving a CXL.cache Host-to-Device (H2D) data message; translating the H2D data message to a UPLI read response; and sending the UPLI read response to the first entity. Other implementations describe an apparatus with a UPLI interface, a CXL.cache interface, and a computer that translates between the two protocols. Yet other implementations describe a system with an accelerator, a host, and an RPU coupled between them for cross-protocol memory access.

### CROSS-REFERENCE TO RELATED APPLICATIONS

This Application claims priority to: U.S. Provisional Patent Application No. 63/991,122, filed Feb. 25, 2026; U.S. Provisional Patent Application No. 63/931,124, filed Dec. 4, 2025; U.S. Provisional Patent Application No. 63/906,709, filed Oct. 28, 2025; U.S. Provisional Patent Application No. 63/895,053, filed Oct. 7, 2025; U.S. Provisional Patent Application No. 63/874,393, filed Sep. 2, 2025; U.S. Provisional Patent Application No. 63/856,653, filed Aug. 3, 2025; U.S. Provisional Patent Application No. 63/826,342, filed Jun. 18, 2025; U.S. Provisional Patent Application No. 63/811,859, filed May 25, 2025; and U.S. Provisional Patent Application No. 63/784,089, filed Apr. 5, 2025. This Application is also a Continuation-In-Part of U.S. patent application Ser. No. 19/371,779, filed Oct. 28, 2025, which claims priority to: U.S. Provisional Patent Application No. 63/752,940, filed Feb. 3, 2025; U.S. Provisional Patent Application No. 63/743,658, filed Jan. 10, 2025; and U.S. Provisional Patent Application No. 63/734,031, filed Dec. 13, 2024. U.S. patent application Ser. No. 19/371,779 is a Continuation of U.S. patent application Ser. No. 19/017,420, filed Jan. 11, 2025, which claims priority to: U.S. Provisional Patent Application No. 63/719,640, filed 12 Nov. 2024; U.S. Provisional Patent Application No. 63/701,554, filed 30 Sep. 2024; U.S. Provisional Patent Application No. 63/695,957, filed 18 Sep. 2024; U.S. Provisional Patent Application No. 63/678,045, filed 31 Jul. 2024; U.S. Provisional Patent Application No. 63/652,165, filed 27 May 2024; and U.S. Provisional Patent Application No. 63/641,404, filed 1 May 2024. U.S. patent application Ser. No. 19/017,420 is also a Continuation-In-Part of U.S. patent application Ser. No. 18/981,443, filed Dec. 13, 2024, which claims priority to U.S. Provisional Patent Application No. 63/609,833, filed 13 Dec. 2023.

### BACKGROUND

The growth of artificial intelligence workloads, such as Large Language Models (LLMs) and Generative AI (GenAI) applications, alongside High-Performance Computing (HPC) applications, demands massive parallelization across accelerators while maintaining low-latency access to memory. Modern datacenter architectures increasingly rely on clusters of accelerators interconnected by high-speed fabrics to deliver computational throughput for training and inference workloads. These accelerators may be coupled with local memory, such as High Bandwidth Memory (HBM), and may also require access to additional memory beyond the local memory capacity to accommodate large datasets, model parameters, and intermediate computation results.

Ultra Accelerator Link (UALink) is a high-speed interconnect technology that enables communication among accelerators and switches in high-performance computing environments. UALink defines a Protocol Level Interface (UPLI) that specifies channels, commands, and fields for memory read and write transactions between originator and completer devices. UALink enables accelerators to form pods comprising a switch and accelerators, wherein the switch routes traffic among the accelerators according to the UALink-based protocol.

Compute Express Link (CXL) is an interconnect technology that enables cache-coherent memory access and high-bandwidth communication between hosts and devices. CXL defines sub-protocols including CXL.io for input/output operations, CXL.cache for cache coherency between hosts and devices, and CXL.mem for memory access between hosts and memory devices. CXL.cache enables devices to cache host memory with full coherency, utilizing distinct message channels for communication in different directions: Device-to-Host (D2H) channels carry requests, responses, and data from a device toward a host, and Host-to-Device (H2D) channels carry requests, responses, and data from a host toward a device.

### SUMMARY

Some of the following implementations describe methods, apparatus, and systems for translating between UALink Protocol Level Interface (UPLI) and CXL.cache to enable memory access across different protocol domains. In various implementations, a method comprises receiving, from a first entity, a UPLI request comprising a read command; translating, by a Resource Provisioning Unit (RPU), the UPLI request to a CXL.cache Device-to-Host (D2H) request comprising a read opcode; sending the CXL.cache D2H request to a second entity; receiving, from the second entity, a CXL.cache Host-to-Device (H2D) data message; translating, by the RPU, the CXL.cache H2D data message to a UPLI read response; and sending the UPLI read response to the first entity. The RPU may further translate UPLI write commands to CXL.cache D2H write opcodes. The translation may involve address translation, Tag-to-CQID mapping, and data aggregation when a UPLI request exceeds a maximum CXL.cache transaction size. The method may be performed by an active cable or a switch.

In other implementations, an apparatus comprises a first interface configured to communicate according to UPLI, a second interface configured to communicate according to CXL.cache, and a computer coupled to the first interface and the second interface. The computer is configured to translate a UPLI request comprising a read command, received via the first interface, to a CXL.cache D2H request comprising a read opcode, and send the CXL.cache D2H request via the second interface; and translate a CXL.cache H2D data message, received via the second interface, to a UPLI read response, and send the UPLI read response via the first interface. The apparatus may include a chiplet within an IC package of a processor coupled to a coherent interconnect. The apparatus may be incorporated in an active cable.

In yet other implementations, a method comprises executing, by an accelerator comprising local memory, an inference workload on a neural network model; sending a UPLI request comprising a read command for model data stored in a host memory of a host; translating, by an RPU, the UPLI request to a CXL.cache D2H request comprising a read opcode; and receiving, from the host, a CXL.cache H2D data message comprising the model data. The RPU translates the H2D data message to a UPLI read response and sends it to the accelerator. The model data may include expert weights associated with a Mixture-of-Experts (MoE) model, key-value (KV) cache entries, or attention parameters.

In yet other implementations, a system comprises an accelerator comprising local memory and configured to communicate according to UPLI, a host comprising host memory and configured to communicate according to CXL.cache, and an RPU coupled between the accelerator and the host. The RPU comprises a first interface configured to communicate with the accelerator according to UPLI and a second interface configured to communicate with the host according to CXL.cache. The RPU is configured to translate UPLI requests to CXL.cache D2H requests and translate CXL.cache H2D data messages to UPLI read responses, whereby the accelerator accesses the host memory via the RPU. The host memory capacity may exceed the local memory capacity, and a UALink switch may couple accelerators to the RPU.

### BRIEF DESCRIPTION OF THE DRAWINGS

FIG. 1A illustrates an example of a system that translates between UALink-based traffic and CXL.cache traffic when communicating with a host;

FIG. 1B illustrates an example of a TFD demonstrating translations between a UPLI request and a CXL.cache D2H RdCurr request;

FIG. 1C illustrates an example of a TFD demonstrating translations between a UPLI request and a CXL.cache D2H RdShared request;

FIG. 2A illustrates an example of a system that translates between UALink-based traffic and CXL.cache traffic when communicating with a device;

FIG. 2B illustrates an example of a TFD demonstrating translations between a UPLI request and a CXL.cache H2D SnpCur request;

FIG. 2C illustrates an example of a TFD demonstrating translations between a UPLI request and a CXL.cache H2D SnpData request;

FIG. 3A illustrates an example of a system comprising a processor comprising an RPU chiplet that translates between UALink and CXL;

FIG. 3B illustrates an example of a TFD demonstrating translating a UPLI request to a protocol utilized by a processor's coherent interconnect;

FIG. 4A illustrates an example of a system comprising a cable that translates between UALink-based traffic and CXL-based traffic;

FIG. 4B illustrates an example of an active optical cable comprising an RPU that translates between UALink-based traffic and CXL-based traffic;

FIG. 5A illustrates an example of a system that translates between UALink-based traffic and CXL-based traffic;

FIG. 5B illustrates an example of a TFD demonstrating translations between a UPLI transaction comprising UPLI read response/data and a CXL transaction;

FIG. 5C illustrates an example of a TFD demonstrating translations between a UPLI transaction comprising UPLI write response and a CXL transaction;

FIG. 6 illustrates an example of a system wherein inference context data is migrated between accelerator local memory and the CXL memory device across UALink and CXL protocol domains;

FIG. 7A illustrates an example of a TFD demonstrating intent-based translations between CXL.mem M2S SnpCur and CXL.cache D2H RdCurr;

FIG. 7B illustrates an example of a TFD demonstrating intent-based translations between CXL.mem M2S SnpData and CXL.cache D2H RdShared;

FIG. 7C illustrates an example of a TFD demonstrating intent-based translations between CXL.mem M2S SnpInv and CXL.cache D2H RdOwn;

FIG. 8A illustrates an example of a TFD demonstrating intent-based translations between CXL.cache D2H RdCurr and CXL.mem M2S SnpCur;

FIG. 8B illustrates an example of a TFD demonstrating intent-based translations between CXL.cache D2H RdShared and CXL.mem M2S SnpData;

FIG. 8C illustrates an example of a TFD demonstrating intent-based translations between CXL.cache D2H RdOwn and CXL.mem M2S SnpInv;

FIG. 9A illustrates an example of a system comprising an RPU that translates between UALink-based traffic and CXL.mem-based traffic;

FIG. 9B illustrates an example of a TFD demonstrating translations between UPLI request and CXL.mem M2S Req MemRd;

FIG. 10A illustrates an example of a system comprising an RPU that enables UALink-based entities to access CXL-based resources coupled to the RPU;

FIG. 10B illustrates an example of a TFD demonstrating intent-based translation between UPLI and CXL.mem;

FIG. 11A illustrates an example of a system comprising a processor comprising a UALink port enabling external entities to access memory resources mapped to an address space utilized by the processor's coherent interconnect;

FIG. 11B illustrates an example of a TFD demonstrating two UPLI requests forwarded to different memories mapped to an address space utilized by a processor's coherent interconnect;

FIG. 12A illustrates an example of a system comprising a processor comprising a coherent interconnect, a UALink port, and a CXL RP;

FIG. 12B illustrates an example of a TFD demonstrating translating two UPLI requests to a coherent interconnect request and to a CXL.mem request;

FIG. 13A illustrates an example of a system that translates between UALink-based traffic and CXL.mem traffic;

FIG. 13B illustrates an example of a TFD demonstrating translations between UPLI request and CXL.mem request, with an optional speculative memory read;

FIG. 14A illustrates an example of a processing pipeline for extracting passenger protocol messages from carrier protocol communications received over a PHY based on IEEE 802.3 PMA;

FIG. 14B illustrates an example of a packet structure that may be suitable for L3 switching operations;

FIG. 14C illustrates an example of a packet structure that may be suitable for L2 switching operations;

FIG. 15A, FIG. 15B, and FIG. 15C illustrate three examples of variations for the Passenger Protocol PDU that may be encapsulated within the Carrier Protocol PDU illustrated in FIG. 14B;

FIG. 16A and FIG. 16B illustrate examples of translating between CXL.mem and UALink-based protocol;

FIG. 17A illustrates an example of an RPU comprising a cache, which translates between CXL.mem and UPLI;

FIG. 17B illustrates an example of an RPU without a cache, translates between CXL.mem and UPLI;

FIG. 18 illustrates an example of a host CPU accessing various devices over CXL.mem to UALink;

FIG. 19A illustrates an example of a system comprising a cable configured to translate between CXL and NVLink;

FIG. 19B illustrates an example of a TFD demonstrating translating between CXL.mem M2S MemRd request and NVLink read request;

FIG. 20A and FIG. 20B illustrate examples comprising an RPU with a cache that differentiates between requests received from a UALink network and requests received from local CUs when translating to CXL.cache;

FIG. 21A illustrates an example of a system comprising a CXL entity coupled to a host via CXL.cache, the host coupled to a UALink entity and includes an RPU that translates between CXL and UALink;

FIG. 21B illustrates an example of a TFD demonstrating translation of a CXL.cache D2H request from a CXL entity to a UPLI request targeting a UALink entity;

FIG. 22A illustrates an example of a system comprising an accelerator with an RPU and a cache, coupled via a UALink switch to another accelerator and coupled via CXL.cache to a host;

FIG. 22B illustrates an example of TFD demonstrating cache miss and cache hit behavior for UPLI read requests translated to CXL.cache requests;

FIG. 23A illustrates an example of a system that translates between CXL-based traffic and UALink-based traffic;

FIG. 23B illustrates an example of a TFD demonstrating translations between a CXL transaction and a UPLI transaction comprising UPLI read response/data;

FIG. 23C illustrates an example of a TFD demonstrating translations between a CXL transaction and a UPLI transaction comprising UPLI write response;

FIG. 24A illustrates an example of a system comprising a processor comprising an NVLink interface, processing cores, LLC, a CXL RP, and memory controllers coupled via memory channels to memory;

FIG. 24B illustrates an example of a transaction flow diagram (TFD) demonstrating translations from NVLink traffic to traffic conforming to a protocol utilized by a processor's coherent interconnect, utilizing CXL.cache as an intermediate protocol;

FIG. 25A illustrates an example of a system comprising a computer coupled between a first interface communicating according to an NVLink-based protocol and a second interface communicating according to CXL.cache;

FIG. 25B illustrates an example of a cable comprising an NVLink port and a CXL port, with an RPU integrated into the cable;

FIG. 25C illustrates an example of a TFD demonstrating translations between NVLink-based requests and CXL.cache requests;

FIG. 26A illustrates an example of a system comprising an xPU with an RPU that translates between CXL.cache and NVLink;

FIG. 26B illustrates an example of a TFD demonstrating translation of a CXL.cache D2H request to an NVLink read request and translation of the NVLink response to a CXL.cache H2D Data message;

FIG. 27A illustrates an example of a system comprising an xPU with an RPU, a cache, and a local memory, showing two access paths for CXL.cache D2H requests;

FIG. 27B illustrates an example of a TFD demonstrating two CXL.cache D2H request flows: a first flow served from local memory with cache state transition, and a second flow translated to an NVLink read request;

FIG. 28A illustrates an example of a system comprising a computer coupled between an NVLink-based interface and a CXL.cache interface;

FIG. 28B illustrates an example of a TFD demonstrating translation of an NVLink read request to a CXL.cache H2D request comprising SnpCur;

FIG. 28C illustrates an example of a TFD demonstrating translation of an NVLink read request to a CXL.cache H2D request comprising SnpData;

FIG. 29A illustrates an example of GPU/CPU coupled to an xPU comprising dies coupled by chip-to-chip interfaces;

FIG. 29B illustrates an example of a custom accelerator comprising an NVLink Fusion chiplet;

FIG. 30A illustrates an example of a system that translates between NVLink-based traffic and CHI-based coherent interconnect traffic;

FIG. 30B illustrates an example of a TFD showing the translation of NVLink read request to CHI ReadOnce request;

FIG. 31A illustrates an example of a system that translates between NVLink-based traffic and ARM CHI traffic;

FIG. 31B illustrates an example of an RPU that translates between NVLink traffic and CHI traffic, utilizing an intermediate protocol based on ARM AMBA ACE-Lite;

FIG. 32A illustrates an example of a system that translates between NVLink traffic and CHI-based traffic;

FIG. 32B illustrates an example of an RPU that translates between NVLink traffic and CHI traffic;

FIG. 33A illustrates an example of a TFD showing translating an NVLink read request to a PCIe UIO read request to an ARM CHI ReadOnce request;

FIG. 33B illustrates an example of a TFD showing translating an NVLink read request to a CXL.cache RdCurr request to an ARM CHI ReadOnce request;

FIG. 34A illustrates an example of a system comprising an external entity coupled to an optional NVLink switch coupled to a processor comprising an RPU comprising an NVLink interface, a Request Agent (RA) Proxy, and a Home Agent (HA) Proxy;

FIG. 34B illustrates an example of a system comprising a processor comprising NVLink chiplets (such as NVLink Fusion) to translate between NVLink and CHI;

FIG. 35A illustrates an example of a system comprising an xPU comprising an RPU that translates between NVLink traffic and CHI traffic;

FIG. 35B illustrates an example of a system comprising an entity including NVLink and CXL ports coupled to CHI interfaces that enable memory access via a processor's coherent interconnect;

FIG. 36A illustrates an example of a system comprising a processor comprising an NVLink chiplet coupled via NVLink-C2C to the processor's coherent interconnect;

FIG. 36B illustrates an example of a system comprising an xPU coupled to a GPU utilizing an RPU that translates between NVLink traffic and CHI-based traffic;

FIG. 37A illustrates an example of a system functioning as a multi-protocol memory switch appliance or a multi-protocol memory pool comprising NVLink-based interfaces;

FIG. 37B illustrates an example of a TFD depicting a multi-entity memory access scenario wherein separate NVLink and UALink transactions utilize the same coherent interconnect infrastructure for memory access;

FIG. 38 illustrates an example of a heterogeneous computing system comprising an NVLink chiplet coupled to an accelerator based on ARM mesh architecture; and

FIG. 39 illustrates an example of utilizing a node controller to connect processors of a memory pool.

### DETAILED DESCRIPTION

In environments where entities may utilize different protocols while requiring access to shared memory resources, there may be scenarios where a first entity communicating according to UPLI, such as an accelerator or a UALink switch, needs to access memory resources residing in a CXL domain, such as host memory accessible via a CXL host. An RPU or other suitable device may translate between UPLI and CXL.cache to facilitate memory operations across different protocol domains. The translation may involve converting UPLI requests comprising read or write commands to CXL.cache D2H requests comprising corresponding read or write opcodes, and converting CXL.cache H2D data messages and responses to UPLI read responses, including translations of addresses, Tags, CQIDs, and data formats.

In various implementations, a method comprising: receiving, from a first entity, an Ultra Accelerator Link Protocol Level Interface (UPLI) request comprising a read command; translating, by a Resource Provisioning Unit (RPU), the UPLI request to a CXL.cache Device-to-Host (D2H) request comprising a read opcode, wherein CXL denotes Compute Express Link; sending the CXL.cache D2H request to a second entity; receiving, from the second entity, a CXL.cache Host-to-Device (H2D) data message; translating, by the RPU, the CXL.cache H2D data message to a UPLI read response; and sending the UPLI read response to the first entity. The method translates between UPLI and CXL.cache domains. The RPU receives UPLI requests containing read commands which may include Read commands, AtomicR commands, Vendor Defined Commands with read data returned over the UPLI read response/data (Rd Rsp/Data) Channel, or other read command types supported by UPLI. The RPU translates these read commands into corresponding CXL.cache read opcodes such as RdCurr, RdOwn, RdShared, or RdAny. The translation adapts the operation to the requirements and capabilities of the domain. Upon receiving data responses from the CXL host, the RPU translates the data for the originator, which enables communication between the UPLI and CXL domains while abstracting the protocol differences from both sides.

In some implementations of the method, the UPLI request comprises a source accelerator identifier and a destination accelerator identifier, and the UPLI read response comprises a destination accelerator identifier carrying a value that matches the source accelerator identifier from the UPLI request, and wherein the RPU saves at least the source accelerator identifier from the UPLI request for use in generating the UPLI read response. In some examples, the UPLI request includes identifiers that specify both the source and destination accelerators. The RPU saves at least the source accelerator identifier upon receiving the UPLI request. When generating the UPLI read response, the RPU uses the saved source accelerator identifier from the request as the destination accelerator identifier in the response for proper message routing back to the original requester. In some examples, the RPU may also save the destination accelerator identifier from the UPLI request, and include a source accelerator identifier in the UPLI read response, such as for debugging purposes, however such inclusion is not required for basic functionality.

In some implementations of the method, the UPLI request further comprises a first address and a first Tag, the CXL.cache D2H request comprises a second address translated from the first address and a command queue identifier (CQID) associated with the first Tag, and the UPLI read response comprises the first Tag. In some examples, the RPU performs address translation between physical addresses within UALink address space and physical addresses within CXL.cache address space while maintaining correlations between requests and responses utilizing Tag/CQID mapping. The RPU translates the UALink address to a corresponding CXL.cache address based on configured address mappings. Additionally, the RPU maintains a mapping between UPLI Tags and CXL.cache CQIDs to properly associate responses with their originating requests. This mapping enables the RPU to include the original UPLI Tag in the UPLI read response, allowing the originator to correlate responses with its outstanding requests.

In some implementations of the method, the UPLI request further comprises a length field indicating an amount of data requested; and wherein translating the UPLI request comprises generating multiple CXL.cache D2H requests when the amount of data requested exceeds a maximum CXL.cache transaction size. The RPU may handle UPLI requests that specify data transfers larger than what a CXL.cache transaction can support. The length field in the UPLI request indicates the amount of data requested, which can be up to 256 bytes, while CXL.cache transactions typically handle up to 64 bytes each. When the requested data size exceeds the CXL.cache transaction size limit, the RPU may segment the request into multiple CXL.cache transactions. For example, a 256-byte UPLI request would be translated into four 64-byte CXL.cache transactions, and the RPU manages these multiple transactions while maintaining the appearance of a single operation to the originator.

In some implementations of the method, the UPLI request comprises a Tag, the CXL.cache D2H requests comprise command queue identifiers (CQIDs); and wherein generating the multiple CXL.cache D2H requests comprises associating multiple CQIDs with the Tag. When handling large data transfers that require multiple CXL.cache transactions, the RPU may implement Tag-to-CQID mapping. For a UPLI comprising one Tag, the RPU may generate and track multiple CQIDs, one for each CXL.cache transaction. For example, if a UPLI request comprising Tag #1 requires four CXL.cache transactions, the RPU may generate CQIDs #1 through #4, maintaining mappings between the CQIDs and the original Tag #1. This mapping enables the RPU to associate the relevant CXL.cache responses with the original UPLI request and generate a consolidated response.

In some implementations of the method, translating the CXL.cache H2D data message further comprises: receiving multiple CXL.cache H2D data messages corresponding to the multiple CXL.cache D2H requests, aggregating data from the multiple CXL.cache H2D data messages, and including the aggregated data in the UPLI read response. When handling large data transfers that were split into multiple CXL.cache transactions, the RPU may perform data aggregation before generating the UPLI read response. The RPU receives multiple CXL.cache H2D data messages collectively containing the requested data, which are collected and optionally reassembled in a predetermined order to form a complete data payload. The RPU may manage this aggregation process while maintaining data integrity and proper ordering, such that the originator receives a single, coherent response containing the requested data.

In some implementations of the method, the read opcode of the CXL.cache D2H request is RdCurr, and processing the CXL.cache D2H request does not change existing state in a cache accessible to the RPU. In some examples, the RPU translates the UPLI read command into a CXL.cache D2H request comprising RdCurr, thereby indicating that the memory read is performed using a current state read function, which means that the RPU either does not issue cache commands, or processing the CXL.cache RdCurr request does not change existing state in a cache accessible to the RPU.

In some implementations of the method, the read command is selected from at least one of: a Read command, an AtomicR command, or a Vendor Defined Command with read data returned over a UPLI read response/data (Rd Rsp/Data) Channel; and wherein the read opcode is selected from at least one of: RdCurr, RdOwn, RdShared, or RdAny. The RPU may support translation between various types of read commands in the UPLI domain and read opcodes in the CXL domain. The UPLI read commands may include one or more of memory reads, atomic operations that provide atomicity guarantees, and/or Vendor Defined read commands for custom functionality. The UPLI read commands are translated to appropriate CXL.cache read opcodes based on the operation's requirements. For example, RdCurr requests the current value without changing cache states, RdOwn obtains exclusive ownership, RdShared enables shared access, and RdAny allows flexible coherency state transitions.

In some implementations of the method, the CXL.cache H2D data message comprises first data in a first format; and wherein translating the CXL.cache H2D data message comprises transforming the first data to second data in a second format for the UPLI read response. The RPU may need to transform data between different formats as it moves between UPLI and CXL.cache domains, which may involve changes in data organization, alignment, or representation. The RPU can maintain data integrity while performing the applicable format conversions to meet the requirements of the protocol. The first format may be optimized for CXL.cache operations, while the second format adheres to UPLI specifications for data transfer.

In some implementations, the method further comprises receiving, from the first entity, a UPLI request comprising a write command and write data; translating, by the RPU, the UPLI request comprising the write command to a CXL.cache D2H request comprising a write opcode selected from at least one of: DirtyEvict, ItoMWr, WrCur, or WrInv; and sending the CXL.cache D2H request comprising the write opcode and the write data to the second entity; wherein the first entity comprises a UPLI originator, an accelerator, or a UALink switch; and wherein the second entity comprises a CXL host; and wherein the RPU comprises a CXL device exposing a CXL endpoint to the second entity. The RPU may translate UPLI write commands to CXL.cache D2H write opcodes. DirtyEvict may be utilized when evicting a modified cacheline from the RPU, ItoMWr may be utilized for write operations that upgrade the cacheline from Invalid to Modified state, WrCur may write to a cacheline on a cache hit or to memory on a cache miss, and WrInv may write data while invalidating the cacheline. In some examples, the first entity may be a UPLI originator, such as an accelerator or a UALink switch, that initiates the write transaction, and the second entity may be a CXL host that receives the translated CXL.cache D2H write request. The RPU may expose a CXL endpoint, such as a Type-1 or Type-2 CXL device, to the CXL host for CXL.cache communication.

In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

An apparatus may include a first interface configured to communicate according to UPLI and a second interface configured to communicate according to CXL.cache, with a computer coupled to both interfaces and configured to translate between the two protocol domains. The apparatus may be implemented as a discrete component, an IP block embedded within an accelerator or a processor, a chiplet within an IC package, or may be integrated into an active cable. The computer may maintain mappings between UPLI Tags and CXL.cache CQIDs, perform address translations between UALink and CXL address spaces, and aggregate data from multiple CXL.cache transactions when a UPLI request exceeds a maximum CXL.cache transaction size. The first interface may include a UPLI completer that receives UPLI requests from a UPLI originator.

In various implementations, an apparatus comprising: a first interface configured to communicate according to an Ultra Accelerator Link Protocol Level Interface (UPLI); a second interface configured to communicate according to CXL.cache, wherein CXL denotes Compute Express Link; and a computer coupled to the first interface and the second interface, the computer configured to: translate a UPLI request comprising a read command, received via the first interface, to a CXL.cache Device-to-Host (D2H) request comprising a read opcode, and send the CXL.cache D2H request via the second interface; and translate a CXL.cache Host-to-Device (H2D) data message, received via the second interface, to a UPLI read response, and send the UPLI read response via the first interface.

In some implementations of the apparatus, the UPLI request comprises a source accelerator identifier and a destination accelerator identifier, the UPLI read response comprises a destination accelerator identifier carrying a value that matches the source accelerator identifier from the UPLI request; and wherein the computer is configured to save at least the source accelerator identifier from the UPLI request for use in generating the UPLI read response. In some examples, the computer processes identifier information embedded in UPLI messages by saving at least the source accelerator identifiers from incoming UPLI requests, and generating UPLI read responses by using the saved source accelerator identifier as the destination accelerator identifier in the response for proper message routing back to the original requester. Optionally, the computer may also save the destination accelerator identifier from the UPLI request, and include a source accelerator identifier in the UPLI read response, such as for debugging purposes, however such inclusion is not required for basic functionality.

In some implementations of the apparatus, the UPLI request further comprises a first address and a first Tag, the CXL.cache D2H request comprises a second address translated from the first address and a command queue identifier (CQID) associated with the first Tag, and the UPLI read response comprises the first Tag; and wherein the computer is further configured to receive, via the second interface, a CXL.cache H2D response comprising a Global Observation (GO) opcode and the CQID, the GO opcode indicating a cache coherency state. In some examples, the computer performs address translation between physical addresses within UALink address space and physical addresses within CXL.cache address space, while maintaining correlations between requests and responses utilizing Tag/CQID mapping. The computer translates the UALink address to a corresponding CXL.cache address based on configured address mappings. Additionally, the computer maintains a mapping between UPLI Tags and CXL.cache CQIDs to properly associate responses with their originating requests. This mapping enables the computer to include the original UPLI Tag in the UPLI read response, allowing the originator to correlate responses with its outstanding requests.

In some implementations of the apparatus, the UPLI request further comprises a length field indicating an amount of data requested; and wherein the computer is further configured to generate multiple CXL.cache D2H requests when the amount of data requested exceeds a maximum CXL.cache transaction size. The computer may handle UPLI requests that specify data transfers larger than what a single CXL.cache transaction can support. The length field in the UPLI request indicates the amount of data requested, which can be up to 256 bytes, while CXL.cache transactions typically handle up to 64 bytes each. When the requested data size exceeds the CXL.cache transaction size limit, the computer may segment the request into multiple CXL.cache transactions. For example, a 256-byte UPLI request would be translated into four 64-byte CXL.cache transactions, and the computer manages these multiple transactions while maintaining the appearance of a single operation to the originator.

In some implementations of the apparatus, the UPLI request comprises a Tag, the CXL.cache D2H requests comprise command queue identifiers (CQIDs); and wherein the computer is further configured to associate multiple CQIDs with the Tag when generating the multiple CXL.cache D2H requests. When handling large data transfers that require multiple CXL.cache transactions, the computer may implement Tag-to-CQID mapping. For a UPLI request comprising one Tag, the computer may generate and track multiple CQIDs, one for each CXL.cache transaction. This mapping enables the computer to associate the relevant CXL.cache responses with the original UPLI request and generate a consolidated response.

In some implementations of the apparatus, the computer is further configured to: receive multiple CXL.cache H2D data messages corresponding to the multiple CXL.cache D2H requests, aggregate data from the multiple CXL.cache H2D data messages, and include the aggregated data in the UPLI read response. When handling large data transfers that were split into multiple CXL.cache transactions, the computer may perform data aggregation before generating the UPLI read response. The computer receives multiple CXL.cache H2D data messages collectively containing the requested data, which are collected and optionally reassembled in a predetermined order to form a complete data payload. The computer may manage this aggregation process while maintaining data integrity and proper ordering, such that the originator receives a single, coherent response containing the requested data.

In some implementations of the apparatus, the read opcode of the CXL.cache D2H request is RdCurr, and as a result of processing the CXL.cache D2H request the computer is further configured not to change existing state in a cache accessible to the computer. In some examples, the computer translates the UPLI read command into a CXL.cache D2H request comprising RdCurr, thereby indicating that the memory read is performed using a current state read function. In some examples, the apparatus either does not issue cache commands, or when processing the CXL.cache RdCurr request it retrieves data in a manner that does not alter the existing state in a cache accessible to the apparatus.

In some implementations of the apparatus, the read command is selected from at least one of: a Read command, an AtomicR command, or a Vendor Defined Command with read data returned over a UPLI read response/data (Rd Rsp/Data) Channel; and wherein the read opcode is selected from at least one of: RdCurr, RdOwn, RdShared, or RdAny. The computer may support translation between various types of read commands in the UPLI domain and read opcodes in the CXL domain. The UPLI read commands may include one or more of memory reads, atomic operations that provide atomicity guarantees, and/or Vendor Defined read commands for custom functionality. The UPLI read commands are translated to appropriate CXL.cache read opcodes based on the operation's requirements. For example, RdCurr requests the current value without changing cache states, RdOwn obtains exclusive ownership, RdShared enables shared access, and RdAny allows flexible coherency state transitions.

In some implementations of the apparatus, the CXL.cache H2D data message comprises first data in a first format; and wherein the computer is further configured to transform the first data to second data in a second format for the UPLI read response. The computer may need to transform data between different formats as it moves between UPLI and CXL.cache domains, which may involve changes in data organization, alignment, or representation. The computer can maintain data integrity while performing the applicable format conversions to meet the protocol requirements. The first format may be optimized for CXL.cache operations, while the second format adheres to UPLI specifications for data transfer.

In some implementations of the apparatus, the computer is further configured to: translate a UPLI request comprising a write command and write data, received via the first interface, to a CXL.cache D2H request comprising a write opcode selected from at least one of: DirtyEvict, ItoMWr, WrCur, or WrInv; and send the CXL.cache D2H request comprising the write opcode and the write data via the second interface; wherein the first interface comprises a UPLI completer. The computer may translate UPLI write commands to CXL.cache D2H write opcodes. The first interface may include a UPLI completer, which may receive UPLI requests from a UPLI originator, such as an accelerator or a UALink switch.

In some implementations of the apparatus, the apparatus comprises a chiplet within an integrated circuit (IC) package of a processor, the processor comprising a coherent interconnect coupling processing cores to a memory controller; and wherein the second interface is coupled to the coherent interconnect via a CXL root port; whereby the computer translates UPLI requests to CXL.cache D2H requests that traverse the coherent interconnect to access memory coupled to the memory controller. The apparatus may be implemented as a chiplet within an IC package of a processor, such as an MxPU. The coherent interconnect, such as a ring or mesh interconnect, may couple processing cores, an LLC, a CXL RP, and a memory controller. The computer may utilize CXL.cache as an intermediate protocol for translating between UPLI and a protocol utilized by the coherent interconnect. The CXL root port may be included in the chiplet or may be part of the processor, and may communicate with the coherent interconnect via a Ring-to-CXL (R2CXL) interconnect interface.

In some implementations of the apparatus, an active cable comprising: a first pluggable module coupled to a first physical medium, a second pluggable module coupled to a second physical medium, and an apparatus according to claim 13 coupling the first and second physical media.

In AI inference environments, accelerators may execute neural network models whose aggregate data requirements exceed the capacity of the accelerator's local memory. Model data such as expert weights, KV cache entries, and attention parameters may be stored in host memory and fetched on demand during inference. An RPU may translate between UPLI utilized by the accelerator and CXL.cache utilized by the host, enabling the accelerator to read model data from the host memory and write inference context data back to the host memory across the protocol domain boundary.

In various implementations, a method comprising: executing, by an accelerator comprising local memory, an inference workload on a neural network model; sending, by the accelerator, an Ultra Accelerator Link Protocol Level Interface (UPLI) request comprising a read command for model data stored in a host memory of a host; translating, by a Resource Provisioning Unit (RPU), the UPLI request to a CXL.cache Device-to-Host (D2H) request comprising a read opcode, wherein CXL denotes Compute Express Link; sending the CXL.cache D2H request to the host; receiving, from the host, a CXL.cache Host-to-Device (H2D) data message comprising the model data; translating, by the RPU, the CXL.cache H2D data message to a UPLI read response comprising the model data; and sending the UPLI read response to the accelerator. The method enables an accelerator executing an inference workload to access model data stored in a host memory via the RPU. The RPU translates between the UPLI domain utilized by the accelerator and the CXL.cache domain utilized by the host, enabling the accelerator to extend its accessible memory capacity beyond the local memory. The model data may include neural network weights, activation data, intermediate computation results, or other data associated with inference processing. The host memory may provide larger capacity than the accelerator's local memory, and the RPU may bridge the two protocol domains to enable memory capacity expansion for inference workloads.

In some implementations of the method, the model data comprises at least one of: expert weights associated with a Mixture-of-Experts (MoE) model, the expert weights fetched from the host memory when a gating network of the MoE model routes one or more tokens to an expert; key-value (KV) cache entries previously offloaded from the local memory to the host memory during inference of a sequence; or attention parameters associated with a transformer-based model. In MoE models, only a subset of expert sub-networks may be active for any given input token. Inactive expert weights may be offloaded to the host memory to free accelerator local memory capacity, and activated expert weights may be fetched from the host memory when the gating network routes tokens to those experts. KV cache entries may be offloaded to host memory during inference of long sequences to free local memory for active computation, and may be fetched back when needed for attention computation. This dynamic staging may enable inference of models that exceed the available local memory capacity.

In some implementations, the method further comprises sending, by the accelerator, a UPLI request comprising a write command and inference context data; translating, by the RPU, the UPLI request comprising the write command to a CXL.cache D2H request comprising a write opcode; and sending the CXL.cache D2H request and the inference context data to the host for storage in the host memory. The write direction may enable the accelerator to offload inference context data to the host memory, such as KV cache entries that are not actively needed, intermediate computation results, or checkpoint data. The RPU may translate the UPLI write command to a CXL.cache D2H write opcode, such as DirtyEvict, ItoMWr, WrCur, or WrInv, and may forward the inference context data to the host for storage in the host memory.

A system may include an accelerator with local memory, a host with host memory, and an RPU coupled between them to bridge the UPLI and CXL.cache protocol domains. The RPU may enable the accelerator to access host memory capacity beyond its local memory, addressing memory capacity limitations for workloads such as AI inference and high-performance computing. The host memory may include removable DDR modules or CXL-attached memory, providing larger but higher-latency capacity compared to the accelerator's local HBM. A UALink switch may couple accelerators to the RPU, enabling accelerators to share access to the host memory via the RPU.

In various implementations, a system comprising: an accelerator comprising local memory and configured to communicate according to an Ultra Accelerator Link Protocol Level Interface (UPLI); a host comprising host memory and configured to communicate according to CXL.cache, wherein CXL denotes Compute Express Link; and a Resource Provisioning Unit (RPU) coupled between the accelerator and the host, the RPU comprising a first interface configured to communicate with the accelerator according to UPLI and a second interface configured to communicate with the host according to CXL.cache; wherein the RPU is configured to: translate a UPLI request comprising a read command, received from the accelerator via the first interface, to a CXL.cache Device-to-Host (D2H) request comprising a read opcode, and send the CXL.cache D2H request to the host via the second interface; and translate a CXL.cache Host-to-Device (H2D) data message, received from the host via the second interface, to a UPLI read response, and send the UPLI read response to the accelerator via the first interface; whereby the accelerator accesses the host memory via the RPU. The system may enable an accelerator to access host memory through protocol translation performed by the RPU. The RPU may bridge the UPLI domain of the accelerator and the CXL.cache domain of the host, translating read commands to CXL.cache D2H read opcodes and translating CXL.cache H2D data messages back to UPLI read responses. The system may address memory capacity limitations of the accelerator by enabling access to the host memory, which may provide larger capacity than the accelerator's local memory. The RPU may be a discrete component, an IP block embedded in a processor, or a chiplet within an IC package.

In some implementations of the system, a capacity of the host memory exceeds a capacity of the local memory; and wherein the local memory comprises high-bandwidth memory (HBM) and the host memory comprises removable DDR modules, or CXL-attached memory; whereby the accelerator accesses a combined memory capacity comprising the local memory and the host memory; and wherein the RPU is further configured to: translate a UPLI request comprising a write command and write data, received from the accelerator, to a CXL.cache D2H request comprising a write opcode; and send the CXL.cache D2H request comprising the write opcode and the write data to the host for storage in the host memory. In one example, the removable DDR modules refer to a standardized hardware assembly comprising one or more memory integrated circuits disposed on a substrate and encompassing various form factors and mounting architectures, including but not limited to: dual in-line memory modules (DIMMs), compression-attached memory modules (CAMM or CAMM2), and any future iterations of modular memory form factors.

In some implementations, the system further comprises a UALink switch coupled between the accelerator and the RPU; wherein the UALink switch routes the UPLI request from the accelerator to the RPU based on a destination accelerator identifier carried in the UPLI request; and wherein accelerators are coupled to the UALink switch, the accelerators sharing access to the host memory via the RPU. The UALink switch may route UPLI traffic based on the destination accelerator identifier, such as the ReqDstPhysAccID field, utilizing a route table to map the destination identifier to an egress port coupled to the RPU. The accelerators may share access to the host memory via the RPU, enabling accelerators to extend their accessible memory capacity. In some examples, the UALink switch may also route UPLI responses from the RPU back to the originating accelerator based on the destination accelerator identifier in the response.

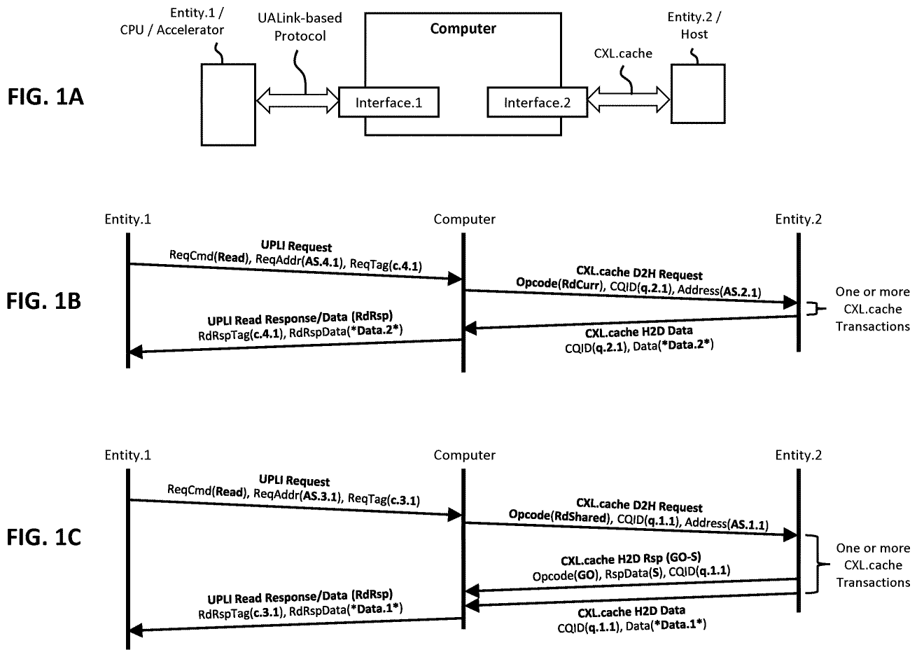

FIG. 1A illustrates an example of a system comprising a computer, that may be included in a switch or in a bridge, comprising a first interface (Interface.1) and a second interface (Interface.2). The first interface may communicate according to a UALink-based protocol, such as UPLI, with a first entity (Entity.1), which may be a CPU or an accelerator. The second interface may communicate according to CXL.cache, with a second entity (Entity.2), such as a host. The computer may extract addresses from requests received via the first interface, wherein these addresses may refer to a first address space, such as a Network Physical Address (NPA) space utilized by the first entity. The computer may further translate these addresses, and generate requests carrying the translated addresses for transmission via the second interface; wherein these translated addresses may refer to a second address space utilized by the second entity. In some examples, the first address space and the second address space may be associated with the same address space, such as a common address space, a global address space, a pod address space, or a fabric address space, wherein the computer may perform address translations between addresses within the same common address space. In other examples, the computer may be implemented in an IC package having high-speed differential I/O balls positioned according to a ball grid array layout defined by a retimer specification.

FIG. 1B illustrates an example of a TFD demonstrating translations, such as protocol translations, between UALink-based requests, such as UPLI requests, received from a first entity (Entity.1), which may be a CPU or an accelerator, and CXL requests, such as CXL.cache D2H requests, sent to a second entity (Entity.2), which may be a host, possibly enabling the first entity to access resources mapped to an address space utilized by the second entity. The first entity may initiate a UPLI transaction that may include a UPLI request comprising ReqCmd(Read), ReqAddr(AS.4.1), and ReqTag(c.4.1). The computer may translate the UPLI transaction to a CXL transaction that may include a CXL.cache D2H request comprising Opcode(RdCurr), CQID(q.2.1), and Address(AS.2.1), and may send the CXL.cache D2H request to the second entity. Upon receiving one or more responses from the second entity, which may include a CXL.cache H2D Data comprising CQID(q.2.1) and Data(*Data.2*), the computer may translate the one or more responses, such as translating the CXL.cache H2D Data to a UPLI read response/data (RdRsp) comprising RdRspTag(c.4.1) and RdRspData(*Data.2*), and send the UPLI RdRsp to the first entity. In some examples, the computer may perform additional translations, such as address translations, between first physical addresses, such as Network Physical Addresses (NPAs), carried in UPLI requests received from the first entity, and second physical addresses, such as Host Physical Addresses (HPAs), carried in CXL requests sent to the second entity.

The computer may perform further translations, such as opcode translations, command translations, TLP type translations, and field translations between the UALink-based domain and the CXL domain. In some examples, the computer may issue multiple CXL.cache D2H requests in response to receiving a UPLI request from the first entity, such as when splitting a UPLI request for a large block of data (e.g., 256 B) to smaller CXL.cache D2H requests (e.g., 64 B each), or when prefetching data from the second entity utilizing CXL.cache reads. The computer may translate requests or transactions initiated from the UALink-based domain to the CXL domain, may translate requests or transactions initiated from the CXL domain to the UALink-based domain, or may translate requests or transactions initiated from both domains.

FIG. 1C illustrates an example of a TFD demonstrating translations, such as protocol translations, between UALink-based requests, such as UPLI requests, received from a first entity (Entity.1), which may be a CPU or an accelerator, and CXL requests, such as CXL.cache D2H requests, sent to a second entity (Entity.2), which may be a host, possibly enabling the first entity to access resources mapped to an address space utilized by the second entity. The first entity may initiate a UPLI transaction that may include a UPLI request comprising ReqCmd(Read), ReqAddr(AS.3.1), and ReqTag(c.3.1). The computer may translate the UPLI transaction to a CXL transaction that may include a CXL.cache D2H request comprising Opcode(RdShared), CQID(q.1.1), and Address(AS.1.1), and send the CXL.cache D2H request to the second entity. Upon receiving one or more responses from the second entity, which may include a CXL.cache H2D Rsp comprising Opcode(GO), RspData(S), and CQID(q.1.1), and may further include a CXL.cache H2D Data comprising CQID(q.1.1) and Data(*Data.1*), the computer may translate the one or more responses, such as translating the CXL.cache H2D Data to a UPLI read response/data (RdRsp) comprising RdRspTag(c.3.1) and RdRspData(*Data.1*), and may send the UPLI RdRsp to the first entity. In some examples, the computer may include a cache or may control a cache that is external to the computer, wherein the computer may be configured to select the CXL.cache D2H request opcode according to a cacheline state intent that may be identified based on the UPLI request, or according to a caching policy, such as selecting RdShared for storing a shared copy of the cacheline in the cache, or selecting RdOwn for storing an exclusive copy of the cacheline in the cache.

In some examples, the computer may perform additional translations, such as address translations, between first physical addresses, such as Network Physical Addresses (NPAs), carried in UPLI requests received from the first entity, and second physical addresses, such as Host Physical Addresses (HPAs), carried in CXL requests sent to the second entity. The computer may perform further translations, such as opcode translations, command translations, TLP type translations, and field translations between the UALink-based domain and the CXL domain. In some examples, the computer may issue multiple CXL.cache D2H requests in response to receiving a UPLI request from the first entity, such as when splitting a UPLI request for a large block of data (e.g., 256 B) to smaller CXL.cache D2H requests (e.g., 64 B each), or when prefetching data from the second entity utilizing CXL.cache reads. The computer may translate requests or transactions initiated from the UALink-based domain to the CXL domain, may translate requests or transactions initiated from the CXL domain to the UALink-based domain, or may translate requests or transactions initiated from both domains.

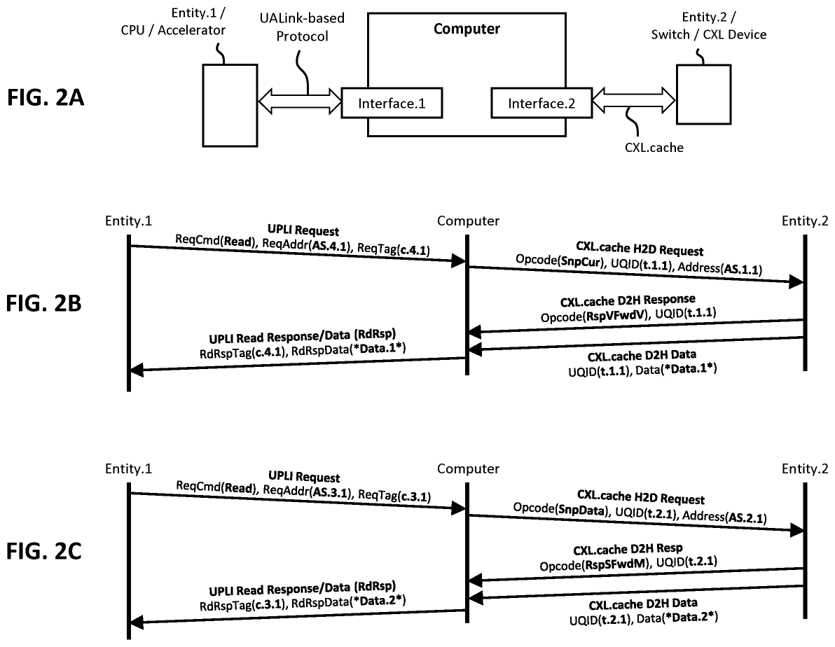

FIG. 2A illustrates an example of a system comprising a computer, that may be included in a switch or in a bridge, comprising a first interface (Interface.1) and a second interface (Interface.2). The first interface may communicate according to a UALink-based protocol, such as UPLI, with a first entity (Entity.1), which may be a CPU or an accelerator. The second interface may communicate according to CXL.cache, with a second entity (Entity.2), such as a switch, or a CXL device, which may be a CXL memory expander, a CXL memory pool, a GFD, or a CXL accelerator. The computer may extract addresses from requests received via the first interface, wherein these addresses may refer to a first address space, such as a Network Physical Address (NPA) space utilized by the first entity. The computer may further translate these addresses, and generate requests carrying the translated addresses for transmission via the second interface; wherein these translated addresses may refer to a second address space utilized by the second entity. In some examples, the first address space and the second address space may be associated with the same address space, such as a common address space, a global address space, a pod address space, or a fabric address space, wherein the computer may perform address translations between addresses within the same common address space. In some examples, the computer may be implemented in an IC package having high-speed differential I/O balls positioned according to a ball grid array layout defined by a retimer specification.

FIG. 2B illustrates an example of a TFD demonstrating translations, such as protocol translations, between UALink-based requests, such as UPLI requests, received from a first entity (Entity.1), which may be a CPU or an accelerator, and CXL requests, such as CXL.cache H2D requests, sent to a second entity (Entity.2), which may be a switch or a CXL device, possibly enabling the first entity to access resources associated with an address space utilized by the second entity. The first entity may initiate a UPLI transaction that may include a UPLI request comprising ReqCmd(Read), ReqAddr(AS.4.1), and ReqTag(c.4.1). The computer may translate the UPLI transaction to a CXL transaction that may include a CXL.cache H2D request comprising Opcode(SnpCur), UQID(t.1.1), and Address(AS.1.1), and may send the CXL.cache H2D request to the second entity. Upon receiving one or more responses from the second entity, which may include a CXL.cache D2H response comprising Opcode(RspVFwdV) and UQID(t.1.1), and may further include a CXL.cache D2H Data comprising UQID(t.1.1) and Data(*Data.1*), the computer may translate the one or more responses, such as translating the CXL.cache D2H Data to a UPLI read response/data (RdRsp) comprising RdRspTag(c.4.1) and RdRspData(*Data.1*), and may send the UPLI RdRsp to the first entity. In some examples, the computer may include a cache or may control a cache that is external to the computer, wherein the computer may be configured to select the CXL.cache H2D request opcode according to a cacheline state intent that may be identified based on the UPLI request, or according to a caching policy, such as selecting SnpData for a cacheline that is intended to be cached in either Shared or Exclusive state, or selecting SnpCur to get the current version of a cacheline without requiring change of any cache state in the hierarchy.

In some examples, the computer may perform additional translations, such as address translations, between first physical addresses, such as Network Physical Addresses (NPAs), carried in UPLI requests received from the first entity, and second physical addresses, such as Host Physical Addresses (HPAs), carried in CXL requests sent to the second entity. The computer may perform further translations, such as opcode translations, command translations, TLP type translations, and field translations between the UALink-based domain and the CXL domain. In some examples, the computer may issue multiple CXL.cache H2D requests in response to receiving a UPLI request from the first entity, such as when splitting a UPLI request for a large block of data (e.g., 256 B) to smaller CXL.cache H2D requests (e.g., 64 B each), or when prefetching data from the second entity utilizing CXL.cache reads. The computer may translate requests or transactions initiated from the UALink-based domain to the CXL domain, may translate requests or transactions initiated from the CXL domain to the UALink-based domain, or may translate requests or transactions initiated from both domains.

FIG. 2C illustrates an example of a TFD demonstrating translations, such as protocol translations, between UALink-based requests, such as UPLI requests, received from a first entity (Entity.1), which may be a CPU or an accelerator, and CXL requests, such as CXL.cache H2D requests, sent to a second entity (Entity.2), which may be a switch or a CXL device, possibly enabling the first entity to access resources associated with an address space utilized by the second entity. The first entity may initiate a UPLI transaction that may include a UPLI request comprising ReqCmd(Read), ReqAddr(AS.3.1), and ReqTag(c.3.1). The computer may translate the UPLI transaction to a CXL transaction that may include a CXL.cache H2D request comprising Opcode(SnpData), UQID(t.2.1), and Address(AS.2.1), and may send the CXL.cache H2D request to the second entity. Upon receiving one or more responses from the second entity, which may include a CXL.cache D2H response comprising Opcode(RspSFwdM) and UQID(t.2.1), and may further include a CXL.cache D2H Data comprising UQID(t.2.1) and Data(*Data.2*), the computer may translate the one or more responses, such as translating the CXL.cache D2H Data to a UPLI read response/data (RdRsp) comprising RdRspTag(c.3.1) and RdRspData(*Data.2*), and may send the UPLI RdRsp to the first entity. In some examples, the computer may include a cache or may control a cache that is external to the computer, wherein the computer may be configured to select the CXL.cache H2D request opcode according to a cacheline state intent that may be identified based on the UPLI request, or according to a caching policy, such as selecting SnpData for a cacheline that is intended to be cached in either Shared or Exclusive state, or selecting SnpCur to get the current version of a cacheline without requiring change of any cache state in the hierarchy.

In some examples, the computer may perform additional translations, such as address translations, between first physical addresses, such as Network Physical Addresses (NPAs), carried in UPLI requests received from the first entity, and second physical addresses, such as Host Physical Addresses (HPAs), carried in CXL requests sent to the second entity. The computer may perform further translations, such as opcode translations, command translations, TLP type translations, and field translations between the UALink-based domain and the CXL domain. In some examples, the computer may issue multiple CXL.cache H2D requests in response to receiving a UPLI request from the first entity, such as when splitting a UPLI request for a large block of data (e.g., 256 B) to smaller CXL.cache H2D requests (e.g., 64 B each), or when prefetching data from the second entity utilizing CXL.cache reads. The computer may translate requests or transactions initiated from the UALink-based domain to the CXL domain, may translate requests or transactions initiated from the CXL domain to the UALink-based domain, or may translate requests or transactions initiated from both domains.

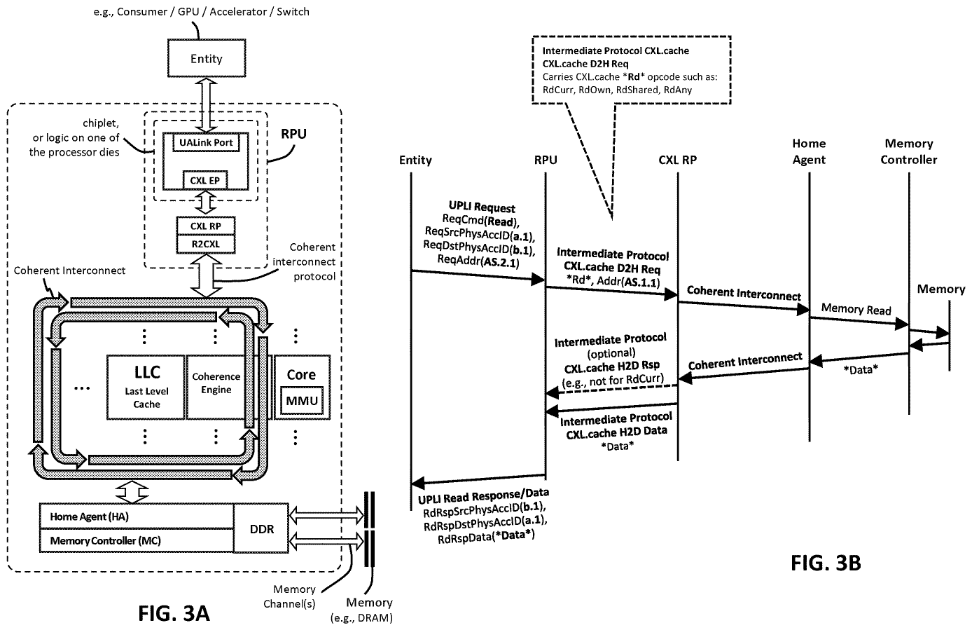

FIG. 3A illustrates an example of a system comprising a processor (such as an MxPU) comprising processing cores, LLC, a CXL RP, and a memory controller optionally coupled via memory channels to memory, such as DRAM. The CXL RP may be coupled to an on-chip coherent interconnect, such as a CHI ring or mesh interconnect, via a Ring-to-CXL (R2CXL) interconnect interface that may communicate with the coherent interconnect according to a protocol utilized by the coherent interconnect, such as ARM CHI, Intel UPI, or AMD Infinity Fabric. An RPU, which may be included in the MxPU, performs physical address translations that may enable an entity such as a GPU to access the memory. The MxPU may expose to the entity, optionally via the RPU, a UALink port that may communicate with the entity according to UPLI. The RPU may further perform translations, such as from UPLI to a protocol utilized by the coherent interconnect, wherein the RPU may utilize an intermediate protocol, such as CXL (e.g., CXL.cache), to provide the translations. The RPU may expose to the processor, via a CXL RP that may be included in the RPU, a CXL device utilizing a CXL endpoint (CXL EP), such as a Type-1 CXL device or a Type-2 CXL device, where an R2CXL, that may reside in the RPU, may communicate with the coherent interconnect and complete the translation path from UPLI to a protocol utilized by the coherent interconnect. In some examples, the RPU, the UALink port and the CXL device may be implemented in a chiplet inside an IC package of an MxPU, whereas in other examples they may be implemented as functional blocks on the same die with the CXL RP of the processor, or split between processor dies or chiplets.

FIG. 3B illustrates an example of a TFD demonstrating a UPLI request (Req) received from an entity, such as a GPU or an accelerator, wherein the RPU may translate a physical address (AS.2.1) carried in the UPLI request, to a physical address (AS.1.1) utilized for accessing the memory. The RPU may perform further translations, such as protocol translations from UPLI to a protocol utilized by the processor's coherent interconnect, possibly utilizing an intermediate protocol such as CXL.cache. The RPU may perform further translations, such as opcode translations and Tag translations, e.g., of transaction Tags, such as translating from UPLI Tags to CQIDs. The CXL.cache request, carrying the translated address (AS.1.1), is sent to the CXL RP for further processing and fetching of the requested data, such as from an LLC over the on-chip ring interconnect, or from memory, such as DRAM via the memory channels. The data may then return over the on-chip ring interconnect to the RPU, wherein the RPU provides UPLI read response/data (RdRsp) to the requesting entity.

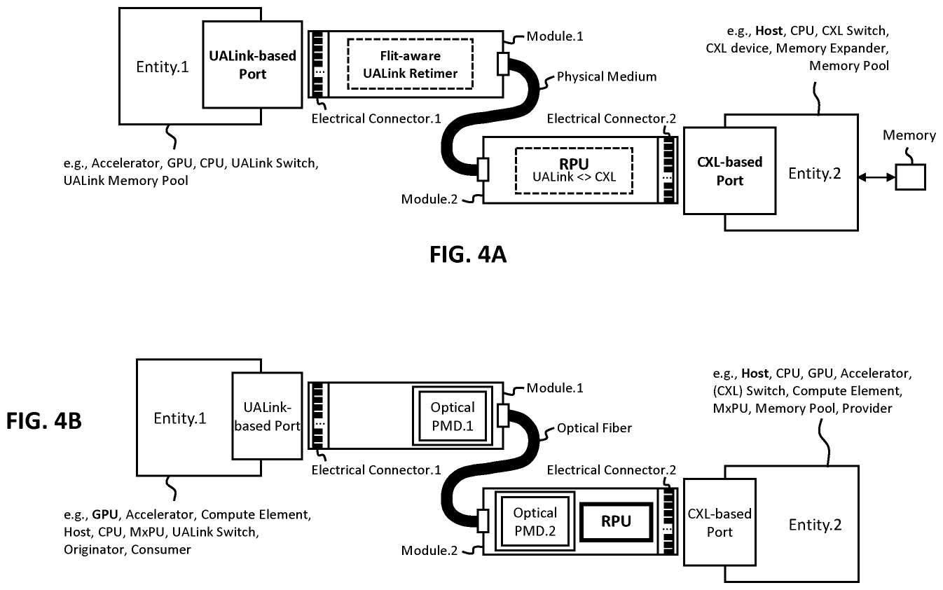

FIG. 4A illustrates an example of a system comprising a cable, such as an active cable, referred to as Cable/RPU, which may translate between UALink-based traffic and CXL-based traffic, such as at least one of CXL.io, CXL.mem, or CXL.cache traffic. The Cable/RPU enables a first entity (Entity.1), which may be an accelerator, a GPU, a CPU, a UALink switch, a UPLI originator, or a resource consumer, to access, via a UALink-based port, via the Cable/RPU, and via a CXL-based port, resources, such as memory, coupled to a second entity (Entity.2), which may be a host, a CPU, a CXL switch, a CXL device, a memory expander, a memory pool, or a resource provider. The Cable/RPU, which may include an RPU, may communicate with the first entity according to a UALink-based protocol, such as a UPLI, and may communicate with the second entity according to a CXL-based protocol, such as at least one of CXL.io, CXL.mem, or CXL.cache. In some examples, the UALink-based protocol, such as UPLI, may be associated with a first address space, such as an NPA space, and the CXL-based protocol, such as CXL.mem, may be associated with a second address space, such as a System Physical Address (SPA) space or a Host Physical Address (HPA) space; wherein the Cable/RPU may perform address translations between addresses within the first and second address spaces, respectively, such as between addresses within the NPA space and addresses within the SPA space or the HPA space.

In other examples, the UALink-based protocol, such as UPLI, and the CXL-based protocol, such as CXL.mem, may be associated with the same physical address space, such as a global address space, a pod address space, or a fabric address space; wherein the Cable/RPU may perform address translations between addresses within the same address spaces. The Cable/RPU may perform further translations, such as opcode, command, or TLP translations, e.g., translating between Read commands in UPLI requests and read opcodes in CXL.cache D2H requests. The Cable/RPU may further translate between messages conforming to the UALink-based protocol and messages conforming to the CXL-based protocol, translate Tags, and/or translate error indications, such as data corruption indications or poison.

In some examples, the Cable/RPU, such as an OSFP copper cable, an OSFP-XD copper cable, an OSFP Active Optical Cable (AOC), or an OSFP-XD AOC cable, may further include a first module (Module.1), which may include a flit-aware UALink retimer, a PAM4 retimer, or a retimer PHY, and may further include a second module (Module.2), which may include the RPU, optionally included in a discrete component compatible with a retimer form-factor. The Cable/RPU may conform to a standard specification, an industry standard, an implementation agreement (IA), or a multi-source agreement (MSA), such as Octal Small Form Factor Pluggable Module (OSFP), Octal Small Form Factor eXtra Dense Pluggable Module (OSFP-XD), Quad Small Form-Factor Pluggable (QSFP), Quad Small Form-Factor Pluggable Double Density (QSFP-DD), a SNIA SFF standard (such as SFF-8665), an Optical Internetworking Forum (OIF) implementation agreement, or an Institute of Electrical and Electronics Engineers (IEEE) standard. The Cable/RPU may further include a physical medium that may include a copper wire or an optical fiber. In some examples, the Cable/RPU may be coupled to the UALink-based port via a first electrical connector (Electrical Connector.1) and may be further coupled to the CXL-based port via a second electrical connector (Electrical Connector.2), whereas in other examples the Cable/RPU may be coupled to the UALink-based port and/or the CXL-based port via optical connectors.

FIG. 4B illustrates an example of a system comprising an active optical cable. The active optical cable may couple a first entity (Entity.1), such as a GPU, an accelerator, a compute element, a host, a CPU, an MxPU, a UALink switch, a UPLI originator, or a consumer, to a second entity (Entity.2), such as a host, a CPU, a GPU, an accelerator, a CXL switch, a compute element, an MxPU, a memory pool, or a provider. In some examples, the first entity may be coupled to a first port (Port.1), such as a UALink port, via a first electrical connector (Electrical Connector.1). The active optical cable may include a first module (Module.1) comprising a first optical physical media dependent (Optical PMD.1) device, and a second module (Module.2) comprising a second optical physical media dependent (Optical PMD.2) device and an RPU. The first module may be coupled to the first electrical connector and may convert electrical signals from the first entity to optical signals for transmission over an optical fiber. The second module may convert the optical signals back to electrical signals and may further comprise the RPU, which may translate between a UALink-based protocol, such as UPLI, and a CXL-based protocol, such as at least one of CXL.io, CXL.mem, or CXL.cache. The second module may be coupled to the second entity via a second electrical connector (Electrical Connector.2), wherein the second entity may be coupled to a second port (Port.2), such as a CXL port.

In some examples, the RPU within the active optical cable may perform address translations between addresses within a first address space associated with the UALink-based protocol, such as a NPA space, and addresses within a second address space associated with the CXL-based protocol, such as HPA space. The RPU may further perform opcode translations, command translations, Tag translations, and translations of error indications such as data corruption indications or poison. In some examples, the active optical cable may conform to a standard specification, an industry standard, an implementation agreement, or a multi-source agreement, such as Octal Small Form Factor Pluggable Module (OSFP), Octal Small Form Factor eXtra Dense Pluggable Module (OSFP-XD), Quad Small Form-Factor Pluggable (QSFP), Quad Small Form-Factor Pluggable Double Density (QSFP-DD), a SNIA SFF standard, an Optical Internetworking Forum (OIF) implementation agreement, or an IEEE standard. In other examples the active optical cable may utilize other form factors or standards as they become available.

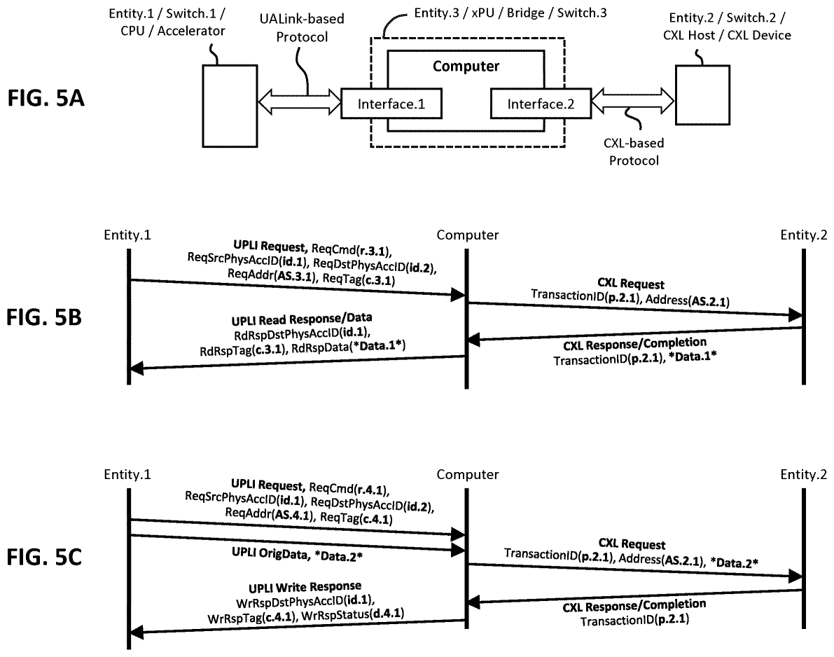

FIG. 5A illustrates an example of a system comprising a third entity (Entity.3), such as an xPU, a bridge, or a third switch (Switch.3). The third entity includes a computer comprising a first interface (Interface.1) and a second interface (Interface.2). The first interface may communicate according to a UALink-based protocol, such as UPLI, with a first entity (Entity.1), such as a first switch (Switch.1), a CPU, or an accelerator. The second interface may communicate according to a CXL-based protocol, such as CXL.io, CXL.mem, or CXL.cache, with a second entity (Entity.2), such as a second switch (Switch.2), a CXL host, or a CXL device which may be a CXL memory expander, a CXL-based memory pool, a GFD, or a CXL accelerator. The computer may perform translations, such as protocol translations between the UALink-based protocol and the CXL-based protocol, transaction translations, protocol data unit (PDU) translations, message translations, and/or address translations between the UALink-based protocol domain and the CXL-based protocol domain. In some examples, the computer may extract addresses from requests received via the first interface, wherein these addresses may refer to a first address space, such as a Network Physical Address (NPA) space utilized by the first entity. The computer may translate these addresses, and generate requests carrying the translated addresses for transmission via the second interface; wherein these translated addresses may refer to a second address space, such as a Host Physical Address (HPA) space utilized by the second entity. In other examples the first address space and the second address space may be associated with the same address space, such as a common address space, a global address space, a pod address space, or a fabric address space, wherein the computer may perform address translations between addresses within the same common address space. In some examples, the computer may be implemented in a chiplet, may utilize UCIe for chip-to-chip or die-to-die connectivity, or may be implemented in an IC package having high-speed differential I/O balls positioned according to a ball grid array layout defined by a retimer specification.

FIG. 5B illustrates an example of a TFD demonstrating translations, such as protocol translations, transaction translations, protocol data unit (PDU) translations, message translations, and/or address translations, which may be performed by a computer, between a UALink-based protocol, such as UPLI, utilized by a first entity (Entity.1), such as a first switch (Switch.1), a CPU, or an Accelerator, and a CXL-based protocol, such as CXL.io, CXL.mem, or CXL.cache, utilized by a second entity (Entity.2), such as a second switch (Switch.2), a CXL host, or a CXL device. The first entity may initiate a UPLI transaction that may include a UPLI request comprising ReqCmd(r.3.1), such as Read or Read class Vendor Defined Command, ReqSrcPhysAccID(id.1), ReqDstPhysAccID(id.2), ReqAddr(AS.3.1), and ReqTag(c.3.1). The computer may translate the UPLI transaction to a CXL transaction that may include a CXL request comprising TransactionID(p.2.1) and Address(AS.2.1), and may send the CXL request to the second entity. In some examples, the TransactionID, such as a CXL.io Tag, a CXL.mem Tag, a CXL.cache CQID, or a CXL.cache UQID, may be utilized by the computer as a transaction identifier for matching responses or completions with requests, and may be further utilized to identify outstanding transactions in-flight. Upon receiving from the second entity a CXL response or completion (CXL Response/Completion) comprising TransactionID(p.2.1) and *Data.1*, the computer may translate the CXL Response/Completion to a UPLI read response/data comprising RdRspDstPhysAccID(id.1), RdRspTag(c.3.1), and RdRspData(*Data.1*), and may send the UPLI read response/data to the first entity.

The computer may perform further translations, such as opcode translations, command translations, TLP type translations, or other translations between the UALink-based protocol domain and the CXL-based protocol domain. In some examples, the computer may issue multiple CXL requests in response to receiving a UPLI request from the first entity. For example, the computer may issue CXL.mem M2S requests comprising MemRd or MemRdData, such as when splitting a UPLI request for a large block of data (e.g., 256 B) to smaller CXL.mem reads (e.g., 64 B each), or when prefetching data from the second entity utilizing CXL.mem reads. The computer may translate requests or transactions initiated from the UALink-based protocol domain to the CXL-based protocol domain, may translate requests or transactions initiated from the CXL-based protocol domain to the UALink-based protocol domain, or may translate requests or transactions initiated from the protocol domains.

FIG. 5C illustrates an example of a TFD demonstrating translations, such as protocol translations, transaction translations, protocol data unit (PDU) translations, message translations, and/or address translations, which may be performed by a computer, between a UALink-based protocol, such as UPLI, utilized by a first entity (Entity.1), such as a first switch (Switch.1), a CPU, or an Accelerator, and a CXL-based protocol, such as CXL.io, CXL.mem, or CXL.cache, utilized by a second entity (Entity.2), such as a second switch (Switch.2), a CXL host, or a CXL device. The first entity may initiate a UPLI transaction that may include a UPLI request comprising ReqCmd(r.4.1), such as Write or Write class Vendor Defined Command, ReqSrcPhysAccID(id.1), ReqDstPhysAccID(id.2), ReqAddr(AS.4.1), and ReqTag(c.4.1). The UPLI transaction may further include a UPLI OrigData comprising *Data.2*. The computer may translate the UPLI transaction to a CXL transaction that may include a CXL request comprising TransactionID(p.2.1), Address(AS.2.1), and *Data.2*, and may send the CXL request to the second entity. In some examples, the TransactionID, such as a CXL.io Tag, a CXL.mem Tag, a CXL.cache CQID, or a CXL.cache UQID, may be utilized by the computer as a transaction identifier for matching responses or completions with requests, and may be further utilized to identify outstanding transactions in-flight. Upon receiving from the second entity a CXL response or completion (CXL Response/Completion) comprising TransactionID(p.2.1), the computer may translate the CXL Response/Completion to a UPLI write response comprising WrRspDstPhysAccID(id.1), WrRspTag(c.4.1), and WrRspStatus(d.4.1), and may send the UPLI write response to the first entity.

The computer may perform further translations, such as opcode translations, command translations, TLP type translations, or other translations between the UALink-based protocol domain and the CXL-based protocol domain. In some examples, the computer may issue CXL requests in response to receiving a UPLI request from the first entity. For example, the computer may issue multiple CXL.mem M2S RwD comprising MemWr or MemWrTEE, such as when splitting a UPLI request writing a large block of data (e.g., 256 B) to smaller CXL.mem writes (e.g., 64 B each). The computer may translate requests or transactions initiated from the UALink-based protocol domain to the CXL-based protocol domain, may translate requests or transactions initiated from the CXL-based protocol domain to the UALink-based protocol domain, or may translate requests or transactions initiated from the protocol domains.

In AI inference systems, accelerators such as GPUs or TPUs may generate and consume large volumes of inference context data, including key-value (KV) cache data, model weight parameters, activation tensors, and embedding vectors. When the volume of inference context data exceeds the capacity of the accelerator's local memory, such as HBM, the data may be staged to external memory resources that provide larger capacity at lower cost, such as CXL memory devices, CXL memory pools, or GFDs. In environments where accelerators are coupled via a UALink switch and the CXL memory devices are accessible via CXL.mem, an RPU may translate between UPLI and CXL.mem to enable the accelerators to migrate inference context data between their local memory and the CXL memory devices across the UALink and CXL protocol domain boundaries. The accelerator may initiate migration by sending UPLI requests to the RPU via the UALink switch, and the RPU may translate these requests to CXL.mem M2S requests targeting the CXL memory device. The migration may be bidirectional: the accelerator may write inference context data to the CXL memory device when evicting data from local memory, and may read inference context data from the CXL memory device when the data is needed for active computation. The RPU may perform address translations between address spaces utilized by the UALink domain and the CXL domain, such as between NPA or SPA addresses and HPA addresses, and may further perform Tag and opcode translations between UPLI and CXL.mem message formats.

In various implementations, a method for migrating inference context data across protocol domain boundaries, comprising: sending, by an accelerator coupled to an Ultra Accelerator Link (UALink) switch, a UALink Protocol Level Interface (UPLI) request via the UALink switch to a resource provisioning unit (RPU), the UPLI request associated with the inference context data stored in a local memory of the accelerator, the UPLI request comprising a first physical address; translating, by the RPU, the UPLI request to a Compute Express Link (CXL) CXL.mem Master-to-Subordinate (M2S) request comprising a second physical address; and sending, by the RPU, the CXL.mem M2S request to a CXL memory device; wherein the inference context data is migrated between the local memory of the accelerator and the CXL memory device across a UALink protocol domain and a CXL protocol domain. The method may be utilized in AI inference systems where accelerator working memory, such as HBM, is insufficient to retain all inference context data simultaneously. The RPU may translate between UPLI and CXL.mem including translations of opcodes, commands, addresses, Tags, and additional fields. The migration may be performed by the accelerator without host intervention, such as when the accelerator determines that certain inference context data is no longer actively needed and may be offloaded to a lower-cost memory tier. Alternatively, the migration may be coordinated by a host or a scheduler that directs the accelerator to evict or fetch specific data. The UPLI request may include a write command when data is being evicted from local memory to the CXL memory device, carrying the inference context data on the UPLI Originator Data Channel. The UPLI request may alternatively comprise a read command when data is being fetched from the CXL memory device to local memory, in which case the data is returned via the CXL.mem S2M data response path and translated to a UPLI read response. The method may be implemented in hardware, firmware, software, or combinations thereof, and may be performed by various types of devices, such as a processor, a switch, a bridge, an RPU, or a semiconductor device.

In some implementations of the method, the inference context data comprises key-value (KV) cache data generated during attention computation in a transformer-based inference model, the KV cache data comprising key tensors and value tensors associated with one or more attention layers of the transformer-based inference model. The KV cache data may grow proportionally to the sequence length and the number of attention layers. As context lengths increase, the KV cache may consume a substantial portion of accelerator HBM, motivating migration of less-recently-accessed KV cache entries to CXL memory.

In some implementations of the method, the transformer-based inference model utilizes at least one of: (i) grouped query attention (GQA) wherein a plurality of query heads share a reduced number of key-value heads, or (ii) multi-latent attention (MLA) wherein the key tensors and the value tensors are compressed into a low-rank latent representation; and wherein the KV cache data corresponds to the reduced number of key-value heads or to the low-rank latent representation, respectively. GQA may reduce KV cache size by sharing key-value heads across multiple query heads, as utilized in models such as Llama. MLA may further compress the KV cache by projecting key and value tensors into a lower-dimensional latent space, as utilized in models such as DeepSeek. The reduced KV cache size per token may affect staging granularity and transfer efficiency.

In some implementations of the method, the inference context data comprises at least one of: model weight parameters, activation tensors generated during inference computation, or embedding vectors associated with an input sequence. Model weight parameters may be staged when different models or model components are loaded on demand, such as in multi-tenant serving or model-switching scenarios. Activation tensors may be checkpointed to CXL memory during long inference sequences. Embedding vectors, such as token embeddings or positional embeddings, may be pre-staged from CXL memory before inference begins.

In some implementations of the method, the accelerator executes a mixture-of-experts (MoE) inference model comprising a gating network and expert sub-networks, and wherein the inference context data comprises weight parameters of at least one expert sub-network of the expert sub-networks; and wherein the UPLI request is sent based on a routing decision of the gating network indicating that the at least one expert sub-network is to be activated or deactivated. In MoE models, only a subset of expert sub-networks may be active for any given input token. Inactive expert weights may be offloaded to CXL memory to free accelerator HBM capacity, and activated expert weights may be fetched from CXL memory when the gating network routes tokens to those experts. This dynamic staging may enable serving MoE models that are larger than the available HBM capacity.

In some implementations, the method further comprises sending, by the accelerator, a second UPLI request comprising a read command and a third physical address via the UALink switch to the RPU; translating, by the RPU, the second UPLI request to a second CXL.mem M2S request comprising a fourth physical address; sending, by the RPU, the second CXL.mem M2S request to the CXL memory device; receiving, by the RPU, a CXL.mem Subordinate-to-Master Data Response (S2M DRS) comprising second inference context data from the CXL memory device; translating, by the RPU, the CXL.mem S2M DRS to a UPLI read response (RdRsp) comprising the second inference context data; and sending, by the RPU, the UPLI RdRsp to the accelerator via the UALink switch; wherein the second inference context data is stored in the local memory of the accelerator. The fetch direction may be utilized when inference context data that was previously offloaded to the CXL memory device is needed again for active computation. The RPU may translate the CXL.mem S2M DRS, including by translating the Tag back to the original UPLI ReqTag and formatting the data as UPLI RdRspData. In some examples, the RPU may accumulate data from CXL.mem S2M DRS messages before sending a UPLI RdRsp, such as when the CXL.mem cacheline size differs from the UPLI transfer size.

In some implementations of the method, the CXL memory device comprises a Global Fabric-Attached Memory Device (GFD), the local memory comprises at least one of high-bandwidth memory (HBM) or High-Bandwidth Flash (HBF), the first physical address refers to a Network Physical Address (NPA) or a System Physical Address (SPA), and the second physical address refers to a Host Physical Address (HPA); and wherein the translating comprises translating the first physical address to the second physical address. The GFD may provide large-capacity memory accessible by both accelerators via the RPU and hosts via direct CXL.mem access. The address translation between NPA or SPA and HPA may be performed utilizing lookup tables, base-and-offset calculations, or programmable translation functions within the RPU.

In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

In AI inference systems, a host such as a CPU may orchestrate the staging of inference context data between CXL memory devices and accelerators that reside in the UALink domain. The host may read inference context data from a CXL memory device via CXL.mem and write the data to an accelerator by sending a CXL.mem M2S request to an RPU, which translates the request to a UPLI request and forwards it to the accelerator via a UALink port. This host-initiated staging may be utilized in scenarios where the host manages a tiered memory hierarchy, determines which inference context data to pre-stage to accelerators based on scheduling policies, inference request queues, or predicted workload patterns, and coordinates data movement between the CXL and UALink protocol domains. The host may also orchestrate reading inference context data from accelerators via the RPU and writing it to CXL memory devices for longer-term retention. This bidirectional host-orchestrated staging may support a variety of inference architectures and model types, including transformer models with large KV caches, mixture-of-experts models with dynamic expert activation, disaggregated prefill and decode architectures, speculative decoding, hybrid attention and state-space models, multimodal models, and retrieval-augmented generation pipelines. In each case, the CXL memory device may serve as an intermediate staging area that bridges the capacity gap between accelerator working memory and the volume of inference context data associated with the workload.

In various implementations, a method for staging inference context data across protocol domain boundaries, comprising: reading, by a host, inference context data from a Compute Express Link (CXL) memory device via CXL.mem; sending, by the host, a CXL.mem Master-to-Subordinate (M2S) request to a resource provisioning unit (RPU), the CXL.mem M2S request associated with the inference context data and comprising a first physical address; translating, by the RPU, the CXL.mem M2S request to an Ultra Accelerator Link (UALink) Protocol Level Interface (UPLI) request comprising a second physical address; and sending, by the RPU, the UPLI request to an accelerator via a UALink port; wherein the inference context data is staged from the CXL memory device to a local memory of the accelerator across a CXL protocol domain and a UALink protocol domain. The host-initiated staging may enable the host to manage a tiered memory hierarchy comprising accelerator local memory as a working memory tier, host memory as an intermediate tier, and CXL memory devices as a capacity tier. The host may determine which inference context data to stage based on scheduling policies, inference request queues, or predictions about upcoming workload requirements. The RPU may be a discrete component, an IP block embedded in an accelerator, or a chiplet within an IC package. The CXL.mem M2S request may include a write command carrying the inference context data, and the translated UPLI request may carry the data on the UPLI Originator Data Channel to the accelerator. The RPU may perform address translations between HPA addresses utilized by the host and NPA or SPA addresses utilized by the UALink domain, and may further perform Tag and opcode translations between CXL.mem and UPLI message formats. The host may access the CXL memory device via CXL.mem without translation, and may access the accelerator via the RPU that translates between CXL.mem and UPLI. The method may be implemented in hardware, firmware, software, or combinations thereof.

In some implementations, the method further comprises reading, by the host, second inference context data from the accelerator, wherein the reading comprises the host sending a second CXL.mem M2S request to the RPU, the RPU translating the second CXL.mem M2S request to a second UPLI request comprising a read command and sending the second UPLI request to the accelerator via the UALink port, the RPU receiving a UPLI read response (RdRsp) comprising the second inference context data from the accelerator, and the RPU returning the second inference context data to the host; and writing, by the host, the second inference context data to the CXL memory device via CXL.mem. This direction may enable the host to evict inference context data from accelerator local memory to the CXL memory device when the data is no longer actively needed or when the local memory capacity is exceeded. The host may coordinate both staging and eviction to maintain a working set of inference context data in accelerator local memory that matches the current workload.

In some implementations of the method, the accelerator executes a mixture-of-experts (MoE) inference model comprising a gating network and expert sub-networks, and the second inference context data comprises weight parameters of an inactive expert sub-network of the expert sub-networks, the inactive expert sub-network identified based on a routing decision of the gating network. Evicting inactive expert weights to CXL memory may free accelerator HBM capacity for the active experts, enabling the system to serve MoE models whose total expert weight parameters exceed the HBM capacity.

In some implementations of the method, the second inference context data comprises key-value (KV) cache entries that have been evicted from the local memory of the accelerator based on at least one of: an access frequency, an access recency, or the KV cache entries exceeding a capacity of the local memory. Long-context inference models may generate KV cache entries that exceed the accelerator HBM capacity. Eviction policies based on access frequency or recency may retain the most relevant KV cache entries in HBM while offloading less-accessed entries to CXL memory for potential later retrieval.

In some implementations of the method, the inference context data comprises key-value (KV) cache data associated with a transformer-based inference model, and wherein the host stages the KV cache data from the CXL memory device to the local memory of the accelerator based on a scheduled inference request or a predicted inference request. The host may maintain a scheduling queue of inference requests and may pre-stage KV cache data associated with upcoming requests to reduce latency when the request is dispatched to the accelerator. Prediction of upcoming requests may be based on session affinity, user activity patterns, or model serving policies.

In some implementations of the method, the accelerator comprises a decode accelerator, the inference context data comprises key-value (KV) cache data generated during a prefill phase of an inference operation by a prefill accelerator, and the KV cache data is staged from the CXL memory device to the local memory of the decode accelerator for use in a decode phase of the inference operation; and wherein the CXL memory device serves as an intermediate storage between the prefill accelerator and the decode accelerator. In disaggregated inference architectures, the prefill phase and the decode phase may be performed by different accelerators to optimize resource utilization. The prefill accelerator may write the generated KV cache data to the CXL memory device, and the host may subsequently stage the KV cache data from the CXL memory device to the decode accelerator. The CXL memory device may thus serve as a shared staging area that decouples the prefill and decode phases across protocol domain boundaries.

In some implementations of the method, the accelerator performs speculative decoding comprising a draft model generating candidate token sequences and a verification model accepting or rejecting the candidate token sequences, and wherein the inference context data comprises at least one of: draft model weight parameters, draft model KV cache data, or verification context data associated with the speculative decoding. Speculative decoding may utilize a smaller draft model to generate candidate tokens that a larger verification model subsequently accepts or rejects. The draft model weight parameters or the draft model KV cache data may be staged from CXL memory to accelerator HBM when speculative decoding is activated for a given inference session.

In some implementations of the method, the inference context data comprises state data associated with a hybrid inference model, the hybrid inference model comprising attention layers that generate key-value (KV) cache data and state-space model layers that maintain recurrent state vectors; and wherein the staging comprises staging at least one of the KV cache data or the recurrent state vectors from the CXL memory device to the local memory of the accelerator. Hybrid models, such as those combining attention layers with Mamba-style state-space model (SSM) layers, may maintain both KV cache data for attention layers and recurrent state vectors for SSM layers. The staging may include both data types, which may have different sizes, access patterns, and staging priorities.

In some implementations of the method, the inference context data comprises visual embeddings generated by an image encoder or a video encoder of a multimodal inference model; and wherein the staging comprises staging the visual embeddings from the CXL memory device to the local memory of the accelerator for processing alongside text token embeddings by the multimodal inference model. Multimodal inference models may process both visual and textual inputs. Visual embeddings generated by an image or video encoder may be large and may be pre-computed and stored in CXL memory, then staged to the accelerator when a multimodal inference request is dispatched.

In some implementations of the method, the inference context data comprises pre-computed embeddings associated with retrieved documents in a retrieval-augmented generation (RAG) pipeline; and wherein the staging comprises staging the pre-computed embeddings from the CXL memory device to the local memory of the accelerator for concatenation with an input query during inference. In RAG pipelines, retrieved document embeddings may be pre-computed and stored in the CXL memory device as a large-capacity embedding store. When a query triggers retrieval, the relevant embeddings may be staged from the CXL memory device to the accelerator for concatenation with the query tokens before the generation phase.

In some implementations of the method, the inference context data comprises key-value (KV) cache entries associated with token positions in an input sequence, and the staging comprises staging a subset of the KV cache entries from the CXL memory device to the local memory of the accelerator, the subset selected based on the token positions being predicted to be accessed during a subsequent inference step; and wherein remaining KV cache entries associated with remaining token positions are retained in the CXL memory device. For long-context inference, the host may stage only the KV cache entries associated with token positions predicted to be attended during the next decoding step, retaining the remaining entries in CXL memory. This selective staging may reduce transfer volume and accelerator memory pressure while maintaining the full context available for on-demand retrieval.

In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

In AI inference deployments, a system may include a cluster of accelerators coupled via a UALink switch, one or more CXL memory devices providing large-capacity memory, an RPU that translates between UPLI and CXL.mem, and a host that orchestrates workload scheduling and data movement. Such a system may be configured to migrate inference context data between accelerator local memory and the CXL memory devices across the UALink and CXL protocol domain boundaries, enabling the system to serve inference workloads whose aggregate inference context data exceeds the capacity of any single accelerator's local memory. The host may access the CXL memory devices via CXL.mem, while the accelerators access the same CXL memory devices via the RPU that translates between UPLI and CXL.mem. This architecture may support tiered memory management, where inference context data is staged between accelerator HBM, HBF, host memory, and CXL memory based on access patterns, scheduling policies, or memory capacity constraints.

In various implementations, a system comprising: an Ultra Accelerator Link (UALink) switch; accelerators coupled to the UALink switch, each accelerator of the accelerators comprising a local memory; a Compute Express Link (CXL) memory device; a resource provisioning unit (RPU) coupled to the UALink switch and to the CXL memory device, the RPU configured to translate between UALink Protocol Level Interface (UPLI) and CXL.mem; and a host coupled to the CXL memory device via CXL.mem; wherein the system is configured to migrate inference context data between the local memory of at least one accelerator of the accelerators and the CXL memory device across a UALink protocol domain and a CXL protocol domain. The system may enable both accelerator-initiated and host-initiated data migration across the protocol domain boundaries. The accelerators may communicate with one another and with the RPU via the UALink switch utilizing UPLI, while the host may communicate with the CXL memory device utilizing CXL.mem. The RPU may be implemented as a discrete component coupled to the UALink switch, as an IP block embedded within one of the accelerators, or as a chiplet within an IC package. The system may support various inference workloads, and the inference context data may include KV cache data, model weight parameters, activation tensors, embedding vectors, or other data generated or consumed during inference computation. The CXL memory device may include a CXL memory expander, a CXL memory pool, or a GFD.

In some implementations of the system, the at least one accelerator is configured to initiate migration of the inference context data by sending a UPLI request via the UALink switch to the RPU, and the RPU is configured to translate the UPLI request to a CXL.mem M2S request and send the CXL.mem M2S request to the CXL memory device. The accelerator may determine when to migrate inference context data based on local memory capacity utilization, access patterns, or workload scheduling signals received from the host or from other accelerators.

In some implementations of the system, the local memory comprises a first memory tier, the system further comprises host memory coupled to the host, the host memory comprising a second memory tier, and the CXL memory device comprises a third memory tier; and wherein the inference context data is migrated between the first memory tier and the third memory tier based on at least one of: access frequency, access recency, a capacity of the first memory tier, or a scheduling policy of the host. The tiered memory hierarchy may enable the system to retain actively-accessed inference context data in the highest-bandwidth tier (accelerator local memory) while staging less-accessed data to lower-cost, higher-capacity tiers (CXL memory). The second memory tier (host memory) may serve as an intermediate staging buffer.

In some implementations, the system further comprises a second CXL memory device and a CXL fabric coupling the RPU to the CXL memory device and the second CXL memory device; wherein at least one of the CXL memory device or the second CXL memory device comprises at least one of: a CXL memory expander, a CXL memory pool, or a Global Fabric-Attached Memory Device (GFD). The CXL fabric may include one or more CXL switches and may provide connectivity between the RPU and CXL memory devices. The RPU may route translated requests to specific CXL memory devices based on the physical addresses carried in the UPLI requests.

In some implementations of the system, the inference context data comprises key-value (KV) cache data associated with a transformer-based inference model, the local memory comprises high-bandwidth memory (HBM), and the at least one accelerator comprises at least one of: a graphics processing unit (GPU) or a tensor processing unit (TPU). GPUs and TPUs are accelerators commonly utilized for transformer-based inference workloads that generate substantial KV cache data. HBM provides the high-bandwidth, low-latency access needed for active inference computation, while the CXL memory device may provide the additional capacity needed for KV cache entries that are not actively accessed.

In environments where accelerators communicate utilizing NVLink-based protocols, such as GPUs coupled via NVLink or NVSwitches, the accelerators may similarly need to migrate inference context data to CXL memory devices that reside in a different protocol domain. An RPU may translate between NVLink-based protocol messages and CXL.mem messages to enable accelerators in the NVLink domain to stage inference context data to and from CXL memory devices. The RPU may be integrated into an active cable, an NVSwitch, or a discrete bridge device, and may perform address translations between NVLink addresses and CXL.mem addresses, as well as command and Tag translations between the two protocol domains. This NVLink-to-CXL.mem translation path may enable heterogeneous computing environments where different clusters of accelerators utilize different interconnect protocols while sharing access to common CXL memory resources.

In various implementations, a method for migrating inference context data across protocol domain boundaries, comprising: sending, by an accelerator, a request conforming to an NVLink-based protocol to a resource provisioning unit (RPU), the request associated with the inference context data stored in a local memory of the accelerator, the request comprising a first physical address; translating, by the RPU, the request to a Compute Express Link (CXL) CXL.mem Master-to-Subordinate (M2S) request comprising a second physical address; and sending, by the RPU, the CXL.mem M2S request to a CXL memory device; wherein the inference context data is migrated between the local memory of the accelerator and the CXL memory device across an NVLink protocol domain and a CXL protocol domain. The method may enable accelerators communicating according to an NVLink-based protocol to access CXL memory resources for staging inference context data. The RPU may translate between NVLink-based protocol messages and CXL.mem messages, including translations of addresses, commands, and identifiers. The first physical address may be an NVLink Network Address, and the second physical address may be an HPA utilized by the CXL memory device. The RPU may be integrated into an active cable, an NVSwitch, or a discrete bridge device. In some examples, the RPU may be positioned closer to the CXL port to optimize signal integrity, since CXL runs over PCIe electricals designed for shorter-reach connectivity while NVLink may incorporate signaling characteristics compatible with longer-reach interconnects.

In some implementations of the method, the accelerator is coupled to the RPU via an NVLink switch (NVSwitch), and the request conforming to the NVLink-based protocol is sent via the NVSwitch to the RPU. The NVSwitch may route the NVLink-based request from the accelerator to the RPU based on routing information carried in the request. The NVSwitch may couple accelerators to the RPU, enabling accelerators within the NVLink domain to access the CXL memory device for inference context data staging.

In some implementations of the method, the inference context data comprises key-value (KV) cache data generated during attention computation in a transformer-based inference model, and the local memory comprises high-bandwidth memory (HBM). KV cache data generated by NVLink-coupled accelerators during transformer-based inference may be staged to CXL memory devices when the KV cache exceeds the HBM capacity.

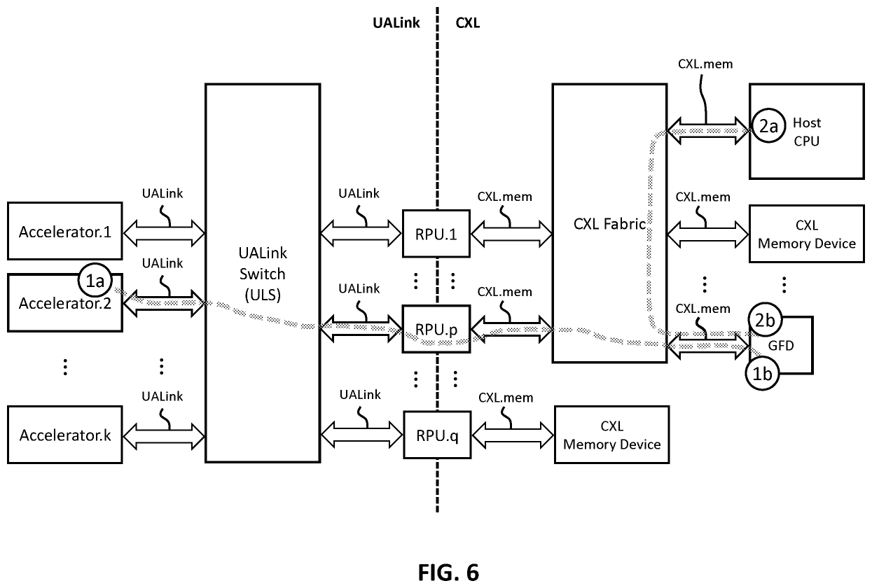

FIG. 6 illustrates an example of a system comprising a cluster of accelerators (e.g., GPUs or TPUs) interconnected by a UALink switch, an RPU coupled to the UALink switch, CXL memory devices coupled to the RPU via a CXL fabric, and a host coupled to the CXL memory devices via CXL.mem. Path 1a to 1b illustrates an accelerator-initiated data migration path. Accelerator.2 sends a UPLI request via the UALink switch to RPU.p. RPU.p translates the UPLI request to a CXL.mem M2S request and sends the CXL.mem M2S request to a GFD via the CXL fabric. The RPU may translate addresses between the UALink address space (e.g., NPA or SPA) and the CXL address space (e.g., HPA), and may translate opcodes, Tags, and additional fields between UPLI and CXL.mem message formats. In the write direction, the accelerator may evict inference context data from its local memory, such as HBM and/or HBF, to the GFD by sending a UPLI write request carrying the data on the Originator Data Channel. In the read direction, the accelerator may fetch inference context data from the GFD by sending a UPLI read request, and the RPU may receive a CXL.mem S2M DRS from the GFD, translate the CXL.mem S2M DRS to a UPLI RdRsp, and return the data to the accelerator via the UALink switch.

Path 2a to 2b illustrates a host-initiated access path. The host accesses the GFD via CXL.mem, without translation by the RPU. The host may read inference context data from the GFD via CXL.mem, and may subsequently write the inference context data to an accelerator by sending a CXL.mem M2S RwD to the RPU, which translates the CXL.mem M2S request to a UPLI request and sends the UPLI request to the accelerator via the UALink switch. Conversely, the host may read inference context data from an accelerator by sending a CXL.mem M2S request to the RPU, which translates the request to a UPLI read request, receives a UPLI RdRsp from the accelerator, and returns the data to the host; the host may then write the data to the GFD via CXL.mem. The host may thus orchestrate bidirectional data staging between the CXL memory devices and the accelerators across the CXL and UALink protocol domain boundaries.

In one example, the host may bring inference context data, such as KV cache data, from storage (e.g., NVMe or remote storage) into a CXL memory device such as the GFD. The accelerator may then fetch the KV cache data from the GFD to its local memory (e.g., HBM and/or HBF) for active inference computation. When the KV cache data is no longer actively accessed, or when the local memory capacity is exceeded, the accelerator may migrate the colder KV cache data from its HBM back to the GFD. In this manner, the system may maintain a tiered memory hierarchy where the accelerator HBM serves as a working memory tier for actively-accessed inference context data, and the CXL memory device serves as a capacity tier for less-frequently-accessed inference context data. The RPU may enable the data migration between these tiers by translating between UPLI and CXL.mem across the protocol domain boundaries.

The CXL memory devices shown in FIG. 6 may include CXL memory expanders, CXL memory pools, or GFDs, and may be coupled to the RPU via the CXL fabric, which may include one or more CXL switches. The RPU may route translated requests to specific CXL memory devices based on the physical addresses carried in the translated CXL.mem M2S requests. The system may support various types of inference context data, including KV cache data associated with transformer-based models, model weight parameters associated with mixture-of-experts models, activation tensors, embedding vectors, and other data generated or consumed during inference computation.

In various implementations, a method for translating between Compute Express Link (CXL) messages, comprising: receiving a first CXL message from a first entity; identifying a cacheline state intent based on at least one of a first opcode, a Snoop Type (SnpType), a Metadata Field (MetaField), or a Metadata Value (MetaValue) of the first CXL message, wherein the cacheline state intent pertains to a cacheline address specified in the first CXL message; translating the first CXL message to a second CXL message comprising a second opcode selected based at least in part on the identified cacheline state intent, wherein the second opcode differs from the first opcode; and sending the second CXL message to a second entity. The first entity may include a first host, the second entity may include a second host, and the entities may communicate using CXL. The cacheline state intent may indicate a desired cache state, such as Modified, Exclusive, Shared, or Invalid (MESI) that an entity seeks to acquire or affect for the cacheline address. For CXL.cache messages, the intent may be derived from the opcode, such as SnpData, SnpInv, or SnpCur for H2D requests, or RdOwn, RdShared, or CLFlush for D2H requests. For CXL.mem messages, the intent may be derived from the opcode, the SnpType, or a combination thereof, wherein the SnpType may indicate No-Op, SnpInv, or SnpData snoop requirements. By identifying the intent from the incoming message, the translation logic may select an appropriate opcode for the outgoing message that achieves the desired cache state transition, wherein the selected opcode differs from the incoming opcode due to differences in protocol direction or protocol type. The method may be performed by an RPU, a semiconductor device, or other computing apparatus positioned between the first entity and the second entity.

In some implementations of the method, the first CXL message comprises a CXL.cache Host-to-Device (H2D) request, and the first opcode is selected from SnpData, SnpInv, or SnpCur; and wherein the second CXL message comprises a CXL.cache Device-to-Host (D2H) request, and the second opcode is selected from RdOwn, RdShared, RdOwnNoData, RdCurr, RdAny, or CLFlush. The translation from CXL.cache H2D request to CXL.cache D2H request may enable inter-host communication via a device positioned between the hosts, wherein the device may expose CXL.cache interfaces to each host. H2D requests comprise snoops, such as SnpData, SnpInv, or SnpCur that indicate different cacheline state intents, while D2H requests comprise read or cache operation opcodes such as RdOwn, RdShared, RdOwnNoData, RdCurr, or CLFlush that achieve the corresponding cache state transitions.

In some implementations of the method, the first opcode comprises SnpData, the second opcode is selected from RdShared or RdOwn, whereby RdShared is selected to enable both the first entity and the second entity to retain cached copies of the cacheline in shared state, and whereby RdOwn is selected to cause the second entity to relinquish ownership and provide cacheline data for exclusive state acquisition by the first entity. SnpData indicates a snoop request for a cacheline that is intended to be cached in either shared or exclusive state at the first entity. The translation logic may determine whether shared or exclusive state is desired based on additional context, system configuration, or bias state information. RdShared requests a cacheline to be cached in shared state, enabling concurrent caching by multiple entities. RdOwn requests a cacheline to be cached in exclusive or modified state, causing the second entity to relinquish ownership and provide cacheline data to the translation logic for forwarding to the first entity.

In some implementations of the method, the first opcode comprises SnpInv, the second opcode is selected from CLFlush, RdOwnNoData, or RdOwn, whereby CLFlush is selected to invalidate the cacheline at the second entity without data return, whereby RdOwnNoData is selected to acquire exclusive ownership of the cacheline without data return, and whereby RdOwn is selected to acquire exclusive ownership of the cacheline with cacheline data return from the second entity. SnpInv indicates a snoop request that invalidates the cacheline at the receiving device and signals intent to acquire exclusive state at the first entity. The translation logic may determine whether data transfer is required based on data caching policies associated with the translation logic, the first entity's cache state, pending write operations, or other context. CLFlush requests flushing of the cacheline at the second entity, which may include data return if the cacheline is in Modified state, and may be selected when invalidation of the second entity's cached copy is the primary intent. RdOwnNoData requests exclusive ownership without data return and may be selected when the first entity will overwrite the entire cacheline. RdOwn requests exclusive ownership with data return and may be selected when the first entity requires current cacheline contents before modification.

In some implementations of the method, the first opcode comprises SnpCur, the second opcode comprises RdCurr, and whereby the translation enables the first entity to obtain current cacheline data from the second entity without modifying cache states at either the first entity or the second entity. SnpCur indicates a snoop request to obtain the current version of the cacheline without requiring change of cache states in the hierarchy. RdCurr indicates a read request to get the most current data without changing the existing state in any cache. The translation from SnpCur to RdCurr may enable the first entity to read current data from the second entity without affecting cache coherency states, which may be useful for I/O data operations, such as I/O-coherent reads (e.g., I/O-coherency mode), monitoring, debugging, or speculative operations.

In some implementations of the method, the first CXL message comprises a CXL.cache Device-to-Host (D2H) request, and the first opcode is selected from RdOwn, RdOwnNoData, RdShared, RdCurr, or CLFlush; and wherein the second CXL message comprises a CXL.cache Host-to-Device (H2D) request, and the second opcode is selected from SnpData, SnpInv, or SnpCur based on the cacheline state intent indicated by the first opcode. The translation from CXL.cache D2H request to CXL.cache H2D request may enable inter-device communication, wherein a read request or cache operation from one device is translated to a snoop request targeting another device. The translation logic may map RdShared to SnpData when the intent is to acquire shared state with possible data return, may map RdOwn, CLFlush, or RdOwnNoData to SnpInv when the intent is exclusive ownership acquisition or invalidation, and may map RdCurr to SnpCur when the intent is non-state-changing data access.

In some implementations of the method, the first CXL message comprises a CXL.mem Master-to-Subordinate (M2S) request; and wherein the second CXL message comprises a CXL.cache Device-to-Host (D2H) request, and the second opcode is selected from RdOwn, RdOwnNoData, RdShared, RdCurr, RdAny, or CLFlush. The translation from CXL.mem M2S request to CXL.cache D2H request may enable memory access operations from a first entity utilizing CXL.mem to be translated into cache coherency operations targeting a second entity utilizing CXL.cache. A set of fields in the M2S request, which may include SnpType, MetaField, or MetaValue, may indicate the cacheline state intent, which may be utilized to select an appropriate D2H request opcode. The translation logic may bridge between the CXL.mem and CXL.cache domains while preserving the intent of the memory operation.

In some implementations of the method, the CXL.mem M2S request comprises the SnpType and the MetaValue, the CXL.cache D2H request comprises the second opcode, and the second opcode is selected based on the SnpType and the MetaValue. The combination of SnpType and MetaValue in the M2S request may provide finer-grained indication of the cacheline state intent than SnpType alone. For example, an M2S request with SnpType indicating SnpData and MetaValue indicating Shared(S) may result in selection of RdShared. The translation logic may utilize both fields to determine the appropriate D2H request opcode.

In some implementations of the method, the CXL.mem M2S request comprises the SnpType that comprises SnpCur, and the CXL.cache D2H request comprises the second opcode that comprises RdCurr. The SnpCur to RdCurr translation may enable requests for a non-cacheable but current value of a cacheline, such as for I/O-coherent reads. The M2S request may further include MetaValue indicating Invalid (I) to indicate that the requester will not cache the line. RdCurr may retrieve the most current data from the second entity without causing state transitions in any cache. Upon receiving a response, such as a CXL.cache H2D Data, the computer may translate the response to a CXL.mem S2M DRS comprising MemData and a CXL.mem S2M NDR comprising Cmp.

In some implementations of the method, the CXL.mem M2S request comprises the SnpType that comprises SnpData, and the CXL.cache D2H request comprises the second opcode that comprises RdShared. The SnpData to RdShared translation may enable the requester to acquire a cacheline in shared state, permitting concurrent caching by multiple entities. The M2S request may further include MetaValue indicating Shared(S) to indicate the host may have at most a shared copy of the line. Upon receiving a response from the second entity, which may include a CXL.cache H2D response comprising GO-S, the computer may translate the response to a CXL.mem S2M NDR comprising Cmp-S, providing an indication for Shared state.

In some implementations of the method, the CXL.mem M2S request comprises the SnpType that comprises SnpInv, and the CXL.cache D2H request comprises the second opcode that comprises RdOwn. The SnpInv to RdOwn translation may enable the requester to acquire exclusive ownership of a cacheline, causing the second entity to relinquish any cached copies. The M2S request may further include MetaValue indicating Any (A) to indicate the host may have a shared, exclusive, or modified copy of the line. Upon receiving a response from the second entity, which may include a CXL.cache H2D response comprising GO-E or GO-M, the computer may translate the response to a CXL.mem S2M NDR comprising Cmp-E, providing an indication for Exclusive ownership.

In some implementations of the method, the second opcode is selected based on the SnpType as follows: RdOwn or RdOwnNoData is selected when the SnpType indicates SnpInv for exclusive ownership acquisition with or without data return respectively, CLFlush is selected when the SnpType indicates SnpInv for cacheline invalidation without ownership acquisition, and RdShared is selected when the SnpType indicates SnpData for shared state acquisition. The SnpType in the M2S request may indicate SnpInv for invalidation snoops or SnpData for data snoops. When SnpType indicates SnpInv, the translation logic may select RdOwn if data return is required, RdOwnNoData if exclusive ownership without data is sufficient, or CLFlush if invalidation is needed. When SnpType indicates SnpData, the translation logic may select RdShared to acquire the cacheline in shared state. This mapping enables CXL.mem operations to be properly coordinated with CXL.cache coherency.

In some implementations of the method, the first CXL message comprises a CXL.cache Device-to-Host (D2H) request, and the first opcode is selected from RdOwn, RdShared, RdCurr, RdAny, or CLFlush; and wherein the second CXL message comprises a CXL.mem Master-to-Subordinate (M2S) request comprising MemRd* and a second SnpType. The translation from CXL.cache D2H request to CXL.mem M2S request may enable cache coherency operations from a first entity utilizing CXL.cache to be translated into memory access operations targeting a second entity utilizing CXL.mem. The D2H request opcode may indicate the cacheline state intent, which may be utilized to select an appropriate SnpType value for the M2S request. For example, a D2H request comprising RdOwn may be translated to an M2S request comprising MemRd with SnpType set to SnpInv, while a D2H request comprising RdShared may be translated to an M2S request comprising SnpType set to SnpData.

In some implementations of the method, the CXL.cache D2H request comprises the first opcode, and the second SnpType is set based on the cacheline state intent indicated by the first opcode. The translation logic may analyze the first opcode to determine the cacheline state intent and set the second SnpType accordingly. For example, RdOwn may indicate intent to acquire exclusive state, resulting in SnpType being set to SnpInv, while RdShared may indicate intent to acquire shared state, resulting in SnpType being set to SnpData. This intent-based translation may enable CXL.cache operations to be properly coordinated with CXL.mem coherency semantics.

In some implementations of the method, the CXL.cache D2H request comprises the first opcode that comprises RdCurr, and the CXL.mem M2S request comprises the second SnpType that comprises SnpCur. The RdCurr to SnpCur translation may enable requests for a non-cacheable but current value of a cacheline via the CXL.mem interface. The M2S request may further include MetaField indicating MS0 and MetaValue indicating Invalid (I) to indicate that the requester may not cache the line. Upon receiving a response from the second entity, which may include a CXL.mem S2M DRS comprising MemData and a CXL.mem S2M NDR comprising Cmp, the computer may translate the response to a CXL.cache H2D Data for delivery to the first entity.

In some implementations of the method, the CXL.cache D2H request comprises the first opcode comprising RdShared, and the CXL.mem M2S request comprises the second SnpType comprising SnpData. The RdShared to SnpData translation may enable the CXL.cache requester to acquire a cacheline in shared state via the CXL.mem interface. The M2S request may further include MetaField indicating MS0 and MetaValue indicating Shared(S). Upon receiving a response from the second entity, which may include a CXL.mem S2M NDR comprising Cmp-S providing an indication for Shared state, the computer may translate the response to a CXL.cache H2D response comprising GO-S and a CXL.cache H2D Data comprising the cacheline data.

In some implementations of the method, the CXL.cache D2H request comprises the first opcode comprising RdOwn, and the CXL.mem M2S request comprises the second SnpType comprising SnpInv. The RdOwn to SnpInv translation may enable the CXL.cache requester to acquire exclusive ownership of a cacheline via the CXL.mem interface, typically receiving the cacheline in Exclusive or Modified state. The M2S request may further include MetaField indicating MS0 and MetaValue indicating Any (A). Upon receiving a response from the second entity, which may include a CXL.mem S2M NDR comprising Cmp-E providing an indication for Exclusive ownership, the computer may translate the response to a CXL.cache H2D response comprising GO-E and a CXL.cache H2D Data comprising the cacheline data.

In some implementations, the method further comprises maintaining a mapping between cacheline state intents and corresponding opcodes for the second CXL message, wherein the cacheline state intent indicates whether the first entity seeks to acquire a cache state that permits concurrent caching by other entities, a cache state that requires exclusive ownership, or invalidation of the cacheline at the second entity; and wherein the translating comprises utilizing the mapping to select the second opcode to achieve the indicated cache state transition at the second entity. The mapping may be implemented as a lookup table, combinational logic, or programmable translation function that associates each cacheline state intent with one or more candidate opcodes for the second CXL message. The cacheline state intent may be categorized as shared state acquisition (permitting concurrent caching), exclusive state acquisition (requiring the second entity to relinquish cached copies), or invalidation (causing the second entity to discard cached copies without ownership transfer). The translation logic may utilize the mapping to select an opcode that achieves the desired cache state transition while considering additional context such as whether data return is required.

In some implementations, the method further comprises receiving, from the second entity, a response message indicating a cache state based on at least one of a third opcode or cacheline data included in the response message; translating the response message to a translated response message comprising a fourth opcode selected based on the cache state indicated by the response message; wherein the fourth opcode differs from the third opcode; and sending the translated response message to the first entity. The response message may include a CXL.cache H2D response such as GO-M, GO-E, GO-S, or GO-I indicating Modified, Exclusive, Shared, or Invalid (MESI) cacheline state, respectively. The translation logic may select an opcode for the translated response message, such as a CXL.cache D2H response comprising RspIHitI, RspSHitSE, RspIFwdM, or similar, which communicates the resulting cacheline state to the first entity. The translation may utilize a previously stored identifier mapping to correctly route the response back to the originating transaction.

In some implementations of the method, the cache state indicated by the response message indicates shared state, exclusive state, or modified state; and wherein the fourth opcode is selected as follows: RspSHitSE is selected when the third opcode indicates GO-S for shared state to communicate that the cacheline is available in shared state, RspIHitI or RspIHitSE is selected when the third opcode indicates GO-E for exclusive state to communicate that the cacheline is no longer present in the cache abstraction, and RspIFwdM is selected when the third opcode indicates GO-M for modified state to communicate that modified data is being forwarded. The GO-S indication signifies that the second entity is providing the cacheline in shared state, permitting concurrent caching by multiple entities, and the translation logic may select RspSHitSE to indicate to the first entity that the cacheline was hit in a clean state and its current state is shared. The GO-E indication signifies that the second entity has granted exclusive ownership, and the translation logic may select RspIHitI or RspIHitSE to indicate that the cacheline is no longer present in the cache abstraction. The GO-M indication signifies that the second entity previously held the cacheline in modified state and is relinquishing ownership along with modified data, and the translation logic may select RspIFwdM to indicate that modified data is being forwarded.

In some implementations, the method further comprises exposing a cache abstraction to the first entity, wherein the cache abstraction appears to the first entity as a device cache accessible via CXL transactions, whereby the cache abstraction acts as a proxy for cache resources maintained by the second entity, and wherein the first entity issues CXL messages targeting the cache abstraction that are translated to outgoing CXL messages affecting actual caches in the second entity based on the identified cacheline state intent. The cache abstraction may be exposed as a CXL Type-1 or CXL Type-2 device interface that the first entity may enumerate and interact with as a local device cache. The first entity may issue CXL messages, such as snoop requests, that target the cache abstraction, wherein the translation logic may identify the cacheline state intent from these messages and translate them to appropriate outgoing CXL messages that affect actual caches in the second entity. This proxy arrangement may enable cache coherency operations between entities that cannot communicate directly due to protocol direction constraints or address space differences.

In some implementations of the method, the translating enables cacheline state orchestration between a first cache maintained by the first entity and a second cache maintained by the second entity; wherein the cacheline state orchestration enables the first entity to affect cache states in the second cache through the translated second CXL message, and indicates transitions between at least two states selected from Modified, Exclusive, Shared, or Invalid (MESI) according to a cache coherency protocol. Cacheline state orchestration may encompass coordinated transitions between various cache states according to MESI or similar cache coherency protocols. The translation logic may enable the first entity to cause invalidation, downgrade, or ownership transfer of cachelines in the second entity's cache hierarchy by translating the first entity's CXL messages into appropriate CXL messages for the second entity.

In some implementations of the method, the cacheline state orchestration further enables cache-coherent memory sharing between the first entity and the second entity by allowing both entities to access shared memory resources while maintaining data consistency. The translation logic may track pending transactions and coordinate state transitions to maintain coherency invariants across both cache hierarchies, enabling cache-coherent memory sharing in disaggregated memory systems, multi-GPU clusters, heterogeneous computing platforms, or other multi-entity architectures.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

In various implementations, a system comprising: a computer configured to: receive, from a first entity, a first Compute Express Link (CXL) message; identify a cacheline state intent based on at least one of a first opcode, a Snoop Type (SnpType), a Metadata Field (MetaField), or a Metadata Value (MetaValue) of the first CXL message, wherein the cacheline state intent pertains to a cacheline address specified in the first CXL message; translate the first CXL message to a second CXL message comprising a second opcode selected based at least in part on the identified cacheline state intent, wherein the second opcode differs from the first opcode; and send the second CXL message to a second entity. The computer may include processing logic, memory for storing translation tables and transaction state, and interface controllers for managing CXL communications with each entity. The system may be implemented as a standalone device, integrated into a larger semiconductor component, or distributed across multiple components within a computing platform. The translation capabilities may enable diverse system architectures such as disaggregated memory systems, multi-host configurations, multi-GPU clusters, or heterogeneous computing platforms.

In some implementations of the system, the computer is included within a semiconductor device comprising a first CXL.cache interface configured to receive CXL.cache Host-to-Device (H2D) requests from the first entity and a second CXL.cache interface configured to send CXL.cache Device-to-Host (D2H) requests to the second entity; wherein the semiconductor device is positioned between the first entity and the second entity to enable inter-entity communication based on translating snoops received from the first entity to read or cache operation opcodes sent to the second entity based on the identified cacheline state intent. The semiconductor device may be implemented as an ASIC, FPGA, SoC, RPU, or other integrated circuit technology. The first CXL.cache interface may receive H2D requests comprising snoops such as SnpData, SnpInv, or SnpCur, and the second CXL.cache interface may send D2H requests comprising opcodes such as RdOwn, RdShared, RdOwnNoData, or CLFlush selected based on the cacheline state intent. Each interface may include physical layer circuits, link layer controllers, and protocol layer engines specifically designed for CXL.cache communication.

In some implementations of the system, the first CXL message comprises a CXL.mem Master-to-Subordinate (M2S) request, the second CXL message comprises a CXL.cache Device-to-Host (D2H) request, and wherein the computer is configured to bridge between CXL.mem and CXL.cache by identifying the cacheline state intent, based on at least one of the SnpType or the first opcode, and selecting an opcode for the D2H request that achieves a corresponding cache state transition at the second entity. The computer may be configured to bridge between CXL.mem and CXL.cache domains, enabling memory access operations from entities utilizing CXL.mem to be coordinated with cache coherency operations targeting entities utilizing CXL.cache. The system may analyze SnpType values to determine whether SnpInv or SnpData is indicated, and may select corresponding D2H request opcodes such as RdOwn, RdOwnNoData, CLFlush, or RdShared to achieve the intended cache state transition. This bridging capability may enable heterogeneous systems where different entities utilize different CXL protocols.

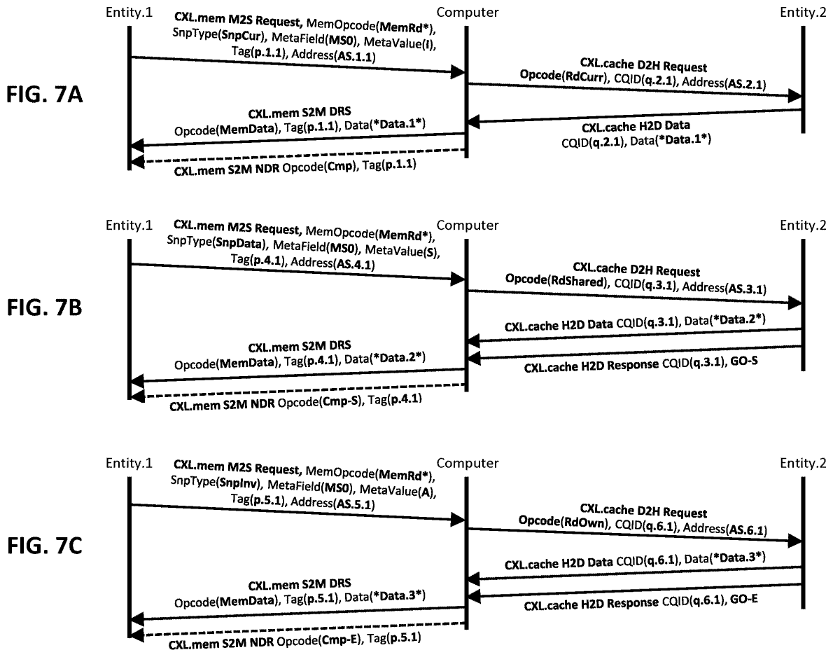

FIG. 7A illustrates an example of a TFD demonstrating intent-based translations between CXL.mem messages received from a first entity (Entity.1), such as a first host (Host.1), and CXL.cache messages sent to a second entity (Entity.2), such as a second host (Host.2), possibly enabling the first entity to access resources mapped to an address space utilized by the second entity. The first entity may initiate a CXL.mem transaction that may include a CXL.mem M2S request comprising MemOpcode(MemRd*), SnpType(SnpCur), MetaField(MS0), MetaValue(I), Tag(p.1.1), and Address(AS.1.1), wherein the CXL.mem M2S request may indicate an intent to request a non-cacheable but current value of a cacheline. The computer may perform intent-based translation between the CXL.mem domain and the CXL.cache domain, by translating the CXL.mem transaction to a CXL.cache transaction that may include a CXL.cache D2H request comprising Opcode(RdCurr), CQID(q.2.1), and Address(AS.2.1), wherein the CXL.cache D2H request may indicate a corresponding intent to request a non-cacheable but current value of a cacheline by utilizing RdCurr. The computer may send the CXL.cache D2H request to the second entity. Upon receiving a response from the second entity, which may include a CXL.cache H2D Data comprising CQID(q.2.1) and Data(*Data.1*), the computer may translate the CXL.cache H2D Data to a CXL.mem S2M DRS comprising Opcode(MemData), Tag(p.1.1), and Data(*Data.1*), and may further translate the CXL.cache H2D Data to a CXL.mem S2M NDR comprising Opcode(Cmp) and Tag(p.1.1). The computer may perform further translations, such as address translations, translations between CXL.mem Tags and CXL.cache CQIDs, translations between reserved fields, and/or opcode translations, e.g., translating between CXL.mem M2S request opcodes, such as MemRd*, and CXL.cache D2H request opcodes, such as RdCurr, RdOwn, RdShared, RdAny, RdOwnNoData, ItoMWr, WrCur, CLFlush, CleanEvict, DirtyEvict, CleanEvictNoData, WOWrInv, WOWrInvF, WrInv, or CacheFlushed.

FIG. 7B illustrates an example of a TFD demonstrating intent-based translations wherein a first entity may initiate a CXL.mem transaction that may include a CXL.mem M2S request comprising MemOpcode(MemRd*), SnpType(SnpData), MetaField(MS0), MetaValue(S), Tag(p.4.1), and Address(AS.4.1), wherein the CXL.mem M2S request may indicate an intent to request a shared copy of the cacheline. A computer may perform intent-based translation between the CXL.mem domain and the CXL.cache domain, and may translate the CXL.mem transaction to a CXL.cache transaction that may include a CXL.cache D2H request comprising Opcode(RdShared), CQID(q.3.1), and Address(AS.3.1), wherein the CXL.cache D2H request may indicate a corresponding intent to request a cacheline to be cached in shared state by utilizing RdShared. The computer may send the CXL.cache D2H request to a second entity. Upon receiving a response from the second entity, which may include a CXL.cache H2D Data comprising CQID(q.3.1) and Data(*Data.2*), and may further include CXL.cache H2D response comprising CQID(q.3.1) and GO-S, the computer may translate the CXL.cache H2D Data to a CXL.mem S2M DRS comprising Opcode(MemData), Tag(p.4.1), and Data(*Data.2*), and may further translate the CXL.cache H2D response to a CXL.mem S2M NDR comprising Opcode(Cmp-S) and Tag(p.4.1), wherein Cmp-S may provide an indication from the DCOH to the first entity for Shared state.

FIG. 7C illustrates an example of a TFD demonstrating intent-based translations wherein a first entity may initiate a CXL.mem transaction that may include a CXL.mem M2S request comprising MemOpcode(MemRd*), SnpType(SnpInv), MetaField(MS0), MetaValue(A), Tag(p.5.1), and Address(AS.5.1), wherein the CXL.mem M2S request may indicate an intent to request an exclusive copy of the cacheline. A computer may perform intent-based translation between the CXL.mem domain and the CXL.cache domain, and may translate the CXL.mem transaction to a CXL.cache transaction that may include a CXL.cache D2H request comprising Opcode(RdOwn), CQID(q.6.1), and Address(AS.6.1), wherein the CXL.cache D2H request may indicate a corresponding intent to request a cacheline to be cached in any writeable state by utilizing RdOwn, typically receiving the cacheline in Exclusive (GO-E) or Modified (GO-M) state, and wherein the computer may send the CXL.cache D2H request to a second entity. Upon receiving a response from the second entity, which may include a CXL.cache H2D Data comprising CQID(q.6.1) and Data(*Data.3*), and may further include a CXL.cache H2D response comprising CQID(q.6.1) and GO-E, the computer may translate the CXL.cache H2D Data to a CXL.mem S2M DRS comprising Opcode(MemData), Tag(p.5.1), and Data(*Data.3*), and may further translate the CXL.cache H2D response to a CXL.mem S2M NDR comprising Opcode(Cmp-E) and Tag(p.5.1), wherein Cmp-E may provide an indication from the DCOH to the first entity for Exclusive ownership.

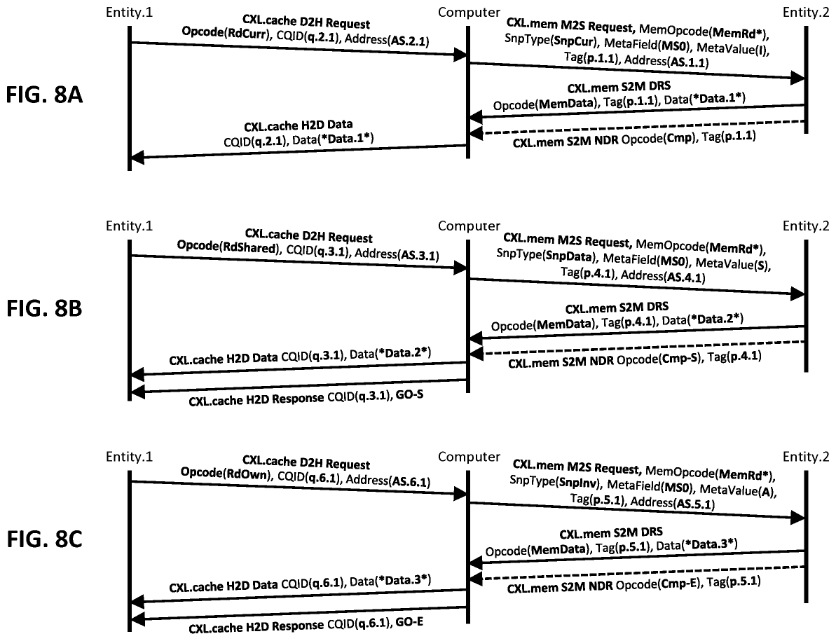

FIG. 8A illustrates an example of a TFD demonstrating intent-based translations between CXL.cache messages received from a first entity (Entity.1), such as a first device (Device.1), and CXL.mem messages sent to a second entity (Entity.2), such as a second device (Device.2), possibly enabling the first entity to access resources mapped to an address space utilized by the second entity. The first entity may initiate a CXL.cache transaction that may include a CXL.cache D2H request comprising Opcode(RdCurr), CQID(q.2.1), and Address(AS.2.1), wherein the CXL.cache D2H request may indicate an intent to request a non-cacheable but current value of a cacheline by utilizing RdCurr.

The computer may perform intent-based translation between the CXL.cache domain and the CXL.mem domain, and may translate the CXL.cache transaction to a CXL.mem transaction that may include a CXL.mem M2S request comprising MemOpcode(MemRd*), SnpType(SnpCur), MetaField(MS0), MetaValue(I), Tag(p.1.1), and Address(AS.1.1). The CXL.mem M2S request may indicate a corresponding intent to request a non-cacheable but current value of a cacheline. The computer may send the CXL.mem M2S request to the second entity. Upon receiving a response from the second entity, which may include a CXL.mem S2M DRS comprising Opcode(MemData), Tag(p.1.1), and Data(*Data.1*), and may further include a CXL.mem S2M NDR comprising Opcode(Cmp) and Tag(p.1.1), the computer may translate the CXL.mem S2M DRS to a CXL.cache H2D Data comprising CQID(q.2.1) and Data(*Data.1*). The computer may perform further translations, such as address translations, translations between CXL.cache CQIDs and CXL.mem Tags, translations between reserved fields, and/or opcode translations, e.g., translating between CXL.cache D2H request opcodes, such as RdCurr, RdOwn, RdShared, RdAny, RdOwnNoData, ItoMWr, WrCur, CLFlush, CleanEvict, DirtyEvict, CleanEvictNoData, WOWrInv, WOWrInvF, WrInv, or CacheFlushed, and CXL.mem M2S request opcodes, such as MemRd*.

FIG. 8B illustrates an example of a TFD demonstrating intent-based translations wherein a first entity may initiate a CXL.cache transaction that may include a CXL.cache D2H request comprising Opcode(RdShared), CQID(q.3.1), and Address(AS.3.1), wherein the CXL.cache D2H request may indicate an intent to request a cacheline to be cached in shared state by utilizing RdShared. A computer may perform intent-based translation between the CXL.cache domain and the CXL.mem domain, and may translate the CXL.cache transaction to a CXL.mem transaction that may include a CXL.mem M2S request comprising MemOpcode(MemRd*), SnpType(SnpData), MetaField(MS0), MetaValue(S), Tag(p.4.1), and Address(AS.4.1), wherein the CXL.mem M2S request may indicate a corresponding intent to request a shared copy of the cacheline, and wherein the computer may send the CXL.mem M2S request to the second entity. Upon receiving a response from the second entity, which may include a CXL.mem S2M DRS comprising Opcode(MemData), Tag(p.4.1), and Data(*Data.2*), and may further include a CXL.mem S2M NDR comprising Opcode(Cmp-S) and Tag(p.4.1), the Cmp-S may provide an indication from the DCOH to the computer for Shared state. The computer may translate the CXL.mem S2M DRS to a CXL.cache H2D Data comprising CQID(q.3.1) and Data(*Data.2*), and may further translate the CXL.mem S2M DRS and/or the CXL.mem S2M NDR to a CXL.cache H2D response comprising CQID(q.3.1) and GO-S.

FIG. 8C illustrates an example of a TFD demonstrating intent-based translations wherein a first entity may initiate a CXL.cache transaction that may include a CXL.cache D2H request comprising Opcode(RdOwn), CQID(q.6.1), and Address(AS.6.1), wherein the CXL.cache D2H request may indicate an intent to request a cacheline to be cached in any writeable state by utilizing RdOwn, typically receiving the cacheline in Exclusive (GO-E) or Modified (GO-M) state. A computer may perform intent-based translation between the CXL.cache domain and the CXL.mem domain, and may translate the CXL.cache transaction to a CXL.mem transaction that may include a CXL.mem M2S request comprising MemOpcode(MemRd*), SnpType(SnpInv), MetaField(MS0), MetaValue(A), Tag(p.5.1), and Address(AS.5.1), wherein the CXL.mem M2S request may indicate a corresponding intent to request an exclusive copy of the cacheline, and wherein the computer may send the CXL.mem M2S request to a second entity. Upon receiving a response from the second entity, which may include a CXL.mem S2M DRS comprising Opcode(MemData), Tag(p.5.1), and Data(*Data.3*), and may further include a CXL.mem S2M NDR comprising Opcode(Cmp-E) and Tag(p.5.1), the Cmp-E may provide an indication from the DCOH to the computer for Exclusive ownership. The computer may translate the CXL.mem S2M DRS to a CXL.cache H2D Data comprising CQID(q.6.1) and Data(*Data.3*), and may further translate the CXL.mem S2M DRS and/or the CXL.mem S2M NDR to a CXL.cache H2D response comprising CQID(q.6.1) and GO-E.

In environments where entities may utilize different protocols while requiring coordinated access to shared resources, there may be scenarios where a first entity communicating according to UALink UPLI, such as an accelerator, needs to access memory resources coupled to a second entity communicating according to CXL, such as CXL.mem. An RPU may translate between UPLI and CXL.mem to facilitate memory operations, data transfers, and/or resource sharing across different protocol domains while maintaining the requirements of each protocol. The RPU may translate opcodes, commands, addresses, Tags, and additional fields between UPLI and CXL.mem messages, and may further perform address translations between different address spaces, such as between a Network Physical Address (NPA) space utilized by UALink-based traffic and a Host Physical Address (HPA) space utilized by CXL-based traffic, or between addresses within the same address space, such as a global address space, a partitioned global address space (PGAS), a pod address space, a virtual pod address space, or a fabric address space. The RPU may be implemented as a discrete component, as an IP block embedded in a processor, or as a chiplet within an IC package.

In various implementations, a method for translating from Ultra Accelerator Link (UALink) Protocol Level Interface (UPLI) requests to Compute Express Link (CXL) requests, comprising: communicating with a first entity according to UPLI; communicating with a second entity according to CXL.mem; receiving, from the first entity, a UPLI request comprising a read command and a first physical address; translating the UPLI request to a CXL.mem Master-to-Subordinate request comprising: a MemRd* and a second physical address (CXL.mem M2S Req MemRd*); and sending the CXL.mem M2S Req MemRd* to the second entity. The translation may enable entities communicating according to UPLI to access memory resources coupled to entities communicating according to CXL.mem. The method may be implemented in hardware, firmware, software, or combinations thereof, and may be performed by various types of devices, such as a processor, a switch, a bridge, an RPU, or a semiconductor device. MemRd* may refer to MemRd, MemRdData, MemRdTEE, MemRdDataTEE, or other memory read opcode variants defined or to be defined in CXL.mem. The first physical address may be associated with a first address space, such as an NPA space, and the second physical address may be associated with a second address space, such as an HPA space or an SPA space, wherein the translating may include translating the first physical address to the second physical address. Additionally or alternatively, the first and second physical addresses may be associated with the same address space, such as a global address space, a PGAS, a pod address space, a virtual pod address space, or a fabric address space. The elements may communicate through one or more intermediary components, such as a switch, a retimer, or other suitable entity that facilitates information transfer.

In some implementations of the method, the UPLI request further comprises a ReqSrcPhysAccID field, a ReqDstPhysAccID field, a ReqLen field, a ReqTag field, a ReqAddr field comprising the first physical address, and a ReqCmd field comprising the read command; and further comprising translating the ReqTag to a Tag associated with the CXL.mem M2S Req. The ReqSrcPhysAccID and ReqDstPhysAccID fields may carry identifiers that may be utilized by the RPU for routing the UPLI request to its target, and may be further utilized for constructing response routing information. The ReqLen field may indicate a transfer size of up to 256 Bytes of data. When the ReqLen indicates a transfer size exceeding a CXL.mem cacheline size (e.g., 64 Bytes), the RPU may translate a UPLI request to multiple CXL.mem M2S requests. The Tag translation may involve maintaining a bidirectional mapping between UPLI ReqTag values and CXL.mem Tag values, enabling proper correlation of CXL.mem responses with their corresponding UPLI requests.

In some implementations, the method further comprises receiving, from the second entity, a CXL.mem Subordinate-to-Master Data Response (S2M DRS) comprising MemData, a Tag, and data; translating the CXL.mem S2M DRS to a UPLI read response (RdRsp) comprising a RdRspSrcPhysAccID field, a RdRspDstPhysAccID field, a RdRspTag field, and RdRspData comprising the data; and sending the UPLI RdRsp to the first entity. The RdRspSrcPhysAccID may correspond to the ReqDstPhysAccID from the original UPLI request, and the RdRspDstPhysAccID may correspond to the ReqSrcPhysAccID, reflecting the routing path for the response. The RdRspTag may be retrieved from the bidirectional mapping maintained by the RPU, enabling the first entity to correlate the response with its original request. In some examples, the RPU may accumulate data from one or more CXL.mem S2M DRS messages before sending the data via the UPLI RdRsp, such as when CXL.mem M2S requests were generated from a UPLI request.

In some implementations of the method, the CXL.mem S2M DRS further comprises a Poison field, and the UPLI RdRsp further comprises a RdRspDataError field; and further comprising translating the Poison field of the CXL.mem S2M DRS to the RdRspDataError field of the UPLI RdRsp. The Poison field in CXL.mem S2M DRS may indicate that the returned data contains an error. The RdRspDataError field in UPLI may serve as a per-beat data poison indicator. The translation of error indications across protocol boundaries may enable the first entity to detect data corruption that originated in the CXL domain, and to take appropriate recovery actions, such as discarding the corrupted data, retrying the request, or reporting the error to system management software.

In some implementations of the method, the read command comprises a Read Class Vendor Defined Command, the first entity comprises an accelerator or a UALink switch, the second entity comprises a CXL device, and the second physical address is a host physical address (HPA) utilized by the second entity. Read Class VDCs may correspond to ReqCmd encodings and may enable vendor-specific memory access operations that extend beyond the standard UPLI read commands. The CXL device may include a CXL memory expander, a CXL memory pool, a Global Fabric-Attached Memory (G-FAM) Device (GFD), or a CXL accelerator. The HPA may represent an address within the address space utilized by the second entity for servicing memory requests.

In some implementations of the method, the UPLI request indicates an I/O-coherent read, and the CXL.mem M2S Req MemRd* further comprises a SnpType field comprising SnpCur, a MetaField field comprising Meta0-State (MS0), and a MetaValue field comprising Invalid (I). The SnpType(SnpCur), MetaField(MS0), and MetaValue(I) combination in the CXL.mem M2S request may indicate an intent to perform an I/O-coherent read by requesting a non-cacheable but current value of the data. This combination may correspond to the I/O-coherency model utilized by UALink, wherein a read from peer memory returns the most recent coherent copy from memory or a cache within the destination's system node. The RPU may select the SnpType, MetaField, and MetaValue values based on a predefined, predetermined, configurable, rule-based, or dynamic intent mapping between the UPLI I/O-coherent read semantics and CXL.mem coherency fields.

In some implementations, the method further comprises sending to the second entity a CXL.mem M2S request comprising MemSpecRd. The speculative memory read may be initiated by the RPU to facilitate data availability from the second entity before, or without, the first entity explicitly requesting that data. The decision to initiate speculative reads may be based on pattern recognition algorithms analyzing the first entity's memory access behavior, statistical models predicting future access locations, configurable prefetch policies defining aggressiveness and scope of speculation, and/or bandwidth availability assessments determining when speculative operations will not interfere with demand requests. When utilizing the MemSpecRd opcode, some of the CXL.mem M2S Req fields, such as Tag, MetaField, MetaValue, and SnpType, may be reserved. Additionally or alternatively, the RPU may issue reads (e.g., CXL.mem M2S requests comprising MemRd or MemRdData) to prefetch data from the second entity, and may buffer the returned data for satisfying subsequent demand requests from the first entity.

In some implementations of the method, the first physical address is associated with a first address space, the second physical address is associated with a second address space different from the first address space, and the translating further comprises translating the first physical address to the second physical address. The first address space may include an NPA space utilized by the UALink-based traffic, and the second address space may include an HPA space utilized by CXL-based traffic. The first and second address spaces may have different sizes, different base addresses, different memory layouts, or different granularities, and the translation may accommodate these differences while maintaining the meaning of the memory operations.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

In computing environments where external entities, such as accelerators, may access memory resources coupled to a processing unit, there may be scenarios where the processing unit provides access to memory resources via different memory paths. For example, a processing unit may include a first memory path from a UALink port to a first memory via a memory controller, and a second memory path from the UALink port to a second memory via a CXL port. The processing unit may include an RPU that translates between a UALink-based protocol, such as UPLI, and the protocols utilized for accessing the first and second memories. The RPU may perform physical address translations, such as from NPAs to HPAs, to enable external entities to access both memory resources via the UALink port.

In various implementations, a system comprising: a processing unit comprising an Ultra Accelerator Link (UALink) port, a memory controller coupled to a first memory, and a Compute Express Link (CXL) port coupled to a second memory; wherein the UALink port is configured to communicate with an entity according to a UALink-based protocol; wherein the processing unit is configured to provide a first memory path from the UALink port to the first memory via the memory controller, and a second memory path from the UALink port to the second memory via the CXL port; and wherein the processing unit further comprises a resource provisioning unit (RPU) configured to receive a first UALink Protocol Level Interface (UPLI) request from the entity and forward a first translated request to the first memory via the first memory path, and to receive a second UPLI request from the entity and forward a second translated request to the second memory via the second memory path. The processing unit may be implemented as a processor, a system-on-chip (SoC), or as chiplets within an IC package. The first memory may include DRAM coupled to the memory controller, and the second memory may include a CXL memory expander, a CXL memory pool, or a CXL device that exposes memory resources. The RPU may perform physical address translations to determine whether a given UPLI request targets the first memory or the second memory, and may route the translated request to the appropriate memory path accordingly. The entity may include an accelerator, a CPU, or a switch that communicates with the processing unit via the UALink port according to UPLI. In some examples, the requested data may be provided by a cache of the processing unit, such as by LLC, instead of by the first or second memory.

In some implementations of the system, the processing unit further comprises a coherent interconnect, and wherein the first memory path and the second memory path traverse a portion of the coherent interconnect. The coherent interconnect may include a mesh network, a ring interconnect, a crossbar, a Network on Chip (NoC), or other types of interconnect fabrics that maintain cache coherency among processing cores and other components of the processing unit. The first memory path may traverse the coherent interconnect from the RPU to the memory controller, and the second memory path may traverse the coherent interconnect from the RPU to the CXL port. In some examples, the RPU may translate between the UALink-based protocol, such as UPLI, and a protocol utilized by the coherent interconnect. The paths from the RPU to the different memories may traverse other components coupled to the coherent interconnect, such as caching/home agent (CHA) slices, snoop filter (SF) slices, or LLC slices, optionally for resolving coherency.

In some implementations of the system, the CXL port comprises a CXL/PCIe root port (RP) coupled to the coherent interconnect. The CXL/PCIe RP may be a separate component on the coherent interconnect, enabling the processing unit to communicate with CXL devices coupled to the second memory. In other examples, the CXL/PCIe RP may be included within the RPU.

In some implementations of the system, the processing unit further comprises processing cores, caching/home agent (CHA), snoop filter (SF), and Last Level Cache (LLC) slices coupled to the coherent interconnect; and further comprising at least one of: a PCIe root port coupled to an I/O device, or an inter-socket link (ISoL) port coupled to a second processing unit. The processing cores, CHA/SF/LLC slices, and additional ports may be coupled to the coherent interconnect, enabling coordinated access to memory resources. The PCIe RP may be coupled to an I/O device, such as a network controller, an Ethernet NIC, an InfiniBand adapter, or a PCIe GPU. The ISoL port may utilize NVIDIA NVLink-C2C, ARM CHI C2C, or ICPIP for inter-socket or inter-chip communication.

In some implementations of the system, the UALink port, the CXL port, and the memory controller are located in a same integrated circuit (IC) package; and wherein the RPU is further configured to translate physical addresses associated with the UALink-based protocol to physical addresses associated with the processing unit, enabling the entity to access the first memory and the second memory. The IC package may be implemented as a monolithic die or as chiplets within a multi-chip module. The physical address translation may include translating Network Physical Addresses (NPAs) carried in UPLI requests to Host Physical Addresses (HPAs) utilized by the processing unit's address space. The translated addresses may be utilized by the processing unit to determine whether a given request targets the first memory or the second memory, and to route the translated request to the appropriate memory path.

In some implementations of the system, the second translated request comprises a CXL.mem Master-to-Subordinate (M2S) request comprising MemRd*, and the CXL port is configured to send the CXL.mem M2S request to the second memory; and wherein the CXL port is further configured to receive a CXL.mem Subordinate-to-Master Data Response (S2M DRS) comprising MemData and data from the second memory, and the RPU is further configured to translate the CXL.mem S2M DRS to a UPLI read response (RdRsp) comprising the data and send the UPLI RdRsp to the entity. The second memory path may utilize CXL.mem for communication between the CXL port and the second memory, wherein the RPU may translate between UPLI and CXL.mem, including translations of addresses, Tags, and opcodes. The second memory may include a CXL memory expander or a CXL device that responds to CXL.mem M2S requests with CXL.mem S2M DRS messages carrying the requested data.

In computing environments where a cluster of accelerators may be coupled via a switch, the accelerators may need to access memory resources that are external to the UALink domain. For example, memory resources such as CXL memory expanders, CXL memory pools, or GFDs may be coupled to the cluster via an RPU that translates between the UALink-based protocol utilized by the accelerators and CXL.mem utilized by the CXL memory devices. In some configurations, the RPU may be coupled to multiple distinct CXL memory devices, and may route translated requests to different CXL memory devices based on the physical addresses carried in the UPLI requests received from the accelerators. The RPU may thus enable accelerators within the cluster to access a pool of CXL memory resources distributed across devices, while the switch provides the communication fabric among the accelerators and between the accelerators and the RPU.

In various implementations, a system comprising: a switch; accelerators coupled to the switch, wherein the accelerators communicate according to a UALink-based protocol; a resource provisioning unit (RPU) coupled to the switch; a first Compute Express Link (CXL) memory device coupled to the RPU; and a second CXL memory device coupled to the RPU; wherein the RPU is configured to receive a first UALink Protocol Level Interface (UPLI) request and a second UPLI request from a first accelerator of the accelerators via the switch, translate the first UPLI request to a first CXL.mem Master-to-Subordinate (M2S) request and send the first CXL.mem M2S request to the first CXL memory device, and translate the second UPLI request to a second CXL.mem M2S request and send the second CXL.mem M2S request to the second CXL memory device. The system may enable accelerators within a UALink cluster to access CXL memory resources that reside outside the UALink domain, without requiring modifications to the accelerators'UALink interfaces or protocols. The RPU may determine which CXL memory device to target for each translated request based on the physical address carried in the UPLI request, for example by comparing the address against address range registers or translation tables that map address ranges to specific CXL memory devices. The first and second CXL memory devices may have different capacities, different performance characteristics, different address ranges, or different device types. The RPU may be implemented as a discrete component coupled to the switch, as an IP block embedded within one of the accelerators, or as a chiplet within an IC package. The RPU may translate between UPLI and CXL.mem including translations of opcodes, addresses, Tags, and additional fields. In some examples, the RPU may be coupled to more than two CXL memory devices, and may distribute translated requests across the CXL memory devices based on address, load balancing policies, or other criteria. The method may be implemented in hardware, firmware, software, or combinations thereof.

In some implementations of the system, at least one of the first CXL memory device or the second CXL memory device comprises a Global Fabric-Attached Memory Device (GFD); and wherein the RPU is further configured to receive a CXL.mem Subordinate-to-Master Data Response (S2M DRS) from the GFD, translate the CXL.mem S2M DRS to a UPLI read response (RdRsp), and send the UPLI RdRsp to the first accelerator via the switch. The GFD may provide large-capacity memory resources accessible via CXL.mem, and may be shared among requesters including accelerators via the RPU and hosts via direct CXL.mem access. The RPU may translate the CXL.mem S2M DRS, including by translating the Tag back to the original UPLI ReqTag and formatting the data as UPLI RdRspData for delivery to the first accelerator.

In some implementations, the system further comprises a host coupled to at least one of the first CXL memory device or the second CXL memory device via CXL.mem; wherein both the first accelerator, via the RPU, and the host access the at least one of the first CXL memory device or the second CXL memory device. The shared access configuration may enable both accelerators and hosts to access the same CXL memory resources, potentially for data sharing, producer-consumer communication, or tiered memory management. The host may access the CXL memory device via CXL.mem without translation, while the accelerators access the same CXL memory device via the RPU that translates between UPLI and CXL.mem.

In some implementations, the system further comprises a CXL fabric coupling the RPU to the first CXL memory device and the second CXL memory device; wherein at least one of the first CXL memory device or the second CXL memory device comprises at least one of: a CXL memory expander, a CXL memory pool, or a Global Fabric-Attached Memory Device (GFD). The CXL fabric may include one or more CXL switches, and may provide connectivity between the RPU and CXL memory devices. The CXL fabric may enable the RPU to reach CXL memory devices that are not directly coupled to the RPU.

In some implementations of the system, the first UPLI request comprises a first physical address associated with a first address space, and the second UPLI request comprises a second physical address associated with the first address space; wherein the first CXL.mem M2S request comprises a third physical address associated with a second address space, and the second CXL.mem M2S request comprises a fourth physical address associated with the second address space; and wherein the RPU translates the first physical address to the third physical address and the second physical address to the fourth physical address; and wherein the first address space comprises a Network Physical Address (NPA) space or a System Physical Address (SPA) space, and the second address space comprises a Host Physical Address (HPA) space. The address translation may be implemented utilizing lookup tables, page tables, base-and-offset calculations, range-based mapping, and/or programmable translation functions. The RPU may determine which CXL memory device to target based on the translated address, for example by comparing the third or fourth physical address against address ranges assigned to the first and second CXL memory devices. In some examples, the first and second address spaces may be the same address space, such as a global address space or a fabric address space, and the RPU may perform routing without address translation.

In some implementations of the system, the switch comprises a UALink switch comprising a route table, and the UALink switch routes the first UPLI request and the second UPLI request from the first accelerator to the RPU based on a Destination Accelerator ID carried in the first UPLI request and the second UPLI request; and wherein the accelerators communicate with the UALink switch via UPLI request channels and UPLI response channels. The UALink switch may route UPLI traffic based on the ReqDstPhysAccID field in each UPLI request, utilizing the route table to map the Destination Accelerator ID to an egress port coupled to the RPU. The RPU may thus appear to the accelerators as a UALink endpoint identified by an Accelerator ID, enabling the accelerators to send UPLI requests to the RPU using standard UALink routing mechanisms. The route table may be programmed by a Pod Controller or other management entity. The UPLI request channels may carry read, write, atomic, and vendor defined commands, and the UPLI response channels may carry corresponding read responses and write responses.

In environments where entities communicating according to UPLI need to write data to memory resources coupled to entities communicating according to CXL.mem, an RPU or other translating device may translate between UPLI write requests and CXL.mem write requests. The write path involves translating from UPLI request and Originator Data channels to CXL.mem M2S RwD messages, and translating the CXL.mem S2M NDR completion back to a UPLI write response (WrRsp). The RPU may translate opcodes, commands, addresses, Tags, byte enables, and completion status between the two protocol domains. In some examples, the RPU may split a UPLI write request carrying a transfer size exceeding a CXL.mem cacheline size into multiple CXL.mem M2S RwD requests, and may aggregate the corresponding completions before returning the UPLI WrRsp to the originating entity.

In various implementations, a method for translating from Ultra Accelerator Link (UALink) Protocol Level Interface (UPLI) write requests to Compute Express Link (CXL) write requests, comprising: communicating with a first entity according to UPLI; communicating with a second entity according to CXL.mem; receiving, from the first entity, a UPLI request comprising a write command, a first physical address, and write data; translating the UPLI request to a CXL.mem Master-to-Subordinate Request with Data (M2S RwD) comprising a MemWr* and a second physical address; sending the CXL.mem M2S RwD and the write data to the second entity; receiving, from the second entity, a CXL.mem Subordinate-to-Master No Data Response (S2M NDR) comprising Cmp*; translating the CXL.mem S2M NDR to a UPLI write response (WrRsp); and sending the UPLI WrRsp to the first entity. The write translation may enable entities communicating according to UPLI to store data in memory resources coupled to entities communicating according to CXL.mem. The method may be implemented in hardware, firmware, software, or combinations thereof, and may be performed by various types of devices, such as a processor, a switch, a bridge, an RPU, or a semiconductor device. The first physical address may be associated with a first address space, such as an NPA space, and the second physical address may be associated with a second address space, such as an HPA space, wherein the translating may include translating the first physical address to the second physical address. Additionally or alternatively, the first and second physical addresses may be associated with the same address space, such as a global address space, a PGAS, a pod address space, a virtual pod address space, or a fabric address space. The UPLI write command may include a Write, a WriteFull, or a Write Class Vendor Defined Command as defined by the UPLI specification.

In some implementations of the method, the UPLI request further comprises a ReqSrcPhysAccID field, a ReqDstPhysAccID field, a ReqTag field, and a ReqAddr field comprising the first physical address; wherein the write data is received on a UPLI Originator Data (OrigData) channel comprising OrigDataByteEn; and further comprising translating the ReqTag to a Tag associated with the CXL.mem M2S RwD. The ReqSrcPhysAccID and ReqDstPhysAccID fields may carry identifiers utilized for routing the UPLI request and for constructing response routing information. The OrigDataByteEn field may carry per-byte enable bits indicating which bytes of the write data are valid. The Tag translation may involve maintaining a bidirectional mapping between UPLI ReqTag values and CXL.mem Tag values, enabling proper correlation of CXL.mem S2M NDR completions with their corresponding UPLI write requests.

In some implementations of the method, the MemWr* comprises MemWrPtl, and the write data comprises a partial cacheline update; and wherein byte enables associated with a UPLI Originator Data channel are utilized to indicate which bytes of the cacheline are to be written by the second entity. The MemWrPtl opcode may indicate a partial write where only a subset of bytes within a CXL.mem cacheline are updated. The byte enables from the UPLI OrigDataByteEn field may be propagated to the CXL.mem domain, enabling the second entity to update only the specified bytes while preserving the remaining bytes of the cacheline.

In some implementations of the method, the UPLI WrRsp further comprises a WrRspTag field and a WrRspStatus field, and the CXL.mem S2M NDR further comprises a Cmp* completion opcode; and further comprising translating a Tag of the CXL.mem S2M NDR to the WrRspTag of the UPLI WrRsp, and translating a completion status of the CXL.mem S2M NDR to the WrRspStatus of the UPLI WrRsp. The WrRspTag may be retrieved from the bidirectional mapping maintained by the RPU, enabling the first entity to correlate the write response with its original write request. The WrRspStatus may indicate success or failure of the write operation. The translation of completion status across protocol boundaries may enable the first entity to detect write failures that originated in the CXL domain and to take appropriate recovery actions.

In some implementations of the method, the first entity comprises an accelerator, the second entity comprises a CXL device comprising at least one of: a CXL memory expander, a CXL memory pool, or a Global Fabric-Attached Memory Device (GFD); the first physical address is associated with a Network Physical Address (NPA) space; and the second physical address is associated with a Host Physical Address (HPA) space; and wherein the translating further comprises translating the first physical address to the second physical address. The address translation from NPA to HPA may be implemented utilizing lookup tables, page tables, base-and-offset calculations, range-based mapping, and/or programmable translation functions. The GFD may provide large-capacity memory resources accessible via CXL.mem and shared among requesters.

In some implementations of the method, the UPLI request further comprises a ReqLen field indicating a transfer size exceeding a CXL.mem cacheline size; and wherein the translating further comprises generating CXL.mem M2S RwD requests from the UPLI request, each of the CXL.mem M2S RwD requests comprising a respective MemWr* and a respective portion of the write data. UPLI write requests may carry a ReqLen indicating a transfer size of up to 256 bytes, while CXL.mem M2S RwD messages may carry up to 64 bytes of data per request. When the ReqLen exceeds the CXL.mem cacheline size, the RPU may split the UPLI write request into CXL.mem M2S RwD requests, each carrying a respective portion of the write data with a respective translated address. The RPU may aggregate the corresponding CXL.mem S2M NDR completions before returning a UPLI WrRsp to the first entity.

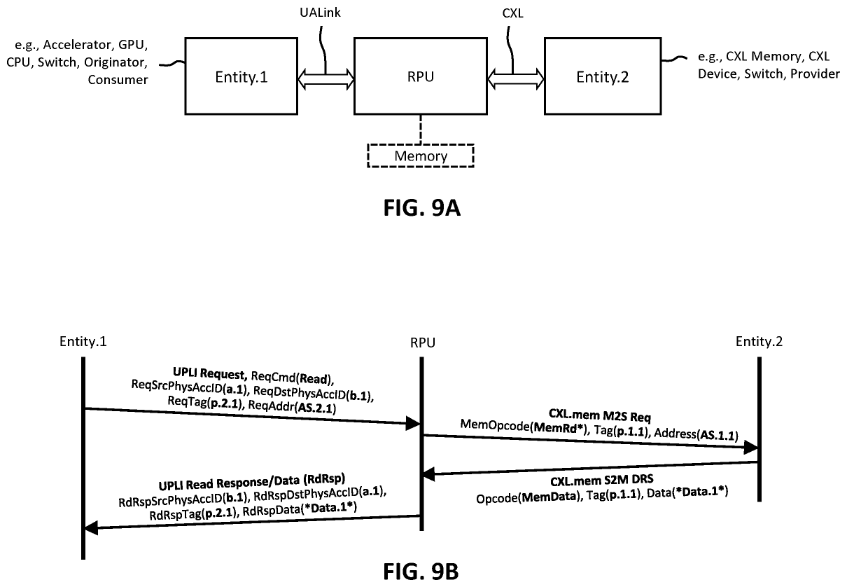

FIG. 9A illustrates an example of a system comprising an RPU, which may be coupled to memory, wherein the RPU may enable external entities to access resources coupled to the RPU. The RPU may translate between a UALink-based protocol (such as UPLI) and a CXL-based protocol (such as CXL.mem). Additionally or alternatively, the RPU may translate between UPLI and CXL.io, and/or between UPLI and CXL.cache. In some examples, the RPU may be implemented as a discrete component, such as on a PCB, coupled to other components such as CPUs, GPUs, accelerators, switches, or CXL devices. In other examples, the RPU may be embedded in another silicon design, such as an IP within a processor, or may be implemented as a chiplet within an IC package. The RPU is coupled to a first entity (Entity.1), which may be an accelerator, a GPU, a CPU, a switch, an originator, or a consumer, wherein the RPU may communicate with the first entity according to a UALink-based protocol, such as UPLI. The RPU is further coupled to a second entity (Entity.2), which may be a CXL memory, a CXL device, a switch, or a provider, wherein the RPU may communicate with the second entity according to a CXL-based protocol, such as at least one of CXL.mem, CXL.io, or CXL.cache. In some examples, the UALink-based traffic, such as UPLI traffic, may be associated with a first address space, such as an NPA space, and the CXL-based traffic, such as CXL.mem traffic, may be associated with a second address space, such as a System Physical Address (SPA) space or a Host Physical Address (HPA) space; wherein the RPU may perform address translations between addresses within the first and second address spaces, respectively, such as between addresses within the NPA space and addresses within the SPA space or the HPA space. In other examples, the UALink-based traffic and the CXL-based traffic may be associated with the same physical address space, such as with a global address space, a partitioned global address space (PGAS), a pod address space, a virtual pod address space, or a fabric address space; wherein the RPU may perform address translations between addresses within the same address spaces. The RPU may perform further translations, such as opcode, command, or TLP translations, e.g., translating between commands in requests conforming to the UALink-based protocol (e.g. UPLI vendor-defined read command) to opcodes in requests conforming to the CXL-based protocol (e.g., CXL.mem MemRd). The RPU may further translate between messages conforming to the UALink-based protocol and messages conforming to the CXL-based protocol, Tag translations, traffic class (TC) translations, and/or cross-field translations such as between CXL.mem Tag and UPLI ReqTag, and/or between UPLI RdRspTag and CXL.mem Tag. Additionally, the RPU may maintain tracking between Tags in the UPLI domain and Tags in the CXL domain, such as in order to associate responses with their corresponding requests. The RPU may further translate error indications, such as poison.

FIG. 9B illustrates an example of a TFD demonstrating translations performed by an RPU, between UALink-based traffic, such as UPLI traffic, utilized for communicating with a first entity (Entity.1), such as an accelerator, a GPU, a CPU, a switch, an originator, or a consumer, and CXL-based traffic, such as CXL.mem traffic, utilized for communicating with a second entity (Entity.2), such as a CXL device, a CXL memory, or a CXL switch. Additionally or alternatively, the RPU may translate between UPLI and CXL.io requests, and/or between UPLI and CXL.cache requests. The first entity may initiate a UPLI transaction that may include a UPLI request (Req) comprising Request Command (e.g., ReqCmd(Read)), Request Source Physical Accelerator ID (e.g., ReqSrcPhysAccID(a.1)), Request Destination Physical Accelerator ID (e.g., ReqDstPhysAccID(b.1)), Request Tag (e.g., ReqTag(p.2.1)), and Request Address (e.g., ReqAddr(AS.2.1)). The RPU may translate the UPLI transaction to a CXL.mem transaction that may include a CXL.mem M2S request comprising MemOpcode(MemRd*), Tag(p.1.1), and Address(AS.1.1), and may send the CXL.mem M2S request to the second entity. The asterisks in the translated CXL.mem M2S request MemRd indicate that this could represent any suitable superset combination of read opcodes, commands, or operations, supported by CXL.mem, such as MemRd, MemRdData, MemRdTEE, MemRdDataTEE, etc. The RPU may further translate between other fields of the UPLI transaction and fields of the CXL.mem transaction, such as between address fields, Tag fields, QoS-related fields, or identification (ID) fields that may serve to route the UPLI request to its target.

Upon receiving a response from the second entity, that may include a CXL.mem S2M DRS comprising Opcode(MemData), Tag(p.1.1), and Data(*Data.1*), the RPU may translate the CXL.mem S2M DRS to a UPLI read response/data (RdRsp) comprising Read Response Source Physical Accelerator ID (e.g., RdRspSrcPhysAccID(b.1)), Read Response Destination Physical Accelerator ID (e.g., RdRspDstPhysAccID(a.1)), Read Response Transaction Tag (e.g., RdRspTag(p.2.1)), and Read Response Data (e.g., RdRspData(*Data.1*)). Optionally, the RPU may act as an endpoint, or may act as a completer device, and may terminate the UPLI transactions. The RPU may issue the CXL.mem transactions, optionally acting as an independent protocol initiator, such as a CXL host, and may utilize translated fields from the UPLI transaction for constructing the CXL.mem transaction. The RPU may perform further translations, such as opcode or command translations, e.g., translating between vendor-defined read commands in UPLI requests and MemRd in CXL.mem requests. The RPU may further translate between messages conforming to UPLI and messages conforming to CXL.mem, translate Tags, and/or translate error indications, such as poison.

In some examples, the RPU may translate a UPLI transaction to multiple CXL.mem transactions, such as when the UPLI request may include a request length field, such as ReqLen, that may carry values representing a read of up to 256 Bytes of data, wherein the RPU may translate such UPLI requests to CXL.mem M2S requests, such that each may carry up to 64 Bytes of data that may represent a cacheline. The RPU may further translate between CXL.mem responses, such as CXL.mem S2M NDR and/or CXL.mem S2M DRS, and UPLI responses, such as UPLI read response, and may forward read data carried in CXL.mem DRS messages into the UPLI read response. In some examples, the RPU may accumulate data from one or more CXL.mem DRS messages before sending the data via the UPLI read response.

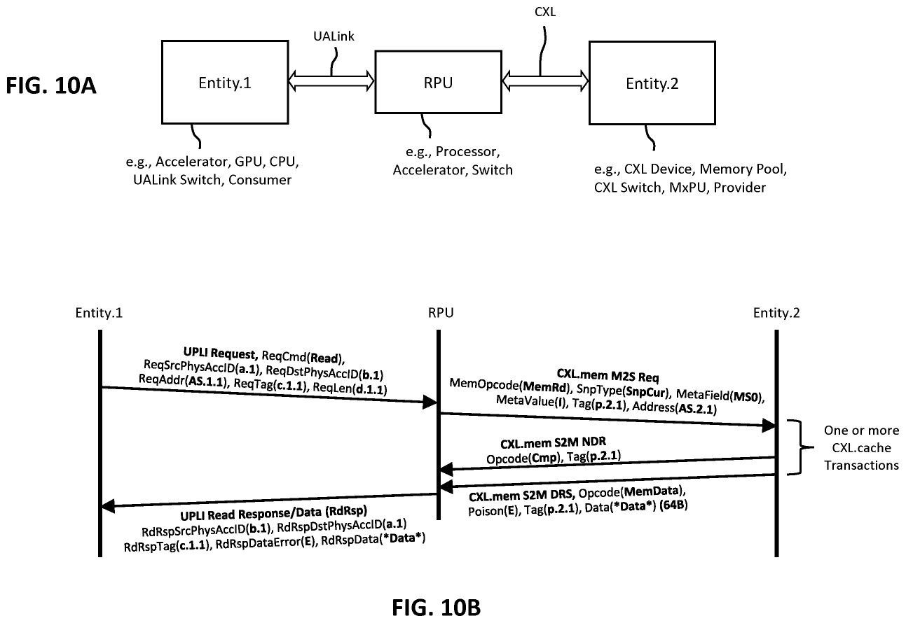

FIG. 10A illustrates an example of a system comprising an RPU (such as a processor, an accelerator, or a switch) that enables external entities to access resources coupled to the RPU, such as CXL devices or CXL memory. The RPU is coupled to a first entity (Entity.1), which may be an accelerator, a GPU, a CPU, a UALink switch, or a consumer, wherein the RPU may communicate with the first entity according to a UALink-based protocol, such as a UPLI. The RPU is further coupled to a second entity (Entity.2), which may be a CXL device, CXL memory, CXL-based memory pool, a CXL switch, an MxPU, or a provider, wherein the RPU may communicate with the second entity according to a CXL-based protocol, such as CXL.mem. In some examples, the UALink-based protocol, such as UPLI, may be associated with a first address space, such as an NPA space, and the CXL-based protocol, such as CXL.mem, may be associated with a second address space, such as an HPA space; wherein the RPU may perform address translations between addresses within the first and second address spaces, respectively, such as between addresses within the NPA space and addresses within the HPA space. In other examples, the UALink-based protocol, such as UPLI, and the CXL-based protocol, such as CXL.mem, may be associated with the same physical address space, such as a global address space; wherein the RPU may perform address translations between addresses within the same address spaces. The RPU may perform further translations, such as opcode or command translations, e.g., translating between Read commands in UPLI requests and MemRd in CXL.mem requests. The RPU may further translate between messages conforming to UPLI and messages conforming to CXL.mem, translate Tags, and/or translate error indications, such as poison.

FIG. 10B illustrates an example of a TFD demonstrating an RPU that may translate between UALink-based traffic, such as UPLI traffic, and CXL-based traffic, such as CXL.mem traffic. Additionally or alternatively, the RPU may translate between UPLI and CXL.io, and/or between UPLI and CXL.cache. The RPU may provide intent-based translation between protocols, such as between UPLI and CXL.mem, identifying the intent of a received transaction, and generating a translated transaction that may convey a corresponding intent, or convey an intent based on a predefined, predetermined, configurable, rule-based, or dynamic mapping between intentions. The RPU may receive from a first entity (Entity.1), such as an accelerator, a UALink UPLI transaction that may include a UPLI request comprising Request Command (e.g., ReqCmd(Read)), Request Source Physical Accelerator ID (e.g., ReqSrcPhysAccID(a.1)), Request Destination Physical Accelerator ID (e.g., ReqDstPhysAccID(b.1)), Request Address (e.g., ReqAddr(AS.1.1)), Request Tag (e.g., ReqTag(c.1.1)), and Request Length (e.g., ReqLen(d.1.1)). The received UPLI transaction may indicate an intent to perform an I/O-coherent read, e.g., a request for the most recent copy of the data, corresponding to an I/O-coherency model that may be typical for UALink.

The RPU may translate the UPLI transaction to a CXL.mem transaction, that may include a CXL.mem M2S request comprising Memory Operation (e.g., MemOpcode(MemRd)), Snoop Type (e.g., SnpType(SnpCur)), Metadata Field (e.g., MetaField(MS0)), Metadata Value (e.g., MetaValue(I)), Tag(p.2.1), and Address(AS.2.1). This translation from UPLI to CXL.mem may indicate an intent to perform an I/O-coherent read, via a CXL.mem request for a non-cacheable but current value of the data, wherein the data may be represented as 64 B cachelines that correspond to the Request Length (e.g., ReqLen(d.1.1)) in the UPLI request. The RPU may further translate between other values of the UPLI transaction and the CXL.mem transaction, such as between addresses, Tags, QoS-related values, or identifications (IDs) that may serve to route the UPLI request to its destination.

In some examples, the RPU may translate a UPLI transaction to multiple CXL.mem transaction, such as when the UPLI request comprises a request length field (e.g., ReqLen), which may carry values indicating a read of more than 64 Bytes of data, wherein the RPU may translate such UPLI requests to CXL.mem M2S requests, such that each may carry up to 64 Bytes of data, possibly representing a 64 Byte cacheline. The RPU may further translate between CXL.mem responses, such as CXL.mem S2M NDR and/or CXL.mem S2M DRS, and UPLI responses, such as UPLI read responses, and may forward read data carried in CXL.mem DRS messages via UPLI read responses.

In some examples, the RPU may receive a response from the second entity (Entity.2), which may include a CXL.mem S2M NDR comprising Opcode(Cmp) and Tag(p.2.1), and may further include a CXL.mem S2M DRS comprising Opcode(MemData), Poison(E), Tag(p.2.1), and Data(*Data*). The RPU may translate the CXL.mem S2M DRS to a UPLI read response/data (RdRsp) comprising Read Response Source Physical Accelerator ID (e.g., RdRspSrcPhysAccID(b.1)), Read Response Destination Physical Accelerator ID (e.g., RdRspDstPhysAccID(a.1)), Read Response Transaction Tag (e.g., RdRspTag(c.1.1)), Read Response Data Error (e.g., RdRspDataError(E)), and Read Response Data (e.g., RdRspData(*Data*)). This translation demonstrates that the RPU may propagate error responses from the CXL domain to the UPLI domain, such as by translating error indications carried in CXL.mem S2M DRS messages, such as poison, to error indications carried in UPLI RdRsp messages, such as Read Response Data Error (e.g. RdRspDataError). Additionally, the RPU may accumulate data from one or more CXL.mem DRS messages before sending the data via the UPLI read response.

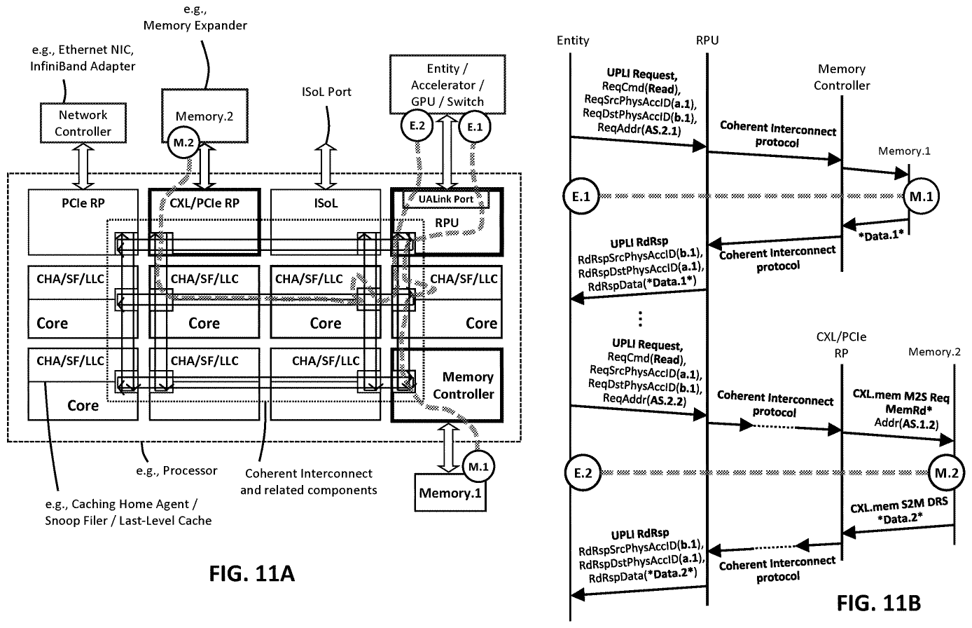

FIG. 11A illustrates an example of a system comprising a processor, including a coherent interconnect, capable of enabling an external entity, such as a GPU or an accelerator, to access memory resources mapped to an address space utilized by the coherent interconnect, such as via one or more of the two illustrated paths denoted as (E.1)-(M.1) and (E.2)-(M.2). The processor may include processing cores, caching/home agent (CHA), snoop filter (SF), and LLC, optionally implemented as distributed slices coupled to the coherent interconnect. The processor may further include a PCIe RP that may be coupled to a Network Controller, such as an Ethernet NIC or an InfiniBand Adapter, a CXL/PCIe RP, a memory controller that may be coupled to a first memory (Memory.1), such as DRAM, and an ISoL port, such as a port utilizing NVIDIA NVLink-C2C, ARM CHI C2C, or Intel Coherent Processor Interconnect Protocol (ICPIP), such as Intel UPI. The processor may be coupled to a second memory (Memory.2), such as a CXL memory expander, and may further include an RPU that includes or is coupled to a UALink port that may communicate with the entity according to a UALink-based protocol, such as UPLI, wherein the RPU may perform physical address translations to enable the entity to access the first memory, such as over the path (E.1)-(M.1), and/or access the second memory, such as over the path (E.2)-(M.2). The illustrated RPU may be coupled to the coherent interconnect, and may translate between the UALink-based protocol and a protocol utilized by the coherent interconnect. The processor may be implemented as an IP block embedded into a silicon design, such as a switch or an accelerator. In other examples, the processor may be implemented as a monolithic die, as chiplets within an IC package, or as components on a board, and may utilize a mesh-based coherent interconnect, may utilize a ring, a crossbar, a Network on Chip (NoC) or other types of coherent interconnects.

FIG. 11B illustrates an example of a TFD demonstrating two UPLI requests, such as UPLI read requests, received from an entity, such as a GPU or an accelerator, processed by an RPU and forwarded, possibly using a protocol utilized by a coherent interconnect, to different memories mapped to an address space utilized by the coherent interconnect. The paths from the RPU to the different memories may traverse other components, such as CHA/SF/LLC slices, memory controllers, or in other examples traverse a home agent or a home node, optionally for resolving coherency. The RPU may perform physical address translations, such as from Network Physical Addresses (NPAs) to Host Physical Addresses (HPAs), to enable the entity to access the processor's memories. The processor may have multiple memory resources, such as first memory (Memory.1), which may be a DRAM coupled to a memory controller of the processor, and/or second memory (Memory.2), which may be a CXL memory expander coupled to a CXL/PCIe RP of the processor. The RPU may further perform additional translations, such as protocol translations from a UALink-based protocol, such as UPLI, to a protocol utilized by the coherent interconnect, and may send the optionally translated request to the coherent interconnect, requesting a read from memory. In some examples, the requested data may be provided by a processor cache, such as by an LLC, instead of by the memory. The data may then return over the coherent interconnect to the RPU, wherein the RPU provides UPLI read response/data (RdRsp) to the requesting entity.

The TFD illustrates two exemplary transactions between the entity and the RPU, corresponding to two distinct memory read paths denoted as (E.1)-(M.1) and (E.2)-(M.2), each associated with a different physical address mapped to different memory resources. The first exemplary transaction includes a first UPLI request (Req) comprising physical address (AS.2.1), which may be an NPA, which the RPU translates and forwards via the coherent interconnect protocol and via the memory controller to the first memory (Memory.1), resulting in the retrieval of *Data.1*, that is sent to the entity via the coherent interconnect protocol and via the RPU with the first UPLI RdRsp. The second exemplary transaction includes a second UPLI request comprising physical address (AS.2.2), which may be an NPA, which the RPU may translate to physical address (AS.1.2) and forward to the second memory (Memory.2), via the coherent interconnect protocol and via the CXL/PCIe RP, utilizing a CXL.mem M2S request. *Data.2* is retrieved from the second memory utilizing a CXL.mem S2M DRS, and sent to the RPU via the coherent interconnect protocol. The RPU may then send *Data.2* to the entity via the second UPLI RdRsp. It is noted that the physical addresses (AS.2.1) and (AS.2.2) may refer to different memory regions within an NPA address space exposed via the UALink port, enabling the entity to access memory resources based on the RPU's translation capabilities.

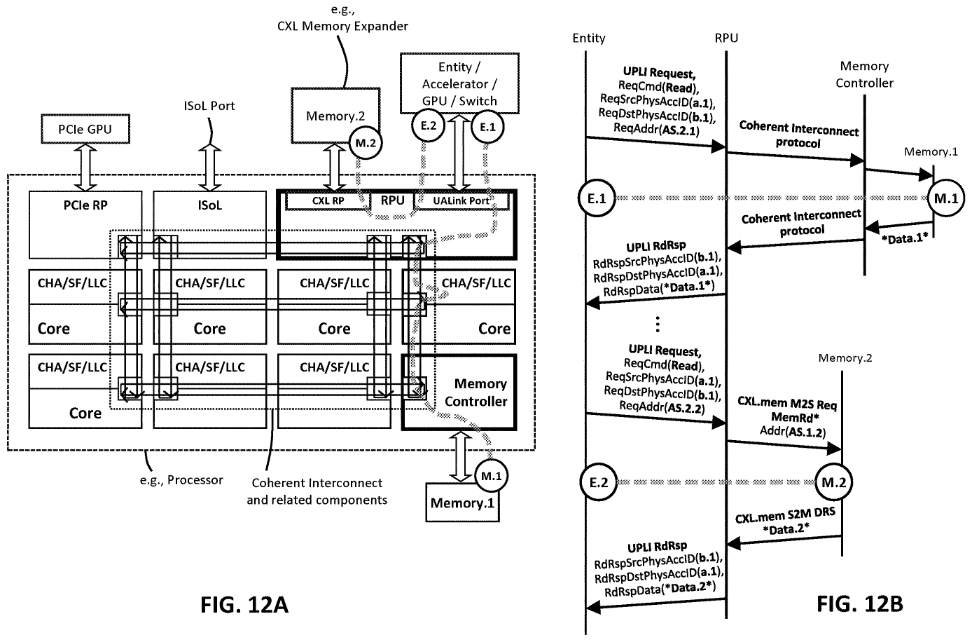

FIG. 12A illustrates an example of a system comprising a processor, including a coherent interconnect, capable of enabling an external entity, such as a GPU or an accelerator, to access memory resources mapped to an address space utilized by the coherent interconnect, such as via one or more of the two illustrated paths denoted as (E.1)-(M.1) and (E.2)-(M.2). The processor may include processing cores, caching/home agent (CHA), snoop filter (SF), and LLC, optionally implemented as distributed slices coupled to the coherent interconnect. The processor may further include a PCIe RP that may be coupled to a PCIe GPU, a memory controller that may be coupled to a first memory (Memory.1), such as DRAM, and an ISoL port, such as a port utilizing NVIDIA NVLink-C2C, ARM CHI C2C, or Intel Coherent Processor Interconnect Protocol (ICPIP), such as Intel UPI. The processor may include an RPU that includes or is coupled to a UALink port that may communicate with the entity according to a UALink-based protocol, such as UPLI, wherein the RPU further includes a CXL RP coupled to a second memory (Memory.2), such as a CXL memory expander. The RPU may perform physical address translations to enable the entity to access the first memory, such as over the path (E.1)-(M.1), and/or access the second memory, such as over the path (E.2)-(M.2). The illustrated RPU may be coupled to the coherent interconnect, and may translate between the UALink-based protocol and a protocol utilized by the coherent interconnect. The processor may utilize a mesh-based coherent interconnect, or in other examples may utilize a ring, a crossbar, a Network on Chip (NoC) or other types of coherent interconnects.

FIG. 12B illustrates an example of a TFD demonstrating two UPLI requests, such as UPLI read requests, received from an entity, such as a GPU or an accelerator, processed by an RPU and forwarded, possibly using a protocol utilized by a coherent interconnect of a processor, to different memories mapped to an address space utilized by the coherent interconnect. The paths from the RPU to the different memories may traverse other components, such as CHA/SF/LLC slices, memory controllers, or in other examples traverse a home agent or a home node, optionally for resolving coherency. The RPU may perform physical address translations, such as from Network Physical Addresses (NPAs) to Host Physical Addresses (HPAs), or from NPAs to System Physical Addresses (SPAs), to enable the entity to access memory resources of the processor. The processor may have multiple memory resources, such as first memory (Memory.1), which may be a DRAM coupled to a memory controller of the processor, and/or second memory (Memory.2), which may be a CXL memory expander coupled to a CXL RP of the processor, wherein the CXL RP may be included in the RPU. The RPU may further perform additional translations, such as protocol translations, between a UALink-based protocol, such as UPLI, and a protocol utilized by the coherent interconnect, wherein the RPU may send the optionally translated UPLI requests to the coherent interconnect, requesting reads from memory, such as from the first memory or from the second memory. The RPU may further translate between UALink-based traffic, such as UPLI traffic, and CXL-based traffic, such as at least one of CXL.mem, CXL.io, or CXL.cache traffic, wherein the RPU may send the optionally translated UPLI traffic to the second memory via the CXL RP. In some examples, the requested data may be provided by a cache of the processor, such as by an LLC, instead of by the memory. The data may then return over the coherent interconnect to the RPU, wherein the RPU provides UPLI read response/data (RdRsp) to the requesting entity.

The TFD illustrates two exemplary transactions between the entity and the RPU, corresponding to two distinct memory read paths denoted as (E.1)-(M.1) and (E.2)-(M.2), each associated with a different physical address mapped to different memory resources. The first exemplary transaction corresponds to the memory read path denoted as (E.1)-(M.1), and may include a first UPLI request (Req) comprising physical address (AS.2.1), which may be an NPA, which the RPU may translate and forward via the coherent interconnect protocol and via the memory controller to the first memory, resulting in the retrieval of *Data.1*, that is sent to the entity via the coherent interconnect protocol and via the RPU with the first UPLI RdRsp. The second exemplary transaction corresponds to the memory read path denoted as (E.2)-(M.2), and may include a second UPLI request comprising physical address (AS.2.2), which may be an NPA. The RPU may translate the second UPLI request to a CXL.mem M2S request comprising MemRd* and Address(AS.1.2), wherein the RPU may send the translated request to the second memory via the CXL RP. *Data.2* is retrieved from the second memory utilizing a CXL.mem S2M DRS, and sent to the RPU via the CXL RP, wherein the RPU may send *Data.2* to the entity utilizing the second UPLI RdRsp.

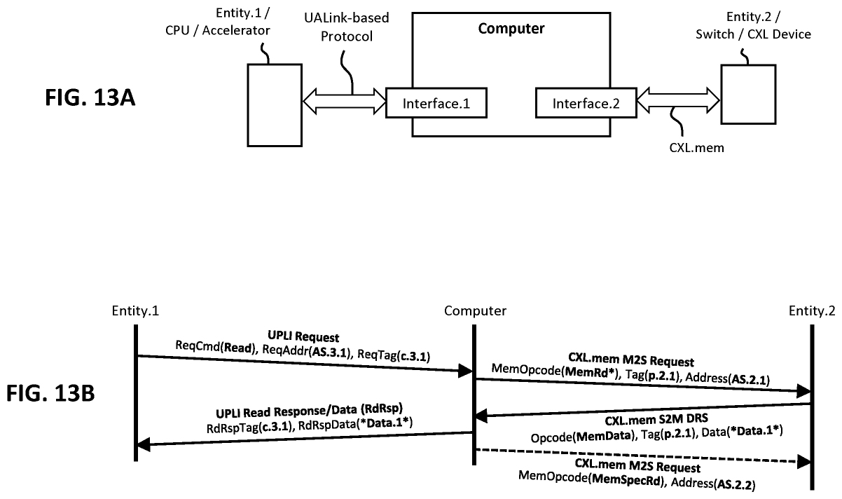

FIG. 13A illustrates an example of a system comprising a computer, that may be included in a switch or in a bridge, comprising a first interface (Interface.1) and a second interface (Interface.2). The first interface may communicate according to a UALink-based protocol, such as UPLI, with a first entity (Entity.1), which may be a CPU or an accelerator. The second interface may communicate according to CXL.mem, with a second entity (Entity.2), such as a switch, or a CXL device which may be a CXL memory expander, a CXL memory pool, a GFD, or a CXL accelerator. The computer may extract addresses from requests received via the first interface, wherein these addresses may refer to a first address space, such as a Network Physical Address (NPA) space utilized by the first entity. The computer may further translate these addresses, and generate requests carrying the translated addresses for transmission via the second interface; wherein these translated addresses may refer to a second address space utilized by the second entity. In other examples, the first address space and the second address space may be associated with the same address space, such as a common address space, a global address space, a pod address space, or a fabric address space, wherein the computer may perform address translations between addresses within the same common address space. The computer may be implemented in an IC package having high-speed differential I/O balls positioned according to a ball grid array layout defined by a retimer specification.

FIG. 13B illustrates an example of a TFD demonstrating translations, such as address translations, performed by a computer, between: (1) first physical addresses, such as Network Physical Addresses (NPAs), carried in UALink-based requests, such as UPLI requests, received from a first entity (Entity.1), which may be a CPU or an accelerator; and (2) second physical addresses, such as Host Physical Addresses (HPAs), carried in CXL requests, such as CXL.mem requests, sent to a second entity (Entity.2), which may be a switch or a CXL device, possibly enabling the first entity to access resources mapped to an address space utilized by the second entity. The first entity may initiate a UPLI transaction that may include a UPLI request comprising ReqCmd(Read), ReqAddr(AS.3.1), and ReqTag(c.3.1). The computer may translate the UPLI transaction to a CXL transaction that may include a CXL.mem M2S request comprising MemOpcode(MemRd*), Tag(p.2.1), and Address(AS.2.1), and may send the CXL.mem M2S request to the second entity. Upon receiving one or more responses from the second entity, which may include a CXL.mem S2M DRS comprising Opcode(MemData), Tag(p.2.1), and Data(*Data.1*), the computer may translate the one or more responses, such as translating the CXL.mem S2M DRS to a UPLI read response/data (RdRsp) comprising RdRspTag(c.3.1) and RdRspData(*Data.1*), and send the UPLI RdRsp to the first entity.

The computer may further initiate speculative memory reads targeting the second entity, wherein the speculative memory reads may include a CXL.mem M2S request comprising MemOpcode(MemSpecRd) and Address(AS.2.2), and wherein the computer may utilize the speculative memory reads, optionally on behalf of the first entity, to facilitate data prefetches and potentially reduce read latency from the second entity. When utilizing the MemSpecRd opcode, some of the CXL.mem M2S Req fields, such as Tag, MetaField, MetaValue, and SnpType, may be reserved. The computer may perform further translations, such as protocol translations, opcode translations, command translations, TLP type translations, and translations between the UALink-based domain and the CXL domain. In some examples, the computer may issue multiple CXL.mem reads in response to receiving a UPLI request from the first entity. For example, the computer may issue CXL.mem M2S requests comprising MemRd or MemRdData, such as when splitting a UPLI request for a large block of data (e.g., 256 B) to smaller CXL.mem reads (e.g., 64 B each), or when prefetching data from the second entity utilizing CXL.mem reads. The computer may translate requests or transactions initiated from the UALink-based domain to the CXL domain, may translate requests or transactions initiated from the CXL domain to the UALink-based domain, or may translate requests or transactions initiated from both domains.

Some implementations of the following method relate to processing pipelines, such as in a Fabric Processing Unit (FPU), for extracting and reconstructing CXL PDUs from carrier protocol communications received over a physical layer based on IEEE 802.3 PMA, possibly via software-defined methods, such as via protocol processing firmware executed on an FPU. A carrier protocol may refer to a protocol that transports or encapsulates other protocol data for transmission across a network or fabric, such as Ethernet, Ultra Ethernet Transport (UET), Ethernet for Scale-Up Networking (ESUN), Scale Up Ethernet (SUE), NVLink, or UALink. A passenger protocol may refer to a protocol whose data is encapsulated within the carrier protocol for transport, such as CXL.mem, CXL.cache, or CXL.io. A carrier protocol PDU refers to a protocol data unit of the carrier protocol, and a CXL PDU refers to a protocol data unit of a CXL sub-protocol. The CXL PDU may represent data indicative of a CXL message or a subset thereof, and may include fields that have been formatted, reduced, or otherwise adapted for transport within the carrier protocol PDU.

Modern datacenter architectures may benefit from transporting CXL traffic over network fabrics that utilize IEEE 802.3-based physical layers, enabling memory disaggregation, composable infrastructure, and remote memory access across rack-scale and cluster-scale deployments. When CXL PDUs are encapsulated within carrier protocol PDUs, the carrier protocol may utilize different field formats, may omit fields that are not required for transport, or may encode CXL information in carrier-specific representations. A processing pipeline within an RPU or similar processing unit may receive carrier protocol PDUs, extract encapsulated CXL information, translate fields between carrier and CXL formats, and reconstruct complete CXL PDUs that conform to the CXL specification for delivery to CXL devices or hosts. The pipeline may include stages for physical coding sublayer (PCS) processing, parsing, validity checking, stream extraction, access control, field translation, stream editing, address translation, and protocol translation, wherein different stages may be utilized depending on the carrier protocol type, the passenger protocol type, and the system configuration.

In various implementations, a method comprising: receiving, via a physical layer based on IEEE 802.3 physical medium attachment (PMA), a transmission comprising a protocol data unit (PDU) of a carrier protocol (carrier protocol PDU) encapsulating data indicative of a Compute Express Link (CXL) PDU; parsing the carrier protocol PDU to identify a passenger protocol type; extracting, from the carrier protocol PDU, fields of the CXL PDU; translating at least one extracted field from a format associated with the carrier protocol PDU to a field conforming to a CXL specification; and reconstructing an output CXL PDU comprising the translated field and at least one additional field not present in the carrier protocol PDU. The processing pipeline may be implemented as hardware, firmware, software, or combination thereof, within an FPU, an RPU, or a similar processing unit that is coupled to the physical layer based on IEEE 802.3 PMA. The physical layer may receive transmissions from external entities such as hosts, accelerators, switches, or memory devices that communicate CXL traffic encapsulated within carrier protocol PDUs. The parsing stage may examine protocol-specific patterns or markers in the data stream to identify both the carrier protocol type and the type of CXL sub-protocol (such as CXL.mem, CXL.cache, or CXL.io) encapsulated within. The extraction stage may identify and extract fields of interest from the carrier protocol PDU, including data indicative of CXL opcodes, physical addresses, transaction identifiers, and other protocol-specific fields. The translation stage may convert one or more extracted fields from a representation or encoding utilized by the carrier protocol into a representation that conforms to the CXL specification, such as translating a carrier-specific command encoding into a CXL opcode. The reconstruction stage may assemble a complete CXL PDU by combining translated fields with additional fields that were not included in the carrier protocol PDU, such as reserved fields, validity indicators, or metadata fields that may be omitted from the carrier PDU to conserve bandwidth but are utilized by CXL devices for proper parsing and processing of the CXL request.

In some implementations of the method, the at least one additional field is reconstructed based on at least one of a configuration or a default value, and wherein the method further comprises validating access permissions based on at least one of a physical address or an opcode extracted from the CXL PDU, and blocking the output CXL PDU from further processing when the access permissions are not satisfied. The reconstruction of fields not present in the carrier protocol PDU may utilize configuration parameters stored in registers or memory of the RPU, or may utilize default values defined by the CXL specification or by system policy. For example, a Valid field may be reconstructed as valid based on the presence of a well-formed carrier protocol PDU, while Reserved (RSVD) fields may be reconstructed utilizing configured default values such as zero. The access control validation may be performed by an Access Control List (ACL) module within the processing pipeline that evaluates extracted CXL fields against access policies. The ACL module may examine physical addresses to determine whether the requesting entity is permitted to access the targeted memory region, and may examine opcodes to determine whether the requested operation type is permitted. When access permissions are not satisfied, the pipeline may discard the CXL PDU, generate an error response, or log the access violation. This access control may operate at the CXL protocol level rather than at the carrier protocol level, enabling fine-grained memory access control that is specific to the CXL address space and operation types.

In some implementations, the method further comprises translating a physical address extracted from the CXL PDU from a first physical address space to a second physical address space. The address translation may be performed by an Address Translator stage within the processing pipeline, downstream of the field extraction and translation stages. The first physical address space may correspond to a Host Physical Address (HPA) space utilized by the external entity that originated the CXL request, while the second physical address space may correspond to an HPA space utilized by a local host or a Device Physical Address (DPA) space utilized by a local CXL device. The translation may be implemented utilizing lookup tables, page tables, hash tables, base-and-offset calculations, or programmable translation functions. The address translation may enable entities utilizing different address spaces to communicate via CXL over the carrier protocol fabric, without requiring the entities to share a common address space or address mapping.

In some implementations, the method further comprises translating the output CXL PDU from a first CXL channel to a second CXL channel, wherein the first CXL channel and the second CXL channel are different CXL sub-protocols. The protocol translation may be performed by a Protocol Translator stage within the processing pipeline, downstream of the stream editing and address translation stages. The first CXL channel may be CXL.mem and the second CXL channel may be CXL.cache, or vice versa, depending on the system configuration and the types of entities involved. For example, the Protocol Translator may translate a CXL.mem M2S request message into a CXL.cache H2D request message when the receiving entity is a CXL host that issues snoop requests to a local CXL device. Conversely, the Protocol Translator may translate a CXL.cache H2D request message into a CXL.mem M2S request message when the receiving entity is a memory device that processes memory access requests. The cross-channel translation may enable heterogeneous CXL deployments where different entities utilize different CXL sub-protocols while communicating through a common carrier protocol fabric.

In some implementations of the method, the carrier protocol comprises at least one of Ethernet, Ultra Ethernet Transport (UET), Ethernet for Scale-Up Networking (ESUN), Scale Up Ethernet (SUE), NVLink, or UALink, and wherein the physical layer based on IEEE 802.3 PMA operates at a lane rate of at least 100 Gbps. Different carrier protocols may utilize the IEEE 802.3 PMA in different ways while maintaining compatibility with the PMA interface specifications. Ethernet may utilize standard Ethernet framing with MAC-layer processing, while UET, ESUN, and SUE may utilize optimized framing adapted for high-performance computing and artificial intelligence workloads. UALink may utilize the IEEE 802.3 PMA as its physical layer while employing UALink-specific data link and transport layer protocols. The lane rate of at least 100 Gbps may correspond to IEEE 802.3 PMA specifications such as 100 GBASE or higher rates, enabling sufficient bandwidth for CXL memory traffic that may involve high-frequency, low-latency transactions. Higher lane rates, such as 200 Gbps or 400 Gbps per lane, may further increase the available bandwidth for encapsulated CXL traffic.

In some implementations, the method further comprises receiving a CXL response PDU, removing at least one field from the CXL response PDU, encapsulating remaining fields of the CXL response PDU within a second carrier protocol PDU, and transmitting the second carrier protocol PDU via the physical layer based on IEEE 802.3 PMA. The return path may operate as a reverse pipeline that processes CXL responses generated by local CXL devices or hosts for transmission to remote entities via the carrier protocol fabric. The removal of fields from the CXL response PDU may reduce bandwidth consumption by omitting fields that can be reconstructed at the receiving end, such as Valid fields, Reserved fields, or metadata fields that carry default or derivable values. The encapsulation may include generating carrier protocol headers and trailers appropriate for the carrier protocol type being utilized. The return path processing may mirror the inbound processing pipeline stages in reverse order, with the Stream Editor stripping unnecessary fields, the Field Translator converting CXL-specific field representations into carrier-specific formats, and the PCS performing encoding operations such as 64 B/66 B encoding, scrambling, and FEC encoding for transmission via the IEEE 802.3 PMA.

In some implementations of the method, the CXL PDU comprises a CXL.mem Master-to-Subordinate (M2S) PDU, the extracted fields comprise a MemOpcode field and an Address field, and the at least one additional field not present in the carrier protocol PDU comprises at least one of a Valid field, a Reserved (RSVD) field, a MetaField field, a SnpType field, or a Traffic Class (TC) field. The CXL.mem M2S PDU may refer to a Master-to-Subordinate message from either the M2S Req channel, which carries requests without data such as reads and invalidations, or the M2S RwD channel, which carries requests with data such as writes. Both channel types may include a MemOpcode field and an Address field as the primary extracted fields, along with other fields such as Valid, MetaField, SnpType, Tag, TC, and RSVD. When the carrier protocol PDU encapsulates CXL.mem information, the MemOpcode and Address fields may be included because they carry the operation type and target address that are needed for routing and processing. Other fields, such as Valid, RSVD, MetaField, SnpType, and TC, may be omitted from the carrier protocol PDU when their values can be reconstructed. The Valid field may be reconstructed based on the presence of a well-formed carrier protocol PDU. The RSVD field may be reconstructed utilizing a default value of zero. The MetaField, SnpType, and TC fields may be reconstructed based on RPU configuration parameters, system policies, or context derived from the MemOpcode and other extracted fields. The Tag field, which provides a transaction identifier for response correlation, may also be extracted from the carrier protocol PDU.

In some implementations of the method, the translating comprises translating a command field of the carrier protocol PDU to the MemOpcode field conforming to the CXL specification, the MemOpcode field comprising at least one of MemRd, MemRdData, MemWr, MemWrPtl, or MemInv. The carrier protocol may encode memory operation types utilizing a carrier-specific command field that differs in format, bit width, or encoding from the CXL MemOpcode field. The Field Translator may map carrier-specific command encodings to CXL MemOpcode values such as MemRd for memory read operations, MemRdData for memory read operations with specific metadata handling, MemWr for full cacheline write operations, MemWrPtl for partial cacheline write operations, or MemInv for invalidation operations. The mapping may be configurable, enabling the same processing pipeline to support different carrier protocols that utilize different command encoding schemes.

In some implementations of the method, the CXL PDU comprises a CXL.cache Host-to-Device (H2D) request PDU, the extracted fields comprise an Opcode field, an Address field, and a Unique Queue ID (UQID) field, and the at least one additional field not present in the carrier protocol PDU comprises at least one of a Valid field or a Reserved (RSVD) field. The CXL.cache H2D request PDU may include fields as defined by the CXL specification, including Valid, Opcode, Address, UQID, and RSVD fields. The Opcode field may carry H2D request opcodes such as SnpData, SnpInv, or SnpCur that indicate the type of snoop operation. The Address field may carry the physical address of the cacheline targeted by the snoop operation. The UQID field may identify the host entry that originated the request, enabling response routing. The Valid and RSVD fields may be omitted from the carrier protocol PDU because their values can be reconstructed: the Valid field based on PDU presence, and the RSVD field utilizing default values. Different flit modes defined by the CXL specification (such as 68 B flit, 256 B flit, or PBR flit) may include different sets of additional fields such as CacheID, SPID, and DPID, which may also be subject to extraction or reconstruction depending on the flit mode negotiated for the target CXL link.

In some implementations of the method, the CXL PDU comprises a CXL.cache Device-to-Host (D2H) request PDU, the extracted fields comprise an Opcode field, a command queue identifier (CQID) field, and an Address field, and the at least one additional field not present in the carrier protocol PDU comprises at least one of a Valid field, a NonTemporal (NT) field, or a Reserved (RSVD) field. The CXL.cache D2H request PDU may include fields as defined by the CXL specification, including Valid, Opcode, CQID, NT, Address, and RSVD fields. The D2H request direction carries requests from a device toward a host, with D2H request opcodes such as RdShared, RdOwn, RdCurr, RdOwnNoData, CLFlush, or other D2H request opcodes. The CQID field may identify the device tracker entry associated with the request. The NT (NonTemporal) field may provide a caching hint indicating that the requested data is not expected to be reused in the near term, allowing the host to avoid caching the data in a preferred cache position or to treat it as non-cacheable. The RSVD field in D2H requests may be larger than in H2D requests, and the NT field may carry a default value that can be reconstructed based on system configuration. The field set for D2H requests differs from H2D requests in both the transaction identifier (CQID versus UQID) and the available fields (NT versus CacheID in certain flit modes), which may result in different extraction and reconstruction behavior for each direction.

In some implementations of the method, the CXL PDU comprises a CXL.io Transaction Layer Packet (TLP), the extracted fields comprise a Type field, an Address field, and a Tag field, and the translating comprises translating a command field of the carrier protocol PDU to a Fmt/Type field of the CXL.io TLP. CXL.io utilizes TLPs based on the PCIe Transaction Layer specification. The TLP header may include fields such as Fmt/Type (which encodes the packet format and transaction type), TC (Traffic Class), Attr (Attributes), EP (Error Poisoned), Length, Requester ID, Tag, and Address, among others. The Fmt and Type fields together determine the TLP type, such as Memory Read (MRd), Memory Write (MWr), Completion with Data (CplD), or Configuration Read/Write. The carrier protocol may encode the CXL.io transaction type utilizing a carrier-specific command field that differs from the PCIe Fmt/Type encoding. The Field Translator may map carrier-specific commands to appropriate Fmt/Type values. In flit mode, the Fmt field may be absorbed into the Type field, and the translation may accommodate both flit mode and non-flit mode TLP header formats. The Tag and Address fields may be extracted from the carrier protocol PDU for routing and transaction tracking, while other TLP header fields such as TC, Attr, and EP may be omitted from the carrier PDU and reconstructed utilizing default values or configuration parameters.

In some implementations of the method, an active cable comprising first and second pluggable modules coupled by a physical medium, wherein the active cable further comprises hardware circuitry, integrated into the active cable, configured to perform the method. In some implementations of the method, an apparatus configured to operate as a switch, wherein the apparatus comprises switching circuitry and is configured to perform the method.

In various implementations, an apparatus comprising: a physical layer based on IEEE 802.3 physical medium attachment (PMA) configured to receive a transmission comprising a protocol data unit (PDU) of a carrier protocol (carrier protocol PDU) encapsulating data indicative of a Compute Express Link (CXL) PDU; and a processing unit coupled to the physical layer, the processing unit configured to: parse the carrier protocol PDU to identify a passenger protocol type; extract, from the carrier protocol PDU, fields of the CXL PDU; translate at least one extracted field from a format associated with the carrier protocol PDU to a field conforming to a CXL specification; and reconstruct an output CXL PDU comprising the translated field and at least one additional field not present in the carrier protocol PDU. The apparatus may be implemented as an integrated circuit, an SoC, an FPGA, a SmartNIC, a data processing unit (DPU), a Fabric Processing Unit (FPU), or any other suitable hardware platform that includes a physical layer based on IEEE 802.3 PMA and a processing unit capable of performing the described operations. The processing unit may include dedicated hardware logic, a programmable processor, or a combination thereof. The processing unit may implement the pipeline stages, including parsing, extraction, translation, and reconstruction, as hardware pipeline stages that process carrier protocol PDUs at line rate, or as software-driven stages that provide configurability and flexibility. The apparatus may include physical layers based on IEEE 802.3 PMA for communicating with external entities, and may include processing units or pipeline instances for parallel processing of carrier protocol PDUs.

Some implementations of the following method further relate to bandwidth-optimized transport of CXL protocol data over carrier protocols utilizing a physical layer based on IEEE 802.3 PMA. When CXL PDUs are transported over carrier protocol fabrics, the bandwidth available for encapsulated CXL traffic may be constrained by the carrier protocol overhead, the physical layer data rate, and the number of concurrent transactions. Bandwidth optimization may be achieved by encapsulating a subset of the CXL PDU fields within the carrier protocol PDU, omitting fields that can be reconstructed at the receiving end. Different levels of field inclusion may be utilized depending on available bandwidth, quality-of-service requirements, and/or system configuration.

For example, a CXL.mem M2S request may include fields such as Valid, MemOpcode, MetaField, SnpType, Address, Tag, TC, and RSVD. A complete format may include all fields, while a reduced format may omit the Valid and RSVD fields, and an essential format may include the MemOpcode, Address, and Tag fields. The omitted fields may be reconstructed by the receiving processing unit based on configuration parameters, default values, or context derived from the received fields. Similar bandwidth optimization may be applied to CXL.cache and CXL.io PDUs by identifying fields that can be omitted and reconstructed.

In various implementations, a method comprising: receiving, via a physical layer based on IEEE 802.3 physical medium attachment (PMA), a protocol data unit (PDU) of a carrier protocol (carrier protocol PDU) encapsulating a subset of fields of a Compute Express Link (CXL) PDU, the subset excluding at least one field defined by a CXL specification for the CXL PDU; extracting the subset of fields from the carrier protocol PDU; reconstructing the at least one excluded field; and generating a CXL request comprising the extracted subset of fields and the at least one reconstructed field. The method may enable bandwidth-efficient transport of CXL traffic over carrier protocol fabrics by transmitting those CXL PDU fields that cannot be derived or reconstructed at the receiving end. The sender may analyze the CXL PDU and determine which fields carry information that is not derivable from other fields or from system configuration, and may include those fields in the carrier protocol PDU. The receiver may extract the included fields, reconstruct the excluded fields, and assemble a complete CXL request that conforms to the CXL specification. The bandwidth savings may be proportional to the number and size of excluded fields, and may vary depending on the CXL sub-protocol, the message type, and the level of field inclusion selected. For CXL.mem M2S requests, the savings may range from omitting a few bits (Valid and RSVD) to omitting several fields (MetaField, SnpType, TC, Valid, RSVD), depending on the selected format level.

In some implementations of the method, the at least one excluded field is reconstructed based on at least one of a configuration, a default value, or context derived from the subset of fields. Different reconstruction methods may be utilized for different excluded fields depending on the nature of the field and the information available. Configuration-based reconstruction may utilize values stored in registers or memory of the processing unit, such as system-wide settings for Traffic Class or metadata policies. Default-value reconstruction may utilize values defined by the CXL specification or by system convention, such as zero for Reserved fields or a valid indication for the Valid field when the carrier protocol PDU is well-formed. Context-based reconstruction may derive field values from other extracted fields, such as inferring a SnpType value from the MemOpcode when certain operation types imply specific snoop behaviors. The reconstruction method for each excluded field may be independently configurable, enabling the system to adapt to different deployment scenarios and CXL specification revisions.

In some implementations, the method further comprises receiving a CXL response, excluding at least one field of the CXL response defined by the CXL specification, and transmitting, via the physical layer based on IEEE 802.3 PMA, a carrier protocol PDU encapsulating a subset of fields of the CXL response excluding the at least one excluded field of the CXL response. The bandwidth optimization may be applied symmetrically on both the request and response paths. CXL responses, such as S2M No-Data Response (NDR) messages or S2M Data Response (DRS) messages for CXL.mem, or D2H response and D2H Data messages for CXL.cache, may also include fields that can be omitted for transport. The processing unit may analyze the CXL response, identify fields that can be reconstructed by the remote receiving entity, exclude those fields, and encapsulate the remaining fields within a carrier protocol PDU for transmission. The level of field reduction on the response path may be the same as or different from the level utilized on the request path, depending on the specific response message type and the fields available for reconstruction.

In some implementations, the method further comprises receiving the carrier protocol PDU by a remote processing unit, extracting the subset of fields of the CXL response, and reconstructing the at least one excluded field of the CXL response. The remote processing unit may receive the carrier protocol PDU transmitted by the local processing unit, extract the encapsulated subset of fields of the CXL response, and reconstruct the at least one excluded field. The remote processing unit may utilize its own configuration parameters, default values, or context to reconstruct excluded response fields. The remote processing unit may be implemented within an RPU, a SmartNIC, a DPU, or any other suitable entity coupled to a physical layer based on IEEE 802.3 PMA. The configuration parameters utilized by the remote processing unit for reconstruction may be synchronized with those utilized by the local processing unit for field exclusion, either through out-of-band configuration protocols or through negotiation during connection establishment.

In some implementations of the method, the CXL PDU comprises a CXL.mem Master-to-Subordinate (M2S) request, the subset of fields comprises MemOpcode, MetaField, SnpType, Address, Tag, and TC fields, and the at least one excluded field comprises a Valid field and a Reserved (RSVD) field. The reduced format for CXL.mem M2S requests may retain the fields that carry operational semantics (MemOpcode for the operation type, MetaField and SnpType for coherency behavior, Address for the target location, Tag for transaction tracking, and TC for traffic classification) while omitting the Valid field and the Reserved field. The Valid field may be reconstructed based on the presence of a well-formed carrier protocol PDU, since the receipt of a properly framed and validated carrier protocol PDU implies that the encapsulated CXL information is valid. The Reserved field may be reconstructed utilizing a default value of zero, as reserved fields are defined by the CXL specification to be cleared by the sender and ignored by the receiver.

In some implementations of the method, the CXL PDU comprises a CXL.mem M2S request, the subset of fields comprises MemOpcode, Address, and Tag fields, and the at least one excluded field comprises a Valid field, a MetaField field, a SnpType field, a TC field, and a Reserved (RSVD) field. In one example, the essential format may include the minimum fields for basic CXL.mem operation: MemOpcode to specify the memory operation, Address to identify the target physical address, and Tag to enable transaction tracking and response correlation. The excluded fields (Valid, MetaField, SnpType, TC, and RSVD) may be reconstructed utilizing default values or configuration parameters. The MetaField may be reconstructed as No-Op when the system configuration does not utilize metadata operations, the SnpType may be reconstructed based on the MemOpcode (such as defaulting to No-Op or to a configured snoop type), and the TC may be reconstructed utilizing a configured traffic class priority. The essential format may provide the greatest bandwidth savings and may be suitable for deployments where the carrier protocol bandwidth is constrained or where the additional fields carry predictable values.

In some implementations of the method, the CXL PDU comprises a CXL.cache Host-to-Device (H2D) request, the subset of fields comprises an Opcode field, an Address field, and a UQID field, and the at least one excluded field comprises at least one of a Valid field or a Reserved (RSVD) field. The CXL.cache H2D request may include Opcode, Address, UQID, Valid, and RSVD fields in the 68 B flit format. The Opcode field may carry snoop opcodes such as SnpData, SnpInv, or SnpCur. The Address field carries the cacheline address targeted by the snoop. The UQID identifies the host entry originating the request. The Valid and RSVD fields may be omitted from the carrier protocol PDU and reconstructed. In 256 B flit or PBR flit formats, additional fields such as CacheID, SPID, and DPID may also be subject to field reduction and reconstruction, and the set of excluded fields may vary based on the negotiated flit mode.

In some implementations of the method, the CXL PDU comprises a CXL.cache Device-to-Host (D2H) request, the subset of fields comprises an Opcode field, a command queue identifier (CQID) field, and an Address field, and the at least one excluded field comprises at least one of a Valid field, a NonTemporal (NT) field, or a Reserved (RSVD) field. The CXL.cache D2H request may include Opcode, CQID, NT, Address, Valid, and RSVD fields. The D2H request carries device-initiated requests toward a host, with opcodes such as RdShared, RdOwn, RdCurr, RdOwnNoData, or CLFlush. The CQID identifies the device tracker entry for response routing. The NT field provides a caching hint indicating that the requested data is not expected to be reused in the near term, allowing the host to avoid caching the data in a preferred cache position or to treat it as non-cacheable, and may carry a default value in many configurations. The RSVD field in D2H requests may include a larger number of reserved bits compared to H2D requests, making it a suitable candidate for exclusion. The reconstruction of the NT field may utilize a configured default caching policy, while the RSVD field may be reconstructed as zero.

In some implementations of the method, the CXL PDU comprises a CXL.io Transaction Layer Packet (TLP), the subset of fields comprises a Fmt/Type field, an Address field, a Requester ID field, and a Tag field, and the at least one excluded field comprises at least one of a Traffic Class (TC) field, an Attributes (Attr) field, or a reserved field. CXL.io TLP headers may include fields such as Fmt/Type, TC, Attr, EP, Length, Requester ID, Tag, and Address, among others. The Fmt/Type fields (or the combined Type field in flit mode) determine the transaction type and packet format. The Address and Tag fields are retained for routing and transaction tracking. The Requester ID identifies the originating function. The TC field, which indicates the traffic class for quality-of-service handling, may be reconstructed utilizing a configured default traffic class. The Attr field, which includes attributes such as relaxed ordering and no-snoop hints, may be reconstructed from configuration. Reserved fields and other padding may be reconstructed utilizing zero values. The bandwidth savings from excluding these fields may be proportional to the TLP header size, which varies depending on whether the TLP utilizes 32-bit or 64-bit addressing and whether flit mode or non-flit mode is in use.

In some implementations, the method further comprises selecting between a first format comprising a first subset of fields and a second format comprising a second subset of fields based on at least one of available bandwidth, quality-of-service parameters, or a configuration setting. The processing unit may dynamically select between different field inclusion levels based on runtime conditions or system configuration. When the carrier protocol fabric has sufficient bandwidth, a complete or reduced format with more fields may be selected to minimize reconstruction overhead and maximize protocol compliance fidelity. When bandwidth is constrained, an essential format with fewer fields may be selected to maximize the number of CXL transactions that can be transported within the available bandwidth. Quality-of-service parameters may influence the selection, such as utilizing a complete format for high-priority traffic classes and a reduced format for lower-priority traffic. The selection may be performed on a per-connection basis, a per-transaction basis, or a per-time-interval basis, and may be negotiated between the sender and receiver during connection establishment or renegotiated during operation in response to changing network conditions.

In some implementations of the method, an active cable comprising first and second pluggable modules coupled by a physical medium, wherein the active cable further comprises hardware circuitry, integrated into the active cable, configured to perform the method. In some implementations of the method, an apparatus configured to operate as a switch, wherein the apparatus comprises switching circuitry and is configured to perform the method.

In various implementations, an apparatus comprising: a physical layer based on IEEE 802.3 physical medium attachment (PMA) configured to receive a protocol data unit (PDU) of a carrier protocol (carrier protocol PDU) encapsulating a subset of fields of a Compute Express Link (CXL) PDU, the subset excluding at least one field defined by a CXL specification for the CXL PDU; and a processing unit configured to extract the subset of fields from the carrier protocol PDU, reconstruct the at least one excluded field, and generate a CXL request comprising the extracted subset of fields and the at least one reconstructed field. The apparatus may be implemented as an RPU, a SmartNIC, a DPU, a network interface, a switch, an active cable, or any other suitable device that receives carrier protocol PDUs via a physical layer based on IEEE 802.3 PMA and processes encapsulated CXL traffic. The processing unit may include hardware logic, a programmable processor, or a combination thereof, configured to perform the extraction, reconstruction, and CXL request generation operations. The apparatus may support multiple levels of field inclusion and may be configurable to select between different levels based on system requirements. The apparatus may further include a CXL device or CXL port coupled to the processing unit for delivering the generated CXL requests to the CXL fabric.

In some implementations of the apparatus, the processing unit is configured to reconstruct the at least one excluded field based on at least one of a configuration, a default value, or context derived from the subset of fields. The processing unit may maintain configuration registers or memory structures that store reconstruction parameters for each field type and each CXL sub-protocol. The configuration parameters may be programmed during system initialization, updated during operation via management interfaces, or negotiated with remote entities during connection establishment. Default values may be defined by the CXL specification version targeted by the system, enabling automatic reconstruction without explicit configuration for fields that have specification-defined default behaviors.

In some implementations of the apparatus, the processing unit is further configured to receive a CXL response, exclude at least one field of the CXL response defined by the CXL specification, and transmit, via the physical layer based on IEEE 802.3 PMA, a carrier protocol PDU encapsulating a subset of fields of the CXL response excluding the at least one excluded field of the CXL response. The apparatus may support bidirectional bandwidth optimization by applying field reduction to both request and response directions. The processing unit may analyze outgoing CXL responses to identify fields that can be excluded for transport while maintaining the ability for the remote entity to reconstruct the complete response. The response field exclusion may be coordinated with the remote entity to facilitate proper reconstruction at the receiving end.

In some implementations of the apparatus, the processing unit is further configured to select between a first format comprising a first subset of fields and a second format comprising a second subset of fields based on at least one of available bandwidth, quality-of-service parameters, or a configuration setting. The apparatus may monitor bandwidth utilization on the carrier protocol fabric and dynamically adjust the field inclusion level to optimize performance. When bandwidth utilization is low, the apparatus may select a format with more fields to minimize reconstruction overhead. When bandwidth utilization is high or approaching congestion thresholds, the apparatus may select a format with fewer fields to reduce per-transaction bandwidth consumption and maintain throughput. The quality-of-service parameters may include priority levels, latency targets, or throughput guarantees that influence the selection of field inclusion formats for different traffic classes or transaction types.

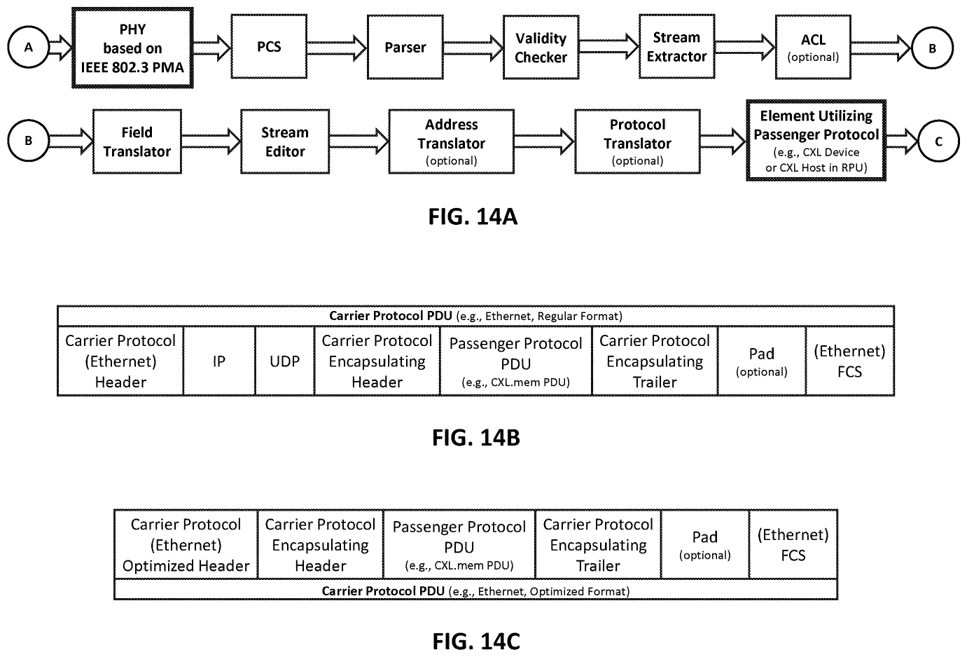

FIG. 14A illustrates an example of a processing pipeline for extracting passenger protocol messages from carrier protocol communications received over a physical layer based on IEEE 802.3 Physical Medium Attachment (PMA). The pipeline may process various carrier protocols that utilize a PMA based on IEEE 802.3, such as certain versions of Ethernet, ESUN, SUE, UALink, or NVLink, to extract encapsulated passenger protocol messages such as CXL.mem, CXL.cache, or CXL.io messages. The figure describes a transmission received by a PMA that is based on IEEE 802.3, which forwards a data stream of the carrier protocol to a Physical Coding Sublayer (PCS). The PCS may include protocol-specific processing operations that may vary based on the carrier protocol being utilized. For Ethernet examples, the PCS may perform operations such as 64 B/66 B block decoding, block framing, block synchronization, descrambling, lane deskewing, and/or forward error correction (FEC) decoding. For UALink or NVLink examples, the PCS may additionally or alternatively perform other operations specific to those protocols while maintaining compatibility with the IEEE 802.3 PMA interface.

The PCS forwards processed data to a Parser. The data may take the form of a partially-delineated stream wherein protocol boundaries have been identified but detailed field parsing has not yet been performed. The Parser may analyze the received data to identify protocol structures and extract protocol-specific information. The Parser may perform analysis operations including identification of the carrier protocol type by examining protocol-specific patterns or markers in the data stream, identification of the passenger protocol type that is encapsulated within the carrier protocol, delineation of Protocol Data Units (PDUs) of the carrier protocol (Carrier PDU) according to the specific framing rules of the identified carrier protocol (such as Ethernet framing, frame-boundary delimitation, and frame synchronization which may involve operations similar to those performed by an Ethernet MAC), and identification of locations of interest within the carrier protocol PDU such as headers, addresses, identifiers, payload sections, and other fields that may be required by subsequent stages of the processing pipeline. The Parser may add metadata fields to the processed data, such as metadata identifying protocol types and data patterns.

The Parser forwards to a Validity Checker a structured data with location information, such as an array of offsets to locations of interest in the Carrier PDU. The Validity Checker performs validation operations on the received data structure, such as validation of data stream format conformance and carrier PDU validity checks including cyclic redundancy checks (CRC) or other error detection logic specific to the carrier protocol. The Validity Checker forwards validated data structures to a Stream Extractor.

The Stream Extractor processes the validated data structures to extract passenger protocol information, such as extracting fields of interest from the Carrier PDU including data indicative of passenger protocol opcodes and physical addresses within a second physical address space utilized by the requesting entity. The Stream Extractor may identify and extract various passenger protocol fields required for message processing, regardless of the specific passenger protocol type. The Stream Extractor forwards its output to an optional Access Control List (ACL) module that may validate access permissions based on the extracted fields. The ACL feeds validated data to a Field Translator that performs field-level transformations between carrier and passenger protocol formats, such as translating fields of interest from the Carrier PDU (e.g., a command field) to fields conforming to the Passenger Protocol specifications (e.g., a CXL opcode field required for constructing a CXL request).

The Field Translator feeds transformed field data to a Stream Editor that reconstructs complete passenger protocol messages. The Stream Editor may perform several operations including reconstruction and formatting of translated fields into a PDU structure compliant with a valid Passenger Protocol PDU (Passenger PDU), such as CXL, insertion of mandatory or optional Passenger Protocol fields that may not be included in the Carrier PDU such as reserved fields of a CXL message that may be omitted from the Carrier PDU but are necessary for an element utilizing passenger protocol, such as a CXL device, to properly parse the request wherein values of omitted fields may be reconstructed based on RPU configurations and/or configurable default values, and removal of intermediate data and metadata that was collected and generated in the processing pipeline but is not part of a compliant Passenger PDU, such as a CXL request.

When no address translation or protocol translation is required, the Stream Editor forwards the Passenger PDU to an element utilizing passenger protocol, such as a CXL device within an RPU. When address translation and/or protocol translation is required, the Stream Editor forwards the Passenger PDU, such as a CXL.mem M2S Req message carrying a physical address within a second HPA space, to an optional Address Translator. The Address Translator translates physical addresses between different physical address spaces, such as translating from a second HPA space to a first HPA space, and forwards the result to an optional Protocol Translator. The Protocol Translator may perform protocol-specific translations, such as translating from a CXL.mem M2S Req message to a CXL.cache D2H Req message. The translated Passenger PDU is then forwarded to the appropriate protocol device, such as forwarding a CXL.cache D2H Req message carrying the physical address within the first HPA space to an element utilizing passenger protocol, such as a CXL host.

FIG. 14B illustrates an example of a packet structure that may be suitable for Layer 3 (L3) switching operations. L3 switching typically refers to packet forwarding based on network layer information, typically using IP addresses or similar network-layer identifiers to make routing decisions across different network segments or subnets. The illustrated packet structure shows a carrier protocol PDU in a regular format that may be processed by standard networking equipment while carrying an encapsulated passenger protocol PDU. The packet structure includes a Carrier Protocol Header, shown as an Ethernet header, which may contain standard Ethernet fields such as destination MAC address, source MAC address, and EtherType or length fields. Following the Ethernet header, the packet includes an IP header that may contain network layer routing information including source and destination IP addresses, protocol identifiers, and other IP-specific fields required for L3 routing decisions. A UDP header follows the IP header and may contain transport layer information including source and destination port numbers that may be used to identify specific services or applications. The packet includes a Carrier Protocol Encapsulating Header that may carry metadata specific to the encapsulation scheme. This header may include a PDU Version (Ver) field that indicates the version or format of the protocol PDU structure, enabling the Parser to correctly interpret the packet structure. A Source Node ID (SourceNodeID) field may identify the originating node in a format specific to the overlay network or fabric topology. A Destination Node ID (DestinationNodeID) field may identify the target node for routing within the overlay network. A Segmentation ID (SegmentID) field may be used for infrastructure virtualization, such as to provide isolation between different tenants or logical networks in multi-tenant environments. A PDU Sequence Number (PSN) field may provide ordering information for reliable delivery or reassembly of segmented messages. A Passenger Protocol (PassengerProt) field may identify the type of passenger protocol encapsulated within the PDU, such as CXL.io, CXL.cache, or CXL.mem, enabling the Parser to apply appropriate processing rules. The Passenger Protocol PDU section may contain the actual passenger protocol message, such as a CXL.mem PDU, that is being transported across the network. The Passenger Protocol PDU section may include the fields required by the passenger protocol specification, or a subset of the fields that enable reconstruction of the message, as further discussed below.

The packet further includes a Carrier Protocol Encapsulating Trailer that may carry additional metadata and integrity information. This trailer may include an Encapsulating CRC (E-CRC) field that provides error detection for the encapsulated portion of the packet, potentially offering stronger integrity protection than the standard Ethernet FCS. A Data Poisoning (Poison) field may be used to mark data that is known to be corrupted, allowing protocols such as CXL or UPI to propagate error indications across the network. A Reported Load (ReportedLoad) field may communicate congestion or load information from the source device, possibly augmented with congestion information from intermediate components along the path, such as CXL DevLoad indicators, enabling network-aware load balancing or congestion management. The packet structure may further include an optional Pad field that may be used to meet minimum frame size requirements of the carrier protocol, and may conclude with an Ethernet Frame Check Sequence (FCS) that provides error detection for the entire Ethernet frame according to Ethernet specifications.

FIG. 14C illustrates an example of a packet structure that may be suitable for Layer 2 (L2) switching operations. L2 switching typically refers to packet forwarding based on data link layer information, typically using MAC addresses to make forwarding decisions within a network segment or broadcast domain. The Carrier Protocol Optimized Header may contain condensed addressing or routing information suitable for L2 forwarding decisions. The Carrier Protocol Encapsulating Header, Passenger Protocol PDU, and Carrier Protocol Encapsulating Trailer may contain similar fields and serve similar functions as described for the L3 packet structure in FIG. 14B, adapted for the L2 switching context. The packet structure maintains the optional Pad field and Ethernet FCS for compatibility with the frame requirements as defined by the Ethernet specification.

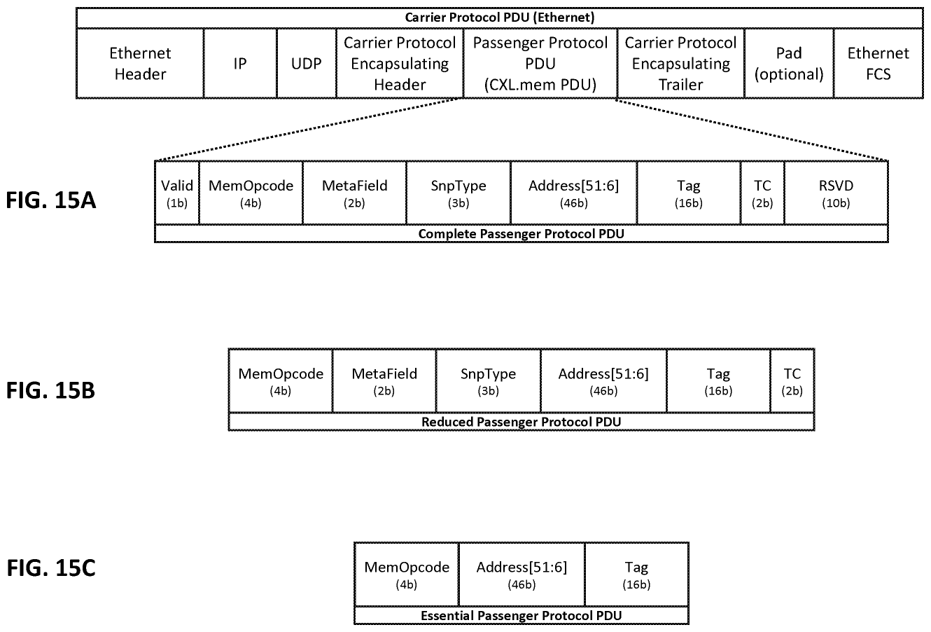

FIG. 15A to FIG. 15C illustrate three examples of variations for the Passenger Protocol PDU that may be encapsulated within the Carrier Protocol PDU illustrated in FIG. 14B. These variations illustrate different levels of field inclusion that may be utilized to optimize bandwidth utilization while maintaining the ability to reconstruct complete passenger protocol messages. The lower part of FIG. 15A illustrates a complete Passenger Protocol PDU for a CXL.mem message conforming to Revision 1.1 of the CXL Specification. The complete PDU includes the fields required by CXL.mem: a Valid field (1 bit) that indicates whether the message contains valid data, a MemOpcode field (4 bits) that specifies the memory operation type, a MetaField field (2 bits) that contains metadata about the transaction, a SnpType field (3 bits) that indicates the snoop type for cache coherency operations, an Address field (46 bits) that carries the physical address for the operation, a Tag field (16 bits) that provides a unique identifier for tracking the transaction, a TC field (2 bits) that may indicate traffic class or priority information, and a Reserved (RSVD) field (10 bits) that is reserved for future use or protocol compliance. This complete format may be utilized when full protocol compliance is required or when the carrier protocol has sufficient bandwidth to accommodate the fields.

FIG. 15B illustrates an example of a reduced Passenger Protocol PDU, wherein some of the fields that can be reconstructed are omitted from the Carrier PDU to reduce bandwidth requirements. The reduced PDU retains the MemOpcode field (4 bits), MetaField field (2 bits), SnpType field (3 bits), Address field (46 bits), Tag field (16 bits), and TC field (2 bits). The reconstructed fields, which are not included in the Carrier PDU but are required for a CXL device for parsing the CXL request, may be reconstructed by the Stream Editor of the RPU. For FIG. 15B, the fields to be reconstructed are the one bit Valid field and the 10 bits Reserved (RSVD) field. The Valid field may be reconstructed based on the presence of a well-formed PDU, while the RSVD field may be reconstructed using configured default values.

FIG. 15C illustrates an example of an essential Passenger Protocol PDU, which may include essentially the minimum fields required for basic operation of the passenger protocol. The essential PDU comprises the MemOpcode field (4 bits) that specifies the operation to be performed, the Address field (46 bits) that identifies the physical address, and the Tag field (16 bits) that enables transaction tracking and response correlation. The fields omitted from the essential PDU, including Valid, MetaField, SnpType, TC, and RSVD fields, may be reconstructed by the Stream Editor using protocol-specific default values or configuration parameters.

In environments where entities may utilize different protocols while requiring coordinated access to shared resources, there may be scenarios where a first entity communicating according to CXL.mem, such as a CXL host, needs to access memory resources residing in a UALink domain, such as memory coupled to accelerators or accessible via a UALink network. An RPU or other suitable device may translate between CXL.mem and UPLI to facilitate memory operations, data transfers, and resource sharing across different protocol domains while maintaining the requirements of each protocol. The translation may involve converting CXL.mem M2S requests to UPLI requests, and converting UPLI responses to CXL.mem S2M responses, including translations of opcodes, commands, addresses, Tags, and additional fields. The RPU may further perform address translations between different address spaces, such as between a Host Physical Address (HPA) space utilized by CXL-based traffic and a Network Physical Address (NPA) space utilized by UALink-based traffic, or between addresses within the same address space. The RPU may include a cache for storing fetched data and may operate as a CXL Type-2 device, a CXL Type-3 device, or may expose both HDM-D and HDM-H memory regions concurrently.

In various implementations, a method for translating from Compute Express Link (CXL) requests to Ultra Accelerator Link (UALink) Protocol Level Interface (UPLI) requests, comprising: communicating with a first entity according to CXL.mem; communicating with a second entity according to UPLI; receiving, from the first entity, a CXL.mem Master-to-Subordinate (M2S) request comprising a MemRd* and a first physical address; translating the CXL.mem M2S request to a UPLI request comprising a read command and a second physical address; sending the UPLI request to the second entity; receiving, from the second entity, a UPLI read response (RdRsp) comprising data; translating the UPLI RdRsp to a CXL.mem Subordinate-to-Master Data Response (S2M DRS) comprising the data; and sending the CXL.mem S2M DRS to the first entity. The translation may enable entities communicating according to CXL.mem to access memory resources coupled to entities communicating according to UPLI, such as HBM and/or High-Bandwidth Flash (HBF) coupled to an accelerator, or memory accessible via a UALink network. The method may be implemented in hardware, firmware, software, or combinations thereof, and may be performed by various types of devices, such as a processor, a switch, a bridge, an RPU, or a semiconductor device. The first physical address may be associated with a first address space, such as an HPA space, and the second physical address may be associated with a second address space, such as an NPA space, wherein the translating may include translating the first physical address to the second physical address. Additionally or alternatively, the first and second physical addresses may be associated with the same address space, such as a global address space, a partitioned global address space (PGAS), a pod address space, a virtual pod address space, or a fabric address space.

In some implementations of the method, the CXL.mem M2S request further comprises a MemOpcode field comprising the MemRd*, a Tag field, and an Address field comprising the first physical address; and wherein the UPLI request further comprises a ReqCmd field comprising the read command, a ReqAddr field comprising the second physical address, a ReqSrcPhysAccID field, a ReqDstPhysAccID field, a ReqLen field, and a ReqTag field; and further comprising translating the Tag to the ReqTag. The Tag translation may involve maintaining a bidirectional mapping between CXL.mem Tag values and UPLI ReqTag values, enabling proper correlation of UPLI responses with their corresponding CXL.mem requests. The ReqSrcPhysAccID and ReqDstPhysAccID fields may carry identifiers utilized for routing the UPLI request to the target accelerator. When the ReqLen indicates a transfer size exceeding a CXL.mem cacheline size (e.g., 64 Bytes), CXL.mem M2S requests may be consolidated into a UPLI request supporting transfer sizes up to 256 Bytes.

In some implementations of the method, the UPLI RdRsp further comprises a RdRspSrcPhysAccID field, a RdRspDstPhysAccID field, a RdRspTag field, and RdRspData comprising the data; and wherein the CXL.mem S2M DRS further comprises an Opcode field comprising MemData and the Tag. The RdRspDstPhysAccID may correspond to the ReqSrcPhysAccID from the original UPLI request, reflecting the routing path for the response. The RdRspTag may be utilized to retrieve the corresponding CXL.mem Tag from the bidirectional mapping maintained during request translation. In some examples, the UPLI RdRsp may carry data across multiple beats, and the RPU may accumulate the beats before constructing the CXL.mem S2M DRS.

In some implementations of the method, the UPLI RdRsp further comprises a RdRspDataError field, and the CXL.mem S2M DRS further comprises a Poison field; and further comprising translating the RdRspDataError field of the UPLI RdRsp to the Poison field of the CXL.mem S2M DRS. The RdRspDataError field in UPLI may serve as a per-beat data poison indicator. The Poison field in CXL.mem S2M DRS may indicate that the returned data contains an error. The translation of error indications across protocol boundaries may enable the first entity to detect data corruption that originated in the UALink domain, and to take appropriate recovery actions.

In some implementations, the method further comprises storing the data from the UPLI RdRsp in a cache; and sending a CXL.mem Subordinate-to-Master No Data Response (S2M NDR) comprising Cmp-S to the first entity, wherein the Cmp-S indicates a shared cacheline state. By storing the fetched data in the cache, the RPU may maintain a local copy of the cacheline and participate in coherency management with the first entity. The S2M NDR comprising Cmp-S may inform the first entity that the RPU retains a shared copy, enabling both the first entity and the RPU to hold cached copies concurrently. This behavior may correspond to CXL Type-2 device semantics utilizing an HDM-D memory region, wherein the device coherency engine (DCOH) manages cacheline state on behalf of the device.

In some implementations of the method, the CXL.mem M2S request further comprises a SnpType field comprising SnpData, a MetaField field comprising Meta0-State (MS0), and a MetaValue field comprising Shared (S); and wherein the CXL.mem M2S request targets a Host-managed Device Memory (HDM-D) memory region. The SnpType(SnpData), MetaField(MS0), and MetaValue(S) combination may indicate an intent by the first entity to acquire a shared copy of the cacheline. The RPU may utilize these fields to determine the coherency behavior and to select the Cmp-S opcode for the S2M NDR.

In some implementations of the method, the CXL.mem M2S request further comprises a SnpType field comprising No-Op and a MetaField field comprising No-Op; and wherein the CXL.mem S2M DRS is sent to the first entity without sending a CXL.mem Subordinate-to-Master No Data Response (S2M NDR) to the first entity; and wherein the CXL.mem M2S request targets a Host-managed Device Memory (HDM-H) memory region. The No-Op values for SnpType and MetaField may indicate that no snoop or metadata operation is involved, corresponding to CXL Type-3 device semantics. In this flow, the RPU may act as a passthrough that forwards data from the UALink domain to the first entity without maintaining a cached copy and without participating in coherency management.

In some implementations, the method further comprises sending a CXL.mem Subordinate-to-Master No Data Response (S2M NDR) comprising Cmp-S to the first entity without storing the data in a cache. The RPU may respond with Cmp-S even when the RPU does not have a cache or does not store the data. This may be beneficial in scenarios where the first entity does not support CXL Type-3 device flows and only supports CXL Type-2 device flows. By emulating Type-2 behavior, the RPU may maintain compatibility with hosts that lack Type-3 support.

In some implementations of the method, the first physical address is associated with a first address space, the second physical address is associated with a second address space different from the first address space, and the translating further comprises translating the first physical address to the second physical address; and wherein the first address space comprises a Host Physical Address (HPA) space or a System Physical Address (SPA) space, and the second address space comprises a Network Physical Address (NPA) space. The address translation may be implemented utilizing lookup tables, page tables, base-and-offset calculations, range-based mapping, and/or programmable translation functions. The HPA or SPA may represent addresses within the CXL domain, and the NPA may represent addresses within the UALink network that may span multiple accelerators or nodes. In some examples, the first and second address spaces may be the same address space, and the RPU may perform routing without address translation.

In some implementations of the method, the first entity comprises a CXL host, the second entity comprises an accelerator or a UALink switch, and the read command comprises a Read command or a Read Class Vendor Defined Command. Read Class VDCs may correspond to ReqCmd encodings that enable vendor-specific memory access operations extending beyond the standard UPLI read commands. The CXL host may include a CPU or other CXL-capable entity. The accelerator may include a GPU, a TPU, or other processing device coupled to a UALink network.

In some implementations, the method further comprises receiving, from the first entity, a CXL.mem Master-to-Subordinate Request with Data (M2S RwD) comprising MemWr* and write data; translating the CXL.mem M2S RwD to a UPLI request comprising a write command; sending the UPLI request and the write data to the second entity; receiving, from the second entity, a UPLI write response (WrRsp); translating the UPLI WrRsp to a CXL.mem Subordinate-to-Master No Data Response (S2M NDR) comprising Cmp; and sending the CXL.mem S2M NDR to the first entity. MemWr* may refer to MemWr, MemWrPtl, MemWrTEE, MemWrPtlTEE, or other memory write opcode variants defined or to be defined in CXL.mem. The write data may be transferred from the CXL.mem domain to the UPLI domain via the Originator Data Channel, optionally with byte enable manipulation utilizing OrigDataByteEn when the MemWr* refers to MemWrPtl for partial writes. The UPLI write command may include a Write or WriteFull command as defined by the UPLI specification. The UPLI WrRsp may carry a WrRspTag and WrRspStatus indicating the completion status of the write operation.

In some implementations, the method further comprises receiving, from the first entity, a CXL.mem M2S request comprising MemSpecRd; and translating the CXL.mem M2S request comprising MemSpecRd to a UPLI request. The MemSpecRd opcode may indicate a speculative read issued by the first entity before coherence resolution, and the RPU may translate it to a UPLI read request directed to the second entity. When utilizing the MemSpecRd opcode, some of the CXL.mem M2S Req fields, such as MetaField, MetaValue, and SnpType, may be reserved. Additionally or alternatively, the RPU may initiate speculative UPLI requests on its own to prefetch data from the second entity, based on access pattern recognition or configurable prefetch policies.

In some implementations of the method, the method is performed by a device that exposes a first memory region utilizing CXL Type-2 device memory flows associated with a Host-managed Device Memory-Device coherent (HDM-D) region, and a second memory region utilizing CXL Type-3 device memory flows associated with a Host-managed Device Memory-Host coherent (HDM-H) region. The CXL specification allows a device to expose both HDM-D and HDM-H memory regions concurrently. For example, local memory such as HBM and/or HBF coupled to an accelerator may be exposed as an HDM-D region utilizing CXL Type-2 memory flows with coherency management, while remote memory accessible via the UALink network may be exposed as an HDM-H region utilizing CXL Type-3 memory flows. The RPU may select the appropriate memory flow based on the address of the CXL.mem M2S request.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an apparatus configured to operate as a switch, wherein the apparatus comprises switching circuitry and is configured to perform the method.

In computing environments where a host communicating according to CXL.mem may need to access memory resources in a UALink domain, such as memory coupled to accelerators or accessible via a UALink network, an RPU may bridge the two protocol domains by translating between CXL.mem and UPLI. The RPU may include a CXL port for communicating with the host and a UALink port for communicating with accelerators or a UALink switch. The RPU may translate CXL.mem M2S requests to UPLI requests and translate UPLI responses to CXL.mem S2M responses. The RPU may include a cache for storing fetched data and may operate as a CXL Type-2 device or a CXL Type-3 device. The RPU may be a discrete component, an IP block embedded within an accelerator, or a chiplet within an IC package.

In various implementations, a system comprising: a resource provisioning unit (RPU) comprising a Compute Express Link (CXL) port configured to communicate with a first entity according to CXL.mem, and an Ultra Accelerator Link (UALink) port configured to communicate with a second entity according to a UALink-based protocol; wherein the RPU is configured to: receive, from the first entity via the CXL port, a CXL.mem Master-to-Subordinate (M2S) request; translate the CXL.mem M2S request to a UPLI request; and send the UPLI request to the second entity via the UALink port. The RPU may serve as a protocol translation bridge that enables entities in the CXL domain to access resources in the UALink domain. The CXL port may support CXL.mem M2S and S2M channels, while the UALink port may support UPLI request, read response/data, write response, and Originator Data channels. The RPU may translate between CXL.mem and UPLI including translations of opcodes, addresses, Tags, and additional fields. The first entity may include a CXL host such as a CPU, and the second entity may include an accelerator, a UALink switch, or other UALink-capable device. The RPU may be coupled to the first entity directly or via a CXL fabric, and may be coupled to the second entity directly or via a UALink switch. The system may be implemented within an IC package, across IC packages, or as a combination of discrete and integrated components.

In some implementations of the system, the RPU is further configured to: receive a UPLI read response (RdRsp) from the second entity via the UALink port; translate the UPLI RdRsp to a CXL.mem Subordinate-to-Master Data Response (S2M DRS); and send the CXL.mem S2M DRS to the first entity via the CXL port. The RPU may translate UPLI RdRsp fields to CXL.mem S2M DRS fields, including mapping the RdRspTag back to the corresponding CXL.mem Tag and formatting the RdRspData as CXL.mem data. The RPU may accumulate data from multiple UPLI response beats before constructing the S2M DRS.

In some implementations of the system, the RPU further comprises a cache; and wherein the RPU is further configured to store data from the UPLI RdRsp in the cache and send a CXL.mem Subordinate-to-Master No Data Response (S2M NDR) comprising Cmp-S to the first entity. By maintaining the fetched data in its cache, the RPU may participate in coherency management with the first entity and may respond to subsequent accesses to the same cacheline without issuing additional UPLI requests. The RPU with a cache may operate as a CXL Type-2 device.

In some implementations of the system, the first entity comprises a CXL host, the second entity comprises an accelerator; and wherein the RPU is configured to operate as at least one of a CXL Type-2 device or a CXL Type-3 device. The RPU may operate as a CXL Type-2 device utilizing HDM-D memory regions with device-managed coherency, or as a CXL Type-3 device utilizing HDM-H memory regions with host-managed coherency. In some examples, the RPU may expose both HDM-D and HDM-H regions concurrently, operating as a CXL Type-2 device for some memory regions and as a CXL Type-3 device for others.

In some implementations, the system further comprises a UALink switch coupled to the UALink port; wherein the RPU is configured to send the UPLI request to the second entity via the UALink switch. The UALink switch may route the UPLI request to the second entity based on a Destination Accelerator ID carried in the UPLI request. The RPU may appear to entities in the UALink domain as a UALink endpoint identified by an Accelerator ID.

In some implementations of the system, the RPU is further configured to: receive, from the first entity via the CXL port, a CXL.mem Master-to-Subordinate Request with Data (M2S RwD) comprising MemWr*; translate the CXL.mem M2S RwD to a UPLI request comprising a write command; and send the UPLI request and write data to the second entity via the UALink port. The RPU may translate CXL.mem write opcodes to UPLI write commands and transfer the write data from the CXL.mem domain to the UPLI Originator Data Channel. When the MemWr* refers to MemWrPtl for partial writes, the RPU may translate the CXL.mem byte enables to UPLI OrigDataByteEn fields.

In computing environments where a host, such as a CPU, may need to access memory resources residing in a UALink domain, such as HBM and/or HBF coupled to accelerators in a UALink pod, the host may communicate via CXL.mem with an RPU that translates requests to UPLI for delivery to the accelerators via a UALink switch. The UALink pod may include accelerators coupled to a UALink switch, forming a high-bandwidth interconnect fabric for inter-accelerator communication. The RPU may be embedded within one of the accelerators, or may be a discrete component coupled to the UALink switch. In some configurations, the system may include a CXL fabric coupling the host to the RPU and to CXL memory devices such as GFDs, memory expanders, or memory pools, enabling the host to access both CXL domain resources and UALink domain resources. The multi-path topology may enable the host to access different accelerators and memory resources via different translation paths, supporting workloads such as AI inference where data may be staged from CXL memory to accelerator memory.

In various implementations, a system comprising: a host; a UALink pod comprising a UALink switch and accelerators coupled to the UALink switch, wherein the accelerators communicate according to a UALink-based protocol; a resource provisioning unit (RPU) coupled to the host via CXL.mem and coupled to the UALink switch; and wherein the RPU is configured to receive a CXL.mem Master-to-Subordinate (M2S) request from the host, translate the CXL.mem M2S request to a UPLI request, and send the UPLI request to an accelerator of the accelerators via the UALink switch. The system may enable the host to access memory resources residing in the UALink domain, such as HBM and/or HBF coupled to the accelerators, DRAM within the accelerators, or memory accessible via the UALink network. The RPU may translate between CXL.mem and UPLI including translations of opcodes, addresses, Tags, and additional fields. The UALink switch may route the UPLI request to the target accelerator based on a Destination Accelerator ID. The host may utilize CXL.mem M2S requests comprising memory read or write opcodes, and the RPU may translate these to corresponding UPLI read or write commands. The system may support workloads where the host stages data between CXL memory resources and accelerator memory, such as populating KV cache entries into accelerator HBM and/or HBF for AI inference workloads. The RPU may be implemented as a discrete component, as an IP block embedded within one of the accelerators, or as a chiplet within an IC package.

In some implementations of the system, the RPU is embedded within a first accelerator of the accelerators, and the first accelerator is coupled to the host via CXL.mem; and wherein the UPLI request is sent from the first accelerator to a second accelerator of the accelerators via the UALink switch. The embedded RPU may share the first accelerator's silicon die or IC package and may utilize the first accelerator's CXL port for communication with the host. The first accelerator may serve as both an accelerator in the UALink pod and as a translation bridge for the host to reach other accelerators.

In some implementations of the system, the RPU is separate from the accelerators and is coupled to the UALink switch via a UALink port. The discrete RPU may function as a standalone protocol translation component that does not perform accelerator compute functions. This configuration may enable the RPU to be deployed independently of the accelerator design, potentially supporting different generations of accelerators or different UALink pod configurations.

In some implementations, the system further comprises a CXL fabric coupling the host to the RPU; and further comprising a CXL memory device coupled to the host via the CXL fabric, wherein the host is configured to access the CXL memory device via CXL.mem. The CXL fabric may include one or more CXL switches and may provide connectivity between the host, the RPU, and CXL memory devices. The host may access the CXL memory device via CXL.mem without protocol translation, while accessing accelerator memory in the UALink pod via the RPU with protocol translation.

In some implementations of the system, the CXL memory device comprises at least one of: a Global Fabric-Attached Memory Device (GFD), a CXL memory expander, or a CXL memory pool. The GFD may provide large-capacity memory resources accessible via CXL.mem, and may be shared among the host and other CXL entities. The host may stage data between the CXL memory device and accelerator memory via the RPU, such as migrating KV cache entries for AI inference workloads.

In some implementations of the system, the RPU is further configured to receive a UPLI read response (RdRsp) from the accelerator via the UALink switch, translate the UPLI RdRsp to a CXL.mem Subordinate-to-Master Data Response (S2M DRS), and send the CXL.mem S2M DRS to the host; and wherein the host comprises a central processing unit (CPU), and the accelerators comprise graphics processing units (GPUs) or tensor processing units (TPUs). The CPU may utilize the CXL.mem response to populate data structures, migrate data between memory tiers, or perform orchestration tasks on behalf of AI or HPC workloads. The GPUs or TPUs may serve as computational accelerators within the UALink pod.

In some implementations, the system further comprises a second RPU coupled to the host via CXL.mem and coupled to the UALink switch; wherein the RPU is configured to translate CXL.mem M2S requests from the host to UPLI requests targeting a first accelerator of the accelerators, and the second RPU is configured to translate CXL.mem M2S requests from the host to UPLI requests targeting a second accelerator of the accelerators. The RPUs may enable the host to access different accelerators through dedicated translation paths, potentially supporting different address ranges, different coherency policies, or different quality-of-service configurations for each path. The first and second RPUs may be discrete components or may include one embedded RPU and one discrete RPU.

In some implementations of the system, the UALink switch comprises a route table, and the UALink switch routes the UPLI request from the RPU to the accelerator based on a Destination Accelerator ID carried in the UPLI request; and wherein the accelerators communicate with the UALink switch via UPLI request channels and UPLI response channels. The UALink switch may route UPLI traffic based on the ReqDstPhysAccID field in each UPLI request, utilizing the route table to map the Destination Accelerator ID to an egress port coupled to the target accelerator. The route table may be programmed by a Pod Controller or other management entity. The RPU may populate the ReqDstPhysAccID based on the address of the CXL.mem M2S request or based on a preconfigured mapping.

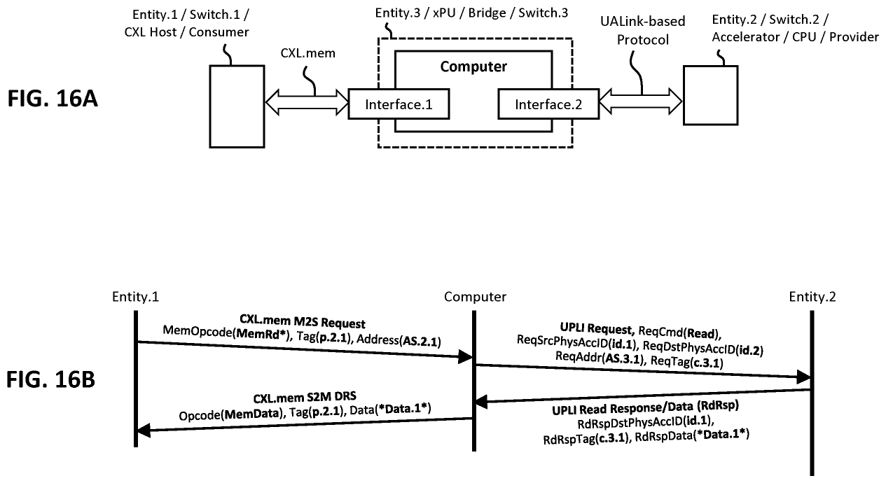

FIG. 16A illustrates an example of a block diagram showing a computer (Entity.3) coupled between a first entity (Entity.1) and a second entity (Entity.2). The first entity communicates with the computer via CXL.mem through a first interface (Interface.1), and the computer communicates with the second entity via a UALink-based protocol through a second interface (Interface.2). The first entity may include a CXL host, a switch, or a consumer of memory resources. The second entity may include an accelerator, a switch, or a provider of memory resources. The computer may include an xPU, a bridge, a switch, or an RPU.

FIG. 16B illustrates an example of a TFD demonstrating translations from a CXL.mem request from Entity.1 to a UPLI request sent to Entity.2, and from a UPLI read response from Entity.2 to a CXL.mem S2M DRS sent to Entity.1. The CXL.mem M2S request carries MemOpcode, Tag, and Address fields, and the UPLI request carries ReqCmd, ReqSrcPhysAccID, ReqDstPhysAccID, ReqAddr, and ReqTag fields. The UPLI read response carries RdRspDstPhysAccID, RdRspTag, and RdRspData fields, and the CXL.mem S2M DRS carries Opcode, Tag, and Data fields.

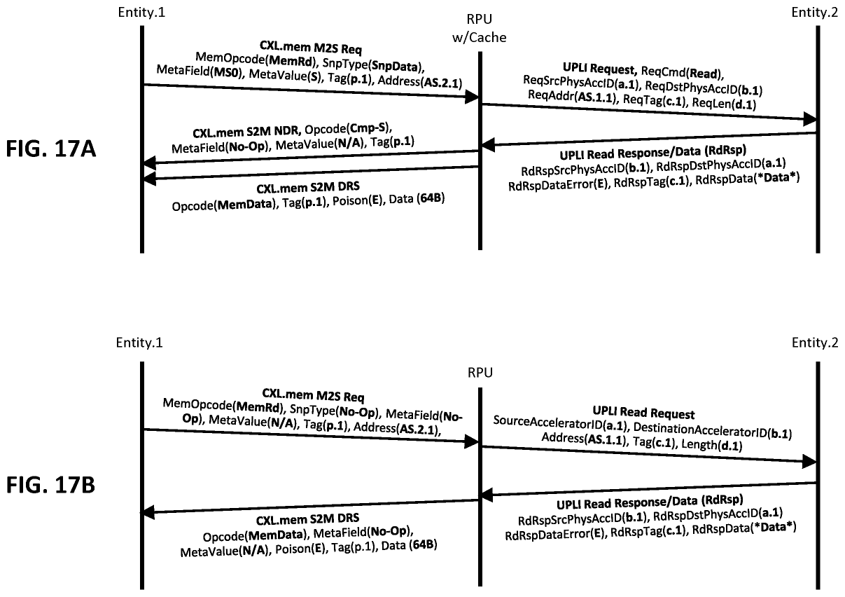

FIG. 17A illustrates an example of a TFD demonstrating an RPU comprising a cache (RPU w/Cache) that exposes a CXL Type-2 device utilizing an HDM-D memory region. Entity.1 sends a CXL.mem M2S request with SnpType(SnpData), MetaField(MS0), and MetaValue(S) to request a shared copy of a cacheline. The RPU translates the request to a UPLI request and receives a UPLI read response from Entity.2. The RPU stores the fetched data in its cache and sends a CXL.mem S2M NDR comprising Cmp-S to Entity.1, indicating a shared cacheline state, followed by a CXL.mem S2M DRS comprising MemData and the data.

FIG. 17B illustrates an example of a TFD demonstrating an RPU without a cache that exposes a CXL Type-3 device utilizing an HDM-H memory region. Entity.1 sends a CXL.mem M2S request with SnpType(No-Op) and MetaField(No-Op). The RPU translates the request to a UPLI request and receives a UPLI read response from Entity.2. The RPU translates the UPLI read response to a CXL.mem S2M DRS comprising MemData and the data, and sends the S2M DRS to Entity.1 without sending an S2M NDR.

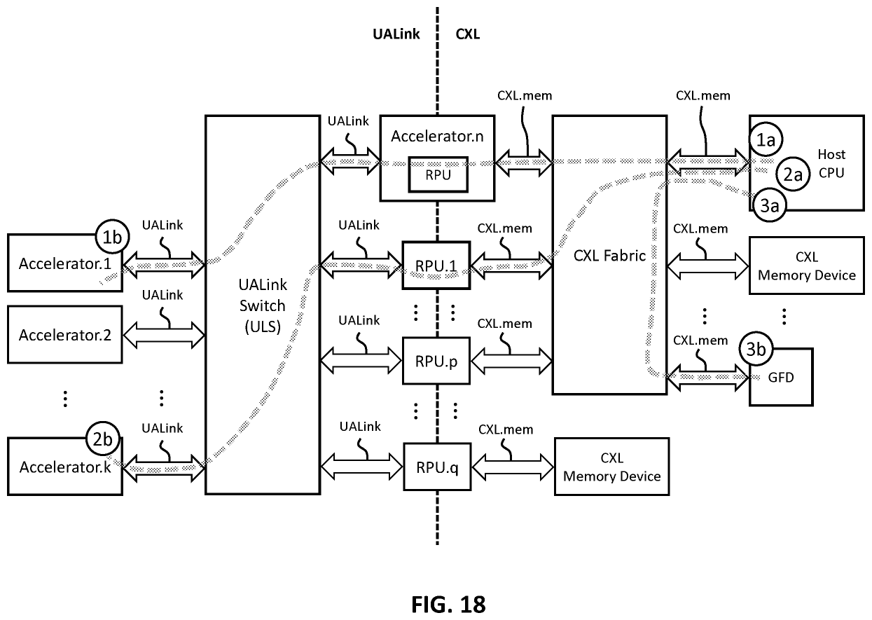

FIG. 18 illustrates an example of a system comprising a host CPU, a CXL fabric, a UALink switch, accelerators, and RPUs. Path 1 (1a to 1b) illustrates the host accessing Accelerator.1 via Accelerator.n that comprises an embedded RPU, wherein the host communicates with Accelerator.n via CXL.mem and Accelerator.n communicates with Accelerator.1 via UALink through the UALink switch. Path 2 (2a to 2b) illustrates the host accessing Accelerator.k via a discrete RPU (RPU.1) coupled to the UALink switch, wherein the host communicates with RPU.1 via CXL.mem and RPU.1 communicates with Accelerator.k via UALink. Path 3 (3a to 3b) illustrates the host accessing a GFD via CXL.mem through the CXL fabric.

In computing environments where a host, such as a CPU, accesses memory resources on a device, such as an accelerator, the device may expose memory regions to the host via CXL. Different memory regions may have different coherency requirements and may be backed by different types of memory. For example, a first memory region may be backed by local memory coupled to the device, such as HBM and/or High-Bandwidth Flash (HBF), and may benefit from device coherency where the device participates in cache coherency with the host. A second memory region may be backed by memory accessible via a UALink network, such as memory residing on remote accelerators, and may not require device coherency participation. The CXL specification defines different HDM types and device type flows that correspond to different coherency models, and a device may expose concurrent HDM regions utilizing different device type flows. An RPU or translation logic within the device may translate between CXL protocol messages received from the host and UPLI messages for accessing memory in the UALink domain, while maintaining the appropriate coherency semantics for each memory region.

In various implementations, a method comprising: exposing, by a device coupled to a host via a Compute Express Link (CXL) link, a first memory region via a first CXL device type flow and a second memory region via a second CXL device type flow, wherein the first CXL device type flow is different from the second CXL device type flow; wherein the first memory region is associated with a first memory; wherein the second memory region is associated with a second memory accessible via an Ultra Accelerator Link (UALink)-based protocol; and translating, by the device, between a protocol based on CXL and UALink Protocol Level Interface (UPLI) for at least one of the first memory region or the second memory region. The method may be implemented in hardware, firmware, software, or combinations thereof, and may be performed by various types of devices, such as an accelerator, an RPU, a semiconductor device, or a chiplet within an IC package. The first and second CXL device type flows may correspond to any combination of CXL Type-2 and Type-3 device flows, and may further include CXL Type-1 device flows in some examples. The device may expose additional memory regions beyond the first and second memory regions, each utilizing different or the same CXL device type flows. Translations between the protocol based on CXL and UPLI may include translations of opcodes, addresses, Tags, and additional fields, and may further include address translations between different address spaces such as a Host Physical Address (HPA) space and a Network Physical Address (NPA) space. The first memory may include memory coupled to the device, such as HBM, HBF, DRAM, or GDDR, while the second memory may include memory accessible via a UALink switch, a UALink network, or remote accelerators within a UALink domain. The elements may communicate through one or more intermediary components, such as a switch, a retimer, or other suitable entity that facilitates information transfer.

In some implementations of the method, the first CXL device type flow comprises a CXL Type-2 device flow and the first memory region comprises a Host-managed Device Memory with Device coherency (HDM-D) region, and the second CXL device type flow comprises a CXL Type-3 device flow and the second memory region comprises a Host-managed Device Memory with Host-only coherency (HDM-H) region; and wherein the device participates in cache coherency with the host for the first memory region and does not participate in cache coherency with the host for the second memory region. The CXL Type-2 device flow may enable the device to utilize both CXL.mem and CXL.cache protocols for the HDM-D region, allowing the device to maintain cached copies of data and participate in coherency negotiations with the host. The CXL Type-3 device flow may utilize CXL.mem without CXL.cache for the HDM-H region, where the host manages coherency without device cache participation.

In some implementations, the method further comprises receiving, from the host, a CXL.mem Master-to-Subordinate (M2S) request comprising MemRd* and an address targeting the first memory region, wherein the CXL.mem M2S request further comprises a SnpType field, a MetaField field, and a MetaValue field; translating the CXL.mem M2S request to a UPLI request; receiving a UPLI response comprising data; and sending to the host a CXL.mem Subordinate-to-Master No Data Response (S2M NDR) comprising Cmp-S or Cmp-E indicating a cache state of a cacheline at the address, and a CXL.mem Subordinate-to-Master Data Response (S2M DRS) comprising MemData and the data. The SnpType, MetaField, and MetaValue fields in the CXL.mem M2S request may indicate the cacheline state intent of the host, such as requesting a shared copy (SnpData) or an exclusive copy (SnpInv). The device may utilize these fields to determine the appropriate coherency response. The device coherency engine (DCOH) may select Cmp-S when the device retains a cached copy of the data, or Cmp-E when the device relinquishes its cached copy. The device may translate the CXL.mem M2S request to a UPLI request to fetch the data from the UALink domain before responding.

In some implementations of the method, the device comprises a cache; and wherein the device stores the data from the UPLI response in the cache and sends the CXL.mem S2M NDR comprising Cmp-S indicating that the device retains a cached copy of the cacheline at the address. By caching the fetched data and responding with Cmp-S, the device may enable subsequent accesses to the same cacheline to be served from its local cache without requiring another UPLI transaction. A device with cache, or a device that controls or utilizes a cache, may include a cache memory, a cache controller, or cache allocation and eviction logic.

In some implementations of the method, the UPLI request comprises a ReqSrcPhysAccID field, a ReqDstPhysAccID field, a ReqTag field, a ReqAddr field, and a ReqCmd field comprising a read command; and further comprising translating a Tag of the CXL.mem M2S request to the ReqTag of the UPLI request. The ReqSrcPhysAccID and ReqDstPhysAccID fields may carry identifiers utilized by the UALink network for routing the UPLI request. The Tag translation may involve maintaining a bidirectional mapping between CXL.mem Tag values and UPLI ReqTag values, enabling proper correlation of UPLI responses with their corresponding CXL.mem requests.

In some implementations, the method further comprises receiving, from the host, a CXL.mem Master-to-Subordinate (M2S) request comprising MemRd* and an address targeting the second memory region; translating the CXL.mem M2S request to a UPLI request; receiving a UPLI response comprising data; and sending to the host a CXL.mem Subordinate-to-Master Data Response (S2M DRS) comprising MemData and the data. For the second memory region, the device may operate as a passthrough translator that fetches data from the UALink domain and returns it to the host without maintaining cached copies or participating in coherency negotiations. The CXL.mem S2M DRS may carry MemData without an accompanying S2M NDR indicating Cmp-S or Cmp-E, because the device does not track cache state for this memory region.

In some implementations of the method, the UPLI response further comprises a RdRspDataError field indicating a data error; and further comprising translating the RdRspDataError field to a Poison field of the CXL.mem S2M DRS sent to the host. The RdRspDataError field in the UPLI response may serve as a per-beat data poison indicator. The translation of error indications across protocol boundaries may enable the host to detect data corruption that originated in the UALink domain and to take appropriate recovery actions.

In some implementations of the method, for the first memory region, the device communicates with the host via CXL.cache; and wherein the device issues CXL.cache Device-to-Host (D2H) requests to the host comprising an opcode selected from RdOwn, RdShared, RdCurr, or RdAny. The CXL.cache D2H requests may enable the device to initiate coherency transactions with the host for data in the first memory region. RdOwn may acquire exclusive ownership, RdShared may acquire a shared copy, RdCurr may request a non-cacheable current value, and RdAny may accept any coherency state.

In some implementations of the method, the first memory comprises at least one of High Bandwidth Memory (HBM) or High-Bandwidth Flash (HBF) coupled to the device, the second memory comprises memory accessible via a UALink switch or a UALink network, and the device comprises an accelerator. The accelerator may be a GPU, a TPU, or other processing unit with HBM and/or HBF that may benefit from device coherency for its local memory. The UALink switch or fabric may couple the accelerator to remote accelerators, and the second memory may reside on the remote accelerators or on other memory resources within the UALink domain.

In some implementations, the method further comprises translating, by the device, between a first address associated with a first address space utilized by the host and a second address associated with a second address space utilized by the UALink-based protocol; wherein the first address space comprises a Host Physical Address (HPA) space, and the second address space comprises a Network Physical Address (NPA) space or a System Physical Address (SPA) space. The address translation may be implemented utilizing lookup tables, page tables, base-and-offset calculations, or programmable translation functions. The HPA space may represent the host's view of the memory, while the NPA or SPA space may represent the address used by the UALink network for routing and accessing memory resources.

In some implementations of the method, at least one of the first memory region or the second memory region comprises a Host-managed Device Memory with Back-Invalidate (HDM-DB) region; and wherein the device sends a CXL.mem Subordinate-to-Master Back-Invalidate Snoop (S2M BISnp) to the host, and the host responds with a CXL.mem Master-to-Subordinate Back-Invalidate Response (M2S BIRsp). The HDM-DB region may enable the device to snoop the host's cache when the device needs to modify or evict cached data. The S2M BISnp may carry opcodes such as BISnpInv, BISnpData, or BISnpCur, and the M2S BIRsp may carry opcodes such as BIRspI, BIRspS, or BIRspE indicating the resulting host cache state. HDM-DB may be utilized with either CXL Type-2 or CXL Type-3 device flows.

In some implementations, the method further comprises receiving, from the host, a CXL.mem Master-to-Subordinate Request with Data (M2S RwD) comprising MemWr* and write data; translating the CXL.mem M2S RwD to a UPLI request comprising a write command and the write data; and sending a CXL.mem Subordinate-to-Master No Data Response (S2M NDR) to the host. The write command in the UPLI request may include Write or WriteFull commands. The device may send the S2M NDR before or after the UPLI write completes, depending on ordering requirements and system configuration.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages.

In computing systems where a host accesses memory resources on a device coupled via CXL, the device may expose memory regions with different coherency characteristics to the host. A first memory region associated with local memory, such as HBM, may be exposed via a CXL device type flow that supports device coherency, enabling the host and device to maintain coherent cached copies of data. A second memory region associated with memory accessible via a UALink port may be exposed via a different CXL device type flow that does not require device coherency participation. The device may include an RPU or translation logic configured to translate between CXL protocol messages and UPLI messages for memory access operations targeting the UALink-accessible memory. A UALink switch may couple the device to one or more remote accelerators whose memory resources form the second memory region.

In various implementations, a system comprising: a host; a device coupled to the host via a Compute Express Link (CXL) link; and a first memory coupled to the device; wherein the device is configured to expose to the host a first memory region via a first CXL device type flow and a second memory region via a second CXL device type flow, wherein the first CXL device type flow is different from the second CXL device type flow; wherein the first memory region is associated with the first memory; wherein the second memory region is associated with a second memory accessible via an Ultra Accelerator Link (UALink) port of the device; and wherein the device is configured to translate between a protocol based on CXL and UALink Protocol Level Interface (UPLI) for requests targeting at least one of the first memory region or the second memory region. The system may enable a host to access both local and remote memory resources on the device through a CXL link, with differentiated coherency semantics for different memory regions. The device may include an RPU, translation logic, or a combination of hardware and firmware that performs the translations between CXL and UPLI. The device may configure the boundaries between the first and second memory regions dynamically or statically, for example utilizing HDM decoder registers or programmable address range registers.

In some implementations of the system, the first CXL device type flow comprises a CXL Type-2 device flow and the first memory region comprises a Host-managed Device Memory with Device coherency (HDM-D) region, and the second CXL device type flow comprises a CXL Type-3 device flow and the second memory region comprises a Host-managed Device Memory with Host-only coherency (HDM-H) region. The CXL Type-2 device flow may enable the device to negotiate CXL.io, CXL.cache, and CXL.mem for the HDM-D region, while the CXL Type-3 device flow may negotiate CXL.io and CXL.mem for the HDM-H region. In some examples, the assignment of HDM types to memory regions may be configurable at system initialization or runtime.

In some implementations of the system, for CXL.mem requests targeting the first memory region, the device is configured to send a CXL.mem Subordinate-to-Master No Data Response (S2M NDR) comprising Cmp-S or Cmp-E indicating a cache state; and for CXL.mem requests targeting the second memory region, the device is configured to translate the CXL.mem requests to UPLI requests and send a CXL.mem Subordinate-to-Master Data Response (S2M DRS) comprising MemData. The differentiated response behavior may reflect the different coherency models of the first and second memory regions. For the first memory region, the Cmp-S or Cmp-E indication may inform the host of the cache state of the cacheline at the device. For the second memory region, the device may translate the request to UPLI, fetch the data from the UALink domain, and return the data.

In some implementations of the system, the host communicates with the device via CXL.mem and CXL.cache for the first memory region, and the host communicates with the device via CXL.mem without CXL.cache for the second memory region. The use of CXL.cache for the first memory region may enable the device to initiate coherency transactions and respond to host snoops, supporting scenarios where the device and host may both cache data from the first memory region. The absence of CXL.cache for the second memory region may simplify the memory access path for remote memory.

In some implementations of the system, the device comprises an accelerator comprising a resource provisioning unit (RPU), and the first memory comprises at least one of High Bandwidth Memory (HBM) or High-Bandwidth Flash (HBF) coupled to the accelerator; and further comprising a UALink switch coupling the UALink port of the device to one or more remote accelerators, wherein the second memory is accessible via the UALink switch. The RPU may be implemented as an IP block embedded within the accelerator, or as a chiplet within an IC package containing the accelerator. The UALink switch may route UPLI traffic based on destination accelerator identifiers carried in the UPLI requests. The one or more remote accelerators may each have their own HBM, HBF, or other memory that collectively forms the second memory accessible from the device.

In computing environments where a host, such as a CPU, accesses memory resources on a device coupled via CXL, the device may expose memory regions to the host with different connectivity. A first memory region may be backed by local memory coupled to the device, while a second memory region may be backed by memory accessible via an NVLink fabric, such as memory residing on GPUs or other NVLink-connected devices. NVLink provides high-bandwidth communication between GPUs and accelerators, and may support distributed memory models where devices access memory via other devices. The device may translate between CXL protocol messages received from the host and NVLink messages for accessing memory in the NVLink domain, while exposing different CXL device type flows for different memory regions to provide appropriate coherency semantics. NVLink messages may carry fields such as source and destination identifiers for routing, addresses for memory location, transaction tags for response correlation, length fields for transfer size, and data payloads.

In various implementations, a method comprising: exposing, by a device coupled to a host via a Compute Express Link (CXL) link, a first memory region via a first CXL device type flow and a second memory region via a second CXL device type flow, wherein the first CXL device type flow is different from the second CXL device type flow; wherein the first memory region is associated with a first memory; wherein the second memory region is associated with a second memory accessible via an NVLink-based protocol; and translating, by the device, between a protocol based on CXL and the NVLink-based protocol for at least one of the first memory region or the second memory region. The method may be implemented in hardware, firmware, software, or combinations thereof, and may be performed by various types of devices, such as an accelerator, an RPU, a semiconductor device, an active cable, or a chiplet within an IC package. The first and second CXL device type flows may correspond to any combination of CXL Type-2 and Type-3 device flows. Translations between CXL and NVLink may include translations of opcodes, addresses, transaction identifiers, and additional fields. NVLink messages may carry functional fields corresponding to source identifiers, destination identifiers, addresses, transaction tags, transfer lengths, and data payloads; the specific field names may vary across NVLink versions or implementations, and the translation may accommodate such variations. The first memory may include memory coupled to the device, such as HBM and/or HBF, while the second memory may include memory accessible via GPUs or other NVLink-connected devices. The device may be positioned in an active cable, in a module coupled to a CXL port, or within a computing platform, and may provide a bridge between the CXL domain and the NVLink domain. The elements may communicate through one or more intermediary components, such as an NVLink switch or other suitable entity that facilitates information transfer.

In some implementations of the method, the first CXL device type flow comprises a CXL Type-2 device flow and the first memory region comprises a Host-managed Device Memory with Device coherency (HDM-D) region, and the second CXL device type flow comprises a CXL Type-3 device flow and the second memory region comprises a Host-managed Device Memory with Host-only coherency (HDM-H) region; and wherein the device participates in cache coherency with the host for the first memory region and does not participate in cache coherency with the host for the second memory region. The CXL Type-2 device flow may enable the device to maintain cached copies of data from the first memory and to participate in coherency negotiations with the host via CXL.cache. The CXL Type-3 device flow for the HDM-H region may enable simpler passthrough access to NVLink-accessible memory without device coherency overhead.

In some implementations, the method further comprises receiving, from the host, a CXL.mem Master-to-Subordinate (M2S) request comprising MemRd* and a first address targeting the second memory region; translating the CXL.mem M2S request to an NVLink read request comprising a SourceID, a DestinationID, a second address, a Tag, and a Length; receiving an NVLink read response comprising *Data*; and sending to the host a CXL.mem Subordinate-to-Master Data Response (S2M DRS) comprising MemData and data from the NVLink read response. The SourceID may identify the device or RPU that originated the NVLink read request, while the DestinationID may identify the target entity, such as a GPU, in the NVLink fabric. The second address may be an NVLink network address that may be utilized to route the NVLink read request to its destination, and may go through additional address translation phases facilitated by one or more Link TLBs in the NVLink domain. The Tag may be a transaction identifier maintained by the device for correlating the NVLink read response with the original CXL.mem M2S request. The Length may indicate the requested transfer size. The *Data* in the NVLink read response may represent data carried in one or more response packets. Different NVLink versions or implementations may use different naming conventions for these functional fields; for example, a source identifier may alternatively be referred to as a requester identifier, a source node identifier, or a similar designation, and a destination identifier may alternatively be referred to as a target identifier, a destination node identifier, or a similar designation.

In some implementations, the method further comprises receiving, from the host, a CXL.mem Master-to-Subordinate (M2S) request comprising MemRd* and an address targeting the first memory region; accessing the first memory to obtain data; and sending to the host a CXL.mem Subordinate-to-Master No Data Response (S2M NDR) comprising Cmp-S or Cmp-E indicating a cache state of a cacheline at the address, and a CXL.mem Subordinate-to-Master Data Response (S2M DRS) comprising MemData and the data. For the first memory region, the device may access local memory, such as HBM and/or HBF, without performing protocol translation to NVLink. The device may respond with Cmp-S or Cmp-E based on the device's caching policy and the host's requested coherency state as indicated by SnpType and MetaValue fields in the M2S request.

In some implementations of the method, for the first memory region, the device communicates with the host via CXL.cache; and wherein the device issues CXL.cache Device-to-Host (D2H) requests to the host comprising an opcode selected from RdOwn, RdShared, RdCurr, or RdAny. The CXL.cache D2H requests may enable the device to initiate coherency transactions with the host for data in the first memory region, such as when the device needs to read or modify data that the host may have cached.

In some implementations, the method further comprises translating, by the device, between a first address associated with a Host Physical Address (HPA) space utilized by the host and a second address associated with an NVLink network address space utilized by the NVLink-based protocol. The address translation may be implemented utilizing lookup tables, page tables, base-and-offset calculations, or programmable translation functions. The NVLink network address may be utilized to route NVLink transactions to specific GPUs or memory resources within the NVLink fabric.

In some implementations of the method, a non-transitory computer-readable medium comprising instructions which, when executed by a processor, cause the processor to perform the method.

In computing systems where a host accesses memory resources on a device coupled via CXL, the device may expose memory regions with different connectivity and coherency models. A first memory region may be backed by local memory coupled to the device, and may be exposed via a CXL device type flow that supports device coherency. A second memory region may be backed by memory accessible via an NVLink port, such as memory residing on GPUs or other NVLink-connected devices, and may be exposed via a different CXL device type flow. The device may include an RPU or translation logic configured to translate between CXL protocol messages and NVLink messages for memory access operations targeting the NVLink-accessible memory. An NVLink switch, such as NVSwitch, may couple the device to one or more GPUs whose memory resources form the second memory region.

In various implementations, a system comprising: a host; a device coupled to the host via a Compute Express Link (CXL) link; and a first memory coupled to the device; wherein the device is configured to expose to the host a first memory region via a first CXL device type flow and a second memory region via a second CXL device type flow, wherein the first CXL device type flow is different from the second CXL device type flow; wherein the first memory region is associated with the first memory; wherein the second memory region is associated with a second memory accessible via an NVLink port of the device; and wherein the device is configured to translate between a protocol based on CXL and an NVLink-based protocol for requests targeting at least one of the first memory region or the second memory region. The system may enable a host to access both local and NVLink-domain memory resources on the device through a CXL link, with differentiated coherency semantics for different memory regions. The device may include an RPU, translation logic, or a combination of hardware and firmware that translate between CXL and the NVLink-based protocol. The device may be an accelerator, an RPU, a bridge device, or a component within an active cable positioned between the CXL domain and the NVLink domain. The device may configure the boundaries between the first and second memory regions dynamically or statically, for example utilizing HDM decoder registers or programmable address range registers. The system may be deployed in datacenter environments where CXL-enabled CPUs participate with NVLink GPUs in inference or training of AI models.

In some implementations of the system, the first CXL device type flow comprises a CXL Type-2 device flow and the first memory region comprises a Host-managed Device Memory with Device coherency (HDM-D) region, and the second CXL device type flow comprises a CXL Type-3 device flow and the second memory region comprises a Host-managed Device Memory with Host-only coherency (HDM-H) region. The CXL Type-2 device flow may enable the device to negotiate CXL.io, CXL.cache, and CXL.mem for the HDM-D region, while the CXL Type-3 device flow may negotiate CXL.io and CXL.mem for the HDM-H region.

In some implementations of the system, for CXL.mem requests targeting the first memory region, the device is configured to send a CXL.mem Subordinate-to-Master No Data Response (S2M NDR) comprising Cmp-S or Cmp-E indicating a cache state; and for CXL.mem requests targeting the second memory region, the device is configured to translate the CXL.mem requests to NVLink read requests and send a CXL.mem Subordinate-to-Master Data Response (S2M DRS) comprising MemData. The differentiated response behavior may reflect the different coherency models of the first and second memory regions. For the first memory region, the Cmp-S or Cmp-E indication may inform the host of the cache state maintained by the device. For the second memory region, the device may translate the request to an NVLink read request, receive data from the NVLink domain, and return the data to the host.

In some implementations of the system, the device comprises an accelerator or a resource provisioning unit (RPU), and the first memory comprises at least one of High Bandwidth Memory (HBM) or High-Bandwidth Flash (HBF) coupled to the device; and further comprising an NVLink switch coupling the NVLink port of the device to one or more GPUs, wherein the second memory is accessible via the NVLink switch. The NVLink switch may be an NVSwitch or similar switch device that provides high-bandwidth routing between the device and GPUs within an NVLink fabric. The one or more GPUs may each have their own HBM, HBF, or other memory that collectively forms the second memory accessible from the device via the NVLink port.

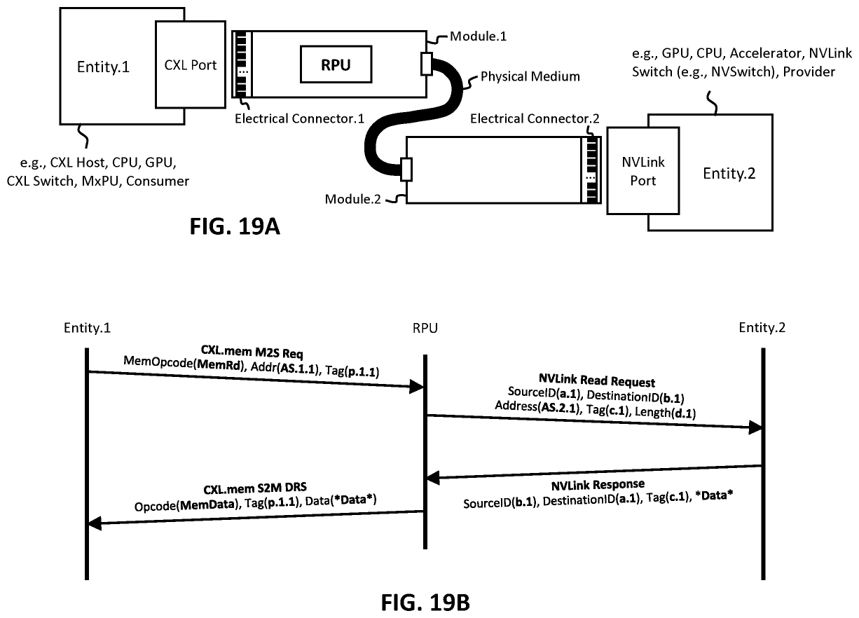

FIG. 19A illustrates an example of a system comprising an active cable that includes an RPU. The cable comprises a first pluggable module (Module.1) and a second pluggable module (Module.2) coupled by a Physical Medium. Module.1 includes the RPU and is coupled via a first electrical connector (Electrical Connector.1) to a CXL Port of a first entity (Entity.1). Module.2 is coupled via a second electrical connector (Electrical Connector.2) to an NVLink Port of a second entity (Entity.2). Entity.1 may be a CXL Host, CPU, GPU, CXL Switch, MxPU, or Consumer. Entity.2 may be a GPU, CPU, Accelerator, NVLink Switch (e.g., NVSwitch), or Provider. The RPU may be placed in various locations as a function of the requirements. In one example, the RPU is placed in Module.1 closer to the CXL Port of Entity.1, since CXL, which runs over PCIe electricals, is designed as a shorter-reach interface utilized for connecting devices to CPUs within a compute platform. Some versions of NVLink incorporate electrical signaling characteristics compatible with Ethernet and/or InfiniBand connectivity, designed for longer-reach interconnects that fit rack-level deployments and beyond. Placing the RPU closer to the CXL port may improve signal integrity. Additionally, NVLink typically utilizes a signaling rate higher than CXL, and consequently NVLink may require fewer lanes than CXL for the same bandwidth, which may allow for reducing the amount of copper wires or optical fibers in the Physical Medium.

FIG. 19B illustrates an example of a TFD demonstrating an RPU that translates between CXL.mem requests and NVLink requests. The TFD shows three entities: Entity.1/Consumer on the left, the RPU in the center, and Entity.2/Provider on the right. Entity.1 may send a CXL.mem M2S Req comprising MemOpcode(MemRd), Addr(AS.1.1), and Tag(p.1.1) to the RPU. Address (AS.1.1) may be an HPA of a Host, such as a CXL-enabled CPU coupled to the RPU. The RPU may translate the CXL.mem M2S Req to an NVLink Request Read comprising SourceID(a.1), DestinationID(b.1), Address(AS.2.1), Tag(c.1), and Length(d.1). Address (AS.2.1) may be an NVLink Network Address utilized to route the NVLink request to its destination on the NVLink fabric. In the response direction, Entity.2 may send an NVLink Response comprising SourceID(b.1), DestinationID(a.1), Tag(c.1), and *Data* to the RPU. The RPU may translate the NVLink Response to a CXL.mem S2M DRS comprising Opcode(MemData), Tag(p.1.1), and Data(*Data*), and may send the CXL.mem S2M DRS to Entity.1. The RPU may map the Tag from the NVLink response back to the original CXL.mem Tag (p.1.1) to enable proper transaction completion at Entity.1. In some examples, the NVLink Network Address may go through additional address translation phases, which may be facilitated by one or more Link TLBs residing on the transaction path. For example, in a GPU, a Link TLB may translate an NVLink Network Address to a GPU Physical Address that may reference memory resources integrated in or adjacent to the destination GPU. The RPU may perform another address translation to translate the HPA utilized by CXL.mem to the NVLink Network Address before the NVLink request is sent. Moreover, NVLink provides a distributed memory model where GPUs may access memory via other GPUs. This example provides a generic CXL.mem bridge/gateway for other, possibly non-NVLink compute elements, such as CPUs, to access memory residing on the NVLink Fabric, for example, where x86 GP-CPUs participate with NVLink GPUs in inference or training of AI models.

In computing environments where entities communicating according to CXL may need to access data or memory resources in a UALink domain, a computer such as an RPU may bridge the two protocol domains by translating between CXL and UPLI. The computer may include a cache that stores data fetched from the UALink domain, such that subsequent CXL requests targeting the same data may be served from the cache without requiring additional cross-protocol translation or remote data fetches. This caching behavior may reduce latency for repeated accesses, reduce traffic on the UALink network, and improve overall system throughput. The computer may perform the cache lookup based on an address or other identifier carried in the CXL request, and may translate opcodes, addresses, Tags, and additional fields between CXL and UPLI messages when the requested data is not present in the cache.

In various implementations, a method comprising: receiving, by a computer comprising a cache, a Compute Express Link (CXL) request from a first entity; performing, by the computer, a cache lookup based on the CXL request; responsive to a cache miss: translating, by the computer, the CXL request to an Ultra Accelerator Link Protocol Level Interface (UPLI) request; sending the UPLI request to a second entity; receiving, from the second entity, a UPLI response comprising data; storing the data in the cache; translating the UPLI response to a CXL response; and sending the CXL response comprising the data to the first entity; and responsive to a cache hit: sending a CXL response comprising data from the cache to the first entity without sending to the second entity a UPLI request corresponding to the CXL request. The method may be performed by an RPU, a semiconductor device, a bridge, or other computing apparatus positioned between the first entity and the second entity. The cache may include an on-chip SRAM cache, an embedded DRAM cache, or a portion of memory allocated for caching purposes. On a cache miss, the computer may translate CXL opcodes to corresponding UPLI commands, translate addresses between address spaces, and map CXL Tags to UPLI Tags. On a cache hit, the computer may generate the CXL response locally from the cached data, avoiding the latency and bandwidth overhead of a cross-protocol round trip. The first entity may include a CXL host, a CXL device, or a CXL accelerator. The second entity may include an accelerator, a UALink switch, or other UPLI-capable entity coupled via a UALink network.

In some implementations of the method, the CXL request comprises a CXL.cache Device-to-Host (D2H) request comprising a read opcode, and the CXL response comprises a CXL.cache Host-to-Device (H2D) response comprising a Global Observation (GO) opcode and a CXL.cache H2D Data message comprising the data; and wherein the first entity comprises a CXL device or a CXL accelerator, and the second entity comprises an accelerator coupled to the computer via a UALink network. The computer may act as a CXL host toward the first entity, receiving D2H requests and responding with H2D responses and H2D Data messages. Examples of read opcodes include RdOwn, RdShared, or RdAny. The GO opcode may indicate a cache state grant such as GO-S, GO-E, or GO-M.

In some implementations of the method, the CXL request comprises a CXL.mem Master-to-Subordinate (M2S) request comprising MemRd*, and the CXL response comprises a CXL.mem Subordinate-to-Master Data Response (S2M DRS) comprising MemData and the data; and wherein the first entity comprises a CXL host. The computer may act as a CXL subordinate device toward the CXL host, exposing a Host-managed Device Memory (HDM) region backed by the cache and UALink-accessible memory.

In some implementations of the method, the CXL request comprises a first address in a first address space, and the UPLI request comprises a second address in a second address space translated from the first address; and wherein the first address space comprises a host physical address (HPA) space and the second address space comprises a network physical address (NPA) space. The computer may perform address translation utilizing address range registers, translation tables, or algorithmic mappings. Additionally or alternatively, both addresses may be within the same address space, such as a global address space or a partitioned global address space (PGAS).

In some implementations, the method further comprises receiving, by the computer, a second CXL request comprising write data from the first entity; translating the second CXL request to a second UPLI request comprising a write command and the write data; sending the second UPLI request to the second entity; and responsive to the second CXL request, at least one of: storing the write data in the cache, or invalidating data in the cache corresponding to an address of the second CXL request. The UPLI write command may include a Write or WriteFull command. The computer may update the cache with the write data to maintain coherency, or may invalidate the corresponding cacheline to avoid stale data, depending on the cache coherency policy utilized by the computer.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages.

An apparatus may include a CXL port, a UALink port, a cache, and a computer coupled to the ports and the cache, enabling the apparatus to bridge CXL and UALink protocol domains while caching data to reduce cross-protocol traffic. The CXL port may expose a CXL Type-2 or Type-3 device interface to the first entity, while the UALink port may couple to a UALink network comprising one or more accelerators. The cache may be located within the computer, within the apparatus but external to the computer, or may include a dedicated region of memory accessible to the computer. The apparatus may be implemented as a discrete device, as a chiplet within a multi-die processing unit, or as an IP block within an accelerator or switch.

In various implementations, an apparatus comprising: a Compute Express Link (CXL) port configured to communicate with a first entity according to CXL; an Ultra Accelerator Link (UALink) port configured to communicate with a second entity according to an Ultra Accelerator Link Protocol Level Interface (UPLI); a cache; and a computer coupled to the CXL port, the UALink port, and the cache; wherein the computer is configured to: receive a CXL request from the first entity via the CXL port; perform a cache lookup based on the CXL request; responsive to a cache miss: translate the CXL request to a UPLI request, send the UPLI request to the second entity via the UALink port, receive a UPLI response comprising data from the second entity, store the data in the cache, translate the UPLI response to a CXL response, and send the CXL response comprising the data to the first entity via the CXL port; and responsive to a cache hit: send a CXL response comprising data from the cache to the first entity via the CXL port without sending to the second entity a UPLI request corresponding to the CXL request. The apparatus may be implemented as an RPU, a bridge device, a semiconductor device, or other hardware positioned between the first entity and the second entity. The CXL port may support one or more CXL sub-protocols including CXL.cache, CXL.mem, and CXL.io. The UALink port may support UPLI commands including Read, Write, WriteFull, and Atomic operations. The cache may be indexed by address, and the computer may perform the cache lookup by comparing the address of the CXL request against tags stored in the cache. On a cache hit, the computer may generate the CXL response locally, avoiding the translation and network latency of a cross-protocol round trip.

In some implementations of the apparatus, the CXL port is further configured to communicate according to CXL.cache, the CXL request comprises a CXL.cache Device-to-Host (D2H) request comprising a read opcode selected from RdOwn, RdShared, or RdAny, and the CXL response comprises a CXL.cache Host-to-Device (H2D) response comprising a Global Observation (GO) opcode and a CXL.cache H2D Data message; and wherein the first entity comprises a CXL device, the second entity comprises an accelerator, and the computer comprises a resource provisioning unit (RPU). RdOwn may request data for exclusive ownership, RdShared may request data for shared state, and RdAny may allow the host to determine the granted state. The GO opcode in the H2D response may be selected by the second entity based on the read opcode and its coherency state tracking for the cacheline.

In some implementations of the apparatus, the computer is further configured to: receive, via the CXL port, a CXL.cache Host-to-Device (H2D) request comprising a snoop opcode targeting a cacheline; invalidate the cacheline responsive to the snoop opcode; and send, via the CXL port, a CXL.cache Device-to-Host (D2H) response comprising an opcode selected from RspIHitSE or RspIHitI. The snoop opcode may include SnpInv, SnpData, or SnpCur. The cache operation may include invalidating a cacheline, downgrading a cacheline from a higher state to Shared, or retaining the current cacheline state, depending on the snoop opcode and the cacheline state at the time the snoop is received. Rsp* may include RspIHitSE, RspIHitI, RspSHitSE, or RspVHitV, and may be selected based on the snoop opcode and the cacheline state. In some examples, the computer may also send a D2H Data message together with the D2H response, such as when the snoop opcode is SnpData and the computer forwards cached data to the second entity.

In some implementations of the apparatus, the computer is further configured to evict data from the cache according to an eviction policy comprising at least one of: a least recently used (LRU) replacement policy, a capacity-based eviction threshold, or a timer-based invalidation interval. Timer-based invalidation may be utilized when the computer caches data transparently without host coherency tracking, such as when utilizing RdCurr. The eviction policy may combine strategies, for example utilizing LRU replacement with a maximum capacity threshold.

In some implementations of the apparatus, the CXL port is further configured to communicate according to CXL.mem, the CXL request comprises a CXL.mem Master-to-Subordinate (M2S) request comprising MemRd*, and the CXL response comprises a CXL.mem Subordinate-to-Master Data Response (S2M DRS) comprising MemData; and wherein the first entity comprises a CXL host. The apparatus may expose an HDM region to the CXL host via CXL.mem, wherein the HDM region is backed by the cache and UALink-accessible memory. The CXL host may access the HDM region using standard CXL.mem read operations.

In some implementations of the apparatus, the apparatus comprises a multi-die processing unit, the computer comprises a resource provisioning unit (RPU) chiplet within the multi-die processing unit, and the CXL port is coupled to a CXL root port of the multi-die processing unit via a coherent interconnect within the multi-die processing unit. The multi-die processing unit may include chiplets coupled via the coherent interconnect, such as compute chiplets, I/O chiplets, and the RPU chiplet. The CXL root port may provide a CXL host interface for communicating with external CXL devices or hosts.

In environments where entities communicating according to UPLI, such as accelerators coupled via a UALink network, may need to access data or memory resources in a CXL domain, such as memory coupled to a CXL host or CXL memory devices, a computer such as an RPU may bridge the two protocol domains by translating between UPLI and CXL. The computer may include a cache that stores data fetched from the CXL domain, such that subsequent UPLI requests targeting the same data may be served from the cache without requiring additional cross-protocol translation or remote data fetches. This may be particularly beneficial for workloads involving repeated accesses to the same data, such as artificial intelligence (AI) inference workloads where accelerators may access shared model weights, key-value (KV) cache entries, or attention parameters stored in CXL-attached memory.

The computer may utilize different CXL opcodes when translating UPLI requests depending on the source of the request and the desired coherency behavior. For example, requests originating from a UALink network may be translated using a non-coherent opcode such as RdCurr, wherein the CXL host is unaware of the cached copy, while requests originating from local compute units within the same accelerator may be translated using a coherent opcode such as RdShared, wherein the CXL host tracks the cache state and may issue snoops to maintain coherency.

In various implementations, a method comprising: receiving, by a computer comprising a cache, an Ultra Accelerator Link Protocol Level Interface (UPLI) request comprising a read command from a first entity; performing, by the computer, a cache lookup based on the UPLI request; responsive to a cache miss: translating, by the computer, the UPLI request to a Compute Express Link (CXL) request; sending the CXL request to a second entity; receiving, from the second entity, a CXL response comprising data; storing the data in the cache; translating the CXL response to a UPLI read response; and sending the UPLI read response comprising the data to the first entity; and responsive to a cache hit: sending a UPLI read response comprising data from the cache to the first entity without sending to the second entity a CXL request corresponding to the UPLI request. The method may be performed by an RPU, a semiconductor device, a bridge, or other computing apparatus positioned between the first entity and the second entity. On a cache miss, the computer may translate the UPLI read command to a CXL read opcode, translate addresses between address spaces such as NPA and HPA, and map UPLI ReqTags to CXL Tags or CQIDs. The UPLI read response may include a RdRsp carrying RdRspData and RdRspTag. On a cache hit, the computer may construct the UPLI read response locally from the cached data, populating the RdRspTag from the original UPLI request and providing the cached data as RdRspData, thereby avoiding cross-protocol translation and CXL network latency. The first entity may include an accelerator, a UALink switch, or other UPLI-capable entity. The second entity may include a CXL host, a CXL device, or a CXL memory device.

In some implementations of the method, the CXL request comprises a CXL.cache Device-to-Host (D2H) request comprising RdShared, and the CXL response comprises a CXL.cache Host-to-Device (H2D) response comprising GO-S and a CXL.cache H2D Data message comprising the data; and further comprising transitioning, by the computer, a cacheline state in the cache from Invalid (I) to Shared(S) responsive to storing the data in the cache. RdShared requests the cacheline in Shared state, allowing the second entity to retain its own cached copy. The GO-S response grants Shared state to the computer, making the second entity aware of the cached copy and enabling the second entity to issue snoops when coherency actions are needed.

In some implementations of the method, the CXL request comprises a CXL.cache Device-to-Host (D2H) request comprising RdCurr, and the CXL response comprises a CXL.cache Host-to-Device (H2D) Data message comprising the data; and wherein storing the data in the cache is transparent to the second entity such that the second entity does not maintain a coherency state for the data stored in the cache. RdCurr retrieves data without establishing a tracked coherency state at the second entity. Because the second entity is unaware of the cached copy, the computer may manage invalidation internally utilizing timer-based expiration, capacity-based eviction, or software-directed invalidation.

In some implementations of the method, the UPLI request is received from the first entity via a UALink network, and the CXL request comprises a first CXL opcode selected based on the UPLI request being received via the UALink network; and further comprising translating, by the computer, a request received from a local compute unit (CU) of an accelerator to a second CXL request comprising a second CXL opcode different from the first CXL opcode. For example, requests from the UALink network may be translated to RdCurr for non-coherent access, while requests from local CUs may be translated to RdShared for coherent caching. The local CU may include a streaming multiprocessor (SM), a compute engine, or other processing element within the accelerator.

In some implementations, the method further comprises receiving, from the second entity, a CXL.cache Host-to-Device (H2D) request comprising SnpInv targeting the data stored in the cache; transitioning the cacheline state in the cache from Shared(S) to Invalid (I); and sending, to the second entity, a CXL.cache Device-to-Host (D2H) response comprising RspIHitSE. SnpInv may be issued by the second entity when another agent requests exclusive ownership of the cacheline. The RspIHitSE response indicates that the cacheline was found in a clean state and has been invalidated, allowing the second entity to grant exclusive ownership to the requesting agent.

In some implementations of the method, the CXL request comprises a CXL.mem Master-to-Subordinate (M2S) request comprising MemRd*, and the CXL response comprises a CXL.mem Subordinate-to-Master Data Response (S2M DRS) comprising MemData and the data; and wherein the second entity comprises a CXL memory device. The CXL memory device may include a CXL memory expander, a CXL memory pool, or a GFD. The computer may act as a CXL master toward the CXL memory device, initiating M2S requests and receiving S2M data responses.

In some implementations of the method, the data stored in the cache comprises inference model data associated with an artificial intelligence (AI) model, the inference model data comprising at least one of: model weight parameters, key-value (KV) cache entries, activation data, or attention matrix coefficients. AI inference workloads may involve repeated access to the same model data by accelerators. Caching inference model data at the computer may reduce repeated cross-protocol fetches, lowering latency and reducing bandwidth consumption on both the CXL and UALink networks.

In some implementations of the method, the first entity comprises an accelerator comprising a local memory, and the second entity provides access to a CXL-attached memory; and wherein the cache provides an intermediate memory tier between the local memory of the first entity and the CXL-attached memory, the cache having a lower access latency for the data than the CXL-attached memory. The local memory may include HBM or other high-bandwidth memory coupled directly to the accelerator. The cache may mitigate the memory wall by providing faster access to frequently used data that does not fit in the local memory, without incurring the full latency of CXL-attached memory access.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages.

An apparatus may include a UALink port, a CXL port, a cache, and a computer coupled to the ports and the cache, enabling the apparatus to bridge UALink and CXL protocol domains while caching data to reduce cross-protocol traffic. The UALink port may couple to a UALink network comprising one or more accelerators, while the CXL port may couple to a CXL host, a CXL device, or a CXL memory device. The computer may utilize different CXL sub-protocols depending on the second entity, for example utilizing CXL.cache D2H requests when communicating with a CXL host, or utilizing CXL.mem M2S requests when communicating with a CXL memory device. The cache may support coherent caching with host-tracked states, transparent caching without host awareness, or both, depending on the CXL opcode utilized for the data fetch.

In various implementations, an apparatus comprising: an Ultra Accelerator Link (UALink) port configured to communicate with a first entity according to an Ultra Accelerator Link Protocol Level Interface (UPLI); a Compute Express Link (CXL) port configured to communicate with a second entity according to CXL; a cache; and a computer coupled to the UALink port, the CXL port, and the cache; wherein the computer is configured to: receive a UPLI request comprising a read command from the first entity via the UALink port; perform a cache lookup based on the UPLI request; responsive to a cache miss: translate the UPLI request to a CXL request, send the CXL request to the second entity via the CXL port, receive a CXL response comprising data from the second entity, store the data in the cache, translate the CXL response to a UPLI read response, and send the UPLI read response comprising the data to the first entity via the UALink port; and responsive to a cache hit: send a UPLI read response comprising data from the cache to the first entity via the UALink port without sending to the second entity a CXL request corresponding to the UPLI request. The apparatus may be implemented as an RPU, a bridge device, a semiconductor device, or other hardware positioned between the first entity and the second entity. The CXL port may support one or more CXL sub-protocols including CXL.cache, CXL.mem, and CXL.io. The UALink port may support UPLI commands including Read, Write, WriteFull, and Atomic operations. On a cache hit, the computer may construct the UPLI read response locally by populating the RdRspTag from the original UPLI request and providing the cached data as RdRspData, thereby avoiding cross-protocol translation and CXL network latency. The UPLI read command may include a Read command or a Read Class Vendor Defined Command.

In some implementations of the apparatus, the CXL port is further configured to communicate according to CXL.cache, the CXL request comprises a CXL.cache Device-to-Host (D2H) request comprising RdShared, and the CXL response comprises a CXL.cache Host-to-Device (H2D) response comprising GO-S and a CXL.cache H2D Data message; and wherein the first entity comprises an accelerator, the second entity comprises a CXL host, and the computer comprises a resource provisioning unit (RPU). The RPU may act as a CXL.cache device toward the CXL host, issuing D2H requests and receiving H2D responses. The GO-S grant makes the CXL host aware of the cached copy, enabling the host to issue snoops when coherency actions are needed for the cached data.

In some implementations of the apparatus, the CXL port is further configured to communicate according to CXL.cache, the CXL request comprises a CXL.cache Device-to-Host (D2H) request comprising RdCurr, and the CXL response comprises a CXL.cache H2D Data message; and wherein storing the data in the cache is transparent to the second entity such that the second entity does not maintain a coherency state for the data stored in the cache; and wherein the first entity comprises an accelerator and the second entity comprises a CXL host. RdCurr returns data without a GO response, leaving the CXL host unaware of the cached copy. The computer may manage cache validity internally utilizing eviction policies such as timer-based invalidation, capacity-based eviction, or software-directed invalidation.

In some implementations of the apparatus, the computer is further configured to: transition a state of a cacheline in the cache from Invalid (I) to Shared(S) responsive to receiving a CXL.cache H2D response comprising GO-S from the second entity; transition the state of the cacheline from Shared(S) to Invalid (I) responsive to receiving a CXL.cache Host-to-Device (H2D) request comprising SnpInv from the second entity; and transition the state of the cacheline from Invalid (I) to Exclusive (E) or from Invalid (I) to Modified (M) responsive to receiving a CXL.cache H2D response comprising GO-E or GO-M from the second entity. The cache state transitions may follow MESI protocol semantics. GO-E or GO-M may be granted by the CXL host when no other agent holds a cached copy of the cacheline, or when the host determines that exclusive or modified state is appropriate based on the access pattern.

In some implementations of the apparatus, the UPLI request comprises a first address in a first address space, and the CXL request comprises a second address in a second address space translated from the first address; and wherein the first address space comprises a network physical address (NPA) space and the second address space comprises a host physical address (HPA) space. The computer may perform address translation utilizing address range registers, translation tables, or algorithmic mappings. Additionally or alternatively, both addresses may be within the same address space, such as a global address space or a partitioned global address space.

In some implementations of the apparatus, the CXL port is further configured to communicate according to CXL.mem, the CXL request comprises a CXL.mem Master-to-Subordinate (M2S) request comprising MemRd*, and the CXL response comprises a CXL.mem Subordinate-to-Master Data Response (S2M DRS) comprising MemData; and wherein the second entity comprises a CXL memory device. The CXL memory device may include a CXL memory expander, a CXL memory pool, or a GFD. The computer may act as a CXL master toward the CXL memory device, caching retrieved data to reduce repeated accesses across the CXL link.

In some implementations of the apparatus, the apparatus comprises a multi-die processing unit, the computer comprises a resource provisioning unit (RPU) chiplet within the multi-die processing unit, and the CXL port is coupled to a CXL root port of the multi-die processing unit via a coherent interconnect within the multi-die processing unit. The multi-die processing unit may include chiplets coupled via the coherent interconnect, such as compute chiplets, I/O chiplets, and the RPU chiplet. The CXL root port may provide a CXL host interface for communicating with external CXL devices or hosts.

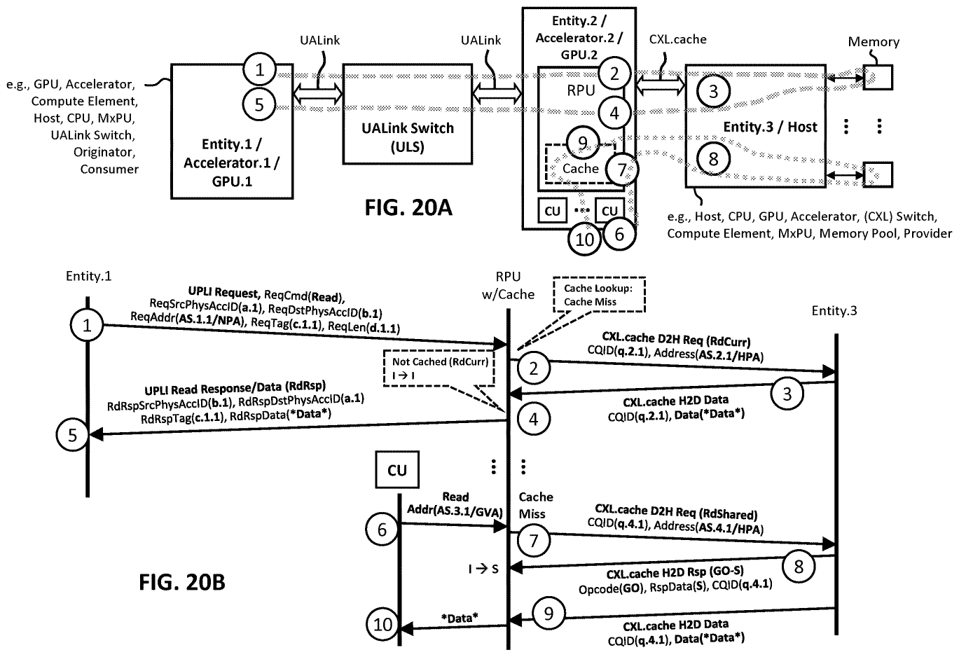

FIG. 20A illustrates an example of a system comprising a first entity (Entity.1/Accelerator.1/GPU.1), a UALink Switch (ULS), a second entity (Entity.2/Accelerator.2/GPU.2) comprising an RPU with a cache, and a third entity (Entity.3/Host) coupled to a memory. Entity.1 may include a GPU, an accelerator, a compute element, a host, a CPU, a multi-die processing unit, a UALink switch, an originator, or a consumer. Entity.3 may include a host, a CPU, a GPU, an accelerator, a CXL switch, a compute element, a multi-die processing unit, a memory pool, or a provider. Entity.1 is coupled to the UALink Switch via a UALink connection. The UALink Switch is coupled to Entity.2 via a UALink connection. Entity.2 comprises the RPU, which is coupled to Entity.3 via a CXL.cache connection. Entity.3 is coupled to a memory. FIG. 20B illustrates an example of a TFD demonstrating how an RPU comprising a cache (RPU w/Cache) may differentiate between requests received from different sources and translate the requests to CXL.cache D2H requests comprising different opcodes based on the source of the request. The TFD shows two transaction sequences: a UALink network request sequence translated to RdCurr, and a local compute unit (CU) request sequence translated to RdShared.

In the UALink network request sequence (denoted by Circles 1 through 5), Entity.1 sends a UPLI request (Req) comprising a read command (ReqCmd(Read)), a source physical accelerator identifier (ReqSrcPhysAccID(a.1)), a destination physical accelerator identifier (ReqDstPhysAccID(b.1)), a request address in network physical address space (ReqAddr(AS.1.1/NPA)), a request tag (ReqTag(c.1.1)), and a request length (ReqLen(d.1.1)) to the RPU (Circle 1). The RPU performs a cache lookup and determines a cache miss. Responsive to the cache miss, the RPU translates the UPLI request to a CXL.cache D2H request comprising RdCurr, a CQID(q.2.1), and an address in host physical address space (Address(AS.2.1/HPA)) (Circle 2). The RPU may perform address translation from the NPA space (AS.1.1/NPA) to the HPA space (AS.2.1/HPA). In some examples, the RPU may perform intermediate address translations, such as NPA to SPA (System Physical Address) to HPA. Entity.3 responds with a CXL.cache H2D Data message comprising CQID(q.2.1) and the requested data (Data(*Data*)) (Circle 3). Because RdCurr is utilized, Entity.3 does not send a GO response, and the data is not cached in a host-tracked coherency state. The annotation “Not Cached (RdCurr)” and the I to I transition (Circle 4) indicate that the RPU may cache the data transparently without Entity.3 maintaining a coherency state for the cached copy, or may not cache the data at all. The RPU translates the CXL.cache H2D Data to a UPLI read response/data (RdRsp) comprising RdRspSrcPhysAccID(b.1), RdRspDstPhysAccID(a.1), RdRspTag(c.1.1), and RdRspData(*Data*), and sends the UPLI RdRsp to Entity.1 (Circle 5).

In the local CU request sequence (denoted by Circles 6 through 10), a compute unit (CU) within the accelerator sends a read request comprising an address in a local address space, such as a guest virtual address (GVA) space (Addr(AS.3.1/GVA)), to the RPU (Circle 6). The RPU performs a cache lookup and determines a cache miss (Circle between 6 and 7). Responsive to the cache miss, the RPU translates the CU request to a CXL.cache D2H request comprising RdShared, a CQID(q.4.1), and an address in host physical address space (Address(AS.4.1/HPA)) (Circle 7). The RPU may perform address translation from the GVA space (AS.3.1/GVA) to the HPA space (AS.4.1/HPA). Entity.3 responds with a CXL.cache H2D response comprising GO-S, a response data value (RspData(S)) indicating Shared state, and CQID(q.4.1) (Circle 8), followed by a CXL.cache H2D Data message comprising CQID(q.4.1) and the requested data (Data(*Data*)) (Circle 9). The RPU stores the data in the cache and transitions the cacheline state from Invalid (I) to Shared(S) (denoted by the I to S transition between Circles 7 and 9). The RPU provides the requested data to the CU (Circle 10).

The opcode differentiation between RdCurr for UALink network requests and RdShared for local CU requests reflects the different coherency requirements of each source. Requests from the UALink network may be I/O-coherent and may not benefit from host-tracked caching, and thus the RPU may translate them to RdCurr, which retrieves data without establishing a tracked coherency state at Entity.3. Requests from local CUs may be related to the accelerator's cache hierarchy and may benefit from coherent caching, and thus the RPU may translate them to RdShared, which establishes a Shared state tracked by Entity.3 and enables Entity.3 to issue snoops when coherency actions are needed.

In environments where entities may utilize different protocols while requiring coordinated access to shared resources, there may be scenarios where a first entity communicating according to CXL, such as a CXL host, a CXL device, or a CXL accelerator, needs to access resources residing in a UALink domain, such as memory coupled to accelerators or accessible via a UALink network. The CXL entity may communicate according to CXL.cache, CXL.mem, or CXL.io, while the UALink entity may communicate according to an UPLI. A computer, such as an RPU, a bridge, a switch, or a semiconductor device, may translate between CXL and UPLI to facilitate memory operations, data transfers, and resource sharing across the CXL and UALink protocol domains while maintaining the requirements of each protocol. The translation may involve converting CXL requests to UPLI requests, and converting UPLI responses to CXL responses, including translations of opcodes, commands, addresses, Tags, and/or additional fields.

In various implementations, a method comprising: receiving, by a computer, a Compute Express Link (CXL) request from a first entity, the CXL request comprising a first address; translating, by the computer, the CXL request to an Ultra Accelerator Link Protocol Level Interface (UPLI) request comprising a second address; sending the UPLI request to a second entity; receiving, from the second entity, a UPLI response; translating, by the computer, the UPLI response to a CXL response; and sending the CXL response to the first entity. The method may encompass translation from any CXL protocol channel to UPLI. The computer may translate opcodes, commands, TLP types, addresses, Tags, and additional fields between the CXL-based protocol domain and the UALink-based protocol domain. The method may be implemented in hardware, firmware, software, or combinations thereof, and may be performed by various types of devices, such as an RPU, a switch, a bridge, a semiconductor device, a Fabric Processing Unit (FPU), a Fabric NIC, or other suitable intermediary components. The first and second addresses may indicate the same address or indicate different addresses. In some examples, the computer may issue multiple UPLI request in response to receiving a CXL request from the first entity, such as when prefetching data from the second entity.

In some implementations of the method, the CXL request comprises a CXL.cache Device-to-Host (D2H) request comprising a read opcode selected from RdCurr, RdShared, RdOwn, or RdAny, and a command queue identifier (CQID); and wherein the UPLI request comprises a read command, a ReqTag, a ReqSrcPhysAccID, and a ReqDstPhysAccID; and wherein the CXL response comprises a CXL.cache Host-to-Device (H2D) response and a CXL.cache H2D Data. The CXL.cache D2H request path may be utilized when the first entity is a CXL device that sends D2H requests to the computer acting as CXL host. The computer may translate D2H read opcodes to UPLI read commands and may return an H2D response, such as GO with appropriate MESI state, and H2D Data carrying the fetched data to the first entity.

In some implementations of the method, the CXL request comprises a CXL.mem Master-to-Subordinate (M2S) request comprising MemRd* and a Tag, and the UPLI request comprises a read command and a ReqTag; and wherein the CXL response comprises a CXL.mem Subordinate-to-Master Data Response (S2M DRS) comprising MemData and the Tag. The CXL.mem path may be utilized when the first entity communicates via the CXL.mem M2S channel. The MemRd* opcode may include MemRd, MemRdData, or other read variants defined by the CXL.mem specification. The S2M DRS may carry the requested data with the MemData opcode and the Tag for correlation with the original M2S request.

In some implementations of the method, the CXL request comprises a CXL.io Memory Read (MRd) request comprising a first Tag, and the UPLI request comprises a read command and a ReqTag; and wherein the CXL response comprises a CXL.io Completion with Data (CplD) comprising the first Tag. The CXL.io path may be utilized when the first entity communicates via CXL.io transactions. The MRd request may include address and Tag fields, and the CplD completion may carry the requested data with the first Tag for correlation.

In some implementations of the method, the first address belongs to a first address space and the second address belongs to a second address space different from the first address space; wherein the first address space comprises a Host Physical Address (HPA) space, and the second address space comprises a Network Physical Address (NPA) space. Address translation may be performed utilizing lookup tables, base-and-offset calculations, or programmable translation functions. HPA addresses utilized by CXL-based traffic may be translated to NPA addresses utilized by UALink-based traffic for routing within the UALink network. In other examples, the first address space and the second address space may be associated with the same address space, such as a global address space, a pod address space, or a fabric address space.

In some implementations of the method, the CXL request comprises a CXL transaction identifier, the UPLI request comprises a ReqTag, the UPLI response comprises a RdRspTag matching the ReqTag, and the CXL response comprises the CXL transaction identifier; and wherein the computer maintains a mapping between the CXL transaction identifier and the ReqTag. The CXL transaction identifier may include a CXL.io Tag, a CXL.mem Tag, a CXL.cache CQID, or a CXL.cache UQID. The bidirectional mapping may be stored in a translation table, a tracker entry, or similar data structure to enable proper correlation of UPLI responses with their corresponding CXL requests.

In some implementations of the method, the CXL request comprises write data, the UPLI request comprises a write command, and translating the CXL request further comprises sending originator data comprising the write data on a UPLI Originator Data (OrigData) channel; and wherein the UPLI response comprises a UPLI write response (WrRsp) comprising a WrRspTag and a WrRspStatus. Write translation may enable the first entity to store data in memory accessible to the second entity across the CXL and UALink protocol domain boundaries. The WrRspStatus may indicate success or failure of the write operation. The OrigData channel may carry the write data in one or more beats from the computer to the second entity.

In some implementations of the method, the first entity comprises at least one of: a CXL host, a CXL device, or a CXL accelerator; and wherein the second entity comprises an accelerator coupled to a UALink network; and wherein the computer comprises a resource provisioning unit (RPU). The RPU may translate between CXL and UPLI domains and may be implemented as a discrete component, an IP block embedded in a processor, or a chiplet within an IC package. The first entity type may determine which CXL channel and message direction is utilized for the translation.

In some implementations of the method, a transfer size indicated by the CXL request differs from a maximum transfer size of a single UPLI request; and wherein translating the CXL request comprises generating UPLI requests or consolidating CXL requests into a UPLI request. UPLI may support transfer sizes up to 256 bytes per request while CXL.cache transactions may handle up to 64 bytes each. The computer may split or consolidate transactions to accommodate the transfer size differences between the two protocol domains, and may manage the transactions while maintaining the appearance of a single operation to the initiating entity.

In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

In heterogeneous computing architectures, entities on different protocol domains may need to access resources across protocol boundaries. An apparatus comprising a CXL interface and a UPLI interface may provide bidirectional translation capability, enabling CXL entities to access UALink resources and UALink entities to access CXL device resources. The apparatus may include a computer that translates CXL requests to UPLI requests in one direction, and UPLI requests to CXL.cache H2D requests (snoops) in the other direction, thereby bridging the two protocol domains. The apparatus may be implemented as a switch, a bridge, a semiconductor device, a chiplet within an IC package, or other suitable form factor.

In various implementations, an apparatus comprising: a first interface configured to communicate according to Compute Express Link (CXL) with a first entity; a second interface configured to communicate according to an Ultra Accelerator Link Protocol Level Interface (UPLI) with a second entity; and a computer coupled between the first interface and the second interface, the computer configured to: translate a CXL request received from the first entity via the first interface to a UPLI request transmitted to the second entity via the second interface; and translate a UPLI response received from the second entity via the second interface to a CXL response transmitted to the first entity via the first interface. The apparatus may provide translation between CXL and UPLI for various CXL channels, including CXL.cache, CXL.mem, and CXL.io. The first interface may expose the computer as a CXL host, a CXL device, or a CXL Type-2 device to the first entity, depending on the system configuration. The second interface may communicate with the second entity utilizing a UPLI completer or originator interface. The computer may include translation logic, address translation tables, Tag mapping structures, and pending transaction trackers. In some examples, the apparatus may be implemented in an IC package having high-speed differential I/O balls positioned according to a ball grid array layout defined by a retimer specification, may utilize UCIe for die-to-die connectivity, or may be implemented as a chiplet within an IC package.

In some implementations of the apparatus, the first interface is further configured to receive CXL.cache Device-to-Host (D2H) requests from the first entity, the first entity comprising a CXL device; and wherein the computer is further configured to translate a CXL.cache D2H request comprising a read opcode and a CQID to a UPLI request comprising a read command and a ReqTag. The CXL device may be a CXL accelerator, a CXL memory expander, or a GFD. The computer acting as CXL host may translate D2H read opcodes such as RdCurr, RdShared, or RdOwn to UPLI read commands, and may return H2D responses and H2D Data to the CXL device after receiving the UPLI response.

In some implementations of the apparatus, the computer is further configured to: translate a UPLI request received from the second entity via the second interface to a CXL.cache Host-to-Device (H2D) request comprising a snoop opcode selected from SnpCur, SnpData, or SnpInv, and transmit the CXL.cache H2D request to the first entity via the first interface; and translate a CXL.cache D2H response and a CXL.cache D2H Data received from the first entity via the first interface to a UPLI read response (RdRsp), and transmit the UPLI RdRsp to the second entity via the second interface. The bidirectional capability may enable UALink entities to access resources associated with a CXL device. The computer may translate D2H responses such as RspVFwdV (in response to SnpCur) or RspSFwdM (in response to SnpData) to UPLI RdRsp messages for the second entity, and may map UQID values from H2D requests to corresponding UPLI ReqTag values in the RdRsp.

In some implementations of the apparatus, the computer is further configured to select the snoop opcode according to at least one of: a cacheline state intent identified based on the UPLI request, or a caching policy; wherein SnpData is selected for a cacheline intended to be cached in shared or exclusive state, and SnpCur is selected for reading current data without requiring a change of cache state. SnpCur may be selected for non-state-changing reads, such as I/O-coherent operations from the UALink network, while SnpData may be selected when the computer intends to cache the data locally. The caching policy may be configurable and may vary based on the source or characteristics of the UPLI request.

In some implementations of the apparatus, the computer comprises a resource provisioning unit (RPU) implemented as a chiplet within an integrated circuit (IC) package of a processor, the processor further comprising a CXL root port (RP) coupled to an on-chip coherent interconnect; and wherein the RPU is configured to translate a UPLI request received from the second entity via the second interface to a CXL.cache D2H request transmitted to the CXL RP. The RPU chiplet may expose a UALink port to external entities and a CXL endpoint to the processor's CXL RP. An R2CXL interface within the RPU may communicate with the on-chip coherent interconnect, such as ARM CHI, Intel UPI, or AMD Infinity Fabric. The RPU may be implemented on a separate die within the IC package or as a functional block on the processor die.

In some implementations of the apparatus, the computer comprises or controls a cache; and wherein the computer is configured to perform a cache lookup based on the CXL request and, on a cache hit, to generate the CXL response from the cache without transmitting the UPLI request to the second entity. The cache may store recently accessed data from either the CXL or UPLI domain, reducing latency for repeated accesses. On a cache miss, the computer may proceed with the UPLI translation path. The cache may be internal to the computer or external but controlled by the computer, and may store cachelines associated with the NPA space or the HPA space.

In AI inference systems, accelerators may execute inference workloads on neural network models that require access to model data distributed across accelerators. When a first accelerator communicating according to CXL needs to access model data stored in the memory of a second accelerator communicating according to UPLI, a computer may translate between CXL and UPLI to enable cross-protocol access. This translation may enable CXL-connected accelerators to access weight parameters, activation tensors, embedding vectors, key-value cache entries, and other model data residing on UALink-connected accelerators, supporting disaggregated inference architectures where model data is distributed across heterogeneous compute elements coupled via different interconnect protocols.

In various implementations, a method comprising: executing, by a first accelerator, an inference workload on a neural network model; sending, by the first accelerator, a Compute Express Link (CXL) request for model data stored in a memory of a second accelerator, the CXL request comprising a first address; translating, by a computer, the CXL request to an Ultra Accelerator Link Protocol Level Interface (UPLI) request comprising a second address; sending the UPLI request to the second accelerator; receiving, from the second accelerator, a UPLI response comprising the model data; translating, by the computer, the UPLI response to a CXL response comprising the model data; and sending the CXL response to the first accelerator. The method may enable a CXL-connected accelerator to access model data stored in the memory of a UALink-connected accelerator without requiring both accelerators to utilize the same interconnect protocol. The first accelerator may be a CXL device, a CXL accelerator, or another CXL-connected compute element that executes inference computation and generates requests for model data. The second accelerator may be a GPU, a TPU, or another accelerator coupled to a UALink network, wherein the model data resides in the second accelerator's local memory, such as HBM and/or HBF. The computer may translate between CXL requests and UPLI requests, including address translations between address spaces utilized by the CXL and UALink domains, opcode translations, and Tag translations. The neural network model may include a transformer-based model, a convolutional neural network, a recurrent neural network, a mixture-of-experts model, a hybrid attention and state-space model, a multimodal model, or other model architectures utilized for inference. The method may be implemented in hardware, firmware, software, or combinations thereof.

In some implementations of the method, the model data comprises at least one of: weight parameters, activation tensors, embedding vectors, or attention parameters associated with the neural network model. Different model data types may be stored across accelerators based on memory capacity, bandwidth requirements, and access patterns. Weight parameters and embedding vectors may be pre-loaded, while activation tensors and attention parameters may be generated and accessed dynamically during inference computation.

In some implementations of the method, the neural network model comprises a mixture-of-experts (MoE) model comprising a gating network and expert sub-networks, and wherein the model data comprises weight parameters of at least one expert sub-network; and wherein the CXL request is sent based on a routing decision of the gating network indicating that the at least one expert sub-network is to be activated. MoE models may have more expert sub-networks than can fit simultaneously in a single accelerator's memory. Fetching expert weights on demand from the second accelerator via CXL-to-UPLI translation may enable serving MoE models whose aggregate expert weights exceed the first accelerator's local memory capacity.

In some implementations of the method, the model data comprises key-value (KV) cache entries generated during attention computation in a transformer-based neural network model, the KV cache entries comprising key tensors and value tensors associated with one or more attention layers; and wherein the memory of the second accelerator comprises at least one of high-bandwidth memory (HBM) or High-Bandwidth Flash (HBF). KV cache entries may grow proportionally to sequence length and the number of attention layers. Storing KV cache data in HBM and/or HBF of the second accelerator and accessing it via CXL-to-UPLI translation may enable processing longer sequences or serving more concurrent inference requests than the first accelerator's local memory can support.

In some implementations, the method further comprises sending, by the first accelerator, a CXL write request comprising inference context data and a third address; translating, by the computer, the CXL write request to a UPLI write request comprising a fourth address and originator data comprising the inference context data; sending the UPLI write request to the second accelerator; and storing the inference context data in the memory of the second accelerator. Write translation may enable the first accelerator to store intermediate inference results, activation checkpoints, updated KV cache entries, or other inference context data in the second accelerator's memory across the CXL and UALink protocol domain boundaries.

In some implementations of the method, the first accelerator is coupled to the computer via CXL.cache, the second accelerator is coupled to the computer via a UALink port; and wherein the CXL request comprises a CXL.cache Device-to-Host (D2H) request comprising a read opcode, and the CXL response comprises a CXL.cache Host-to-Device (H2D) Data comprising the model data. The CXL.cache D2H request path may be utilized when the first accelerator is a CXL device that sends D2H requests to the computer acting as CXL host. The computer may translate the read opcode, such as RdCurr or RdShared, to a UPLI read command targeting the second accelerator.

In computing systems where accelerators are coupled via a UALink switch, a CXL-connected entity may need to access the local memory of those accelerators across the CXL and UALink protocol domain boundaries. The aggregate local memory capacity of accelerators connected via a UALink switch may exceed the memory directly accessible to any single CXL entity, creating a memory capacity challenge. A computer positioned between the CXL entity and the switch may translate between CXL and UPLI to enable the CXL entity to access the distributed local memory of the accelerators, effectively extending the accessible memory pool beyond the limitations of the CXL entity's directly attached memory. This system topology may support disaggregated memory architectures, tiered memory hierarchies, and heterogeneous compute clusters where entities communicating via different protocols share access to accelerator memory resources.

In various implementations, a system comprising: a first entity configured to communicate according to Compute Express Link (CXL); a switch; accelerators coupled to the switch and configured to communicate according to an Ultra Accelerator Link Protocol Level Interface (UPLI), wherein each accelerator of the accelerators comprises a local memory; and a computer coupled between the first entity and the switch, the computer configured to: translate a CXL request from the first entity to a UPLI request, and send the UPLI request to an accelerator of the accelerators via the switch; and translate a UPLI response from the accelerator to a CXL response, and send the CXL response to the first entity; wherein the first entity accesses at least portions of the local memory of at least two of the accelerators via the computer and the switch. The system may enable a CXL entity to access at least portions of the distributed local memory of accelerators connected via a switch, bridging the CXL and UALink protocol domains. The switch may be a UALink switch, a multi-protocol switch, or another switch that provides connectivity between the accelerators. The computer may translate CXL requests from the first entity to UPLI requests targeting specific accelerators, and may translate UPLI responses back to CXL responses. The computer may perform address translations, Tag translations, and opcode translations between the CXL and UPLI domains. The local memory of each accelerator may include HBM, HBF, GDDR, or other memory types. In some examples, the computer may be embedded within one of the accelerators, may be a discrete component coupled to the switch, or may be implemented as a chiplet within an IC package. The system may support both read and write operations across the protocol domain boundaries, enabling bidirectional data access between the first entity and the accelerators.

In some implementations of the system, an aggregate local memory capacity of the accelerators exceeds a memory capacity directly accessible to the first entity; and wherein the switch is a UALink switch, and the first entity accesses the aggregate local memory capacity via the computer and the UALink switch. The aggregate memory capacity may span the local memory of accelerators, enabling workloads that exceed any single entity's memory capacity. The UALink switch may route UPLI requests to specific accelerators based on routing fields such as ReqDstPhysAccID.

In some implementations of the system, the first entity comprises a CXL host coupled to host memory, the host memory comprising DDR5; and wherein the local memory of each accelerator of the accelerators comprises at least one of high-bandwidth memory (HBM) or High-Bandwidth Flash (HBF). DDR5 host memory may serve as a lower-bandwidth, higher-capacity memory tier, while HBM on the accelerators provides high-bandwidth access for compute-intensive operations. The translation may enable the CXL host to access the combined HBM capacity of the accelerator fleet.

In some implementations of the system, the first entity comprises a CXL device or a CXL accelerator coupled to the computer via CXL.cache; and wherein the computer is further coupled to a host via CXL. A CXL device or CXL accelerator coupled via CXL.cache may initiate D2H requests to access accelerator memory on the UALink network. The host may provide CXL connectivity and may expose UALink-accessible resources to the first entity via the computer's address mapping.

In some implementations of the system, the CXL request comprises a first address in a first address space, and the UPLI request comprises a second address in a second address space; wherein the first address space comprises a Host Physical Address (HPA) space and the second address space comprises a Network Physical Address (NPA) space; and wherein the switch is a UALink switch that routes the UPLI request to the accelerator based on a ReqDstPhysAccID field of the UPLI request. Address translation from HPA to NPA may enable routing of requests from the CXL domain to specific accelerators within the UALink network. The ReqDstPhysAccID may identify the target accelerator, and the UALink switch may utilize this field for routing decisions.

In some implementations of the system, the computer is further configured to translate a CXL write request from the first entity to a UPLI write request comprising originator data, and send the UPLI write request to the accelerator via the switch; wherein data from the first entity is stored in the local memory of the accelerator. Write operations may enable the first entity to pre-stage data, update shared state, or store computation results in accelerator local memory across the CXL and UALink protocol domain boundaries.

In some implementations, the system further comprises a second CXL entity configured to communicate according to CXL; wherein both the first entity and the second CXL entity communicate with the accelerators via the computer, and the computer translates between CXL and UPLI for both the first entity and the second CXL entity; and wherein the first entity, the second CXL entity, and the accelerators form a heterogeneous compute cluster in which the first entity and the second CXL entity access the local memory of the accelerators. The heterogeneous compute cluster may be analogous to a super chip architecture where compute elements with different protocol interfaces are unified through the computer's translation capability. The computer may maintain separate translation contexts for each CXL entity, including independent address mappings, Tag translations, and transaction queues, enabling isolated and concurrent access to accelerator memory.

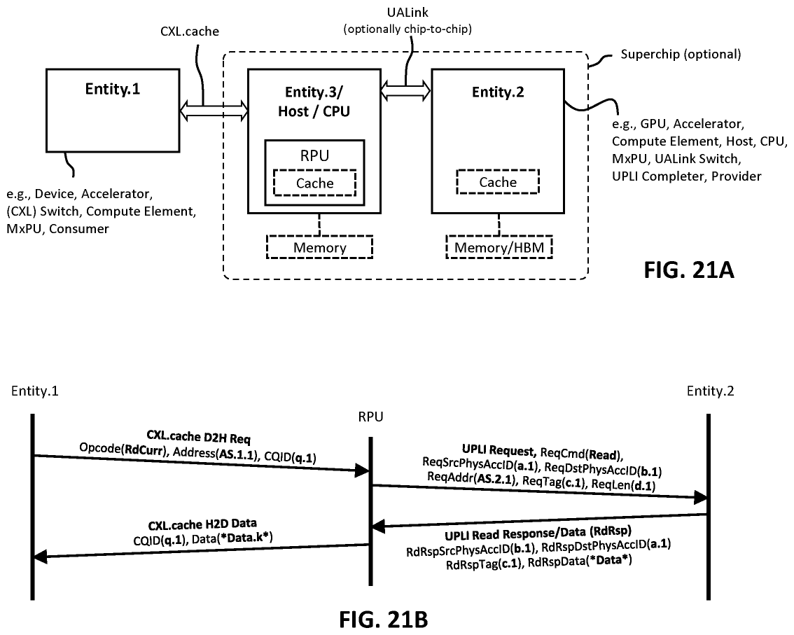

FIG. 21A illustrates an example of a system comprising a first entity (Entity.1), which may be a CXL device, an accelerator, a compute element, a switch, or an MxPU, coupled over CXL.cache to a third entity (Entity.3), which may be a host or a CPU. The third entity may be coupled over UALink, optionally via a chip-to-chip interface, to a second entity (Entity.2), which may be a GPU, an accelerator, a compute element, a host, a CPU, an MxPU, a UALink switch, a UPLI Completer, or a Provider. The third entity may include an RPU and a cache, and may be coupled to memory. The second entity may include a cache and may be coupled to memory, such as HBM and/or HBF. Resources accessible to the third entity via UALink may be mapped to the HPA space of the third entity, and therefore may also be accessible to the first entity over CXL.cache. The second and third entities may be manufactured as a superchip, wherein the first entity, the third entity, and the second entity form a heterogeneous compute cluster in which the first and second entities may access the memory of each other via the RPU.

FIG. 21B illustrates an example of a TFD demonstrating translations, such as protocol translations, between a CXL.cache D2H request received from a first entity (Entity.1), which may be a CXL device, an accelerator, or a compute element, and a UPLI request sent to a second entity (Entity.2), which may be an accelerator or another UALink entity, via an RPU. The first entity may initiate a CXL.cache transaction that may include a CXL.cache D2H request comprising Opcode(RdCurr), Address(AS.1.1), and CQID(q.1). The RPU may translate the CXL.cache D2H request to a UPLI request comprising ReqCmd(Read), ReqSrcPhysAccID(a.1), ReqDstPhysAccID(b.1), ReqAddr(AS.2.1), ReqTag(c.1), and ReqLen(d.1), and may send the UPLI request to the second entity. Upon receiving from the second entity a UPLI read response/data (RdRsp) comprising RdRspSrcPhysAccID(b.1), RdRspDstPhysAccID(a.1), RdRspTag(c.1), and RdRspData(*Data*). The RPU may translate the UPLI RdRsp to a CXL.cache H2D response comprising GO-I (for RdCurr) or GO-S and CQID(q.1), and a CXL.cache H2D Data comprising CQID(q.1) and Data(*Data.k*), and may send the CXL.cache H2D Data to the first entity. This translation from CXL.cache to UALink may enable CXL-connected entities to access resources, such as memory, residing on the UALink network, including resources of UALink-connected accelerators. The RPU may perform additional translations, such as address translations between physical addresses carried in CXL.cache requests and physical addresses carried in UPLI requests, and may further perform opcode translations, Tag-to-ReqTag translations, and field translations between the CXL.cache domain and the UPLI domain.

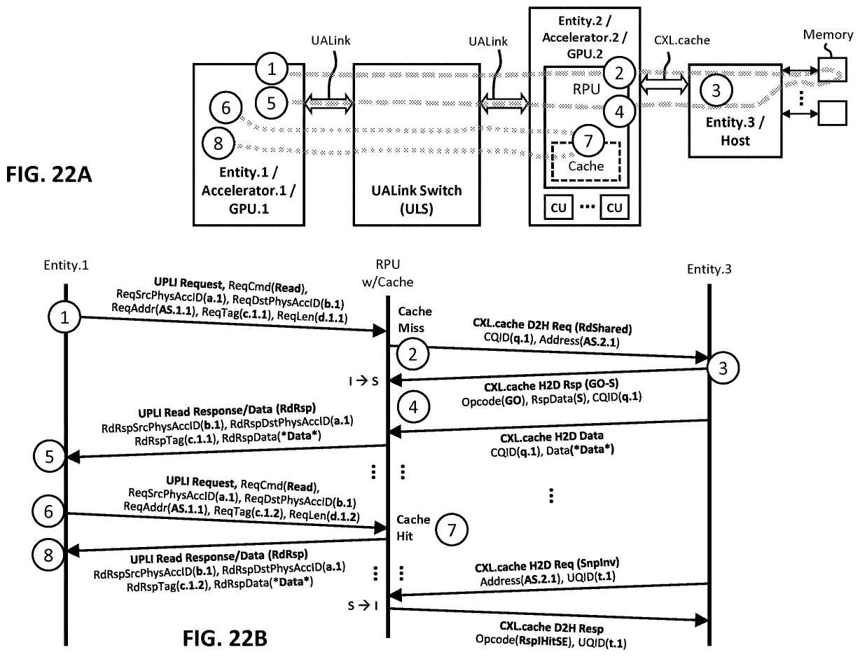

FIG. 22A illustrates an example of a system comprising a first entity (Entity.1), which may be an accelerator or a GPU (Accelerator.1/GPU.1), coupled via UALink to a UALink switch (ULS). The UALink switch is coupled via UALink to a second entity (Entity.2), which may be an accelerator or a GPU (Accelerator.2/GPU.2). The second entity may include an RPU and a cache, and may further include one or more Compute Units (CUs). The second entity may be coupled via CXL.cache to a third entity (Entity.3), which may be a host coupled to memory. The RPU may service memory transactions received from the CUs and UPLI transactions received from the first entity via the UALink switch. In some examples, the RPU may include the cache or may control a cache that is external to the RPU, and may perform cache lookups to service requests from the cache without forwarding the requests to the third entity via CXL.cache. The RPU may perform address translations between a first address space utilized by UALink-based traffic, such as NPA space, and a second address space utilized by CXL.cache, such as HPA space, prior to performing cache lookups or forwarding requests to the third entity.

FIG. 22B illustrates an example of a TFD demonstrating how an RPU comprising a cache (RPU w/Cache) may handle UPLI read requests received from a first entity (Entity.1) and translated to CXL.cache requests directed to a third entity (Entity.3), such as a host. The TFD shows three transaction sequences: a cache miss sequence, a cache hit sequence, and a snoop invalidation sequence. In the cache miss sequence (denoted by Circles 1 through 5), Entity.1 sends a UPLI request (Req) comprising a read command (ReqCmd(Read)), a source physical accelerator identifier (ReqSrcPhysAccID(a.1)), a destination physical accelerator identifier (ReqDstPhysAccID(b.1)), a request address (ReqAddr(AS.1.1)), a request tag (ReqTag(c.1.1)), and a request length (ReqLen(d.1.1)) to the RPU (Circle 1). The RPU performs a cache lookup based on the request address and determines a cache miss (Circle 2). Responsive to the cache miss, the RPU translates the UPLI request to a CXL.cache D2H request comprising RdShared, a command queue identifier (CQID(q.1)), and an address (Address(AS.2.1)), and sends the CXL.cache D2H request to Entity.3. The address AS.2.1 may represent a host physical address (HPA) translated from the network physical address (NPA) AS.1.1 carried in the UPLI request. Entity.3 responds with a CXL.cache Host-to-Device (H2D) response comprising a Global Observation (GO) opcode with GO-S, a response data value (RspData(S)) indicating Shared state, and the CQID(q.1) (Circle 3), followed by a CXL.cache H2D Data message comprising CQID(q.1) and the requested data (Data(*Data*)) (Circle 3). The RPU stores the data in the cache and transitions the cacheline state from Invalid (I) to Shared(S) responsive to receiving the GO-S response (Circle 4, denoted by the I to S transition). The RPU then translates the CXL.cache H2D Data to a UPLI read response/data (RdRsp) comprising RdRspSrcPhysAccID(b.1), RdRspDstPhysAccID(a.1), RdRspTag(c.1.1), and RdRspData(*Data*), and sends the UPLI RdRsp to Entity.1 (Circle 5).

In the cache hit sequence (denoted by Circles 6 through 8), Entity.1 sends a second UPLI request (Req) comprising a read command to the same address (ReqAddr(AS.1.1)) with a different request tag (ReqTag(c.1.2)) and request length (ReqLen(d.1.2)) to the RPU (Circle 6). The RPU performs a cache lookup and determines a cache hit (Circle 7) because the data for address AS.1.1 is already stored in the cache from the previous cache miss sequence. Responsive to the cache hit, the RPU sends a UPLI read response/data (RdRsp) comprising the data from the cache (RdRspData(*Data*)) to Entity.1 (Circle 8) without sending any CXL.cache request to Entity.3. The cache hit sequence demonstrates that the RPU may serve repeated requests for the same data directly from the cache, avoiding cross-protocol translation and the latency associated with fetching data from Entity.3.

In the snoop invalidation sequence, Entity.3 sends a CXL.cache H2D request comprising SnpInv (snoop invalidate) targeting the address (Address(AS.2.1)) and a UQID(t.1) to the RPU. SnpInv indicates that Entity.3 is requesting invalidation of the cacheline, which may be triggered when another agent requests exclusive ownership of the cacheline. The RPU transitions the cacheline state from Shared(S) to Invalid (I) (denoted by the S to I transition) and responds with a CXL.cache Device-to-Host (D2H) response comprising RspIHitSE and UQID(t.1). The RspIHitSE opcode indicates that the cacheline was found in a clean state (Shared or Exclusive) and is now Invalid, allowing Entity.3 to assume that the cacheline has been cleared from the RPU's cache.

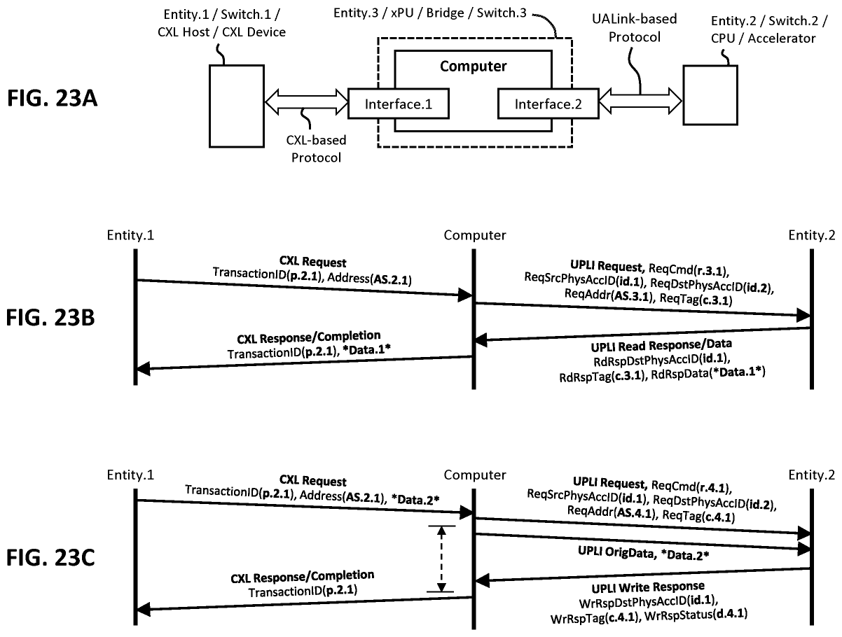

FIG. 23A illustrates an example of a system comprising a third entity (Entity.3), such as an xPU, a bridge, or a third switch (Switch.3) that may include a CXL switch or a UALink switch. The third entity includes a computer comprising a first interface (Interface.1) and a second interface (Interface.2). The first interface may communicate according to a CXL-based protocol, such as CXL.io, CXL.mem, or CXL.cache, with a first entity (Entity.1), such as a first switch (Switch.1), a CXL host, or a CXL device which may be a CXL memory expander, a CXL-based memory pool, a GFD, or a CXL accelerator. The second interface may communicate according to a UALink-based protocol, such as UPLI, with a second entity (Entity.2), such as a second switch (Switch.2), a CPU, or an accelerator. The computer may perform translations, such as protocol translations between the CXL-based protocol and the UALink-based protocol, transaction translations, protocol data unit (PDU) translations, message translations, and/or address translations between the CXL-based protocol domain and the UALink-based protocol domain. In some examples, the computer may extract addresses from requests received via the first interface, wherein these addresses may refer to a first address space, such as a Host Physical Address (HPA) space utilized by the first entity. The computer may translate these addresses, and generate requests carrying the translated addresses for transmission via the second interface; wherein these translated addresses may refer to a second address space, such as a Network Physical Address (NPA), utilized by the second entity. In other examples, the first address space and the second address space may be associated with the same address space, such as a common address space, a global address space, a pod address space, or a fabric address space, wherein the computer may perform address translations between addresses within the same common address space. In some examples, the computer may be implemented in a chiplet, may utilize UCIe for chip-to-chip or die-to-die connectivity, or may be implemented in an IC package having high-speed differential I/O balls positioned according to a ball grid array layout defined by a retimer specification.

FIG. 23B illustrates an example of a TFD demonstrating translations, such as protocol translations, transaction translations, protocol data unit (PDU) translations, message translations, and/or address translations, which may be performed by a computer, between a CXL-based protocol, such as CXL.io, CXL.mem, or CXL.cache, utilized by a first entity (Entity.1), such as a first switch (Switch.1), a CXL host, or a CXL device, and a UALink-based protocol, such as UPLI, utilized by a second entity (Entity.2), such as a second switch (Switch.2), a CPU, or an Accelerator. The first entity may initiate a CXL transaction that may include a CXL request comprising TransactionID(p.2.1) and Address(AS.2.1). In some examples, the TransactionID, such as a CXL.io Tag, a CXL.mem Tag, a CXL.cache CQID, or a CXL.cache UQID, may be utilized by the computer as a transaction identifier for matching responses or completions with requests, and may be further utilized to identify outstanding transactions in-flight. The computer may translate the CXL transaction to a UPLI transaction that may include a UPLI request comprising ReqCmd(r.3.1), such as Read or Read class Vendor Defined Command, ReqSrcPhysAccID(id.1), ReqDstPhysAccID(id.2), ReqAddr(AS.3.1), and ReqTag(c.3.1), and may send the UPLI request to the second entity. Upon receiving from the second entity a UPLI read response/data comprising RdRspDstPhysAccID(id.1), RdRspTag(c.3.1), and RdRspData(*Data.1*), the computer may translate the UPLI read response/data to a CXL response or completion (CXL Response/Completion) comprising TransactionID(p.2.1) and *Data.1*, and may send the CXL Response/Completion to the first entity.

The computer may perform further translations, such as opcode translations, command translations, TLP type translations, or other translations between the CXL-based protocol domain and the UALink-based protocol domain. In some examples, the computer may issue multiple UPLI request in response to receiving a CXL request from the first entity, such as when prefetching data from the second entity. The computer may translate transactions or requests initiated from the CXL-based protocol domain to the UALink-based protocol domain, may translate requests or transactions initiated from the UALink-based protocol domain to the CXL-based protocol domain, or may translate requests or transactions initiated from the protocol domains.

FIG. 23C illustrates an example of a TFD demonstrating translations, such as protocol translations, transaction translations, protocol data unit (PDU) translations, message translations, and/or address translations, which may be performed by a computer, between a CXL-based protocol, such as CXL.io, CXL.mem, or CXL.cache, utilized by a first entity (Entity.1), such as a first switch (Switch.1), a CXL host, or a CXL device, and a UALink-based protocol, such as UPLI, utilized by a second entity (Entity.2), such as a second switch (Switch.2), a CPU, or an Accelerator. The first entity may initiate a CXL transaction that may include a CXL request comprising TransactionID(p.2.1), Address(AS.2.1), and *Data.2*. In some examples, the TransactionID, such as a CXL.io Tag, a CXL.mem Tag, a CXL.cache CQID, or a CXL.cache UQID, may be utilized by the computer as a transaction identifier for matching responses or completions with requests, and may be further utilized to identify outstanding transactions in-flight. The computer may translate the CXL transaction to a UPLI transaction that may include a UPLI request comprising ReqCmd(r.4.1), such as Write or Write class Vendor Defined Command, ReqSrcPhysAccID(id.1), ReqDstPhysAccID(id.2), ReqAddr(AS.4.1), and ReqTag(c.4.1); and may further include a UPLI OrigData comprising *Data.2*; wherein the computer may send the UPLI transaction to the second entity. Upon receiving from the second entity a UPLI write response comprising WrRspDstPhysAccID(id.1), WrRspTag(c.4.1), and WrRspStatus(d.4.1), the computer may translate the UPLI write response to a CXL response or completion (CXL Response/Completion) comprising TransactionID(p.2.1), and may send the CXL Response/Completion to the first entity. The computer may perform further translations, such as opcode translations, command translations, TLP type translations, or other translations between the CXL-based protocol domain and the UALink-based protocol domain. The computer may translate transactions or requests initiated from the CXL-based protocol domain to the UALink-based protocol domain, may translate requests or transactions initiated from the UALink-based protocol domain to the CXL-based protocol domain, or may translate requests or transactions initiated from the protocol domains.

In computing systems where NVLink-attached entities, such as accelerators/GPUs, require access to memory resources managed by a processor, an RPU may translate between NVLink-based traffic and CXL.cache traffic. The RPU may utilize CXL.cache as an intermediate protocol for reaching the processor's coherent interconnect, by presenting itself to a CXL host as a CXL endpoint and issuing CXL.cache D2H requests. The CXL host, which may be a CXL root port or another CXL-capable entity, may process the D2H requests and return data via CXL.cache H2D responses. The RPU may perform address translations between NVLink address spaces (such as GPU physical addresses or NVLink network addresses) and address spaces utilized by the CXL host (such as Host Physical Addresses), as well as Tag translations between NVLink Tags and CXL.cache CQIDs. In some examples, the RPU may split an NVLink-based request to multiple CXL.cache D2H requests when the requested data payload exceeds a cacheline size.

In various implementations, a method comprising: receiving, by a resource provisioning unit (RPU) from a first entity via an NVLink interface that communicates according to an NVLink-based protocol, an NVLink-based request comprising a first physical address; translating, by the RPU, the NVLink-based request to a CXL.cache Device-to-Host (D2H) request comprising an opcode and a second physical address, wherein CXL denotes Compute Express Link; sending, by the RPU, the CXL.cache D2H request to a second entity; receiving, by the RPU from the second entity, a CXL.cache Host-to-Device (H2D) response comprising data accessed via the second physical address; and sending, by the RPU, an NVLink-based response comprising the data to the first entity. The RPU may receive NVLink-based requests from various types of NVLink-attached entities, such as GPUs, accelerators, or NVLink switches, and may translate these requests to CXL.cache D2H requests directed at a CXL host. The second entity may include a CXL root port of a processor, a CXL switch, or another entity that processes CXL.cache D2H requests and returns CXL.cache H2D responses. The opcode in the CXL.cache D2H request may be selected based on the type of NVLink-based request, the caching policy of the RPU, and the coherency requirements of the access. The CXL.cache H2D response may include a Global Observation (GO) indication along with data, or may include data delivered via an H2D Data message. The RPU may aggregate data from one or more H2D responses or H2D Data messages before sending the NVLink-based response to the first entity.

In some implementations of the method, the second entity comprises a CXL root port (RP) coupled to a coherent interconnect of a processor, and the data is retrieved via the coherent interconnect from at least one of: a cache of the processor, a memory controller coupled to memory, or a CXL memory expander. The cache may include an LLC. The memory may include DRAM coupled to the memory controller via memory channels. The CXL memory expander may be coupled to a separate CXL port of the processor. The coherent interconnect may route the request to the appropriate resource based on address decoding.

In some implementations of the method, the CXL RP is coupled to the coherent interconnect via an interconnect interface, and the coherent interconnect utilizes a protocol selected from at least one of: ARM CHI, Intel UPI, or AMD Infinity Fabric. The interconnect interface may be a Ring-to-CXL (R2CXL) interface or a mesh-to-CXL interface that translates between the CXL protocol domain and the coherent interconnect protocol domain.

In some implementations of the method, the translating comprises translating an NVLink Tag carried in the NVLink-based request to a command queue identifier (CQID) carried in the CXL.cache D2H request, and maintaining a mapping between the NVLink Tag and the CQID for correlating the CXL.cache H2D response with the NVLink-based response. The mapping may be maintained in a translation table or tracker. The CQID may identify the RPU's tracker entry for the transaction. Upon receiving an H2D response carrying the CQID, the RPU may look up the corresponding NVLink Tag to route the response to the originating entity.

In some implementations of the method, the translating comprises translating the NVLink-based request to CXL.cache D2H requests when the NVLink-based request specifies a data payload larger than a cacheline, and wherein each of the CXL.cache D2H requests comprises an opcode selected from RdOwn or RdShared. NVLink-based requests may specify data payloads of up to 256 bytes, while CXL.cache D2H requests may operate on cacheline granularity, such as 64 bytes. The RPU may split an NVLink-based request to multiple D2H requests with consecutive addresses. RdOwn or RdShared may be selected based on the caching policy of the RPU.

In some implementations of the method, the translating comprises translating the first physical address from a GPU physical address or an NVLink network address to a Host Physical Address (HPA) carried as the second physical address in the CXL.cache D2H request. The address translation may be implemented utilizing address range registers, translation tables, page tables, or algorithmic mappings. The GPU physical address or NVLink network address may be utilized by the NVLink-attached entity for routing within the NVLink domain, while the HPA may be utilized by the CXL host for accessing memory resources.

In some implementations of the method, the RPU, the NVLink interface, and a CXL device are implemented in a chiplet within an integrated circuit (IC) package of a processor, and the second entity comprises a CXL root port (RP) of the processor. The chiplet may be an NVLink chiplet, or NVLink Fusion, coupled to other dies within the IC package via a chip-to-chip (C2C) interface, such as UCIe or NVLink-C2C. The CXL device may present as a CXL EP to the CXL RP of the processor.

In some implementations of the method, the RPU presents as a CXL endpoint (CXL EP) to the second entity, the CXL EP comprising a Type-1 CXL device or a Type-2 CXL device, and wherein the opcode of the CXL.cache D2H request comprises RdCurr. A Type-1 CXL device may support CXL.io and CXL.cache, enabling the RPU to issue D2H requests and receive H2D responses from the second entity. A Type-2 CXL device may additionally support CXL.mem, enabling the second entity to also access memory resources of the RPU via M2S requests in addition to cache coherency operations. The selection between Type-1 and Type-2 may depend on whether the RPU exposes memory resources to the second entity beyond cache coherency functionality.

In some implementations of the method, the opcode of the CXL.cache D2H request comprises RdCurr, and the data received via the CXL.cache H2D response is forwarded to the first entity without being cached by the RPU, whereby the RPU provides I/O-coherent access to resources accessible via the second entity. I/O-coherent access may be suitable for streaming or peer data transfers where cacheline residency at the RPU is not required and snoop filter overhead at the second entity is to be avoided. The RPU may forward data directly to the first entity upon receipt, without allocating cache entries, maintaining coherency state, or participating in snoop exchanges beyond those inherent to the RdCurr transaction.

In some implementations of the method, the RPU comprises a cache, the opcode of the CXL.cache D2H request is selected from RdOwn, RdShared, or RdAny, and the data received via the CXL.cache H2D response is stored in the cache of the RPU; and further comprising receiving, by the RPU from the second entity, a CXL.cache H2D request comprising a snoop opcode targeting a cacheline stored in the cache, and sending, by the RPU, a CXL.cache D2H response to the second entity. The RPU cache may reduce cross-protocol round trips by serving subsequent requests from cached data. RdOwn may request exclusive ownership, RdShared may request shared state, and RdAny may allow the host to determine the state. The snoop opcode may include SnpData, SnpInv, or SnpCur. The D2H response may include RspIHitI, RspIHitSE, RspSHitSE, RspVHitV, RspSFwdM, RspIFwdM, or RspVFwdV based on the cache state and the snoop type. When the D2H response includes a data-forwarding opcode such as RspSFwdM, RspIFwdM, or RspVFwdV, the RPU may also send a CXL.cache D2H Data comprising the cached data.

In some implementations of the method, a non-transitory computer-readable medium comprising instructions which, when executed by a processor, cause the processor to perform the method. In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

The following system may include a processor with a CXL root port coupled to a coherent interconnect, and an RPU comprising an NVLink interface and a CXL EP. The RPU may translate between NVLink-based requests and CXL.cache D2H requests, enabling NVLink-attached entities to access processor memory resources via the coherent interconnect. The CXL EP may present the RPU to the CXL RP as a CXL device, such as a Type-1 or Type-2 CXL device. The processor may include processing cores, caches, and memory controllers coupled to the coherent interconnect. In some examples, the RPU and NVLink interface may reside on a separate silicon die or chiplet within the processor's IC package.

In various implementations, a system comprising: a processor comprising a Compute Express Link (CXL) root port (RP), a coherent interconnect, and memory controllers; wherein the memory controllers are coupled to the coherent interconnect and coupled to memory; a resource provisioning unit (RPU) comprising: an NVLink interface configured to communicate with an entity according to an NVLink-based protocol, and a CXL endpoint (CXL EP) coupled to the CXL RP; and wherein the RPU is configured to translate between NVLink-based requests received via the NVLink interface and CXL.cache Device-to-Host (D2H) requests sent to the CXL RP, to enable the entity to access memory resources via the coherent interconnect. The system may be implemented as a monolithic processor die, as chiplets within an IC package, or as components on a board. The CXL RP may process the CXL.cache D2H requests and access memory resources via the coherent interconnect, such as from DRAM coupled to the memory controllers, from a cache of the processor, or from a CXL memory expander coupled to a separate CXL port. The RPU may perform address translations between NVLink address spaces and Host Physical Addresses, Tag translations between NVLink Tags and CXL.cache CQIDs, and opcode translations between NVLink request types and CXL.cache D2H opcodes. The entity may include a GPU, an accelerator, or an NVLink switch.

In some implementations of the system, the CXL EP comprises a Type-1 CXL device or a Type-2 CXL device, and the coherent interconnect utilizes a protocol selected from at least one of: ARM CHI, Intel UPI, or AMD Infinity Fabric. A Type-1 CXL device may support CXL.io and CXL.cache. A Type-2 CXL device may additionally support CXL.mem. The coherent interconnect protocol may determine how the CXL RP communicates with processing cores, caches, and memory controllers within the processor.

In some implementations, the system further comprises processing cores and a last level cache (LLC) coupled to the coherent interconnect, and wherein the CXL RP is coupled to the coherent interconnect via an interconnect interface. The interconnect interface may be a Ring-to-CXL (R2CXL) interface or a mesh-to-CXL interface. The processing cores and LLC may be implemented as distributed slices coupled to the coherent interconnect. The CXL.cache D2H requests from the RPU may be served by the LLC on a cache hit, avoiding access to DRAM.

In some implementations of the system, the RPU, the NVLink interface, and the CXL EP are on a first silicon die, and the CXL RP and the coherent interconnect are on a second silicon die, the first and second silicon dies within an IC package. The first silicon die may be an NVLink chiplet, such as NVLink Fusion, coupled to the second silicon die via a chip-to-chip (C2C) interface, such as UCIe or NVLink-C2C.

In some implementations of the system, the RPU is further configured to translate CXL.cache Host-to-Device (H2D) requests received from the CXL RP to NVLink-based requests sent to the entity via the NVLink interface, enabling the processor to access resources of the entity. The translation may enable the processor's cores to access memory or resources coupled to the NVLink-attached entity, such as GPU memory. The RPU may maintain separate translation contexts for inbound (NVLink-to-CXL.cache) and outbound (CXL.cache-to-NVLink) traffic.

In some implementations, a computer may translate CXL.cache H2D requests, such as snoops, to NVLink-based requests targeting NVLink-attached entities. This translation may enable a CXL host, such as a processor, to access resources coupled to NVLink-attached entities, such as GPU memory or accelerator memory, by issuing CXL.cache H2D requests that the computer translates to NVLink-based requests. The computer may translate UQIDs carried in H2D requests to NVLink Tags, perform address translations between Host Physical Addresses and NVLink or GPU physical addresses, and generate CXL.cache D2H response and D2H Data messages from NVLink-based responses. The computer may be implemented in a switch, a bridge, a semiconductor device, a chiplet, or an active cable.

In various implementations, a method comprising: receiving, by a computer from a first entity, a CXL.cache Host-to-Device (H2D) request comprising an opcode and a first address, wherein CXL denotes Compute Express Link; translating, by the computer, the CXL.cache H2D request to an NVLink-based request comprising a second physical address; sending, by the computer via an NVLink interface that communicates according to an NVLink-based protocol, the NVLink-based request to a second entity; receiving, by the computer from the second entity, an NVLink-based response; and translating, by the computer, the NVLink-based response to one or more CXL.cache Device-to-Host (D2H) messages, and sending the one or more CXL.cache D2H messages to the first entity. The first entity may be a CXL host, such as a processor comprising a CXL root port, or another entity that issues CXL.cache H2D requests. The second entity may be a GPU, an accelerator, or an NVLink switch that processes NVLink-based requests and returns NVLink-based responses. The opcode in the H2D request may include a snoop opcode, such as SnpData, SnpInv, or SnpCur, and the computer may generate an appropriate NVLink-based request type based on the snoop intent. The one or more CXL.cache D2H messages may include a CXL.cache D2H response, a CXL.cache D2H Data, or both, depending on whether data return is indicated by the snoop type and the NVLink-based response.

In some implementations of the method, the translating of the CXL.cache H2D request comprises translating a Unique Queue ID (UQID) carried in the CXL.cache H2D request to an NVLink Tag carried in the NVLink-based request, and maintaining a mapping between the UQID and the NVLink Tag for correlating the NVLink-based response with the one or more CXL.cache D2H messages. The UQID may identify the host entry that originated the H2D request. Upon receiving the NVLink-based response, the computer may look up the mapping to recover the UQID for inclusion in the D2H response and D2H Data messages.

In some implementations of the method, the opcode of the CXL.cache H2D request comprises a snoop opcode selected from SnpData, SnpInv, or SnpCur, the NVLink-based request comprises a read or invalidation request type corresponding to the snoop opcode, the first entity comprises a CXL host, and the second entity comprises a GPU, an NVLink switch, or an accelerator. SnpData may be translated to an NVLink read with data return. SnpInv may be translated to an NVLink invalidation or read for exclusive ownership. SnpCur may be translated to an NVLink read without cache state change. The NVLink request type may be selected based on the snoop intent.

In some implementations of the method, the NVLink-based response comprises data, and the one or more CXL.cache D2H messages comprise a CXL.cache D2H response comprising a snoop response opcode and a Unique Queue ID (UQID), and a CXL.cache D2H Data comprising the data and the UQID. The snoop response opcode may include RspSFwdM, RspIFwdM, or RspVFwdV, indicating data forwarding with the corresponding cache state transition. The UQID in both the D2H response and D2H Data may be reflected from the H2D request to enable the first entity to correlate the response with the originating snoop.

In some implementations, the method further comprises issuing, by the computer via the NVLink interface, additional NVLink-based requests to the second entity as prefetch requests based on a detected access pattern of CXL.cache H2D requests received from the first entity. The computer may detect sequential, strided, or other access patterns from the addresses in the H2D requests and may issue speculative NVLink-based requests to reduce latency for subsequent H2D requests. Prefetched data may be stored in a local buffer or cache of the computer.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method.

Some implementations of the following system may include a first interface communicating according to CXL.cache with a first entity and a second interface communicating according to an NVLink-based protocol with a second entity, with a computer coupled between the two interfaces. The computer may translate CXL.cache H2D requests to NVLink-based requests and NVLink-based responses to CXL.cache D2H messages, enabling the first entity to access resources of the second entity across the protocol boundary. The computer may be included in a switch, a bridge, or a standalone semiconductor device, and may further support bidirectional translation.

In various implementations, a system comprising: a first interface configured to communicate according to CXL.cache with a first entity, wherein CXL denotes Compute Express Link; a second interface configured to communicate according to an NVLink-based protocol with a second entity; and a computer coupled between the first and second interfaces, configured to translate CXL.cache Host-to-Device (H2D) requests received via the first interface to NVLink-based requests transmitted via the second interface, and to translate NVLink-based responses received via the second interface to CXL.cache Device-to-Host (D2H) messages transmitted via the first interface. The first entity may be a CXL host, such as a processor, and the second entity may be a GPU, an accelerator, or an NVLink switch. The computer may perform address translations, transaction identifier translations, and opcode translations between the CXL.cache and NVLink protocol domains. The CXL.cache D2H messages may include D2H responses, D2H Data, or both. The system may be implemented in an IC package, on a PCB, or integrated into a cable form factor.

In some implementations of the system, the CXL.cache D2H messages comprise a CXL.cache D2H response comprising an opcode selected from RspSFwdM, RspIFwdM, or RspVFwdV, and a CXL.cache D2H Data comprising data sourced from a memory or a cache of the second entity. The selection of the D2H response opcode may depend on the snoop type in the H2D request and the data returned by the second entity. The memory of the second entity may include HBM, HBF, or DRAM. The cache of the second entity may include an L2 cache or an LLC of a GPU or accelerator.

In some implementations of the system, the computer is configured to translate Host Physical Addresses (HPAs) carried in the CXL.cache H2D requests to NVLink network addresses or GPU physical addresses carried in the NVLink-based requests. The address translation may be implemented utilizing address range registers, translation tables, or algorithmic mappings. HPAs may be utilized by the first entity, such as a processor, and NVLink network addresses or GPU physical addresses may be utilized for routing within the NVLink domain.

In some implementations of the system, the computer is included in a switch or a bridge, and the computer is further configured to translate NVLink-based requests received via the second interface to CXL.cache D2H requests transmitted via the first interface, enabling the second entity to access resources coupled to the first entity. The translation may enable both the first entity to access resources of the second entity and the second entity to access resources of the first entity through the same switch or bridge. The switch may be an NVLink switch or a CXL switch.

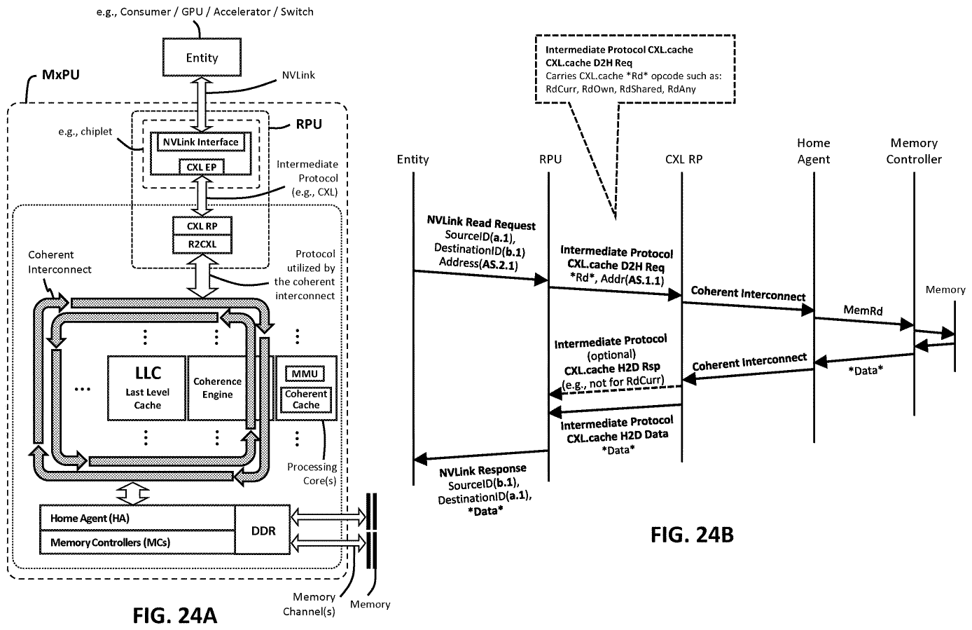

FIG. 24A illustrates an example of a system comprising a processor (such as an MxPU) comprising processing cores, LLC, a CXL RP, and memory controllers coupled via memory channels to memory, such as DRAM. The processor may include a coherent interconnect, such as a ring or mesh interconnect. The coherent interconnect may couple the processing cores, the LLC, and the memory controllers, and may further couple a coherence engine. The processing cores may each include an MMU and a coherent cache. The CXL RP may be coupled to the coherent interconnect via a Ring-to-CXL (R2CXL) interconnect interface that may communicate with the coherent interconnect according to a protocol utilized by the coherent interconnect, such as ARM CHI, Intel UPI, or AMD Infinity Fabric. A Home Agent (HA) may be coupled to the memory controllers, and the memory controllers may communicate with the memory via DDR memory channels.

An RPU, which may be included in the processor, may perform physical address translations that may enable an entity, such as a GPU, an accelerator, or a switch, to access the memory. The processor may expose to the entity, optionally via the RPU, an NVLink interface that may communicate with the entity according to an NVLink-based protocol. The RPU may further perform translations, such as from NVLink to a protocol utilized by the coherent interconnect, wherein the RPU may utilize an intermediate protocol, such as CXL (e.g., CXL.cache), to provide the translations. The RPU may expose to the processor, via the CXL RP, a CXL device utilizing a CXL endpoint (CXL EP), such as a Type-1 CXL device or a Type-2 CXL device. The R2CXL interconnect interface, that may reside in the RPU or between the RPU and the coherent interconnect, may couple the CXL RP to the coherent interconnect and complete the translation path from NVLink, via the intermediate protocol, to traffic based on the protocol utilized by the coherent interconnect. In some examples, the RPU, the NVLink interface, and the CXL device (e.g., CXL EP) may be implemented in a chiplet, such as an NVLink chiplet or NVLink Fusion, inside an IC package of the processor. In other examples, the RPU, the NVLink interface, and the CXL device may be implemented as functional blocks on the same die with the CXL RP of the processor, or split between silicon dies or chiplets inside the IC package of the processor.

FIG. 24B illustrates an example of a TFD demonstrating an NVLink read request received from an entity (such as a consumer, GPU, accelerator, or a switch), wherein the RPU may translate the NVLink read request to traffic conforming to a protocol utilized by the processor's coherent interconnect, utilizing CXL.cache as an intermediate protocol. The entity may send an NVLink request, such as an NVLink read request, comprising SourceID(a.1), DestinationID(b.1), and Address(AS.2.1), to the RPU. The RPU may translate the physical address (AS.2.1) carried in the NVLink request to a physical address (AS.1.1) utilized for accessing the memory. The RPU may perform further translations, such as opcode translations and Tag translations, e.g., translating from NVLink Tags to CXL.cache CQIDs. The RPU may generate a CXL.cache D2H request carrying the translated address (AS.1.1) and a CXL.cache read opcode (*Rd*) which indicates that the CXL.cache D2H request may carry an opcode such as RdCurr, RdOwn, RdShared, or RdAny. The CXL.cache D2H request is sent to the CXL RP for further processing. The CXL RP may communicate with a Home Agent via the coherent interconnect, and the Home Agent may issue a MemRd to a memory controller to retrieve data (*Data*) from the memory. The data may return over the coherent interconnect to the CXL RP, which may send an optional CXL.cache H2D response (when the opcode is not RdCurr) and a CXL.cache H2D Data comprising *Data* to the RPU. The RPU may then send an NVLink response comprising SourceID(b.1), DestinationID(a.1), and *Data* to the requesting entity. In some examples, the data may be provided by an LLC of the processor over the coherent interconnect, instead of by the memory via the memory controller.

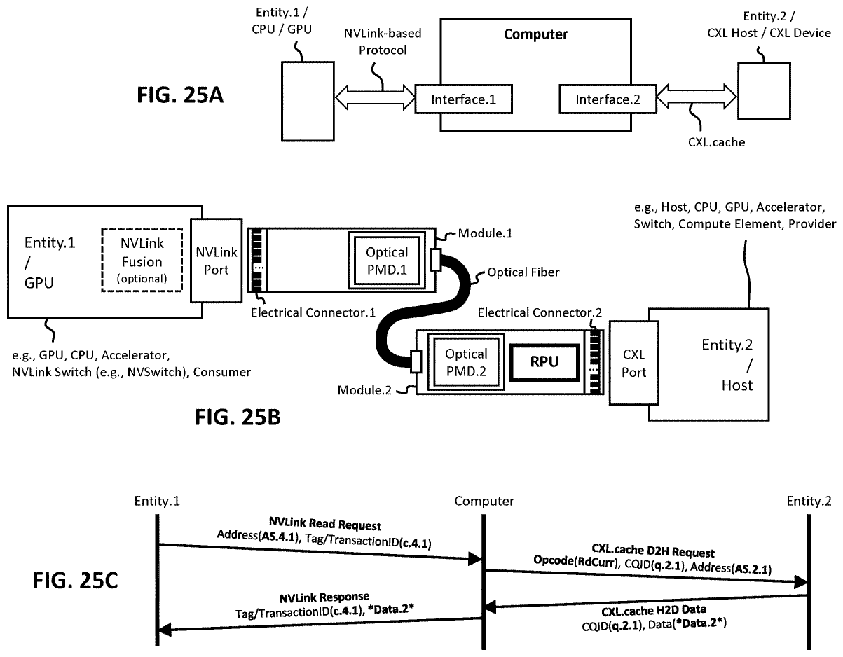

FIG. 25A illustrates an example of a system comprising a computer coupled between a first interface (Interface.1) communicating according to an NVLink-based protocol with a first entity (Entity.1), and a second interface (Interface.2) communicating according to CXL.cache with a second entity (Entity.2). The first entity may be a CPU or a GPU. The second entity may be a CXL host or a CXL device. The computer may extract addresses from requests received via either the first interface or the second interface, translate the addresses, and generate requests carrying the translated addresses for transmission via the other interface. In one direction, the computer may translate NVLink-based requests from the first entity to CXL.cache requests sent to the second entity. In the other direction, the computer may translate CXL.cache requests from the second entity to NVLink-based requests sent to the first entity. The addresses carried in NVLink-based requests may refer to a first address space, such as an NVLink-based address space, an NVLink-based network address space, or a GPU address space utilized by the first entity. The translated addresses carried in CXL.cache requests may refer to a second address space utilized by the second entity, such as a Host Physical Address (HPA) space.

FIG. 25B illustrates an example of a cable comprising an NVLink port and a CXL port, with an RPU integrated into the cable. The cable couples a first entity (Entity.1), such as a GPU, CPU, accelerator, NVLink switch (e.g., NVSwitch), or consumer, to a second entity (Entity.2), such as a host, CPU, GPU, accelerator, switch, compute element, or provider. The first entity may include an NVLink Fusion chiplet or IP block (optional) coupled to an NVLink port. The second entity may include a CXL port. The cable may include a first module (Module.1) including an optical physical medium dependent (Optical PMD.1) sublayer, and a second module (Module.2) including an optical physical medium dependent (Optical PMD.2) sublayer and an RPU. The first module may be coupled to the first entity via a first electrical connector (Electrical Connector.1) and the second module may be coupled to the second entity via a second electrical connector (Electrical Connector.2). An optical fiber may couple the first module to the second module. The RPU may translate between messages conforming to the NVLink-based protocol utilized by the first entity and messages conforming to CXL.cache utilized by the second entity. In the illustrated example, the RPU is placed in Module.2 closer to the CXL port. CXL, which runs over PCIe electricals, is designed as a shorter-reach interface, while some versions of NVLink incorporate electrical signaling characteristics designed for longer-reach interconnects. Placing the RPU closer to the CXL port may improve signal integrity and may allow for reducing the number of optical fibers or copper wires between the modules, since NVLink may utilize a higher signaling rate than CXL and therefore may require fewer lanes for the same bandwidth.

FIG. 25C illustrates an example of a TFD demonstrating translations performed by a computer between NVLink-based requests and CXL.cache requests. A first entity (Entity.1), which may be a CPU or a GPU, may initiate an NVLink request, such as an NVLink read request, comprising Address(AS.4.1) and Tag/TransactionID(c.4.1). The, wherein Tag/TransactionID may denote a Tag, a transaction Tag, a transaction identifier, or another field or set of fields carried in NVLink requests and/or NVLink responses, which may serve to associate the NVLink responses with the NVLink requests. The computer may translate the NVLink request to a CXL.cache D2H request comprising Opcode(RdCurr), CQID(q.2.1), and Address(AS.2.1), and may send the CXL.cache D2H request to a second entity (Entity.2), which may be a CXL host. The computer may translate the physical address (AS.4.1) carried in the NVLink request to a physical address (AS.2.1) carried in the CXL.cache D2H request, and may translate the NVLink Tag/TransactionID(c.4.1) to a CXL.cache CQID(q.2.1). Upon receiving one or more responses from the second entity, which may include a CXL.cache H2D Data comprising CQID(q.2.1) and Data(*Data.2*), the computer may translate the one or more responses to an NVLink response comprising Tag/TransactionID(c.4.1) and *Data.2*, and send the NVLink response to the first entity. In some examples, the computer may issue multiple CXL.cache D2H requests in response to receiving an NVLink request from the first entity, such as when splitting an NVLink request for a large block of data (e.g., 256 bytes) to smaller CXL.cache D2H requests (e.g., 64 bytes each), or when prefetching data from the second entity utilizing CXL.cache reads.

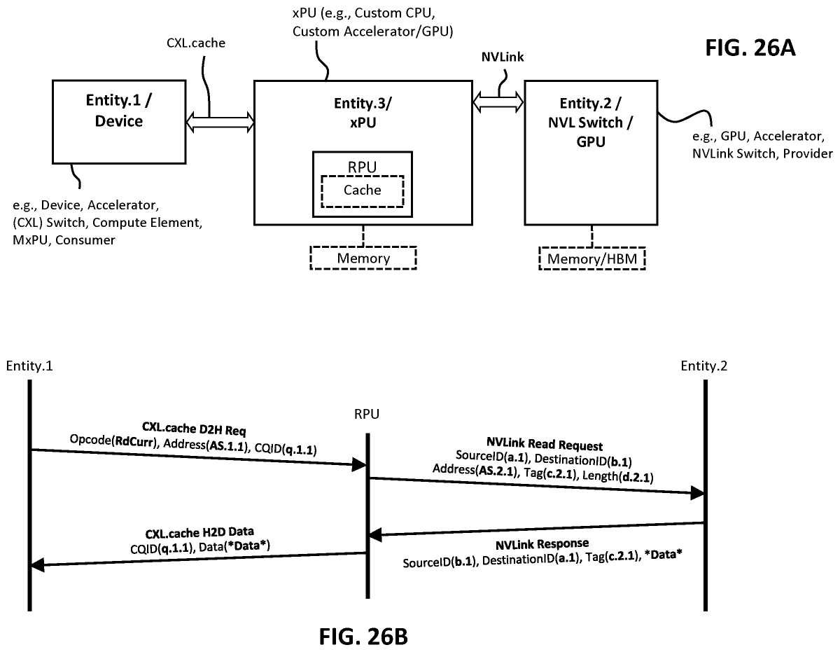

FIG. 26A illustrates an example of a system comprising an xPU (Entity.3), such as a custom CPU or a custom accelerator/GPU, coupled between a first entity (Entity.1) via CXL.cache and a second entity (Entity.2) via NVLink. Entity.1 may be a device, an accelerator, a CXL switch, a compute element, an MxPU, or a consumer. Entity.2 may be a GPU, an accelerator, an NVLink switch, or a provider. The xPU may include an RPU with an optional cache and an optional memory coupled to the RPU. The RPU may translate CXL.cache D2H requests received from Entity.1 to NVLink read requests sent to Entity.2, and may translate NVLink responses to CXL.cache H2D messages returned to Entity.1. Entity.2 may include Memory/HBM accessible via NVLink.

FIG. 26B illustrates an example of a TFD demonstrating translation of a CXL.cache D2H request to an NVLink read request. Entity.1 sends a CXL.cache D2H Req comprising Opcode(RdCurr), Address(AS.1.1), and CQID(q.1.1) to the RPU. The RPU translates the D2H request to an NVLink Read Request comprising SourceID(a.1), DestinationID(b.1), Address(AS.2.1), Tag(c.2.1), and Length(d.2.1), and sends the NVLink Read Request to Entity.2. Entity.2 returns an NVLink Response comprising SourceID(b.1), DestinationID(a.1), Tag(c.2.1), and *Data*. The RPU translates the NVLink Response to a CXL.cache H2D Data comprising CQID(q.1.1) and Data(*Data*), and sends the H2D Data to Entity.1. Because the opcode is RdCurr, no CXL.cache H2D Response (GO) is sent.

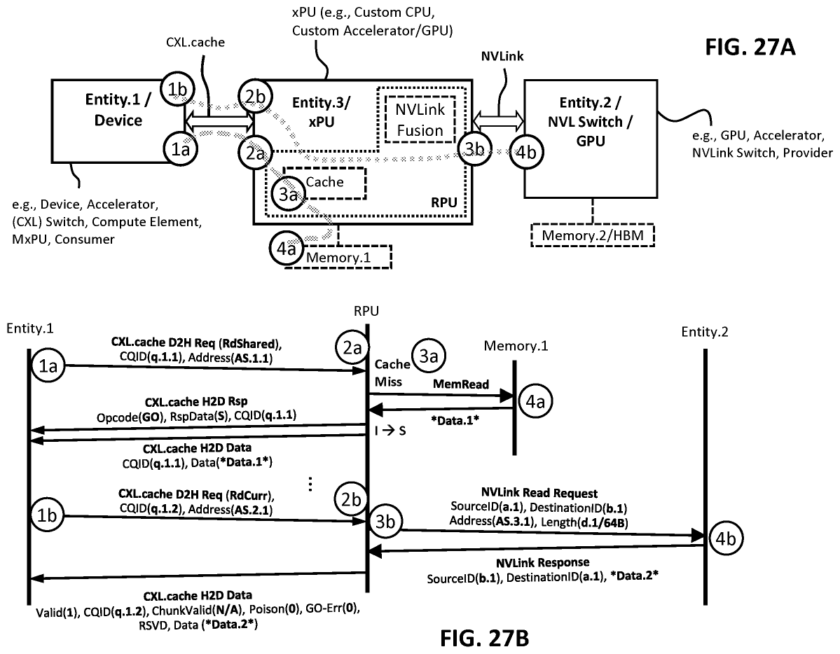

FIG. 27A illustrates an example of a system comprising an xPU (Entity.3), such as a custom CPU or a custom accelerator/GPU, coupled between Entity.1 via CXL.cache and Entity.2 via NVLink. The xPU may include an optional NVLink Fusion chiplet, an RPU with a cache, and a local memory (Memory.1). Entity.1 may be a device, an accelerator, a CXL switch, a compute element, an MxPU, or a consumer. Entity.2 may be a GPU, an accelerator, an NVLink switch, or a provider. Entity.2 may include Memory.2/HBM. The figure illustrates two access paths for CXL.cache D2H requests from Entity.1. A first path (1a, 2a, 3a, 4a) routes a D2H request from Entity.1 to the RPU, through the cache, and to Memory.1 of the xPU. A second path (1b, 2b, 3b, 4b) routes a D2H request from Entity.1 to the RPU, through NVLink, to Entity.2 and its Memory.2/HBM.

FIG. 27B illustrates an example of a TFD demonstrating two CXL.cache D2H request flows processed by an RPU with a cache. In a first flow, Entity.1 sends a CXL.cache D2H Req comprising Opcode(RdShared), CQID(q.1.1), and Address(AS.1.1) to the RPU (step 1a). The RPU performs a cache lookup (step 2a), which results in a cache miss. The RPU issues a MemRead to Memory.1 (step 3a), and Memory.1 returns *Data.1* (step 4a). The RPU stores *Data.1* in the cache and transitions the cache state from Invalid (I) to Shared(S). The RPU sends to Entity.1 a CXL.cache H2D Rsp comprising Opcode(GO) with RspData indicating Shared state and CQID(q.1.1), followed by a CXL.cache H2D Data comprising CQID(q.1.1) and Data(*Data.1*). In a second flow, Entity.1 sends a CXL.cache D2H Req comprising Opcode(RdCurr), CQID(q.1.2), and Address(AS.2.1) to the RPU (step 1b). The RPU translates the D2H request to an NVLink Read Request comprising SourceID(a.1), DestinationID(b.1), Address(AS.3.1), and Length(d.1/64B), and sends the NVLink Read Request to Entity.2 (steps 2b, 3b). Entity.2 returns an NVLink Response comprising SourceID(b.1), DestinationID(a.1), and *Data.2* (step 4b). The RPU translates the NVLink Response to a CXL.cache H2D Data comprising Valid(1), CQID(q.1.2), ChunkValid(N/A), Poison(0), GO-Err(0), RSVD, and Data(*Data.2*), and sends the H2D Data to Entity.1. Because the opcode is RdCurr, no CXL.cache H2D Response (GO) is sent, and the data is not cached by the RPU.

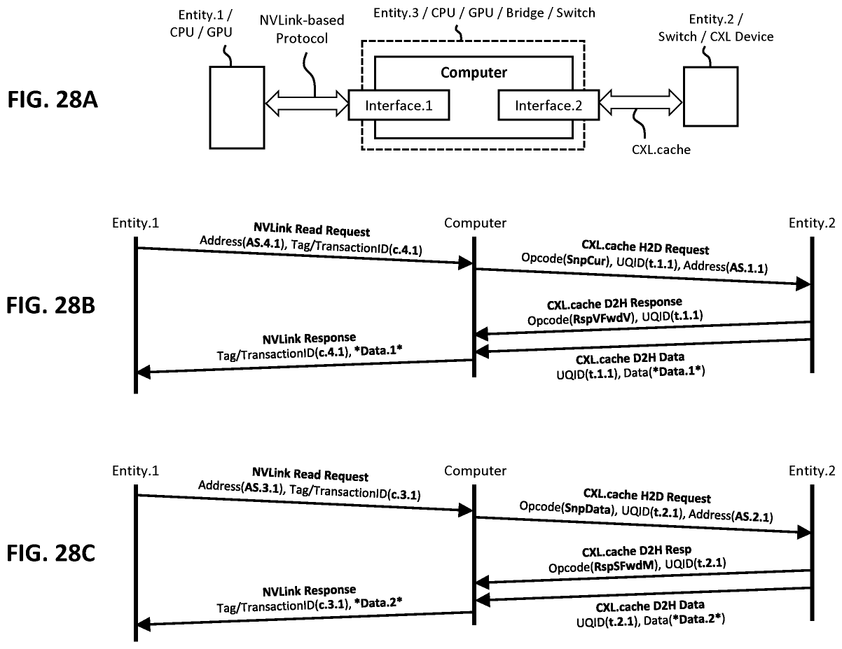

FIG. 28A illustrates an example of a system comprising a computer (Entity.3), such as a CPU, GPU, bridge, or switch, coupled between a first entity (Entity.1) via an NVLink-based protocol and a second entity (Entity.2) via CXL.cache. Entity.1 may be a CPU or a GPU. Entity.2 may be a switch or a CXL device. The computer may include a first interface (Interface.1) communicating according to the NVLink-based protocol and a second interface (Interface.2) communicating according to CXL.cache. The computer may translate NVLink read requests received from Entity.1 to CXL.cache H2D requests sent to Entity.2, and may translate CXL.cache D2H messages received from Entity.2 to NVLink responses sent to Entity.1.

FIG. 28B illustrates an example of a TFD demonstrating translation of an NVLink read request to a CXL.cache H2D request comprising SnpCur. Entity.1 sends an NVLink Read Request comprising Address(AS.4.1) and Tag/TransactionID(c.4.1) to the computer. The computer translates the NVLink Read Request to a CXL.cache H2D request comprising Opcode(SnpCur), UQID(t.1.1), and Address(AS.1.1), and sends the H2D request to Entity.2. Entity.2 returns a CXL.cache D2H Response comprising Opcode(RspVFwdV) and UQID(t.1.1), and a CXL.cache D2H Data comprising UQID(t.1.1) and Data(*Data.1*). The computer translates the D2H messages to an NVLink Response comprising Tag/TransactionID(c.4.1) and *Data.1*, and sends the NVLink Response to Entity.1. RspVFwdV indicates that the data is returned without changing cache state at Entity.2.

FIG. 28C illustrates an example of a TFD demonstrating translation of an NVLink read request to a CXL.cache H2D request comprising SnpData. Entity.1 sends an NVLink Read Request comprising Address(AS.3.1) and Tag/TransactionID(c.3.1) to the computer. The computer translates the NVLink Read Request to a CXL.cache H2D request comprising Opcode(SnpData), UQID(t.2.1), and Address(AS.2.1), and sends the H2D request to Entity.2. Entity.2 returns a CXL.cache D2H Resp comprising Opcode(RspSFwdM) and UQID(t.2.1), and a CXL.cache D2H Data comprising UQID(t.2.1) and Data(*Data.2*). The computer translates the D2H messages to an NVLink Response comprising Tag/TransactionID(c.3.1) and *Data.2*, and sends the NVLink Response to Entity.1. RspSFwdM indicates that the cacheline was in Modified state at Entity.2 and has been downgraded to Shared state, with the data forwarded.

In various implementations, an apparatus comprising: a coherent interconnect that utilizes a protocol based on Coherent Hub Interface (CHI-based protocol), comprising an interconnect component configured to receive CHI-based messages; processing cores coupled via the coherent interconnect to memory controllers coupled to memory channels capable of supporting memory having a capacity of at least 64 GB; a resource provisioning unit (RPU) comprising an NVLink interface and a CHI interface; wherein the NVLink interface utilizes differential pairs and is capable of communicating according to an NVLink-based protocol with an entity external to the apparatus; wherein the CHI interface is coupled to the interconnect component; and wherein the RPU is configured to translate between messages conforming to the NVLink-based protocol and messages conforming to the CHI-based protocol to enable the entity to access resources via the NVLink interface and the coherent interconnect.

In some implementations of the apparatus, the RPU is further configured to: translate first physical addresses associated with the NVLink-based protocol to second physical addresses associated with the CHI-based protocol, and translate NVLink command encodings to corresponding CHI opcodes. The RPU may perform address translation from the NVLink domain to the CHI domain. The address translation may support different memory mapping schemes between the NVLink and CHI domains, while the command translation may preserve the intent of the transaction. For example, when translating an NVLink read request transaction, received from a GPU, to a CHI request transaction, targeting an xPU coherent interconnect, wherein the CHI transaction carries ReadOnce for obtaining a non-cacheable snapshot of the data, satisfying the intent of the I/O-coherent NVLink read request. The RPU may preserve the ordering requirements of the original NVLink traffic within the CHI-based protocol framework.

In some implementations of the apparatus, the resources are selected from at least one of: registers within the apparatus, SRAM, HBF, or HBM within the apparatus, at least some of the 64 GB of memory, network devices coupled to the apparatus, or storage devices coupled to the apparatus.

In some implementations of the apparatus, the RPU further comprises a request node which does not include a hardware-coherent cache, and wherein the request node is configured to communicate with the interconnect component according to the CHI-based protocol.

In some implementations of the apparatus, the request node is coupled to the interconnect component and is further configured to expose registers accessible utilizing memory-mapped I/O (MMIO) operations, to enable the entity to detect at least one of: node type, node configuration, or connection topology based on register inspection.

In some implementations of the apparatus, the request node is configured to expose the registers via Advanced Microcontroller Bus Architecture (AMBA) Advanced Peripheral Bus (APB) interface, to enable the entity to read the registers via the NVLink interface.

In some implementations of the apparatus, the request node comprises an I/O-Coherent Request Node (RN-I) or an I/O-Coherent Request Node with Distributed Virtual Memory (DVM) support (RN-D); and the RPU is configured to translate NVLink read requests to CHI read requests. The integration with ARM mesh architecture may allow the NVLink-coupled entity to participate in the broader system interconnect fabric, with interconnect components, such as crosspoints, providing routing decisions based on transaction addresses and types. The MMIO-accessible registers enable system firmware or diagnostic software to discover the structure of the coherent interconnect, the presence of request nodes and home nodes included in the RPU, verify correct node connections, detect NVLink translation capabilities in the RPU via additional register inspections, and configure operational parameters for the translation path.

In some implementations of the apparatus, the RPU further comprises a home node which does not include a Point of Coherence (PoC) and is not capable of processing snoopable requests, and wherein the home node is configured to communicate with the interconnect component according to the CHI-based protocol.

In some implementations of the apparatus, the home node comprises a I/O-coherent Home Node (HN-I), enabling the processing cores to access resources via the NVLink interface.

In some implementations of the apparatus, the RPU further comprises a request node and a home node, the request node couples the NVLink interface to the interconnect component, and the home node couples the NVLink interface to a second interconnect component. The RPU may implement routing decisions based on transaction types, directing memory access transactions from the NVLink domain through a request node, such as an RN-I node, while receiving, from a home node, such as an HN-I node, transactions targeting the NVLink domain. The apparatus may enable entities communicating according to NVLink-based protocol to perform I/O-coherent accesses to resources within a CHI-based system through appropriate non-coherent or I/O-coherent nodes. A request node, such as an RN-D node, may receive DVM transactions and generate a subset of CHI transactions without maintaining a hardware-coherent cache. The home node, such as an HN-I node, may process a limited subset of request types and manage ordering between I/O requests targeting the I/O subsystem without maintaining coherency utilizing snooping. The RPU may perform protocol-specific translations including command mapping, address formatting, address translations, orchestration and tracking of transaction IDs, and transaction sequencing between the NVLink and CHI domains.

In some implementations of the apparatus, the RPU further comprises an interconnect gateway configured to communicate with the interconnect component according to the CHI-based protocol, wherein the RPU is further configured to utilize a streaming interface protocol to enable connectivity between the NVLink interface and the coherent interconnect via the interconnect gateway.

In some implementations of the apparatus, the streaming interface protocol transports packets of an intermediate protocol; and wherein the RPU is further configured to translate between messages conforming to the intermediate protocol and messages conforming to the CHI-based protocol.

In some implementations of the apparatus, the intermedia protocol conforms to PCIe, and the RPU is further configured to translate a PCIe UIO memory read request utilizing a UIOMRd TLP type to a CHI REQ comprising ReadOnce.

In some implementations of the apparatus, the streaming interface protocol is based on Advanced Microcontroller Bus Architecture (AMBA) Credited eXtensible Stream (CXS); and wherein the interconnect gateway provides credit-based flow-control and supports bi-directional connectivity between the NVLink interface and the coherent interconnect.

In some implementations of the apparatus, the interconnect gateway comprises CXL/CCIX Gateway (CCG) comprising a link agent that supports the streaming interface protocol, providing flit packing and unpacking, end-to-end data integrity, and a flit-retry mechanism for reliability, availability and serviceability (RAS) containment when data corruption is detected.

In some implementations of the apparatus, the interconnect gateway comprises at least one of Coherent Multichip Link (CML) or Cache Coherent Interconnect for Accelerators (CCIX) Gateway (CXG); and wherein the gateway is configured to utilize a 32-bit cyclic-redundancy check (CRC-32) to protect transactions conforming to the streaming interface protocol.

In some implementations of the apparatus, the RPU comprises a request agent (RA) proxy configured to communicate with the interconnect component according to the CHI-based protocol, enabling the entity to access, via the NVLink interface, resources coupled to the coherent interconnect.

In some implementations of the apparatus, the RPU comprises a home agent (HA) proxy configured to communicate with the interconnect component according to the CHI-based protocol, enabling the processing cores to access resources via the NVLink interface.

In some implementations of the apparatus, the interconnect component comprises a crosspoint comprising at least four mesh ports and at least two device ports; and wherein the RPU is coupled to a device port of the at least two device ports.

In some implementations of the apparatus, the coherent interconnect comprises a scalable coherent fabric (SCF), the interconnect component comprises a Cache Switch Node (CSN), and the RPU is coupled to the CSN via the CHI interface. In some implementations, the xPU may be based on an NVIDIA SCF coherent interconnect that includes CSNs as a crosspoint, and an NVLink-C2C for connecting to an external entity, such as a GPU, via an NVLink interface.

In some implementations of the apparatus, the SCF comprises an SCF Cache partition (SCC); and wherein the RPU and the SCC are coupled to the CSN, providing the entity, via the NVLink interface, with low-latency access to caching resources of the apparatus.

In some implementations of the apparatus, the memory comprises dynamic random-access memory (DRAM), and the entity comprises an NVLink Switch, a GPU, or an accelerator.

In various implementations, a method comprising: operating a coherent interconnect that utilizes a protocol based on Coherent Hub Interface (CHI-based protocol), comprising an interconnect component that receives CHI-based messages; communicating, via the coherent interconnect, between processing cores and memory controllers that communicate with memory channels coupled to memory having a capacity of at least 64 GB; operating a resource provisioning unit (RPU) comprising an NVLink interface and a CHI interface, wherein the NVLink interface utilizes differential pairs and communicates according to an NVLink-based protocol with an entity external to the RPU, and wherein the CHI interface communicates with the interconnect component; and translating, by the RPU, between messages conforming to the NVLink-based protocol and messages conforming to the CHI-based protocol to enable the entity to access resources via the NVLink interface and the coherent interconnect.

In some implementations, the method further comprises translating, by the RPU, first physical addresses associated with the NVLink-based protocol to second physical addresses associated with the CHI-based protocol, and translating NVLink command encodings to corresponding CHI opcodes.

In some implementations of the method, the RPU comprises a request agent (RA) proxy, and further comprising communicating, by the RA proxy, with the interconnect component according to the CHI-based protocol, enabling the entity to access, via the NVLink interface, resources coupled to the coherent interconnect.

In some implementations of the method, the RPU comprises a home agent (HA) proxy, and further comprising communicating, by the HA proxy, with the interconnect component according to the CHI-based protocol, enabling the processing cores to access resources via the NVLink interface.

In various implementations, a system comprising: a coherent interconnect that utilizes a protocol based on Coherent Hub Interface (CHI-based protocol), comprising interconnect components configured to route CHI-based messages; processing cores coupled via the coherent interconnect to memory controllers coupled to memory channels coupled to memory having a capacity of at least 64 GB; resource provisioning units (RPUs) comprising external interfaces and CHI interfaces, wherein at least one of the external interfaces comprises an NVLink interface utilizing differential pairs for communication according to an NVLink-based protocol with one or more external entities; wherein the CHI interfaces are coupled to the interconnect components; and wherein the RPUs are configured to translate between protocols utilized by the external interfaces and the CHI-based protocol; whereby the translate enables the external entities to access system resources via the external interfaces and the coherent interconnect.

In some implementations of the system, the RPUs are configured to translate physical addresses from physical address spaces associated with their external interface protocol to addresses from physical address spaces associated with the CHI-based protocol, and to translate command encodings from the external interface protocol to command encodings from corresponding CHI opcodes.

In some implementations of the system, the RPUs comprise at least one of request agent (RA) proxies or home agent (HA) proxies configured to communicate with the interconnect components according to the CHI-based protocol; wherein the RA proxies enable external entities to access memory and I/O resources coupled to the coherent interconnect, and the HA proxies enable the processing cores to access external memory resources via the external interfaces, thereby implementing a distributed shared memory architecture.

In some implementations of the system, at least one of the RPUs comprises an interconnect gateway configured to communicate with a corresponding interconnect component according to the CHI-based protocol; wherein the interconnect gateway utilizes a streaming interface protocol to enable connectivity between the external interface associated with the at least one of the RPUs and the coherent interconnect via the at least one of the RPUs. The external interfaces associated with the RPUs may implement various protocol bridging architectures to enable communication between external entities and the coherent interconnect. In one example, an RPU may utilize proxy-based mechanisms such as Request Agent (RA) proxy and Home Agent (HA) proxy for NVLink translations. In alternative implementations, the RPUs may employ direct translation engines that perform stateless or stateful conversion between external protocols and CHI-based messages, transaction queuing and reordering mechanisms that handle protocol-specific ordering requirements, or address remapping units that maintain translation tables for converting between addresses from different physical address spaces. The RPUs may implement credit-based flow control, transaction tracking structures, or protocol-specific state machines that manage the lifecycle of transactions as they traverse between domains. These various implementation approaches may enable external entities to access system memory while system components access resources attached to the external entities.

Optionally, the architectural flexibility of the RPUs may enable multiple protocols to co-exist within the system utilizing various mechanisms. Different RPUs in the system may support UALink through UPLI message processing engines, CXL protocol through CXL.mem and/or CXL.cache transaction handlers, PCIe protocol through TLP processing units, or proprietary interconnect protocols through custom translation logic. The system may include RPUs configured for multi-protocol operation, such as multi-protocol RPUs embedded in a Fabric Processing Unit (FPU) or in a software-defined fabric processor, wherein an RPU implements protocol detection and routing logic, shared transaction buffers with protocol-specific handling, unified address translation units that support multiple addressing schemes, or configurable state machines that adapt to different protocol requirements. The streaming interface protocol utilized by the interconnect gateway may provide a common transport mechanism with protocol-agnostic packetization and framing, enabling these diverse protocols to efficiently communicate with the CHI-based coherent interconnect. The RPUs may implement protocol-specific optimizations such as transaction coalescing, speculative prefetching, or latency hiding techniques while maintaining protocol semantics and coherency requirements utilizing appropriate translation and synchronization mechanisms.

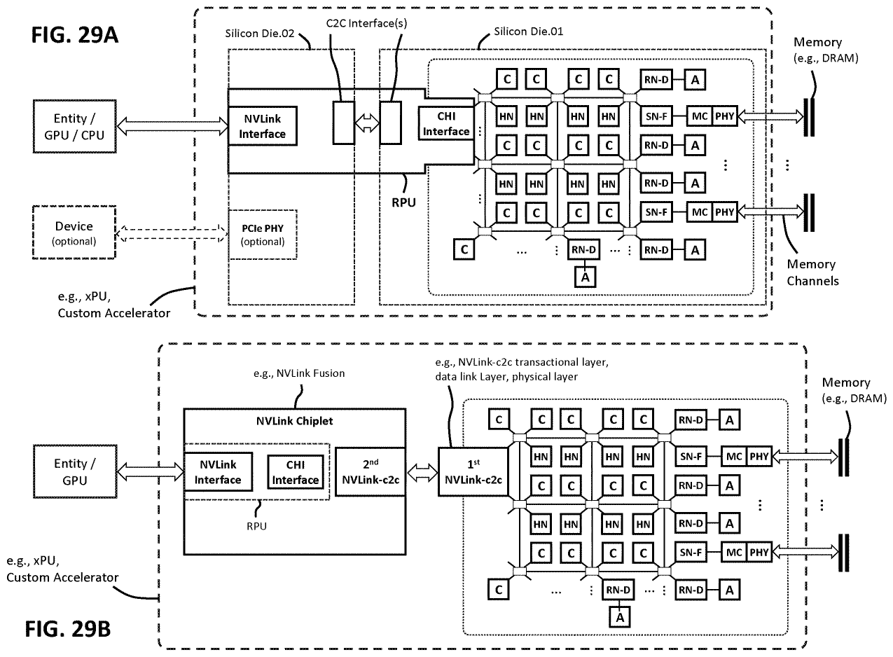

FIG. 29A illustrates an example of an xPU coupled to an entity such as a CPU or a GPU. The xPU includes an RPU which translates between NVLink traffic protocol and CHI-based traffic. The xPU further includes at least two silicon dies, wherein the first die includes a CHI interface of the RPU, and the second die includes an NVLink interface of the RPU. The second die may further include an optional PCIe PHY to communicate according to PCIe with a device external to the xPU. The first die and the second die are coupled by at least one C2C interface, utilizing chip-to-chip or die-to-die protocols such as CHI C2C or NVLink-C2C. The RPU may enable coherent memory access from the entity to the xPU, and optionally, from the device to the xPU.

FIG. 29B illustrates an example of an xPU coupled to an entity such as an NVIDIA Blackwell GPU. The xPU includes processing cores, acceleration cores, memory controllers, a coherent interconnect, and an NVLink chiplet, such as NVLink Fusion, that is coupled to the coherent interconnect via a first NVLink-C2C. The NVLink chiplet includes a second NVLink-C2C, and an RPU that translates between NVLink traffic and CHI-based traffic. The RPU includes an NVLink interface for coupling to the entity, and a CHI interface for coupling to the second NVLink-C2C. The NVLink-C2C interfaces are optionally integrated into NVLink-C2C controllers that includes transactional layers, data link layers and physical layers. The RPU may enable the GPU to access, via the NVLink interface, resources mapped to the physical address space utilized by the xPU coherent interconnect. Correspondingly, the RPU may enable the processing cores of the xPU to access, via the NVLink interface, resources of the GPU, such as HBM, High-Bandwidth Flash (HBF), or GDDR memory.

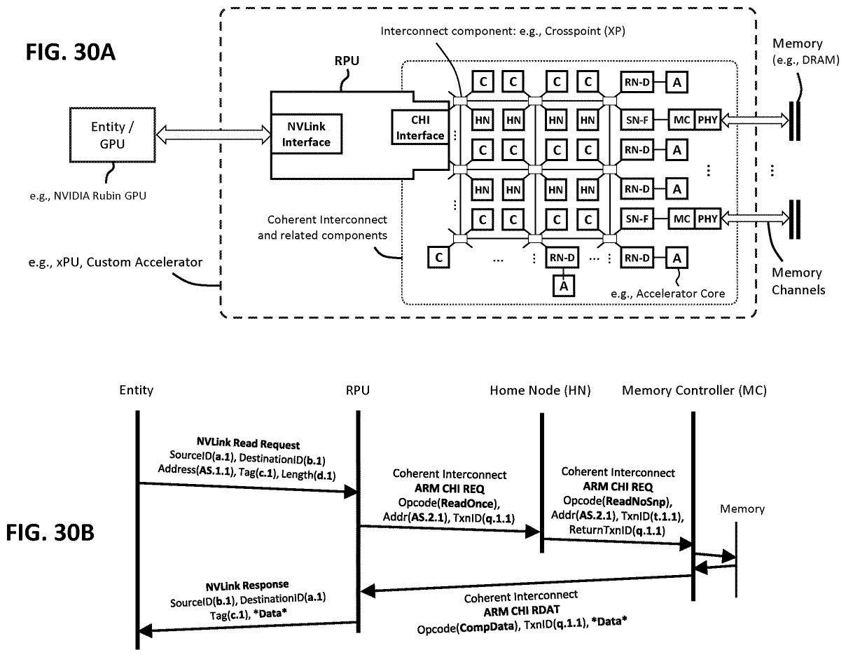

FIG. 30A illustrates an example of a system that translates between NVLink-based traffic and coherent interconnect CHI-based traffic. The NVLink connections are coupled via an RPU to an interconnect component such as a crosspoint (e.g., XP), which may serve as a fundamental building block of a coherent interconnect, providing switching or routing of CHI messages between participating elements such as request nodes, home nodes, gateways, protocol bridges, or other elements that connect to the coherent interconnect. The RPU may translate between NVLink traffic utilized by an entity, such as a GPU or a CPU, to CHI-based traffic utilized by the interconnect component, possibly eliminating intermediate protocol translations. Alternatively, the RPU may translate between an NVLink traffic and CHI traffic by utilizing intermediate protocols such as Advance Extensible Interface (AXI), or AXI Coherency Extensions Lite (ACE-Lite), or by utilizing streaming interface protocols such as Credited eXtensible Stream (CXS). Direct translation from NVLink to CHI may provide high-performance connectivity between a GPU coupled to the NVLink interface and memory coupled to the coherent interconnect, a performance gain that may be reflected via lower-latency accesses to memory and higher-bandwidth of reads and writes.

FIG. 30B illustrates an example of a transaction flow diagram (TFD) showing the translation of NVLink traffic to CHI traffic. An entity, such as a GPU or a CPU, initiates an NVLink read request, that is received by the RPU via the NVLink interface. The RPU translates the NVLink request to a CHI request carrying ReadOnce, optionally translating the physical address (AS.1.1) associated with NVLink to a physical address (AS.2.1) associated with CHI. The RPU may capture identification information associated with the NVLink request, such as source identifier of the requesting entity, and transaction Tag identifier, and may record the information together with identification information associated with the CHI request generated, such as the transaction ID (TxnID), in order to support the generation of an NVLink response for the NVLink request received from the entity. The RPU sends the CHI request, via the CHI interface, to an interconnect component, such as a crosspoint (e.g., an XP on a CHI coherent interconnect), that forwards the request to a home node. The home node processes the request and issues a CHI request carrying ReadNoSnp to a memory controller coupled to the coherent interconnect. The memory controller may read the requested data from memory, and may send the data to the RPU, or alternatively the memory controller may send the data to the home node, wherein the home node is responsible for sending the data to the RPU. When the RPU receives the data via the CHI interface, the RPU may issue an NVLink response with the data to the requesting entity, utilizing the identification information the RPU captured when processing and translating the NVLink request.

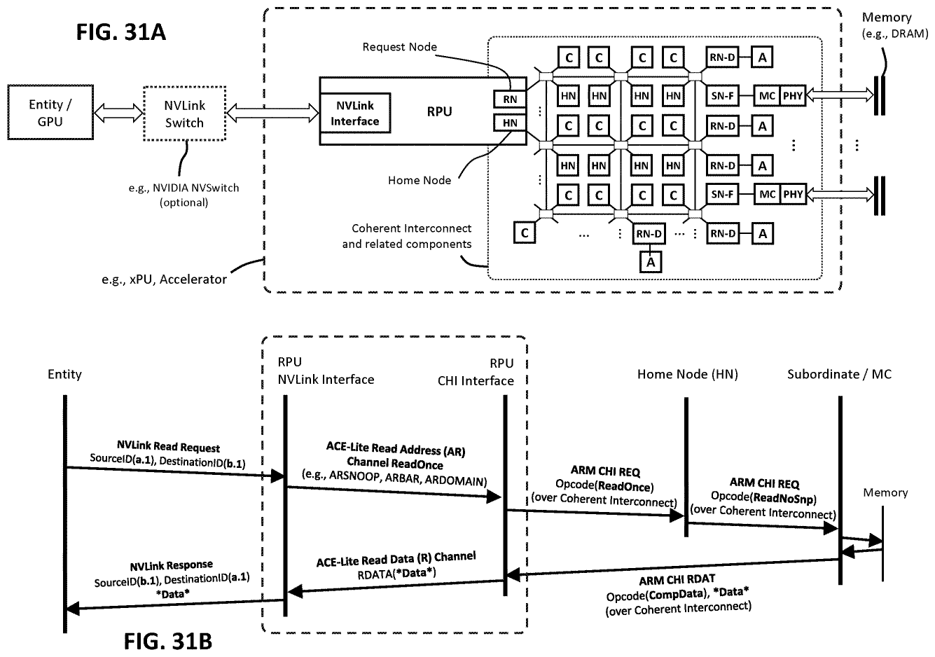

FIG. 31A illustrates an example of a system that translates between NVLink-based traffic and CHI-based traffic. The NVLink connections are coupled via an RPU to crosspoint (e.g., XP) interconnect components of the CHI coherent interconnect. The RPU may include request nodes (e.g., RNs), such as I/O-coherent RN-I nodes and/or RN-D, and/or home nodes (e.g., HNs), such as non-coherent HN-I nodes. This example enables external entities, such as GPUs, CPUs, or accelerators, which communicate utilizing NVLink traffic, to access resources within the ARM-based processor's coherent domain utilizing appropriate translations and routing, such as by an RPU translating from NVLink traffic utilized by a GPU entity, to CHI traffic, utilized by a crosspoint (XP) component of the CHI interconnect, wherein a request node or a home node provides the CHI interface for connecting to the XP.

FIG. 31B illustrates an example of an RPU that translates between NVLink traffic and CHI traffic, utilizing an intermediate protocol based on ARM Advanced Microcontroller Bus Architecture (AMBA) Advance Extensible Interface (AXI) Coherency Extensions Lite (ACE-Lite). The RPU may further translate physical addresses associated with NVLink to physical addresses associated with CHI. The RPU may process and translate the NVLink traffic, received from an NVLink interface, to ACE-Lite traffic for further processing, and send the ACE-Lite traffic to a request node (e.g., RN). The request node translates the ACE-Lite traffic to CHI traffic and provides a CHI interface for connecting to the coherent interconnect. In this example, the RPU receives from an entity, such as a GPU or a CPU, NVLink traffic that includes a read request. The RPU translates the NVLink traffic to an intermediate ACE-Lite ReadOnce, that is further translated by a request node to a CHI ReadOnce destined to a home node (e.g., HN). The home node processes the CHI ReadOnce and may issue a ReadNoSnp to a memory controller, for servicing the original read request received from the entity via the NVLink interface. The memory controller reads the requested data from memory, and may send the data via the coherent interconnect to the CHI interface of the RPU for delivery to the entity over the NVLink interface.

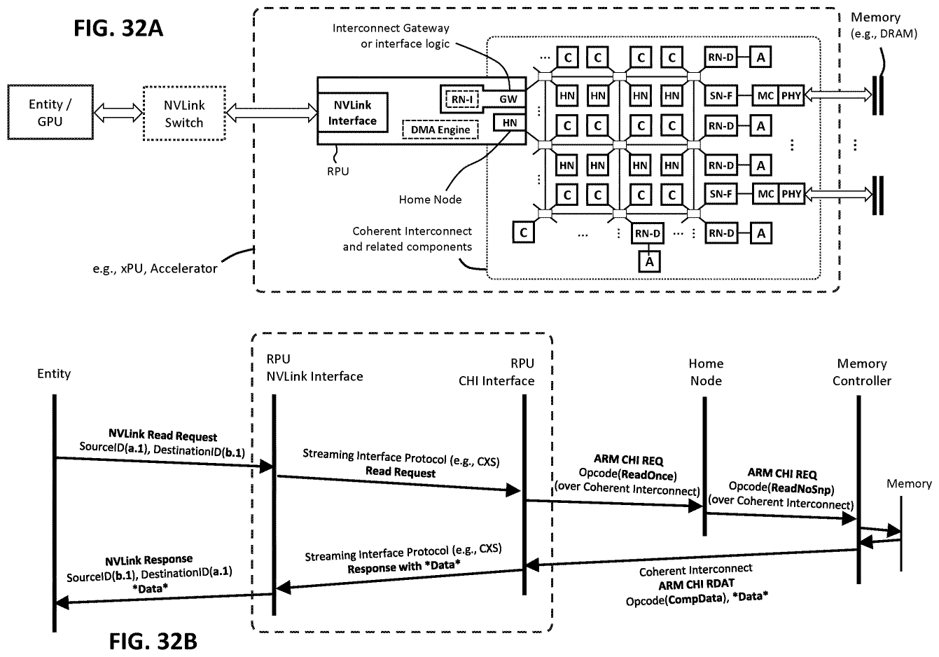

FIG. 32A illustrates an example of a system that translates between an interface based on NVLink, and interconnect components that communicate according to a protocol based on ARM CHI. The system enables entities, such as GPUs or CPUs, to access, via an optional NVLink switch, and an NVLink interface, resources coupled to the coherent interconnect. The NVLink connections are coupled, via an RPU, to crosspoint (e.g., XP) interconnect components of the coherent interconnect. The RPU may include a gateway or interface logic (marked GW in the figure), such as CXL/CCIX Gateway (CCG), Coherent Multichip Link (CML), Cache Coherent Interconnect for Accelerators (CCIX) Gateway (CXG), CHI C2C, or NVLink-C2C, that may include a CHI interface coupled to the coherent interconnect, enabling connectivity between the NVLink interface and the coherent interconnect, via the RPU. The gateway or interface logic may utilize a streaming interface protocol, such as Credited eXtensible Stream (CXS), to provide packing and un-packing of CHI C2C or an intermediate protocol over the streaming interface. The RPU may further include one or more request nodes (e.g., RN-I), home nodes (e.g., HN-I), optionally placed in the GW, that may enable DMA engines in the RPU to move blocks of data between the NVLink interface and the CHI interface. Examples of the gateway or interface logic include CCG, CML, CXG, CHI C2C, or NVLink-C2C.

FIG. 32B illustrates an example of an RPU that translates between NVLink traffic and CHI traffic. The RPU may further translate NVLink physical addresses to CHI physical addresses. The RPU utilizes a streaming interface protocol that may be based on ARM Advanced Microcontroller Bus Architecture (AMBA) Credited eXtensible Stream (CXS). Optionally, the RPU may utilize an intermediate protocol, such as CCIX, PCIe, or CXL, over the streaming interface protocol, and may translate from NVLink to intermediate protocol, and/or from the intermediate protocol to CHI. Optionally or alternatively, the RPU may include interfacing logic such as CHI C2C or NVLink-C2C, that may utilize a streaming interface protocol based on CXS.

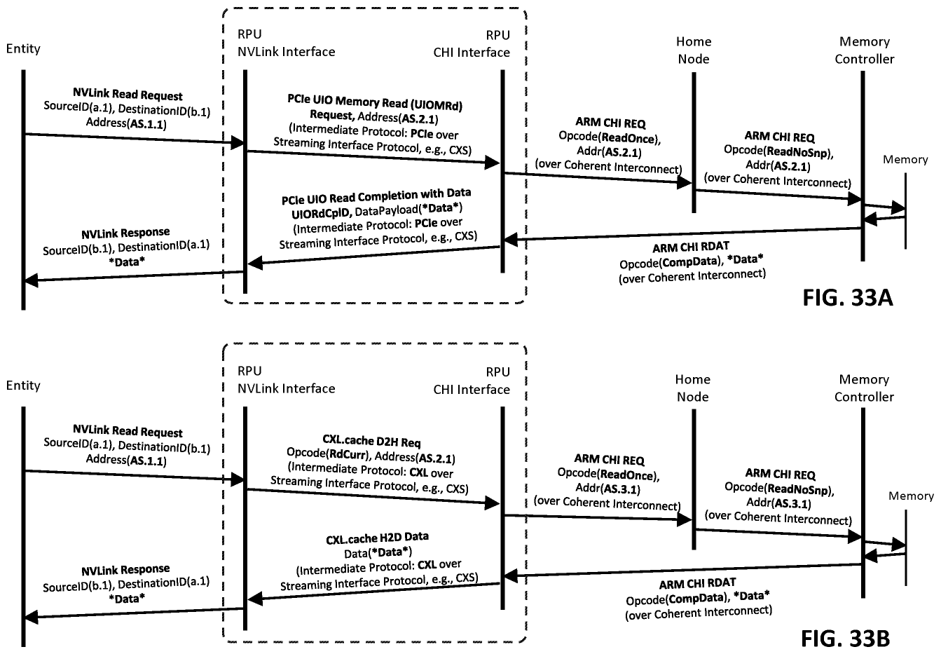

FIG. 33A illustrates an example of a TFD showing a read transaction from an entity such as a GPU to memory resources of an xPU or a memory pool, wherein an RPU provides translations between NVLink traffic, such as traffic based on a protocol utilizing NVLink5, and CHI traffic that may be utilized by the coherent interconnect of the xPU or the memory pool. The RPU may further translate physical addresses associated with NVLink to physical addresses associated with CHI, such as when translating from (AS.1.1) to (AS.2.1), optionally utilizing one stage of address translation. The RPU may utilize a streaming interface protocol, such as CXS, and may utilize PCIe as an intermediate protocol over the CXS streaming interface protocol, translating from NVLink to the PCIe intermediate protocol, and/or from the PCIe intermediate protocol to CHI.

The entity/GPU initiates the transaction by sending an NVLink read request carrying a physical address (AS.1.1) to the RPU, which translates the NVLink read request to a PCIe UIO Memory Read request utilizing a UIOMRd TLP type, optionally translating the physical address (AS.1.1) carried in the NVLink read request to a different physical address (AS.2.1) carried in the UIOMRd TLP. The RPU further translates the PCIe UIO Memory Read request to an ARM CHI REQ carrying ReadOnce and a physical address (AS.2.1 in the illustrated example), which is sent via the coherent interconnect to the Home Node (HN). The Home Node processes the request and sends a subsequent ARM CHI REQ with ReadNoSnp and the physical address (AS.2.1), to the Memory Controller (MC) for retrieving the requested data from memory. The Memory Controller accesses the memory and returns the data via an ARM CHI RDAT message carrying CompData and the requested data. The RPU receives the CHI response and translates it to the intermediate protocol, such as to PCIe UIO Read Completion with Data, utilizing a UIORdCplD TLP type, and further translates from the intermediate protocol to an NVLink response carrying the data, which is sent back to the entity/GPU via the NVLink interface, completing the read transaction.

When the RPU provides address translations, these address translations may take place during a stage wherein the RPU translates from NVLink to an intermediate protocol, such as PCIe or CXL. Additionally or alternatively, address translations may take place during a stage wherein the RPU translates from the intermediate protocol, such as PCIe or CXL, to CHI. In some examples, the RPU may perform address translations in stages, such as from a physical address (AS.1.1) in an NVLink request, to physical address (AS.2.1) in a PCIe request or a CXL request, and to physical address (AS.3.1) in a CHI request, optionally providing physical address space isolation between the NVLink domain, the intermediate protocol domain, and the CHI domain. Opcodes, TLP types, or intermediate protocols shown in this example, serve as an example. Other examples may utilize other TLP types such as MRd for a PCIe or CXL request, CplD for PCIe or CXL response, and other intermediate protocols such as CXL.mem or CXL.io.

FIG. 33B illustrates an example of a TFD showing a read transaction from an entity such as a GPU to memory resources of an xPU or a memory pool, wherein an RPU translates between NVLink traffic, such as traffic based on a protocol utilizing NVLink5, and CHI traffic that may be utilized by the coherent interconnect of the xPU or the memory pool. The RPU may further translate physical addresses associated with NVLink to physical addresses associated with CHI, such as when translating from (AS.1.1) to (AS.3.1), optionally utilizing two stages of address translation with an intermediate address (AS.2.1) that may be associated with an intermediate protocol. The RPU utilizes a streaming interface protocol, such as CXS, and may utilize CXL as an intermediate protocol over the CXS streaming interface protocol, translating from NVLink to the CXL intermediate protocol, and/or from the CXL intermediate protocol to CHI.

The entity/GPU initiates the transaction by sending an NVLink read request carrying a physical address (AS.1.1) to the RPU, which translates the NVLink read request to a CXL.cache D2H request comprising RdCurr, optionally translating the physical address (AS.1.1) carried in the NVLink read request to a different physical address (AS.2.1) carried in the CXL.cache D2H request, wherein (AS.2.1) may be an intermediate address associated with the intermediate protocol. The RPU further translates the CXL.cache D2H request to an ARM CHI REQ carrying ReadOnce, optionally translating the physical address (AS.2.1) carried in the CXL.cache D2H request to a different physical address (AS.3.1), carried in the ARM CHI REQ, which is sent via the coherent interconnect to the Home Node (HN). The Home Node processes the request and sends a subsequent ARM CHI REQ with ReadNoSnp and the physical address (AS.3.1), to the Memory Controller (MC) for retrieving the requested data from memory. The Memory Controller accesses the memory and returns the data via an ARM CHI RDAT message carrying CompData and the requested data. The RPU receives the CHI response and translates it to the intermediate protocol, such as to CXL.cache H2D Data, and further translates from the intermediate protocol to an NVLink response carrying the data, which is sent back to the entity/GPU via the NVLink interface, completing the read transaction.

When the RPU provides address translations, these address translations may take place during a stage wherein the RPU translates from NVLink to an intermediate protocol, such as PCIe or CXL. Additionally or alternatively, address translations may take place during a stage wherein the RPU translates from the intermediate protocol, such as PCIe or CXL, to CHI. In some examples, the RPU may perform address translations in stages, such as from a physical address (AS.1.1) in an NVLink request, to physical address (AS.2.1) in a PCIe request or a CXL request, and to physical address (AS.3.1) in a CHI request, optionally providing physical address space isolation between the NVLink domain, the intermediate protocol domain, and the CHI domain. Opcodes, TLP types, or intermediate protocols shown in this example, serve as an example. Other examples may utilize other opcodes, such as CXL.cache RdShared or CXL.cache RdAny, other TLP types such as MRd for a PCIe or CXL request, CplD for PCIe or CXL response, and other intermediate protocols such as CXL.mem or CXL.io.

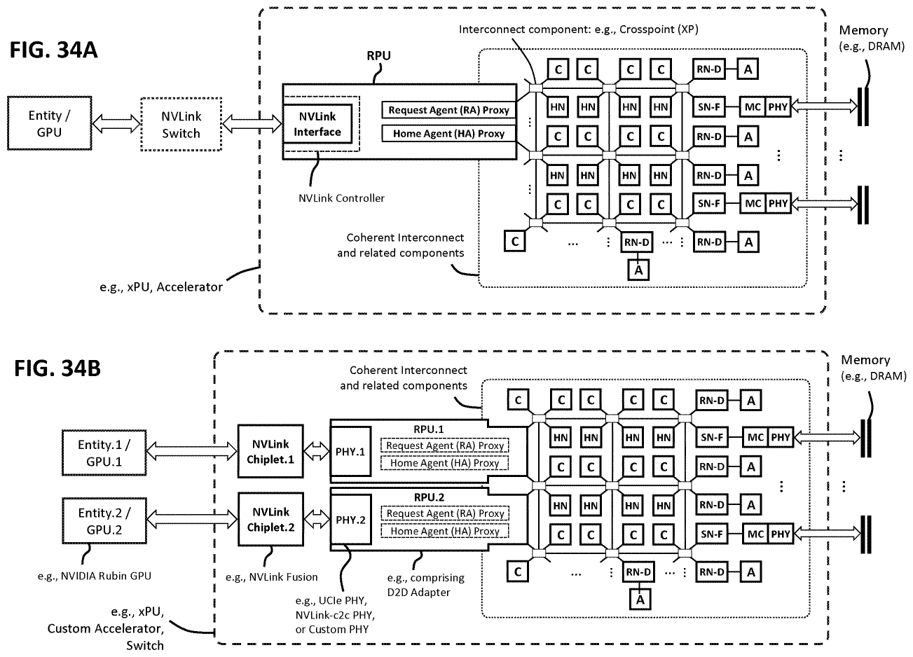

FIG. 34A illustrates an example of a system comprising an external entity coupled to an optional NVLink switch coupled to a processor comprising (such as an xPU) comprising an RPU comprising an NVLink interface, a Request Agent (RA) Proxy, and a Home Agent (HA) Proxy. The RPU may further comprise an NVLink controller, wherein the NVLink controller may include the NVLink interface. The RPU may be coupled to an interconnect component, such as a crosspoint (e.g., XP), optionally via the RA Proxy and/or the HA Proxy, wherein the RPU may communicate with the interconnect component according to a CHI-based protocol. The RPU may be further coupled, via the NVLink interface, and optionally via an NVLink switch, to an external entity, such as a GPU, wherein the RPU may communicate with the external entity according to an NVLink-based protocol. The RPU may translate between messages conforming to the NVLink-based protocol and messages conforming to the CHI-based protocol, possibly enabling the external entity to access resources of the xPU, such as xPU local memory (e.g., DRAM), and/or enabling the xPU to access resources of the external entity, such as remote memory coupled to the entity. The Request Agent (RA) proxy may receive requests that originate outside of the coherent interconnect, such as from remote agents, from the NVLink interface, from the NVLink controller, from an attached accelerator die, or from a remote chip, wherein the RA proxy may represent such remote initiators as a proxy when communicating with the coherent interconnect, e.g., by utilizing a Source ID (SrcID) namespace and a Transaction ID (TxnID) namespace associated with the coherent interconnect. The Home Agent (HA) proxy may own an address window backed by memory that may be placed on another chip or silicon die, such as on the external entity, wherein the HA proxy may enable processing cores of the xPU to access resources coupled to the external entity, such as memory (e.g., HBM and/or HBF).

FIG. 34B illustrates an example of a system comprising an xPU, such as a custom accelerator, that may utilize translations between NVLink and CHI, wherein the xPU may utilize NVLink for communicating with a first entity and with a second entity, which may each be a GPU external to the xPU, and wherein the xPU may further utilize CHI for intra-xPU communications between xPU resources coupled to a coherent interconnect of the xPU. The xPU may include first and second NVLink chiplets, or silicon dies, such as NVLink Fusion, coupled to the first and second entities, respectively. The first and second NVLink chiplets may be further coupled to first and second RPUs, respectively, via first and second physical layers (PHYs), respectively. The first and second RPUs may each include a Die-to-Die (D2D) adapter, a Request Agent (RA) Proxy, and/or a Home Agent (HA) proxy, wherein each RPU may communicate with the coherent interconnect, via the RA Proxy and/or the HA Proxy. The first and second PHYs may each include a UCIe PHY, an NVLink-C2C PHY, or a custom PHY.

The translations between NVLink and CHI may enable the first and/or the second entity to access resources coupled to the coherent interconnect of the xPU; and may further enable processing cores of the xPU to access resources coupled to the first and/or second entity. The translations between NVLink and CHI may further enable the xPU to perform as a switch, such as an NVLink switch, that may utilize NVLink to enable communication between the first entity and the second entity. The first entity may communicate with the second entity via the xPU, such as via the first NVLink chiplet, the first RPU, the coherent interconnect, the second RPU, and the second NVLink chiplet. Similarly, the second entity may communicate with the first entity via the xPU, such as via the second NVLink chiplet, the second RPU, the coherent interconnect, the first RPU, and the first NVLink chiplet.

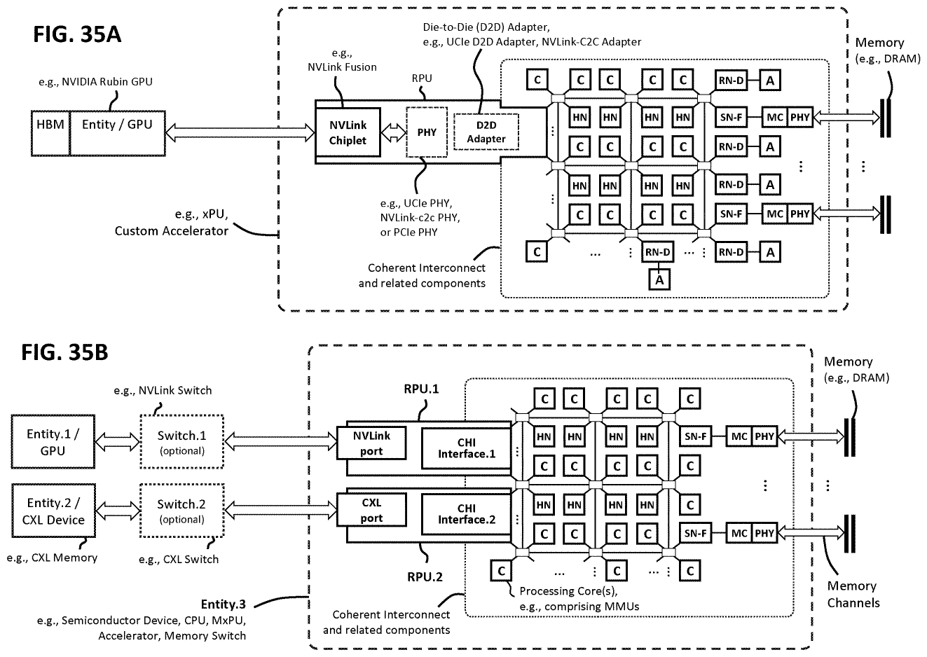

FIG. 35A illustrates an example of a system comprising an xPU comprising an RPU that translates between NVLink traffic and CHI traffic. The RPU may include a die-to-die (D2D) adapter, such as UCIe D2D adapter or NVLink-C2C adapter, which may perform at least one of: (1) Serve as an interfacing logic coupling the coherent interconnect and a die-to-die link; (2) Packetize CHI C2C into flits that can be streamed out to another chip or die, and correspondingly, handle de-packetization in the reverse direction; (3) Provide a CHI interface for connecting to an interconnect component such as a crosspoint (e.g., XP); or (4) Couple to a PHY such as a UCIe PHY, an NVLink-C2C PHY, or a PCIe PHY, for connecting to an NVLink chiplet, such as NVLink Fusion.

FIG. 35B illustrates an example of a system comprising a third entity (Entity.3), such as a semiconductor device, a CPU, an MxPU, an accelerator, or a memory switch, wherein the third entity may be coupled to a memory, such as DRAM, optionally via memory channels. The third entity may include a coherent interconnect, a first RPU (RPU.1) comprising an NVLink port and a first CHI interface (CHI Interface.1), and a second RPU (RPU.2) comprising a CXL port and a second CHI interface (CHI Interface.2). The third entity may be coupled, via the NVLink port and optionally via a first switch (Switch.1), such as an NVLink switch or an NVSwitch, to a first entity (Entity.1), such as a GPU, wherein the third entity may be further coupled, via the CXL port and optionally via a second switch (Switch.2), which may be a CXL switch, to a second entity (Entity.2), such as a CXL device (e.g., CXL memory). The third entity may utilize translations between NVLink and CHI that may enable the first entity to access the memory of the third entity, wherein the third entity may further utilize translations between CXL and CHI that may enable the second entity to access the memory of the third entity.

In some examples, the translations between NVLink and CHI, and the translations between CXL and CHI, may enable the third entity to perform as a switch, such as a multi-protocol switch or a hybrid switch, enabling communication between the first entity and the second entity, which may enable the GPU to utilize the CXL memory. For example, the first entity may communicate with the second entity via the third entity, such as via the first RPU comprising the NVLink port and the first CHI interface (CHI Interface.1), via the coherent interconnect, and via the second RPU that includes the CXL port and the second CHI interface (CHI Inetrface.2). In another example, the second entity may communicate with the first entity via the third entity, such as via the second RPU, the coherent interconnect, and the first RPU.

In some examples, the third entity may enable communication between the NVLink domain and the CXL domain, such as communication between NVLink ports and CXL ports, or communication between NVLink interfaces and CXL ports, whereas in other examples the communication between the NVLink domain and the CXL domain may be restricted, optionally by an access control list (ACL), such as to a subset of the NVLink ports and/or to a subset of the CXL ports. Additionally or alternatively, communication between the NVLink domain and the CXL domain may be restricted to a subset of allowed address regions associated with one or more address spaces, or may be restricted to a subset of allowed protocols, such as CXL.mem (e.g., not allowing CXL.cache transactions).

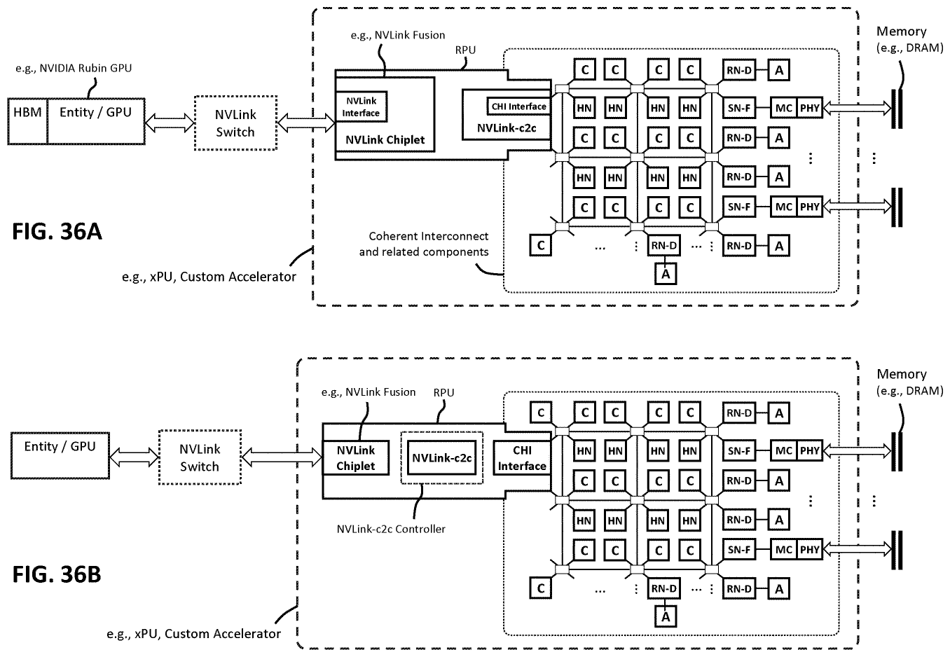

FIG. 36A illustrates an example of a system comprising an xPU or a custom accelerator, coupled to an entity such as a GPU, optionally via an NVLink switch. The xPU includes an RPU which translates between an NVLink traffic and CHI traffic. The RPU includes an NVLink chiplet, such as NVLink Fusion, that provides an NVLink interface for coupling to the external entity. The RPU further includes an NVLink-C2C for coupling the NVLink chiplet to the coherent interconnect, wherein the NVLink-C2C utilizes a CHI interface for connecting to at least one crosspoint of the coherent interconnect. The RPU may provide bi-directional memory access between the xPU and the GPU, enabling the xPU to read from the GPU's HBM, and enabling the GPU to read from DRAM coupled to the xPU. Alternatively, the RPU may provide unidirectional memory access, enabling the GPU to access xPU memory but not vice-versa, such as by exposing at least some of the xPU resources as a memory expander or a memory pool for use by the GPU.

FIG. 36B illustrates an example of a system comprising an xPU coupled to an entity such as a GPU. The xPU includes an RPU which translates between NVLink traffic and CHI-based traffic, wherein the RPU includes a CHI interface for coupling to a coherent interconnect, an NVLink-C2C logic, optionally integrated into an NVLink-C2C controller that includes a transactional layer, a data link layer and a physical layer. The RPU further includes an NVLink chiplet, such as NVLink Fusion, for coupling to the GPU, wherein the NVLink chiplet is further coupled to the coherent interconnect via the NVLink-C2C logic, optionally communicating with at least one crosspoint interconnect component according to a protocol based on ARM CHI.

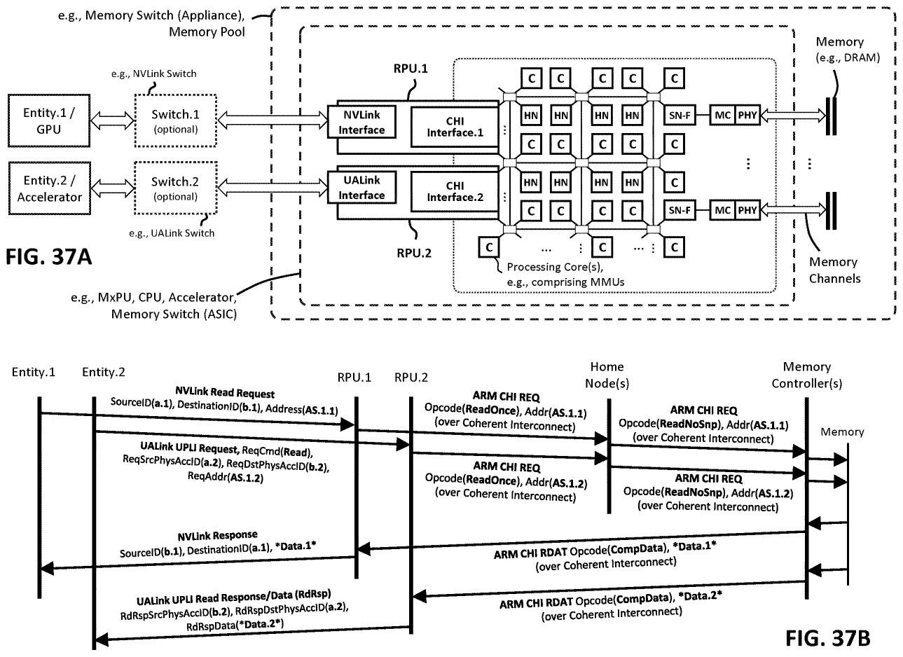

FIG. 37A illustrates an example of a system that may function as a multi-protocol memory switch appliance or a multi-protocol memory pool, and may include an MxPU, CPU, accelerator, or a memory switch ASIC, that may be coupled to two entities, optionally via switches: (1) Entity.1/GPU via an optional first switch (Switch.1), such as an NVLink switch or NVSwitch, and (2) Entity.2/Accelerator via an optional second switch (Switch.2), such as a UALink switch. The MxPU includes processing cores and memory controllers coupled to a coherent interconnect that may be based on CHI. The MxPU may utilize different translations for the external interfaces, performed by different RPUs, such as between NVLink-based interfaces and the MxPU coherent interconnect, or between UALink-based interfaces and the MxPU coherent interconnect. The first RPU (RPU.1) may enable Entity.1/GPU to access resources mapped to a physical address space utilized by the MxPU coherent interconnect, wherein the access is via the optional first switch, the NVLink interface and the MxPU coherent interconnect. Examples of resources mapped to the physical address space utilized by the MxPU coherent interconnect include DRAM or other memory resources of the MxPU. Correspondingly, the second RPU (RPU.2) may enable Entity.2/Accelerator to access, via the optional second switch, the UALink interface and the MxPU's coherent interconnect, resources mapped to a physical address space utilized by the MxPU's coherent interconnect, such as DRAM or other memory resources of the MxPU.

FIG. 37B illustrates an example of a TFD depicting a multi-entity memory access scenario wherein a GPU/first entity and an accelerator/second entity access memory mapped to one or more address spaces utilized by the coherent interconnect (CohInterMappedMemory) utilizing heterogeneous protocol message translations. Entity.1/GPU.1 initiates an NVLink request: Read with SourceID(a.1) to identify the source GPU, DestinationID(b.1) to identify the destination, and Address(AS.1.1) representing a physical address, such as an NVLink network address. RPU.1 translates the NVLink request to ARM CHI REQ carrying Opcode(ReadOnce) while preserving Addr(AS.1.1) unchanged. Concurrently or sequentially, Entity.2/Accelerator may initiate a UALink UPLI request (Req) with ReqCmd(Read), ReqSrcPhysAccID(a.2) to identify the source accelerator, ReqDstPhysAccID(b.2) to identify the destination, and ReqAddr(AS.1.2) representing a request address, such as a network physical address (NPA). RPU.2 translates the UALink UPLI request to ARM CHI REQ carrying Opcode(ReadOnce) while preserving Addr(AS.1.2) unchanged. Both transactions flow through the coherent interconnect to one or more home nodes, which may send respective ARM CHI REQ messages to one or more memory controllers with Opcode(ReadNoSnp) and the addresses Addr(AS.1.1) and Addr(AS.1.2), respectively. The memory controller(s) retrieve the requested data from the CohInterMappedMemory and send first and second ARM CHI RDAT messages with Opcode(CompData) carrying Data.1* and *Data.2*, representing the data retrieved from the addresses AS.1.1 and AS.1.2, respectively. RPU.1 translates the first ARM CHI RDAT message to NVLink response with SourceID(b.1), DestinationID(a.1), and Data.1* for Entity.1/GPU. RPU.2 translates the second ARM CHI RDAT message to UALink UPLI read response/data (RdRsp) with RdRspSrcPhysAccID(b.2), RdRspDstPhysAccID(a.2), and RdRspData(*Data.2*) for Entity.2/Accelerator.

The illustrated example demonstrates how heterogeneous entities utilizing different protocols may share access to the same CohInterMappedMemory through different RPUs that translate messages between different protocols while preserving the physical addresses. Alternatively, the illustrated example may be viewed as separate NVLink and UALink transactions that utilize the same coherent interconnect infrastructure to access the CohInterMappedMemory. Still alternatively, the response and read data paths may be implemented according to other designs, such as wherein the memory controller(s) may send the data to the home node(s) that send it to the respective RPUs, or the home node(s) send responses to the RPUs while the memory controller(s) send the data to the RPUs.

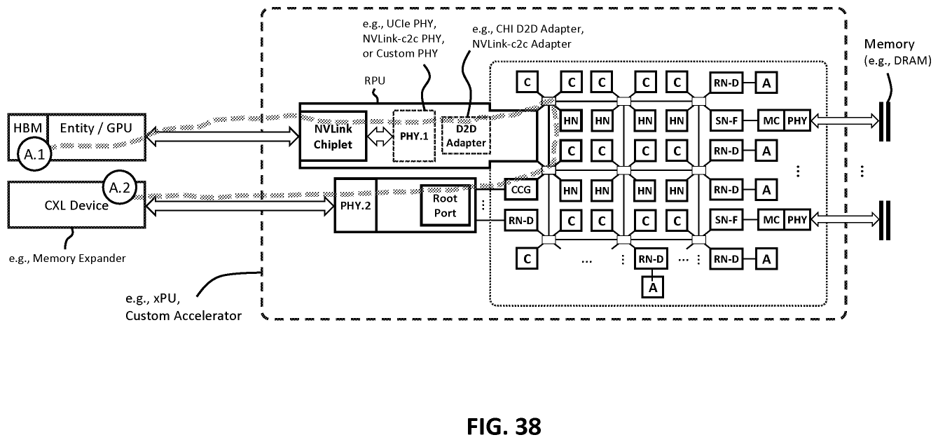

FIG. 38 illustrates an example of a heterogeneous computing system comprising an xPU or custom accelerator that utilizes an ARM-based mesh architecture with protocol interconnections. The xPU comprises a coherent interconnect implemented as a mesh topology with crosspoints (XP) that route transactions between various system components. Processing cores (C) are distributed throughout the mesh architecture and coupled to the coherent interconnect via the crosspoints. Home nodes are positioned within the mesh, optionally including HN-I nodes that may handle I/O-coherent transactions and HN-F nodes that may manage fully coherent transactions. System Node Fully coherent (SN-F) nodes are coupled to memory controllers (MC) which interface with external memory via physical layers (PHYs). The memory may be DRAM accessible through the memory channels. An entity comprising an NVIDIA Rubin GPU with integrated HBM is coupled to the xPU coherent interconnect via an NVLink chiplet. The NVLink chiplet, which may be an NVLink Fusion chiplet or custom PHY, is coupled utilizing a first physical layer (PHY.1, such as a UCIe PHY) to a die-to-die (D2D) adapter, which may be a CHI D2D Adapter or an NVLink-C2C Adapter, that enables communication between the NVLink chiplet and the coherent interconnect. The NVLink chiplet may provide the NVLink physical layer interface and may additionally provide higher protocol layers including the NVLink data link layer and transaction layer functionality.

Moreover, a CXL device, which may be a memory expander, may be coupled to the xPU coherent interconnect via a second physical layer (PHY.2) and a root port. The root port provides the interface between the CXL device and the coherent interconnect, enabling the CXL device to be discovered and configured by the system. The xPU architecture may enable the GPU to access memory resources of the CXL memory expander utilizing translations performed by the RPU and the coherent interconnect. The transaction path denoted as A.1 to A.2 in the figure illustrates a memory access flow that may represent an NVLink read transaction initiated by the GPU. The transaction may traverse from the GPU through the NVLink chiplet to the ARM mesh interconnect, wherein the RPU may translate the NVLink read request to a CHI transaction compatible with the ARM mesh interconnect. The CHI transaction may then be routed through the coherent interconnect to the appropriate home node and subsequently to the root port, wherein it may be further translated to a CXL.mem MemRd transaction for delivery to the CXL memory expander (A.2). The xPU may additionally comprise accelerator cores that may perform specialized computation tasks and may access both the GPU-attached HBM and the CXL-attached memory through the coherent interconnect.

The CPU's market is significantly larger than a memory pool controller's market (such as an MxPU in this context), which would probably result in a greater variety of CPU configurations compared to MxPUs. CPU variations may include differences in cache sizes, number of cores, number and type of ports, clock speeds (e.g., higher frequency for enhanced performance for a busy host, and a lower frequency for improved power efficiency for a station with a low load), and/or support for specialized instructions (e.g., Advanced Vector Extensions (AVX), TensorFlow operations). Additionally, some CPUs may integrate accelerators like GPUs, Tensor Processing Units (TPUs), or FPGAs to further enhance computational capabilities. This diversity in CPU configurations allows for various combinations of essentially the same MxPU with different types of CPUs to address a wide range of use cases. In large data centers, such combinations may improve HPC tasks, virtualized environments, and/or storage and data management. For AI model training and utilization, these combinations can support tasks such as distributed training, AI inference services, model optimization, or model fine-tuning. As a result, the flexibility provided by the MxPU in managing address translations and resource provisioning can enhance the efficiency and performance of systems leveraging diverse CPU configurations.

The MxPU enables the provisioning of CXL memory to other hosts via CXL endpoints, a capability not present in the currently available CPUs. The quantity of MxPUs required in the system can be determined by the number of ports required to establish the connections with the hosts, while the remaining processors may be CPUs or GPUs lacking CXL endpoints. However, in scenarios necessitating a high-fanout, multi-tier memory pool, the system may incorporate multiple MxPUs to increase the number of CXL EPs through which additional hosts can be coupled to the memory pool. This configuration allows for the expansion of the memory pool's connectivity and facilitates efficient memory sharing among a larger number of coupled hosts.

The following examples are three use-cases of combining an MxPU with multiple CPUs for large data centers: In a first example, combining one MxPU with multiple CPUs, such as seven CPUs, can leverage the high parallel processing capabilities required for HPC tasks; the MxPU can handle intensive resource management and address translations between multiple CPUs, optimizing performance for simulations, scientific computations, and data analysis. In a second example, combining one MxPU with three CPUs can be useful for data centers running multiple virtual machines; the MxPU can manage memory and resource allocation efficiently, facilitating isolation and performance stability across virtualized workloads. And in a third example, combining one MxPU with one CPU may be suitable for tasks like data indexing, search, and/or retrieval in large storage systems; the MxPU can facilitate quick address translations and resource allocation, improving data access speeds.

The following are three use case examples of combining an MxPU with multiple CPUs for AI model training and utilization: In a first example, combining one or few MxPUs with multiple CPUs, such as one MxPU with seven CPUs can support distributed training of large AI models, wherein multiple CPUs handle different portions of the dataset; the MxPU may manage memory coherence and data flow between CPUs, facilitating efficient training. In a second example, combining one MxPU with three CPUs may be suitable for deploying AI models for inference in real-time applications; the MxPU can balance the load across multiple CPUs, improving response times and throughput for inference requests. And in a third example, combining one MxPU with one CPU may be useful for tasks like model pruning, quantization, and/or fine-tuning on specific datasets; the MxPU may provide efficient memory management and computational resource allocation, speeding up the optimization process.

In various implementations, a system comprising: a first apparatus comprising: memory channels, a first Compute Express Link (CXL) endpoint (EP), a first resource provisioning unit (RPU), and a first inter-socket link (ISoL) port; memory having a capacity of at least 8 GB, coupled via the memory channels; a second apparatus comprising: a second CXL EP, a second RPU, and a second ISoL port; wherein the first ISoL port is coupled to the second ISoL port, and the first and second apparatuses utilize a first host physical address (HPA) space; wherein the first RPU is configured to perform first host-to-host physical address translations (HHPAT) to enable a first host, coupled to the first CXL EP via a first CXL.mem interface, to utilize a first portion of the memory; and wherein the second RPU is configured to perform second HHPAT to enable a second host, coupled to the second CXL EP via a second CXL.mem interface, to utilize a second portion of the memory.

In some implementations of the system, the first and second hosts utilize second and third HPA spaces, respectively, the first HHPAT translate physical addresses within the second HPA space to physical addresses within the first HPA space, and the second HHPAT translate physical addresses within the third HPA space to physical addresses within the first HPA space.

In some implementations of the system, the system functions as a memory pool, the memory comprises dynamic random-access memory (DRAM), the second MxPU further comprises second memory channels, the second memory channels are coupled to at least 8 GB of second DRAM; and wherein the second and third address translations enable the first and second hosts, respectively, to utilize the second DRAM.

In some implementations, the system further comprises third and fourth MxPUs coupled to the first and second MxPUs over additional ISoLs; the third and fourth MxPUs comprise third and fourth CXL EPs and third and fourth RPUs, respectively; the third and fourth CXL EPs are configured to be coupled to third and fourth hosts via third and fourth CXL.mem interfaces; and wherein the system enables the third and fourth hosts to utilize at least a portion of the memory.

In some implementations, the system further comprises third and fourth MxPUs coupled to the first and second MxPUs over additional ISoLs, wherein the ISoL and the additional ISoLs are interconnected by at least one Node Controller.

In some implementations of the system, the first and second MxPUs are selected from one of (a) modified Intel CPUs, and the first and second ISoLs are based on Intel's Ultra Path Interconnect (UPI), (b) modified AMD CPUs, and the first and second ISoLs are Infinity Fabric or External Global Memory Interconnect (xGMI), or (c) modified Nvidia GPUs, and the first and second ISoLs are Nvidia NVLink.

In some implementations of the system, the first MxPU further comprises a first memory management unit (MMU) configured to map virtual addresses, utilized by an operating system of the first MxPU, to physical addresses within the first HPA space; and the second MxPU further comprises a second MMU configured to map virtual addresses, utilized by an operating system of the second MxPU, to physical addresses within the second HPA space.

In some implementations of the system, the system is configured to support training of a Mixture-of-Experts (MoE) AI model; and wherein the first and second portions of the memory are allocated to different experts of the MoE model.

In some implementations of the system, the first and second RPUs are further configured to create secure memory enclaves within the memory, thereby providing confidential computing environments for the first and second hosts.

In various implementations, a method comprising: utilizing a first host physical address (HPA) space, by first and second apparatuses coupled over an inter-socket link (ISoL), to access memory having a capacity of at least 8 GB via memory channels of the first apparatus; performing first host-to-host physical address translations (HHPAT) to enable a first application host, coupled to a first Compute Express Link (CXL) endpoint (EP) of the first apparatus via a first CXL.mem interface, to utilize a first portion the memory; and performing second HHPAT to enable a second application host, coupled to a second CXL EP of the second apparatus via a second CXL.mem interface, to utilize a second portion the memory. An application host may refer to a host that executes workloads or applications that utilize one or more CXL protocols to support the application host's computational tasks. The executed workloads or applications may access memory, maintain cache coherency, offload computations, or perform other operations over one or more CXL links.

In some implementations of the method, the first application host utilizes a second HPA space, the second application host utilizes a third HPA space, the first HHPAT is translating physical addresses within the second HPA space to physical addresses within the first HPA space, and the second HHPAT is translating physical addresses within the third HPA space to physical addresses within the first HPA space.

In some implementations, the method further comprises monitoring power consumption of the memory and dynamically adjusting the first and second portions of the memory allocated to the first and second application hosts to optimize power efficiency.

In some implementations of the method, the first HPA space is further utilized to access Storage Class Memory (SCM); and further comprising utilizing a tiered memory solution, based on the DRAM coupled to the memory channels and the SCM, to accelerate training of a Large Language Model (LLM).

In various implementations, a system comprising: a processing unit (xPU) comprising: processing cores, a first inter-socket link (ISoL) port, and first memory channels; wherein the first memory channels are coupled to a first memory having a capacity of at least 8 GB; an apparatus comprising: a Compute Express Link (CXL) endpoint (EP), a resource provisioning unit (RPU), a second ISoL port, and second memory channels; wherein the second memory channels are coupled to a second memory having a capacity of at least 8 GB, the first ISoL port is coupled to the second ISoL port, and the apparatus and the xPU utilize a first host physical address (HPA) space; and wherein the RPU is configured to perform host-to-host physical address translations (HHPAT) to enable an application host, communicating with the CXL EP based on CXL.mem, to utilize portions of the first memory and the second memory.

In some implementations of the system, the first and second memories are dynamic random-access memory (DRAM), the application host utilizes a second HPA space, and the HHPAT translate physical addresses within the second HPA space to physical addresses within the first HPA space.

In some implementations of the system, the system functions as a memory pool; and further comprising second and third xPUs coupled to the apparatus and the xPU over additional inter-socket links; the second and third xPUs comprise memory channels coupled to at least 8 GB of third DRAM and fourth DRAM, respectively; and whereby the HHPAT further enables the application host to utilize the third DRAM and the fourth DRAM.

In some implementations of the system, the apparatus further comprises a CXL RP configured to be coupled to a CXL memory expander utilizing another CXL.mem interface; and wherein the HHPAT further enables the application host to utilize memory of the memory expander.

In some implementations of the system, the xPU further comprises a CXL root port (RP), and further comprising a CXL memory expander coupled to the CXL RP of the xPU; and wherein the HHPAT enable the application host to utilize memory of the memory expander while communicating based on the CXL.mem and via the first and second ISoLs.

In some implementations of the system, the apparatus and the xPU further comprise memory management units (MMUs) configured to translate virtual addresses within virtual address spaces, utilized by at least one operating system of the xPU, to physical addresses within the first HPA space.

In some implementations of the system, the system is configured to support training of a Mixture-of-Experts (MoE) AI model; and wherein the first and second portions of the memory are allocated to different experts of the MoE model.

In some implementations of the system, the RPU is further configured to create a secure memory enclave within the memory, thereby providing confidential computing environments for the application host.

In various implementations, a method comprising: utilizing a first host physical address (HPA) space by an apparatus and a processing unit (xPU) coupled over an inter-socket link (ISoL); communicating, via first memory channels of the xPU, with a first memory having a capacity of at least 8 GB; communicating, via second memory channels of the apparatus, with a second memory having a capacity of at least 8 GB; communicating with an application host via a Compute Express Link (CXL) endpoint (EP) of the apparatus based on CXL.mem, whereby the application host utilizes a second HPA space; and enabling the application host to utilize the first memory and the second memory based on host-to-host physical address translations (HHPAT) performed by a resource provisioning unit (RPU) associated with the apparatus.

In some implementations of the method, the HHPAT translate physical addresses within the second HPA space to physical addresses within the first HPA space; and further comprising utilizing machine learning-based controller to dynamically allocate portions of the first memory and the second memory to the application host based on real-time analysis of the application host's memory access patterns. Additionally or alternatively, the ISoL is tunneled over an Ultra Ethernet fabric, and further comprising providing a disaggregated memory solution in a hyperscale data center.

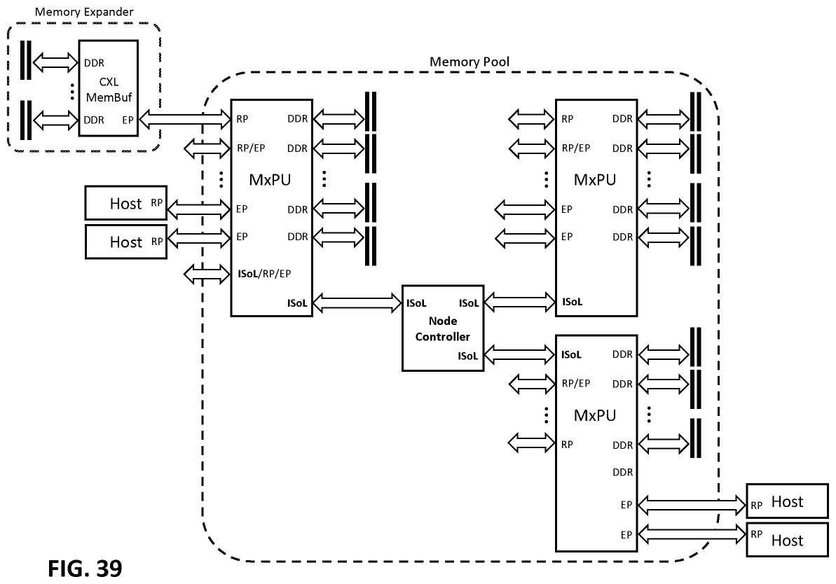

FIG. 39 illustrates an example of connecting at least some of the xPUs and/or MxPUs in the memory pool utilizing a node controller. Utilizing one or more node controllers enables scaling a single server to larger topologies than what is possible with just meshing processors to each other. When using a node controller, the xPUs are not necessarily connected directly to each other. In some examples, node controller refers to a hardware component in a multi-socket computing system that manages communication and coherency between sockets, where each socket typically holds or houses one or more CPUs or GPUs. The node controller primarily interfaces with ISoL, such as UPI, NVLink, or similar proprietary or standardized interconnects designed for high-bandwidth, low-latency communication between processors. Key functions of the node controller may include one or more of: facilitating data transfer and communication between sockets using ISoL protocols; maintaining cache coherency across CPUs or GPUs in different sockets; managing distributed memory access and coherency across the system's memory hierarchy; routing memory and I/O requests between local and remote sockets; implementing various cache coherency protocols suitable for multi-socket architectures; supporting different memory coherency models, including hardware-managed and software-managed approaches; providing address translation and memory mapping services across sockets; enabling scalability of multi-socket systems beyond typical two or four-socket configurations; optimizing data movement and reducing latency between sockets; supporting advanced features such as cache directory management or snoop filtering to improve system performance; facilitating load balancing and resource allocation across sockets; providing mechanisms for partitioning and isolation in multi-socket environments; and/or implementing security and access control features for inter-socket communication. The node controller may be integrated into the package of a CPU or GPU, implemented as a separate chip on the system board, or implemented utilizing a combination of on-die and off-die components. It may be designed to support various processor architectures and may incorporate programmable elements to allow for flexibility and feature updates.

### TERMINOLOGY

The term “Compute Express Link” (CXL) refers to currently available and/or future versions, variations and/or equivalents of the standard as defined by the CXL Consortium. CXL Specification Revisions 1.1, 2.0, 3.0, 3.1, 3.2, and 4.0 are herein incorporated by reference in their entirety.

The term “PCI Express” (PCIe) refers to currently available and/or future versions, variations and/or equivalents of the standard as defined by PCI-SIG (Peripheral Component Interconnect Special Interest Group). PCI Express Base Specification Revisions 5.0, 6.0, 6.1, and 6.2 are herein incorporated by reference in their entirety.

The term “Ultra Accelerator Link” (UALink) refers to currently available and/or future versions, variations and/or equivalents of the UALink Specification as defined by the Ultra Accelerator Link Consortium, Inc. UALink_200 Rev 1.0 Specification and its subsequent revisions are herein incorporated by reference in their entirety.

The term “Universal Chiplet Interconnect Express” (UCIe) refers to currently available and/or future versions, variations and/or equivalents of the standard as defined by the UCIe Consortium. UCIe Specification Revisions 1.0, 1.1, 2.0, and 3.0 are herein incorporated by reference in their entirety.

The term “Resource Provisioning Unit” (RPU) refers to a physical and/or logical processing module comprising or coupled to at least two interfaces and/or ports. The RPU may be implemented in various hardware, firmware, and/or software configurations, such as an ASIC, an FPGA, a logical and/or physical module inside a CPU/GPU/TPU/MxPU, a hardware accelerator, a host, a device, a controller, a switch, a memory pool, and/or a network node. The RPU may be implemented as a single module, a single computer, and/or as a distributed computation entity running on a combination of computing machines, such as ASICs, FPGAs, hosts, servers, network devices, CPUs, GPUs, accelerators, fabric managers, and/or switches. Unless the context indicates otherwise, descriptions of the RPU as comprising its interfaces and/or ports, descriptions of the RPU as being coupled to such elements, and descriptions of such elements as being part of or separate from the RPU, may be used herein interchangeably. Furthermore, references to the RPU performing operations may encompass both direct implementation by the RPU and indirect implementation through components coupled to or associated with the RPU, unless specifically distinguished by the context.

Various implementations described herein involve interconnected computers. The term “computer” refers to a device, an integrated circuit (IC), or a system that includes at least a processor or processing element, memory to store instructions or data, and a communication interface. This definition encompasses a wide range of implementations, including but not limited to: traditional computers, mobile devices, embedded systems, specialized computing elements (such as GPUs, FPGAs, ASICs, and DSPs), System-on-Chip (SoC) designs, network nodes, RPUs, MxPUs, and ICs incorporating processing capabilities, memory, and a communication interface. The processor may be of any type, including single-core or multi-core microprocessors, embedded controllers, accelerators, or any combination thereof. The memory may include volatile or non-volatile storage media. The communication interface allows the processor to send and/or receive data, signals, or instructions, and may include memory interfaces, buses, interconnects, network interfaces, or other arrangements facilitating data exchange. References to a “computer” or a “processor” include any collection of one or more computers and/or processors that individually or jointly execute one or more sets of computer instructions, meaning that the singular term “computer” is intended to imply one or more computers, which jointly perform the functions attributed to “the computer”.

It is noted that in an apparatus comprising interconnect interfaces and/or ports, the computer may be implemented as part of one or more of the interconnect interfaces and/or ports, as a separate component, or as a combination thereof. Unless the context indicates otherwise, operations attributed to the computer may be performed by one or more of the interconnect interfaces and/or ports, and conversely, relevant operations attributed to one or more of the interconnect interfaces and/or ports may be performed by the computer. This interchangeability applies to relevant processing operations described in this specification in relation to elements such as the computer, RPU, MxPU, xPU, switch, or the interconnect interfaces and/or ports.

The term “memory pool” refers to a system, an apparatus, a device, and/or a logically or physically distinct collection of resources that may incorporate, manage, or otherwise control memory capacity (such as volatile memory (e.g., DRAM) and/or non-volatile memory), and that may provide the capability to provision, allocate, deallocate, expose, share, map, and/or otherwise make available portions or aspects of its memory capacity for use, access, sharing, allocation, and/or consumption by one or more entities external to the memory pool. Such entities may include, but are not limited to, hosts, servers, processors, accelerators, computing devices, virtual machines, containers, processes, applications, services, operating systems, hypervisors, or other memory pools. Memory pool encompasses relevant implementations that perform functions related to memory resource aggregation, management, provisioning, and/or sharing, irrespective of its commercial designation, physical form factor, architectural design, interconnection method, communication protocol(s), or implementation methodology. A memory pool may also be capable of running workloads, applications, and/or computational tasks, thereby functioning as both a memory entity and a compute entity. Furthermore, a memory pool may be implemented as a logical entity that borrows, aggregates, or otherwise utilizes memory resources from other entities (such as hosts, devices, or other memory pools), rather than solely relying on dedicated physical memory resources under its direct control.

Depending on the context, the term “inter-socket link” (ISoL) may refer to any current or future high-speed communication link, interconnect, protocol, and/or architecture that facilitates data transfer between processors, such as CPUs, GPUs, TPUs, accelerators, DSAs, and/or other types of processing units. The interface points for these technologies may be collectively referred to as “ISoL ports”, though they may have technology-specific designations. ISoL encompasses direct inter-processor links, switched fabric designs, node controller-based topologies, optical interconnects, and/or heterogeneous computing interconnects linking different processor types. These interconnects support various processor arrangements including those soldered to PCBs, installed in motherboard sockets, or integrated as separate dies within chiplet-based designs.

Non-limiting examples of ISoL technologies include Intel's Coherent Processor Interconnect Protocol (ICPIP) for scalable multiprocessors with a shared physical address space, such as Ultra Path Interconnect (UPI); AMD's Infinity Fabric (IF) and its underlying External Global Memory Interconnect (xGMI); ARM's Coherent Hub Interface chip-to-chip (CHI C2C); NVIDIA's NVLink and NVLink chip-to-chip (NVLink-C2C); Ultra Accelerator Link (UALink); Ethernet for Scale-Up Networking (ESUN), and Scale Up Ethernet (SUE), including SUE-based Protocol Data Units (PDUs) such as SUE PDU, SUE Lite PDU, or PDUs based on future revisions of SUE. Each of these technologies, their successors, and other technologies developed in the future, implements specific port, interface, and protocol designs for inter-processor communication. The interface points for these technologies may have technology-specific designations, such as “UPI port” or “UPI link” for Intel processors, “IF link” or “xGMI link” for AMD processors, “NVLink port”, “NVLink link”, or “NVLink interface” for NVIDIA GPUs, or “UALink port”, “UPLI interface”, or “UPLI interface port” for UALink implementations.

A Cache-Coherent Chip-to-Chip Interconnect (CCCI) refers to a subset of ISoL that enables communication between processors while maintaining cache coherency across chips. CCCI may connect various types of processing units, such as CPUs to CPUs, GPUs to GPUs, CPUs to GPUs, or other combinations of processing units, and may implement cache coherency protocols such as MESI (Modified, Exclusive, Shared, Invalid), MOESI (Modified, Owned, Exclusive, Shared, Invalid), or other coherency schemes. The cache coherency support provided by CCCI may enable the processing units to efficiently share data, maintain memory consistency, and coordinate access to shared resources. Examples of ISoL technologies that function as CCCI include Intel's UPI, AMD's xGMI and Infinity Fabric, ARM's CHI C2C, and NVIDIA'S NvLink-C2C.

The term “Physical Layer” or “PHY” refers to hardware and protocol responsible for transmission and reception of signals, typically in the context of data communication wherein raw data bits are converted to physical signal representations, and vice versa, to be sent and received over a target medium such as copper twin-axial (Twinax) cabling, fiber optics, PCB traces for chip-to-chip (C2C) communication, or a silicon interposer for die-to-die (D2D) connectivity. The physical layer (PHY) is typically associated with the lower layer, or layer 1, of the Open System Interconnection (OSI) reference model, and may include, but is not limited to, sub-layers such as a Physical Coding Sublayer (PCS), a Physical Medium Attachment (PMA), and a Physical Medium Dependent (PMD). Examples of physical layers may include the Flex Bus Physical Layer as specified in the various CXL specifications, the collection of physical layers defined by the IEEE 802.3 Working Group, sometimes collectively referred to as “802.3 PHY”, “Ethernet PHY”, or “IEEE 802.3 PMA” when referring to sub-layers of the PHY, such as a PMA. Other PHYs may include UALink physical layers, such as UALink_200 Rev 1.0 that is based on IEEE 802.3dj (D1.4), NVIDIA NVLink physical layers, Ultra Ethernet Transport (UET) physical layers, or other appropriate current or future communication technologies.

When referring to fields, operations, or operation types associated with communication protocols, the terms “opcode”, “command”, “TLP type”, “request”, “request type”, “transaction”, and “transaction type” may be used herein interchangeably as long as they refer to the same operation, and unless a particular context specifies otherwise. This interchangeable usage may apply to data indicative of operation types (such as a field or a set of fields) within messages, packets (such as TLPs), flits, phits, frames, protocol data units (PDUs), or other protocol data structures, as well as descriptions of protocol operations, requests, transactions, or communications across different communication protocols. For example, a “CXL.cache DirtyEvict opcode”, a “CXL.cache DirtyEvict command”, and a “CXL.cache DirtyEvict request” may refer to the same operation where a device communicates with a host, such as via a D2H request message, asking the host to evict a full 64-byte modified cacheline from the device. Likewise, an “ARM CHI ReadOnce opcode”, an “ARM CHI ReadOnce command”, an “ARM CHI ReadOnce request”, and an “ARM CHI ReadOnce transaction” may refer to the same operation that specifies a read within the CHI framework, whether referring to the actual field within a CHI message or to the operation itself. Similarly, a “UPLI read command”, a “UPLI read opcode”, a “UPLI read request”, and a “UPLI read transaction” may refer to the same operation, field, or set of fields within a UPLI message that indicates a read within the UPLI framework.

The CXL Specifications use terms such as message, transaction, command, opcode, request, and response in contexts that sometimes overlap. For example, “MemRd message”, “MemRd command”, and “MemRd opcode” may refer to similar or related concepts. Similarly, “CXL.mem message”, “CXL.mem transaction”, “CXL.mem request”, and “CXL.mem response” may be used in overlapping contexts. Accordingly, depending on the context, this specification may use such terms broadly. Additionally, references to CXL messages may encompass CXL transactions, and vice versa. Moreover, the CXL Specifications occasionally describe CXL.cache and CXL.mem using various terms such as protocols, channels, interfaces, or transactional interfaces, which may be used herein interchangeably depending on the context.

Depending on the context and implementation, the terms “UALink requests”, “UALink UPLI requests”, and “UPLI requests” may be used herein interchangeably. The interchangeable use of these terms reflects that UPLI constitutes the protocol layer of UALink communications, and unless a particular context requires distinction between the physical layer aspects and the protocol layer aspects, these terms may refer to the same underlying communication transactions within the UALink ecosystem.

In the context of ARM CHI implementations, the terms “CHI messages”, “CHI packets”, and “CHI flits” may be used herein interchangeably, unless a particular context specifies otherwise. The ARM AMBA CHI Architecture Specification defines communication granularity at different layers, including transactions at the protocol layer, packets at the network layer, and flow control units (flits) at the link layer. For CHI, packets may include a single flit, which may contribute to the interchangeable use of these terms. When referring to CHI communications herein, any of these terms may be used to describe CHI protocol-level communications without implying limitations to a specific layer or format.

The terms “port” and “interface” may be used herein interchangeably unless the context requires distinction between them. Depending on the context, a port may refer to a physical or logical connection point configured to support communication with or within components, devices, or systems. A port may include, be included in, or be coupled to various interface types, may support one or more communication protocols and/or may refer to various specialized port types depending on the context. For example, the following pairs may be used herein interchangeably unless a particular context specifies otherwise: CHI interface and CHI port, CXL interface and CXL port, UALink interface and UALink port, and NVLink interface and NVLink port.

The term “Coherent Hub Interface” (CHI) as used herein is intended to encompass presently available and future versions, variations, revisions, and equivalent implementations of the CHI interconnect architecture, including AMBA 5 CHI and subsequent issues or architectural extensions published or adopted by ARM or by other entities that may extend CHI. Unless stated otherwise, translating between CHI and another protocol, such as translating between CHI and CXL, refers to converting CHI-related protocol data units (PDUs), such as CHI requests, CHI snoop requests, CHI data responses, and CHI snoop responses, to corresponding PDUs of the other protocol, such as to CXL.cache requests and responses, or to CXL.mem requests and responses, and vice versa, optionally including field value translations between the CHI domain and the other protocol domain, such as addresses, transaction identifiers, and/or cache state indications.

The term “NVLink” as used herein is intended to encompass previous, current, and future versions, variations, revisions, and equivalent implementations of NVIDIA's NVLink interconnect, including NVLink-C2C, NVLink used with NVSwitch and/or NVLink Switch fabrics, and other NVLink-related implementations that provide a high-bandwidth, low-latency, scalable interconnect between GPUs, between GPUs and CPUs, and/or between other types of processing units. Unless stated otherwise, translating between NVLink and another protocol, such as translating between NVLink and CXL, refers to converting NVLink-related protocol data units (PDUs), such as NVLink requests and NVLink responses, to corresponding PDUs of the other protocol, such as to CXL.io requests and completions, or to CXL.mem requests and responses, and vice versa, optionally including field value translations between the NVLink domain and the other protocol domain, such as Tags, error indications, and/or addresses.

### GENERAL CONSIDERATIONS

Asterisks (*) may be utilized as wildcard notations within the context of an implementation and/or an example, such as for representing a subset of relevant operations within a broader set of operations that may be indicated by opcodes, TLP types, commands, requests, request types, transactions, or transaction types, collectively referred to in this specific paragraph as “operation types”. The subset of relevant operations may include operation types that are relevant to the revisions or standards being discussed, encompassing both existing operation types and potential future operation types that may be introduced in subsequent versions of the applicable interconnect standards, including CXL, UALink, ESUN, SUE, PCIe, UCIe, ARM CHI, ARM AXI, or protocol implementations based on NVLink technology, provided they are applicable and relevant to the implementation in question. For example, the wildcard operation type ReadOnce* may represent a subset of relevant requests or transactions within the ARM CHI specifications, which may include, but is not limited to: ReadOnce, ReadOnceCleanInvalid, and ReadOnceMakeInvalid. Similarly, the wildcard operation type MemRd* may represent a subset of relevant opcodes within the CXL standard, which may include, but is not limited to: MemRd, MemRdData, MemRdFwd, MemRdTEE, MemRdDataTEE, or other opcodes that may be introduced in future CXL standard revisions, provided they are relevant to the implementation under consideration. Likewise, the wildcard operation type *Rd* may represent a broader subset of relevant operations across different protocols or different standards, which may encompass, but is not limited to: (1) ReadNoSnp, ReadOnce, ReadClean, ReadShared, ReadUnique and MakeReadUnique commands in ARM CHI; (2) UIOMRd and MRd TLP types in CXL.io; (3) RdCurr, RdOwn, RdShared, RdAny, and RdOwnNoData opcodes in CXL.cache; (4) MemRd, MemRdData, MemRdFwd, MemRdTEE, MemRdDataTEE, MemSpecRd, or MemSpecRdTEE opcodes in CXL.mem; (5) read commands in UALink UPLI; (6) memory read TLP types in PCIe; (7) read-class operations in SUE; or (8) read request types in NVLink-based protocol implementations. The examples listed for each protocol are non-limiting and are intended to encompass future operation types that may be introduced in subsequent revisions of the applicable standards, provided they are relevant to the implementations. The wildcard notation does not extend to operation types that are irrelevant to the implementation in question, even if such operation types exist within the broader specifications of the respective standards.

The wildcard form “*Data*” may be utilized for denoting essentially the same underlying information (“the Data”) irrespective of its representation, state, or protocol encoding. *Data* may encompass functionally equivalent forms and transformations of “the Data”, such as encoding, packetization, encapsulation, serialization, scrambling, compression, encryption, segmentation, or splitting, and their respective reverse transformations, represented in a suitable structure, manner, form, or format that may be carried by or interoperate with the applicable interconnect standard specifications, such as CXL, UALink, ESUN, SUE, PCIe, UCIe, ARM CHI, ARM AXI, or NVLink-based protocol implementations. For example, *Data* may refer to the same essential data payload when carried across different hops of a communication path that may each use different encryption, such as when one hop utilizes CXL Integrity and Data Encryption (CXL IDE) and another hop utilizes a different encryption mechanism or no encryption, or when different encryption keys are used on different interconnect links or channels. *Data* may further encompass the same essential data payload when carried in PDUs associated with the same or different protocols, such as: a CXL.mem S2M Data Response (DRS), a CXL.cache H2D Data message, a PCIe Completion with Data (CplD), a PCIe UIO Read Completion with Data (UIORdCplD), a UALink UPLI Data Beat carrying Read Response Data, or an NVLink data transmission. *Data* may also denote PDUs having collectively essentially the same payload, such as when splitting a 128 B cacheline into two 64 B transfers carried in two separate messages, or when an RPU splits a request for a large data block into smaller requests for translation to another protocol that supports a smaller maximum transfer size per request.

Depending on the context, each line, arrow, label, and/or box illustrated in the figures may represent one or more lines, arrows, labels, and/or boxes. For example, a single arrow representing a *Rd* operation in CXL, UALink UPLI, ESUN, SUE, PCIe, or an NVLink-based protocol may encompass one or more read or data messages relevant to the specific implementation and applicable standard, even though each may be represented by a single arrow. Additionally, optional messages, such as completion, acknowledgment, or response messages in the respective standards, may be explicitly depicted or implicitly included within the mandatory messages or their equivalents.

It is specifically noted that the transaction flow diagrams (TFDs) presented herein are schematic representations, which means that the number, order, timings, dimensions, and other properties of the information illustrated in the TFDs are non-limiting examples. Every modification, variation, or alternative allowed by a current or future Specification mentioned in the TFD (such as CXL, UALink, ESUN, SUE, PCIe, UCIe, CHI, AXI, etc.) that is relevant to a diagram, is also intended to be included within the scope of said diagrams. Furthermore, the scope of these diagrams extends to encompass implementations that may deviate from the strict specifications mentioned in the TFDs due to factors such as hardware bugs, relaxed designs, or implementation-specific optimizations.

Herein, terms such as send/sending, receive/receiving, communicate/communicating, or exchange/exchanging when used to describe elements (e.g., computer, RPU, MxPU, processor, semiconductor device, switch, port, interface) involved in data, message, packet, or other information exchanges, may refer to direct or indirect operation(s) that facilitate information transfer to/from/between such elements. When a first element is said to send information to a second element, it is not required to directly transmit the information from the first element to the second element; similarly, when a first element is said to receive information from a second element, the first element is not required to directly obtain the information from the second element. Instead, the elements may initiate, cause, make available, control, direct, participate in, or otherwise facilitate such transfer. The information transfer may occur directly or indirectly utilizing one or more intermediary components, such as switches, retimers, redrivers, bridges, and/or protocol translators, and may include routing, forwarding, encryption, buffering, protocol conversion, or other suitable data transfer mechanisms over a suitable communication path and/or connection. Similarly, sentences in the form of “a port/interface configured to communicate with an entity” refer to direct or indirect coupling between the port/interface and the entity.

As used herein, “mounted to” refers to a physical coupling between components, such as cards, boards, or devices, where a first component is mechanically secured or attached to a second component through a suitable mounting mechanism. The physical mounting may be direct or may involve intermediate mounting structures, and encompasses components that are mounted on, mounted in, mounted within, mounted through, mounted under, mounted alongside, or mounted via a mechanical coupling arrangement. The physical mounting connection may include an electrical connection integrated with the mechanical mounting mechanism, such as when a card is inserted into a slot with integrated electrical contacts. Alternatively, the electrical connection between mounted components may be established through a separate element from the mechanical mounting structure. Non-limiting examples of such separate electrical connection elements may include: cables (such as MCIO cables, SlimSAS cables, or power cables), sockets, card edge connectors, PCIe connectors, CXL connectors, backplane connectors, EDSFF connectors, OCP connectors, QSFP-DD connectors, or other electrical interconnects suitable for establishing electrical communication between the mounted components.

References to a protocol “based on” a specific standard or an industry standard (such as a protocol based on CXL, a CXL-based protocol, a protocol based on UALink, a UALink-based protocol, a protocol based on NVLink, an NVLink-based protocol, a protocol based on CHI, a CHI-based protocol, a protocol based on Ethernet, an Ethernet-based protocol, a protocol based on PCIe, or a PCIe-based protocol) are intended to encompass protocols that conform to the referenced standard, as well as protocols that maintain the fundamental communication logic and essential functional characteristics of the referenced standard while potentially incorporating modifications, extensions, or variations. Non-limiting examples of such variations may include protocols that utilize renamed, reordered, or modified fields while preserving the same or similar message formats; protocols that implement essentially the same logical operations utilizing equivalent command sequences or opcodes; protocols that preserve the essential addressing schemes, routing logic, and coherency models; vendor-specific implementations that add proprietary extensions while maintaining core functionality; protocols that implement subsets of the full standard specification; or protocols that adapt the standard for different physical layers or transport mechanisms while maintaining the essential protocol properties. For example, a CXL-based protocol may encompass implementations that rename CXL.mem opcodes but preserve their memory access properties, add vendor-defined fields to CXL message formats while maintaining backward compatibility, or that implement CXL transaction flows over alternative physical layers such as IEEE 802.3 PMA or UCIe. A UALink-based protocol may encompass implementations that add vendor-defined fields, packets, or commands while preserving the essential accelerator-to-accelerator communication model. A PCIe-based protocol may encompass implementations that utilize non-PCIe physical layers or carrier protocols for transferring PCIe TLPs. An NVLink-based protocol may encompass implementations that extend or modify the command encoding while maintaining the fundamental interconnect functionality.

References to a protocol-based port (such as CXL-based port, UALink-based port, NVLink-based port, or PCIe-based port) are intended to encompass ports that communicate according to the referenced protocol or according to a protocol based on the referenced protocol. A protocol-based port may communicate over the protocol's native physical layer, over alternative physical and/or transport layers, or according to the protocol encapsulated within, tunneled over, or transported over other protocols or interconnect technologies. For example, a CXL-based port may refer to a standard CXL port communicating over PCIe physical layer, a port communicating according to CXL over a physical layer based on IEEE 802.3 PMA, or a port communicating according to CXL over UCIe. A UALink-based port may communicate over its native physical layer, over UCIe, over ESUN, or over SUE. Similarly, an NVLink-based port may communicate over its native physical layer, over UCIe, over ESUN, or over SUE.

The drawings presented herein are schematic representations, meaning that the number, order, timings, dimensions, connections, and other properties of the elements illustrated in the drawings are non-limiting examples. Depending on the context, elements (such as lines, arrows, boxes, blocks, symbols, or labels) illustrated in the drawings may represent one or more actual elements. For example, a single box in a block diagram may represent multiple hardware components or software modules, a single arrow in a flowchart may represent multiple process steps or data transfers, and a single line in a circuit diagram may represent multiple electrical connections. Every modification, variation, or alternative allowed by current or future relevant specifications, standards, or common practices in the field is intended to be included within the scope of said drawings. Furthermore, the scope of the drawings extends to encompass implementations that may deviate from strict specifications due to factors such as hardware bugs, relaxed designs, implementation-specific optimizations, or practical constraints, provided such deviations do not fundamentally alter the underlying principles of the implementation.

A computer program (also referred to as software, firmware, or executable logic) encompasses any set of instructions, logic, or data structures executable or interpretable by a computing device. This includes compiled or interpreted code, scripts, and machine-learning models (e.g., neural network weights, biases, and configurations). The computer program may be deployed as a standalone application, autonomous agent, service, microservice, container, or distributed module, and may be organized within any storage architecture, including file systems, object storage, or memory-mapped configurations. The program may reside locally, in a distributed network, or a cloud environment, and may utilize static or dynamic execution paradigms.

As used herein, “non-transitory computer-readable medium” refers to any tangible medium capable of storing instructions, code, or data for access by a computing device, excluding transitory propagating signals. This encompasses all forms of volatile and non-volatile memory, including semiconductor memory (e.g., RAM, Flash, RRAM, MRAM), magnetic storage, optical storage, and emerging persistent storage technologies. The medium may be integral to a device, removable, or distributed across multiple locations (e.g., a distributed database or cloud storage). The instructions, logic, or data structures may be pre-installed or downloaded to the medium via a communication network, such as the Internet. A computer program product comprises such a non-transitory medium containing content that, when accessed by one or more processors, performs the disclosed methods.

The “computer-implemented methods” described herein refer to method operations executed by processing hardware based on logical instructions, firmware, and/or hardwired logic. The processing hardware may include general-purpose processors, ASICs, FPGAs, or other hardware logic that implements the method operations through software execution, firmware execution, dedicated circuitry, or combinations thereof. The execution environment may be centralized or distributed, encompassing standalone devices, networked systems, cloud-based platforms, edge computing nodes, virtualized or containerized environments, and hybrid combinations thereof. The instructions or logic defining the method may be stored on one or more non-transitory computer-readable media, encoded in hardware description languages, and/or implemented in circuit logic.

Unless specifically requiring a particular implementation form, functionality described as implemented in hardware may alternatively be implemented in software, firmware, or a combination thereof, and vice versa. Similarly, functions described as performed by a single component may be distributed across multiple components, and functions described as distributed may be consolidated into a single component. The allocation of functions between hardware and software, or between centralized and distributed implementations, does not limit the scope of the implementations unless explicitly required.

The methods, algorithms, logics, processes, operations, and system functions described herein are not limited by a particular order, timing, sequence, grouping, or a specific implementation or example described or illustrated unless expressly stated otherwise. Steps, operations, and functions may be performed in any reasonable order, simultaneously or sequentially, in parallel or series, and may be combined, separated, modified, rearranged, omitted, supplemented, or distributed across multiple systems or components based on particular implementation requirements. Any process descriptions, steps, or blocks in flowcharts or other illustrations should be understood as potentially representing modules, segments, portions of code, or operations that may be executed in any reasonable order, combination, or concurrently, and are not necessarily limited to the particular sequence depicted.

Phrases such as “an implementation”, “various implementations”, “some implementations”, “one or more implementations”, “an embodiment”, “some embodiments”, “one embodiment”, “an aspect”, “a configuration”, “an example”, and similar phrases are used herein for convenience and do not imply that a disclosure relating to such phrase(s) is essential to the subject technology or that such disclosure applies to all implementations of the subject technology. Phrases such as “an implementation”, “some implementations”, or “various implementations” may refer to one or more implementations and vice versa, and this applies similarly to other foregoing phrases. Distinct references, including terms such as “one implementation”, “another implementation”, “various implementations”, or “some implementations”, do not necessarily denote separate implementations. Such references may describe the same implementation from different perspectives, highlight various aspects of a single implementation, or pertain to distinct implementations. References to examples or instances are to be understood as non-limiting.

Sentences in the form of “X is indicative of Y” mean that X includes information correlated with Y and/or describing Y, up to the case wherein X equals Y. Sentences in the form of “provide/receive an indication (of whether X happened)” may refer to any indication method. The word “most” of something is defined as above 51% of the something (including 100% of the something). The words “portion”, “subset”, “region”, and “area” of something refer to a value between a non-zero fraction of the something and 100% of the something, inclusive; they indicate an open-ended claim language, thus, for example, sentences in the form of “a portion of the memory” or “a subset of the memory” encompass anything from just a small part of the memory to the entire memory, optionally together with additional memory region(s). Sentences in the form of “access the memory” encompass accessing at least a portion of the memory, where the portion may range from a minimal addressable unit to the entire memory capacity, indicating an open-ended claim language. “Coupled” indicates direct or indirect connection, cooperation, and/or interaction, such as direct or indirect physical contact, electrical connection, and/or software and/or hardware interface; the connection between coupled elements may (or may not) involve one or more of passive components, active components, translations, modulation change, modifications to schemes, message alterations, and/or other conversions to the data or signals being transmitted.

The use of “a” or “an” refers to one or more things. The phrase “based on” indicates an open-ended claim language, and encompasses “based, at least in part, on”. Additionally, stating that a value is calculated “based on X” and following that, in a certain implementation, that the value is calculated “also based on Y”, means that in the certain implementation, the value is calculated based on X and Y. Variations of the terms “utilize” and “use” indicate an open-ended claim language, such that sentences in the form of “detecting X utilizing Y” are intended to mean “detecting X utilizing at least Y”, and sentences in the form of “use X to calculate Y” are intended to mean “calculate Y based on X”. The terms first, second, and so forth serve merely as ordinal designations, and shall not be limited in themselves. The phrases “at least one of A or B” and “at least one of A and B” are intended to be interpreted broadly to encompass A alone, B alone, or a combination of both A and B; this interpretation applies regardless of the number of items in a list, or whether the items are connected by the conjunction ‘and’ or ‘or’. A predetermined, predefined, or preselected value is a fixed value and/or a value determined before performing a calculation that utilizes the predetermined value. When appropriate, the word “value” may indicate a predetermined value. The word “threshold” indicates a threshold whose value, and/or the logic used to determine whether the threshold is reached, is established prior to performing the computation that utilizes the threshold, whether the threshold value is fixed, predefined, or dynamically determined.

In the context of RPUs and/or translations, references to “first” and “second” protocols may denote either distinct protocol types, which are different protocols with differing opcodes and functionalities (such as CXL.mem vs. CXL.cache, PCIe vs. NVLink, or UALink vs. SUE), or different instantiations of the same protocol type operating in separate domains or with distinct configurations (such as a first CXL.mem utilizing a first physical address space vs. a second CXL.mem utilizing a second physical address space).

The implementations of an invention may include a variety of combinations and/or integrations of the features of the implementations. Although some implementations may describe serial operations, the implementations may perform certain operations in parallel and/or in different orders from those described. Moreover, the use of repeated reference numerals and/or letters in the text and/or drawings is for the purpose of simplicity and clarity and does not in itself dictate a relationship between the various implementations and/or configurations discussed. Components and/or modules referred to by different reference numerals may or may not perform the same (or similar) functionality, and the fact they are referred to by different reference numerals and/or letters does not mean that they may not have same or similar functionalities.

Certain features of the implementations, which may have been, for clarity, described in the context of separate implementations, may also be provided in various combinations in a single implementation. Conversely, various features of the implementations, which may have been, for brevity, described in the context of a single implementation, may also be provided separately or in any suitable sub-combination. Implementations described in conjunction with specific examples are presented by way of example, and not limitation. Moreover, it is evident that many alternatives, modifications, and variations will be apparent to those skilled in the art. It is to be understood that other implementations may be utilized and structural changes may be made without departing from the scope of the implementations.

The drawings depict some of the couplings between elements, but not necessarily all. The depiction of elements as separate entities may be done to emphasize different functionalities of elements that may be implemented by the same software and/or hardware. Programs and/or elements illustrated and/or described as being single may be implemented via multiple programs and/or involve multiple hardware elements possibly in different locations. The implementations are not limited in their applications to the details of order, or sequence of method steps, or to details of implementation of the devices, set in the description, drawings, or examples. Individual blocks illustrated in the drawings may be functional in nature and therefore may not necessarily correspond to discrete hardware elements.

In implementations where the first domain and the second domain may be associated with the same physical address space, the translator may utilize the address in the transaction associated with the first protocol for generating the address in the transaction associated with the second protocol, possibly copying the address value as is between the messages, or adjusting for address width differences between the messages by zero-extending or truncating unused upper address bits. For example, when translating between CXL-based traffic and ISoL traffic such as UPI, wherein both requests utilize the same physical address space, an address such as (AS.1.1) in a CXL.mem request may be utilized to generate the corresponding address (AS.2.1) in a UPI request. Similarly, when translating between CHI-based traffic and PCIe traffic that share the same physical address space, or between NVLink traffic and CHI traffic in certain configurations, the translator may perform comparable address formatting operations without changing the underlying memory location being referenced. Hence, in relevant contexts, notations in the form of (AS.1.1) and (AS.2.1) used in the drawings may refer to the same address represented in different protocols, such as the address (AS.1.1)=00-00-CA-FE in a protocol that utilizes 32-bit address fields, which corresponds to the address (AS.2.1)=00-00-00-00-00-00-CA-FE in a protocol that utilizes 64-bit address fields.

Claims in the form of “A non-transitory computer-readable medium comprising instructions which, when executed by a processor, cause the processor to perform the method of claim X” are intended to encompass physical storage media capable of storing instructions, including but not limited to semiconductor memory, magnetic storage, optical storage, and other persistent storage technologies. The instructions may be in any form capable of directing a processor to perform the method, including but not limited to compiled code, interpreted code, bytecode, firmware, as well as other forms of directives such as natural language directives, declarative specifications, model parameters or configurations, and symbolic representations, among other formats that may be suitable for processing by processors, AI modules, neural processing units, or other current or future processing architectures. The processor may include any processing unit capable of executing or interpreting stored instructions, including but not limited to CPUs, microprocessors, microcontrollers, DSPs, GPUs, neural processing units, AI accelerators, and quantum processing units. The stored instructions may cause a single processor to perform the method, or may cause the processor to coordinate with one or more additional processors to collectively perform the method in a distributed manner.

Claims in the form of “One or more integrated circuits configured to perform the method of claim X, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages” are intended to encompass hardware implementations that execute, implement, realize, or carry out method steps through circuitry, programmable circuitry, stored instructions executed by processing elements, or distributed across multiple chiplets. The first alternative covers implementations based on processing units designed to execute arbitrary software instructions, including but not limited to CPUs, microprocessors, and application processors, that execute software or firmware to perform the method, with communication interfaces enabling data exchange with other system components. The second alternative covers implementations where specialized circuitry provides hardware acceleration or dedicated processing capabilities, including but not limited to ASICs, FPGAs, PLDs, and SoC devices, wherein the functionality is implemented using electronic and/or photonic components, programmable logic, or combinations thereof. The third alternative covers chiplet-based implementations where the method is performed by one or more semiconductor dies designed for integration within multi-chip modules or system-in-package configurations. These chiplets may reside within a single package or across multiple packages, communicating via inter-chiplet protocols such as UCIe, AIB, CHI-C2C, or other die-to-die interfaces when within the same package, or via package-to-package interfaces when distributed across different packages. The packages may utilize various integration technologies, including but not limited to 2.5D silicon interposers, 3D stacking, organic substrates, and embedded bridge technologies. The method may be partitioned across multiple chiplets with different chiplets implementing different portions, or a single chiplet may implement the complete method.

Claims in the form of “An active cable comprising first and second pluggable modules coupled by a physical medium; wherein the active cable further comprises hardware circuitry, integrated into the active cable, configured to perform the method of claim X” are intended to encompass cable assemblies that include active electronic components capable of processing and modifying signals during transmission. Such claims cover cables having connectors at each end designed for insertion into corresponding receptacles, connected by a transmission medium that may include copper conductors, optical fibers, or other signal-carrying media. The electronic components performing the method may be incorporated anywhere within the cable assembly, including within either or both of the pluggable connectors, or positioned along the cable between segments of the physical medium. The implementation may utilize fixed circuit arrangements, programmable logic, firmware, or combinations thereof. The electronic components may perform the entire method within the cable or may work in conjunction with other processing elements to implement the complete functionality.

Claims in the form of “An apparatus configured to operate as a switch, wherein the apparatus comprises switching circuitry and is configured to perform the method of claim X” are intended to encompass apparatus that selectively routes signals, data, or communications between ports while also performing the method. Such claims cover traditional switching devices with dedicated switch ports as well as processor-based switches and other architectures that achieve switching functions through alternative port configurations. The ports through which data enters or exits the switching function may include physical ports, logical ports, virtual ports, or other port types appropriate for the switching architecture. The apparatus may include homogeneous ports supporting a single protocol or heterogeneous ports supporting different protocols, speeds, or functionalities. The method operations are performed as part of the switching functionality through hardware, firmware, and/or logic contained within the apparatus.

Accordingly, this disclosure is intended to embrace all such alternatives, modifications, and variations that fall within the spirit and scope of the appended claims and their equivalents.

We claim:

1. A method comprising:
receiving, from a first entity, an Ultra Accelerator Link Protocol Level Interface (UPLI) request comprising a read command;
translating, by a Resource Provisioning Unit (RPU), the UPLI request to a CXL.cache Device-to-Host (D2H) request comprising a read opcode, wherein CXL denotes Compute Express Link;
sending the CXL.cache D2H request to a second entity;
receiving, from the second entity, a CXL.cache Host-to-Device (H2D) data message;
translating, by the RPU, the CXL.cache H2D data message to a UPLI read response; and
sending the UPLI read response to the first entity.

2. The method of claim 1, wherein the UPLI request comprises a source accelerator identifier and a destination accelerator identifier, and the UPLI read response comprises a destination accelerator identifier carrying a value that matches the source accelerator identifier from the UPLI request, and wherein the RPU saves at least the source accelerator identifier from the UPLI request for use in generating the UPLI read response.

3. The method of claim 1, wherein the UPLI request further comprises a first address and a first Tag, the CXL.cache D2H request comprises a second address translated from the first address and a command queue identifier (CQID) associated with the first Tag, and the UPLI read response comprises the first Tag.

4. The method of claim 1, wherein the UPLI request further comprises a length field indicating an amount of data requested; and wherein translating the UPLI request comprises generating multiple CXL.cache D2H requests when the amount of data requested exceeds a maximum CXL.cache transaction size.

5. The method of claim 4, wherein the UPLI request comprises a Tag, the CXL.cache D2H requests comprise command queue identifiers (CQIDs); and wherein generating the multiple CXL.cache D2H requests comprises associating multiple CQIDs with the Tag.

6. The method of claim 4, wherein translating the CXL.cache H2D data message further comprises: receiving multiple CXL.cache H2D data messages corresponding to the multiple CXL.cache D2H requests, aggregating data from the multiple CXL.cache H2D data messages, and including the aggregated data in the UPLI read response.

7. The method of claim 1, wherein the read opcode of the CXL.cache D2H request is RdCurr, and processing the CXL.cache D2H request does not change existing state in a cache accessible to the RPU.

8. The method of claim 1, wherein the read command is selected from at least one of: a Read command, an AtomicR command, or a Vendor Defined Command with read data returned over a UPLI read response/data (Rd Rsp/Data) Channel; and wherein the read opcode is selected from at least one of: RdCurr, RdOwn, RdShared, or RdAny.

9. The method of claim 1, wherein the CXL.cache H2D data message comprises first data in a first format; and wherein translating the CXL.cache H2D data message comprises transforming the first data to second data in a second format for the UPLI read response.

10. The method of claim 1, further comprising: receiving, from the first entity, a UPLI request comprising a write command and write data; translating, by the RPU, the UPLI request comprising the write command to a CXL.cache D2H request comprising a write opcode selected from at least one of: DirtyEvict, ItoMWr, WrCur, or WrInv; and sending the CXL.cache D2H request comprising the write opcode and the write data to the second entity;
wherein the first entity comprises a UPLI originator, an accelerator, or a UALink switch; and
wherein the second entity comprises a CXL host; and wherein the RPU comprises a CXL device exposing a CXL endpoint to the second entity.

11. An active cable comprising first and second pluggable modules coupled by a physical medium; wherein the active cable further comprises hardware circuitry, integrated into the active cable, configured to perform the method of claim 1.

12. An apparatus configured to operate as a switch, wherein the apparatus comprises switching circuitry and is configured to perform the method of claim 1.

13. An apparatus comprising:
a first interface configured to communicate according to an Ultra Accelerator Link Protocol Level Interface (UPLI);
a second interface configured to communicate according to CXL.cache, wherein CXL denotes Compute Express Link; and
a computer coupled to the first interface and the second interface, the computer configured to:
translate a UPLI request comprising a read command, received via the first interface, to a CXL.cache Device-to-Host (D2H) request comprising a read opcode, and send the CXL.cache D2H request via the second interface; and
translate a CXL.cache Host-to-Device (H2D) data message, received via the second interface, to a UPLI read response, and send the UPLI read response via the first interface.

14. The apparatus of claim 13, wherein the UPLI request comprises a source accelerator identifier and a destination accelerator identifier, the UPLI read response comprises a destination accelerator identifier carrying a value that matches the source accelerator identifier from the UPLI request; and wherein the computer is configured to save at least the source accelerator identifier from the UPLI request for use in generating the UPLI read response.

15. The apparatus of claim 13, wherein the UPLI request further comprises a first address and a first Tag, the CXL.cache D2H request comprises a second address translated from the first address and a command queue identifier (CQID) associated with the first Tag, and the UPLI read response comprises the first Tag; and wherein the computer is further configured to receive, via the second interface, a CXL.cache H2D response comprising a Global Observation (GO) opcode and the CQID, the GO opcode indicating a cache coherency state.

16. The apparatus of claim 13, wherein the UPLI request further comprises a length field indicating an amount of data requested; and wherein the computer is further configured to generate multiple CXL.cache D2H requests when the amount of data requested exceeds a maximum CXL.cache transaction size.

17. The apparatus of claim 16, wherein the UPLI request comprises a Tag, the CXL.cache D2H requests comprise command queue identifiers (CQIDs); and wherein the computer is further configured to associate multiple CQIDs with the Tag when generating the multiple CXL.cache D2H requests.

18. The apparatus of claim 16, wherein the computer is further configured to: receive multiple CXL.cache H2D data messages corresponding to the multiple CXL.cache D2H requests, aggregate data from the multiple CXL.cache H2D data messages, and include the aggregated data in the UPLI read response.

19. The apparatus of claim 13, wherein the read opcode of the CXL.cache D2H request is RdCurr, and as a result of processing the CXL.cache D2H request the computer is further configured not to change existing state in a cache accessible to the computer.

20. The apparatus of claim 13, wherein the read command is selected from at least one of: a Read command, an AtomicR command, or a Vendor Defined Command with read data returned over a UPLI read response/data (Rd Rsp/Data) Channel; and wherein the read opcode is selected from at least one of: RdCurr, RdOwn, RdShared, or RdAny.

21. The apparatus of claim 13, wherein the CXL.cache H2D data message comprises first data in a first format; and wherein the computer is further configured to transform the first data to second data in a second format for the UPLI read response.

22. The apparatus of claim 13, wherein the computer is further configured to: translate a UPLI request comprising a write command and write data, received via the first interface, to a CXL.cache D2H request comprising a write opcode selected from at least one of: DirtyEvict, ItoMWr, WrCur, or WrInv; and send the CXL.cache D2H request comprising the write opcode and the write data via the second interface; wherein the first interface comprises a UPLI completer.

23. The apparatus of claim 13, wherein the apparatus comprises a chiplet within an integrated circuit (IC) package of a processor, the processor comprising a coherent interconnect coupling processing cores to a memory controller; and wherein the second interface is coupled to the coherent interconnect via a CXL root port; whereby the computer translates UPLI requests to CXL.cache D2H requests that traverse the coherent interconnect to access memory coupled to the memory controller.

24. An active cable comprising: a first pluggable module coupled to a first physical medium, a second pluggable module coupled to a second physical medium, and an apparatus according to claim 13 coupling the first and second physical media.

25. A method comprising:
executing, by an accelerator comprising local memory, an inference workload on a neural network model;
sending, by the accelerator, an Ultra Accelerator Link Protocol Level Interface (UPLI) request comprising a read command for model data stored in a host memory of a host;
translating, by a Resource Provisioning Unit (RPU), the UPLI request to a CXL.cache Device-to-Host (D2H) request comprising a read opcode, wherein CXL denotes Compute Express Link;
sending the CXL.cache D2H request to the host;
receiving, from the host, a CXL.cache Host-to-Device (H2D) data message comprising the model data;
translating, by the RPU, the CXL.cache H2D data message to a UPLI read response comprising the model data; and
sending the UPLI read response to the accelerator.

26. The method of claim 25, wherein the model data comprises at least one of: expert weights associated with a Mixture-of-Experts (MoE) model, the expert weights fetched from the host memory when a gating network of the MoE model routes one or more tokens to an expert;
key-value (KV) cache entries previously offloaded from the local memory to the host memory during inference of a sequence; or attention parameters associated with a transformer-based model.

27. The method of claim 25, further comprising: sending, by the accelerator, a UPLI request comprising a write command and inference context data; translating, by the RPU, the UPLI request comprising the write command to a CXL.cache D2H request comprising a write opcode; and sending the CXL.cache D2H request and the inference context data to the host for storage in the host memory.

28. A system comprising:
an accelerator comprising local memory and configured to communicate according to an Ultra Accelerator Link Protocol Level Interface (UPLI);
a host comprising host memory and configured to communicate according to CXL.cache, wherein CXL denotes Compute Express Link; and
a Resource Provisioning Unit (RPU) coupled between the accelerator and the host, the RPU comprising a first interface configured to communicate with the accelerator according to UPLI and a second interface configured to communicate with the host according to CXL.cache;
wherein the RPU is configured to:
translate a UPLI request comprising a read command, received from the accelerator via the first interface, to a CXL.cache Device-to-Host (D2H) request comprising a read opcode, and send the CXL.cache D2H request to the host via the second interface; and
translate a CXL.cache Host-to-Device (H2D) data message, received from the host via the second interface, to a UPLI read response, and send the UPLI read response to the accelerator via the first interface;
whereby the accelerator accesses the host memory via the RPU.

29. The system of claim 28, wherein a capacity of the host memory exceeds a capacity of the local memory; and wherein the local memory comprises high-bandwidth memory (HBM) and the host memory comprises removable DDR modules, or CXL-attached memory; whereby the accelerator accesses a combined memory capacity comprising the local memory and the host memory; and wherein the RPU is further configured to: translate a UPLI request comprising a write command and write data, received from the accelerator, to a CXL.cache D2H request comprising a write opcode; and send the CXL.cache D2H request comprising the write opcode and the write data to the host for storage in the host memory.

30. The system of claim 28, further comprising a UALink switch coupled between the accelerator and the RPU; wherein the UALink switch routes the UPLI request from the accelerator to the RPU based on a destination accelerator identifier carried in the UPLI request; and wherein accelerators are coupled to the UALink switch, the accelerators sharing access to the host memory via the RPU.
